(19) United States
(12) Patent Application Publication
(10) Pub. No.: US 2014/0006303 A1
(43) Pub. Date: Jan. 2, 2014

(54) Consistent Interface for Customer Contract and Customer Contract Template - Message Set 1

(71) Applicants: Christian Haas, Heidelberg (DE); Uwe Enderle, Weingarten (DE); Phani Bhushan Dhar, Heidelberg (DE); Olivier M. Dreidemy, Holving (FR); Christian Griese, Malsch (DE); Alexander Koegler, Walldorf (DE); Alexandra Mark, Malsch (DE); Bernhard May, Merzig (DE); Ralph Meiswinkel, Bad Schoenborn (DE); Hamid Moghaddam, Osterburken (DE); Sabine Montnacher, Goettelborn (DE); Attila Orban, Blieskastel-Blickweiler (DE); Tibor Tarnai, Heidelberg (DE); Ivo Schmidt, Wuppertal (DE); Frank Freitag, Angelbachtal (DE); Martin Szabadi, Heidelberg (DE); Simon Dieterich, Heidelberg (DE)

(72) Inventors: Christian Haas, Heidelberg (DE); Uwe Enderle, Weingarten (DE); Phani Bhushan Dhar, Heidelberg (DE); Olivier M. Dreidemy, Holving (FR); Christian Griese, Malsch (DE); Alexander Koegler, Walldorf (DE); Alexandra Mark, Malsch (DE); Bernhard May, Merzig (DE); Ralph Meiswinkel, Bad Schoenborn (DE); Hamid Moghaddam, Osterburken (DE); Sabine Montnacher, Goettelborn (DE); Attila Orban, Blieskastel-Blickweiler (DE); Tibor Tarnai, Heidelberg (DE); Ivo Schmidt, Wuppertal (DE); Frank Freitag, Angelbachtal (DE); Martin Szabadi, Heidelberg (DE); Simon Dieterich, Heidelberg (DE)

(73) Assignee: SAP AG

(21) Appl. No.: 13/535,435

(22) Filed: Jun. 28, 2012

(51) Int. Cl. G06Q 99/00

(52) U.S. Cl. CPC G06Q 99/00
USPC 705/345

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to a customer contract and a customer contract template business object.

### CROSS-REFERENCE TO RELATED APPLICATIONS

Some details of the subject matter of this specification are described in previously-filed U.S. patent application Ser. No. 11/803,178, entitled “Consistent Set of Interfaces Derived From a Business Object Model”, filed on May 11, 2007, which is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, a computer-readable medium includes program code for providing a message-based interface for exchanging information about customer contracts. The medium comprises program code for receiving, via a message-based interface exposing at least one service as defined in a service registry and from a heterogeneous application executing in an environment of computer systems providing message-based services, a first message for querying information about customer contract data, using a query by elements. The first message includes a message package hierarchically organized as a customer contract by elements query sync message entity and a customer contract selection by elements package including a customer contract selection by elements entity, a processing conditions package including a processing conditions entity, and a requested elements package including a requested elements entity. The medium further comprises program code for sending a second message to the heterogeneous application responsive to the first message.

Implementations can include the following. The customer contract selection by elements entity includes at least one of the following: at least one selection by identifier, at least one selection by item list customer contract life cycle status code, at least one selection by buyer party identifier, and at least one selection by last changed date time. The requested elements entity includes a customer contact.

In another aspect, a distributed system operates in a landscape of computer systems providing message-based services defined in a service registry. The system comprises a graphical user interface comprising computer readable instructions, embedded on tangible media, for querying information about customer contract data, using a query by elements, the instructions using a request. The system further comprises a first memory storing a user interface controller for processing the request and involving a message including a message package hierarchically organized as a customer contract by elements query sync message entity and a customer contract selection by elements package including a customer contract selection by elements entity, a processing conditions package including a processing conditions entity, and a requested elements package including a requested elements entity. The system further comprises a second memory, remote from the graphical user interface, storing a plurality of service interfaces, wherein one of the service interfaces is operable to process the message via the service interface.

Implementations can include the following. The first memory is remote from the graphical user interface. The first memory is remote from the second memory.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIGS. 32-1 through 32-6 collectively depict an example Customer Contract object model.

FIG. 33 depicts an example Customer Contract by Elements Query Sync message data type.

FIG. 34 depicts an example Customer Contract by Elements Response Sync message data type.

FIGS. 35-1 through 35-4 collectively depict an example Form Customer Contract Notification message data type.

FIGS. 36-1 through 36-6 collectively depict an example Customer Contract by Elements Query Sync element structure.

FIGS. 37-1 through 37-11 collectively depict an example Customer Contract by Elements Response Sync element structure.

FIGS. 38-1 through 38-92 collectively depict an example Form Customer Contract Notification element structure.

FIGS. 39-1 through 39-4 collectively depict an example Customer Contract Template object model.

### DETAILED DESCRIPTION

A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

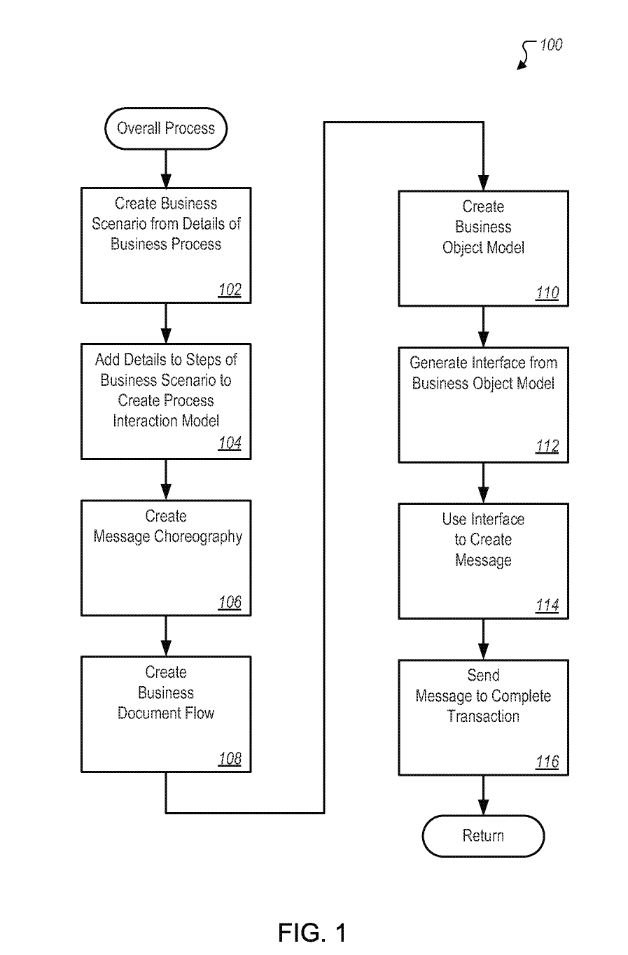

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

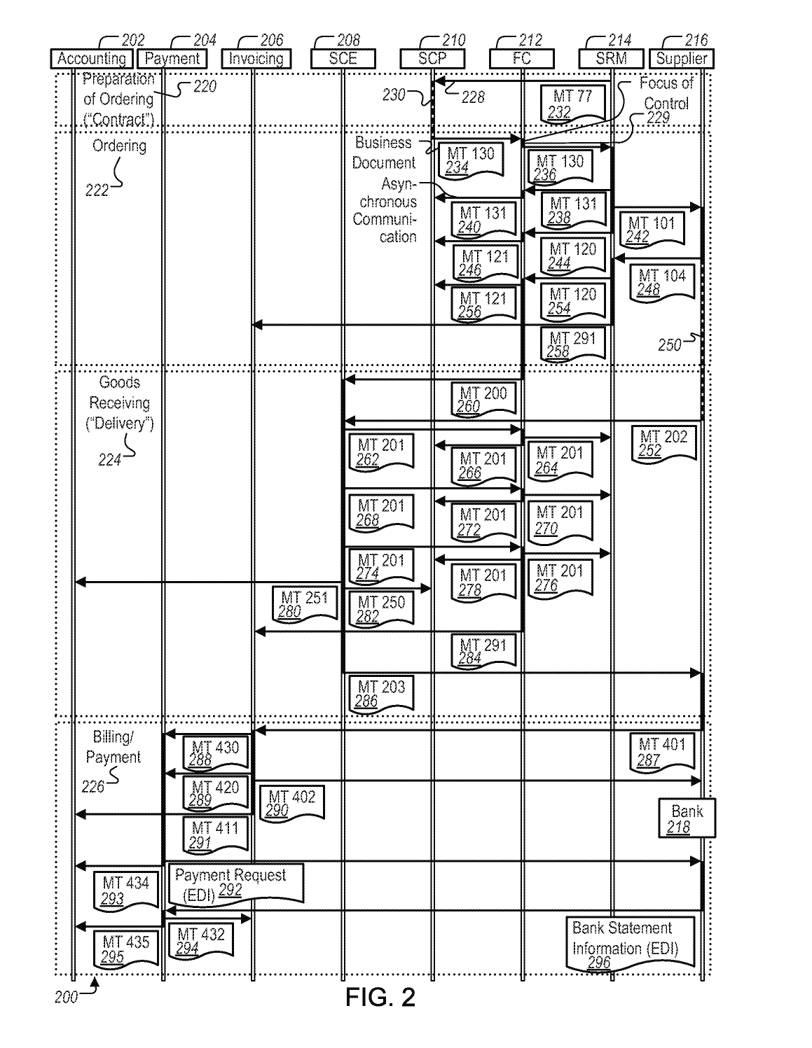

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

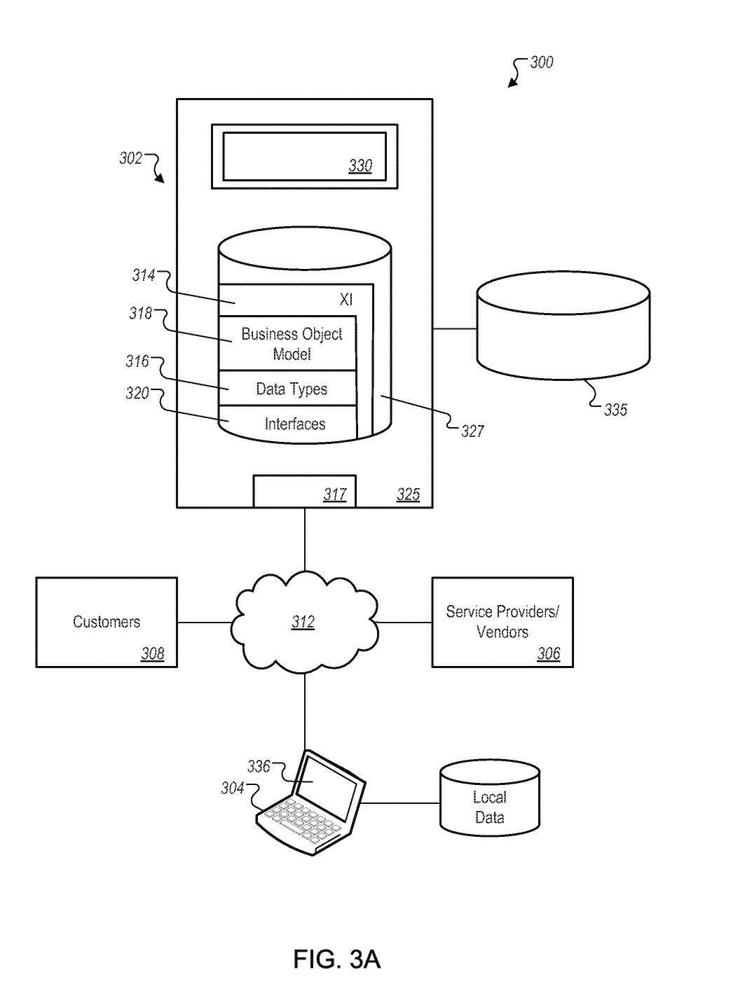

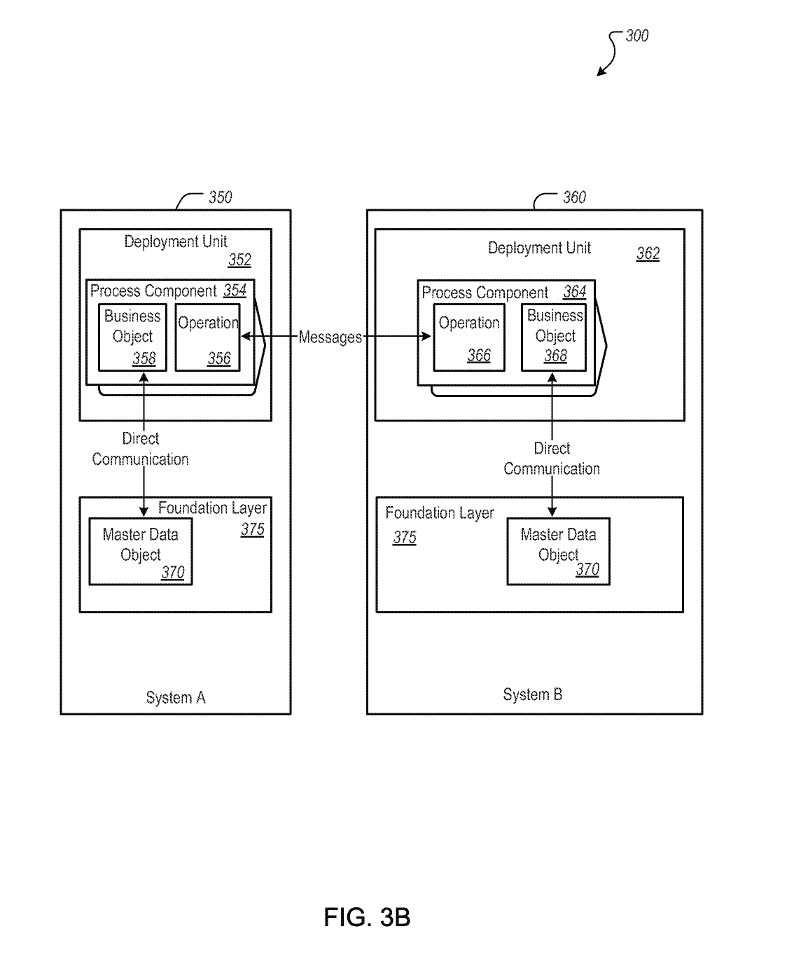

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

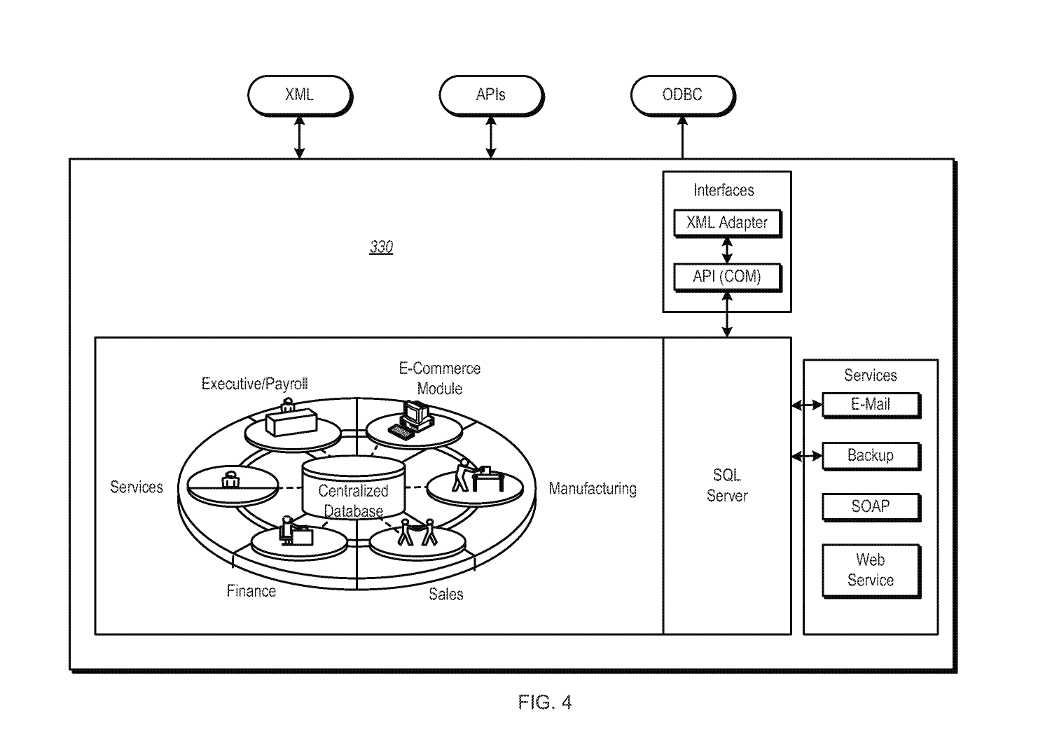

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor 306 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

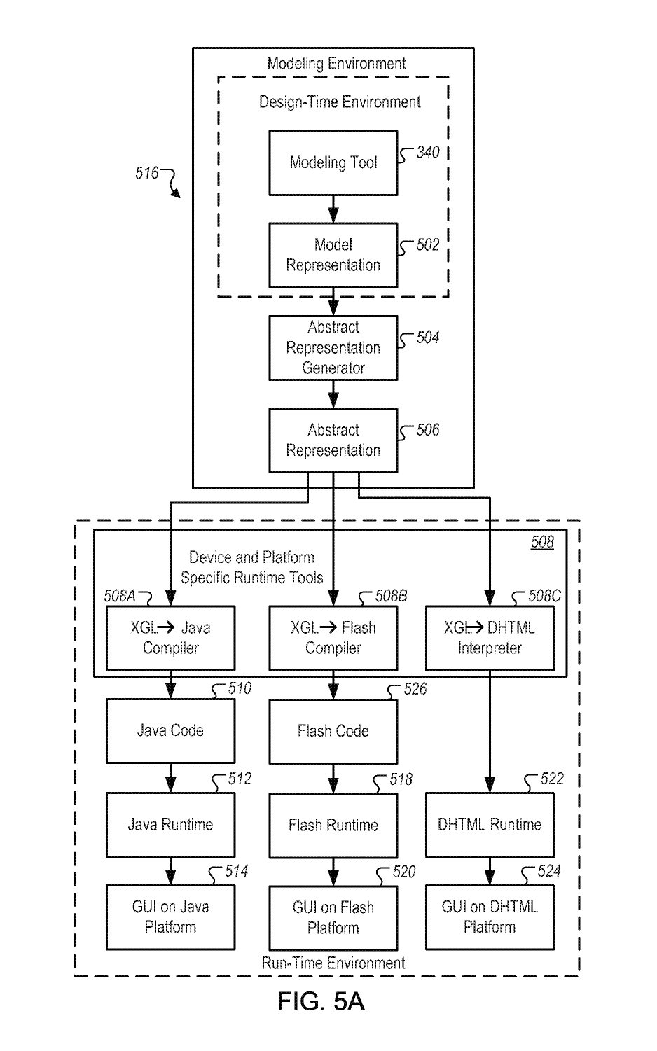

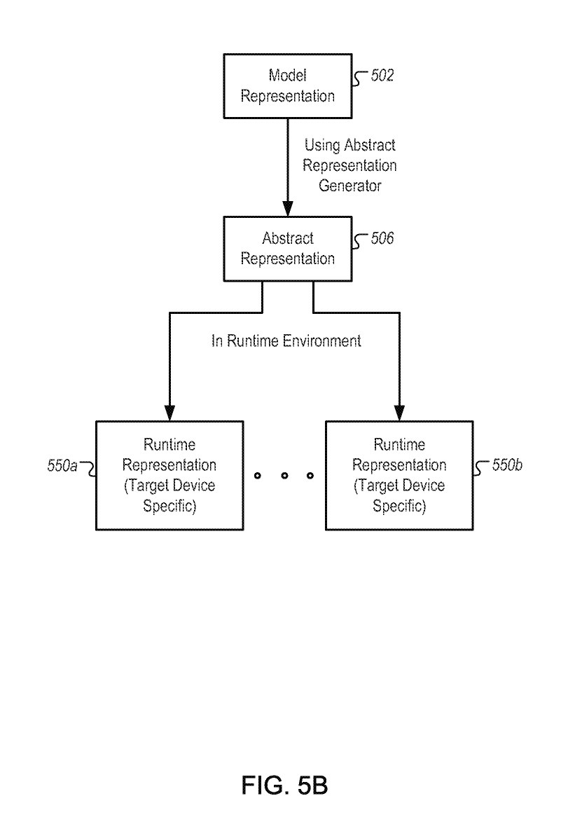

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

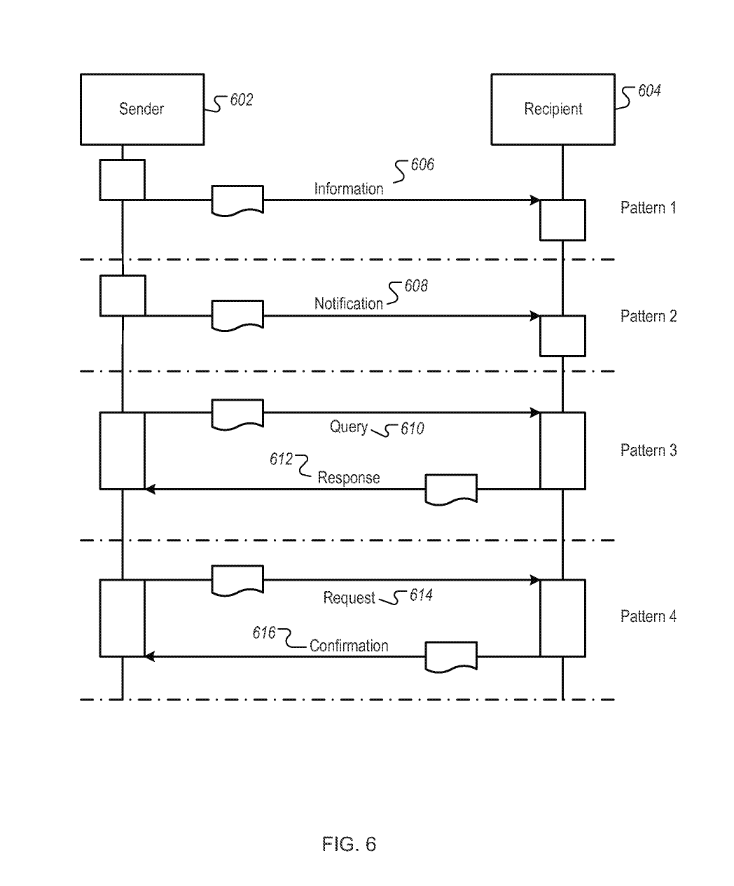

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

(1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

(2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

(3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

(4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

(5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

(6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model”. For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

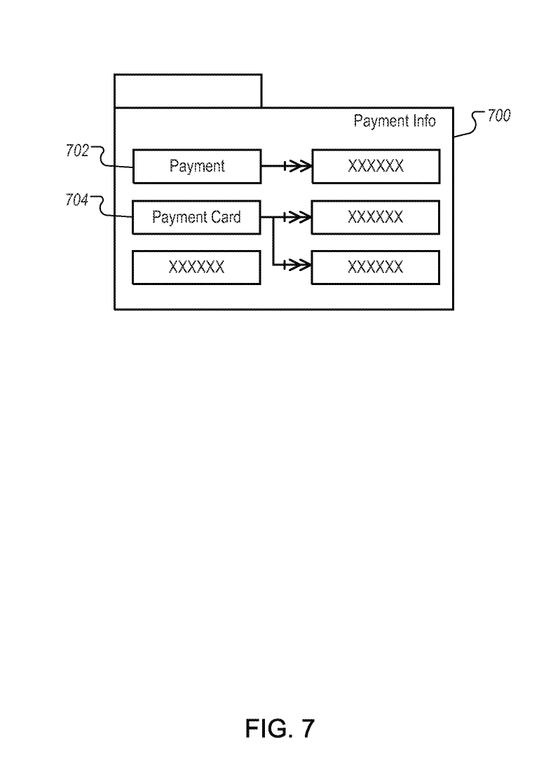

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

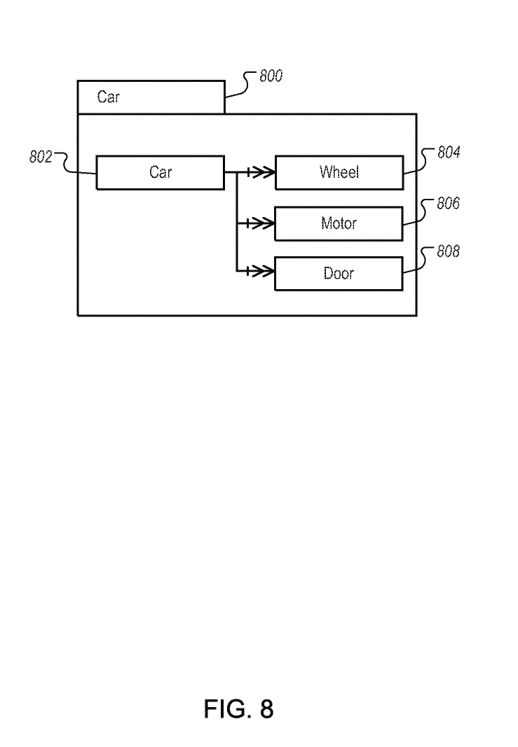

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

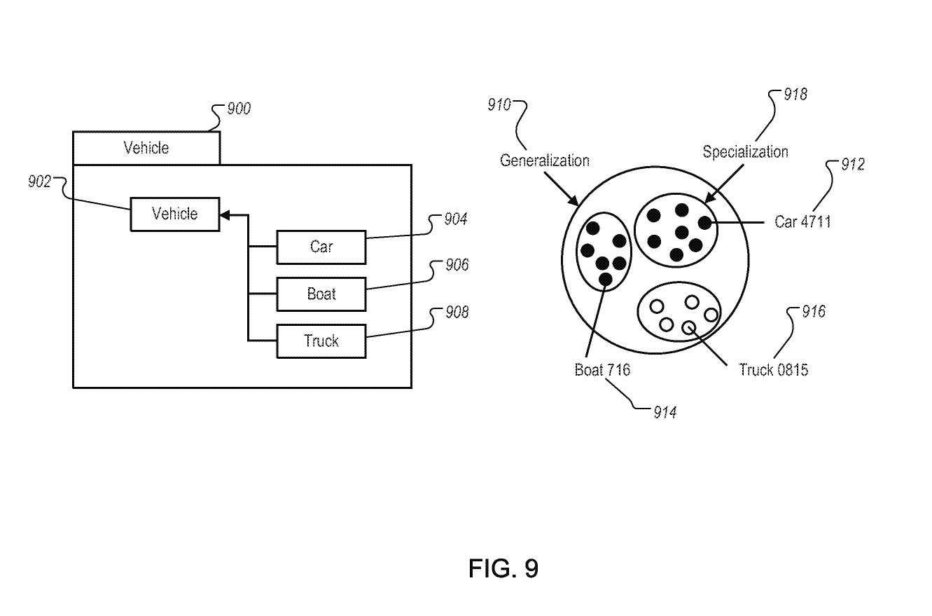

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

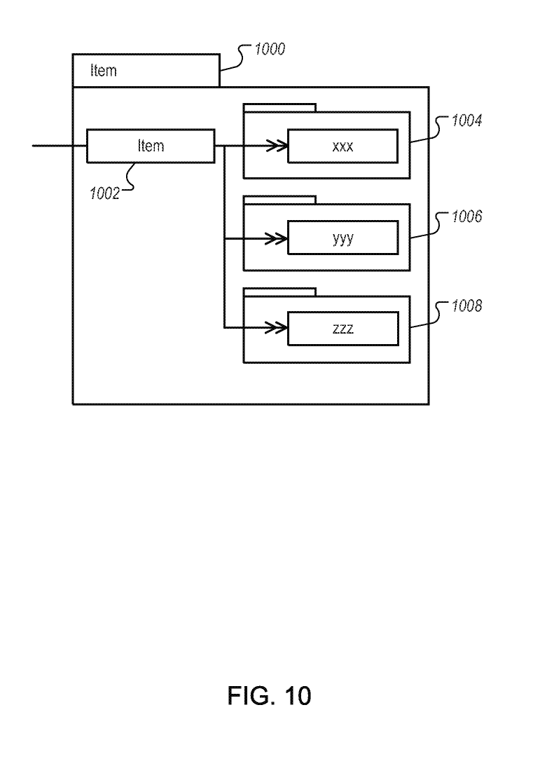

Packages also may be used to represent hierarchy levels. For example, as depicted in FIG. 10, the Item Package 1000 includes Item 1002 with subitem xxx 1004, subitem yyy 1006, and subitem zzz 1008.

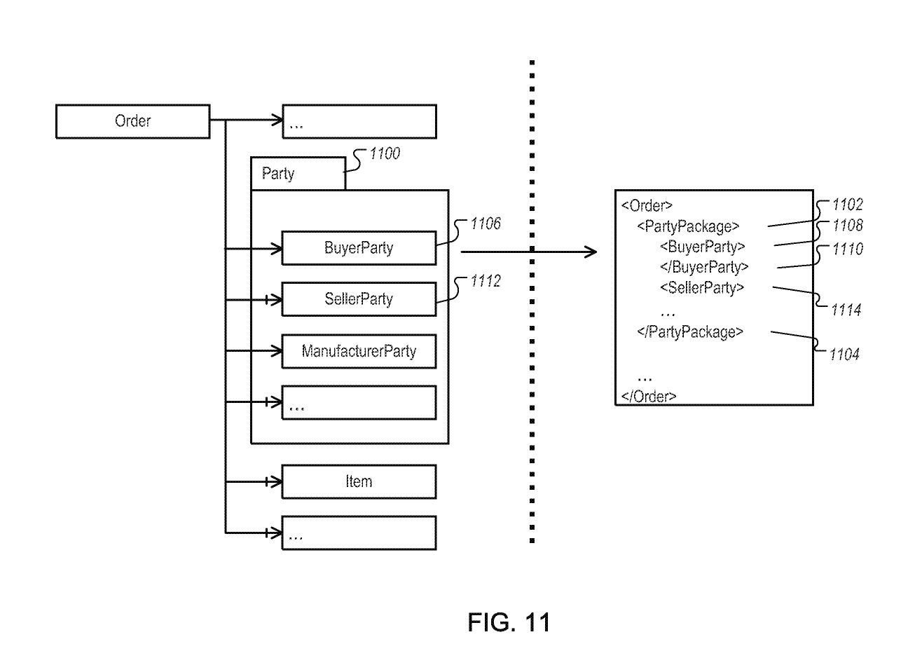

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

(1) Cardinality of Relationships

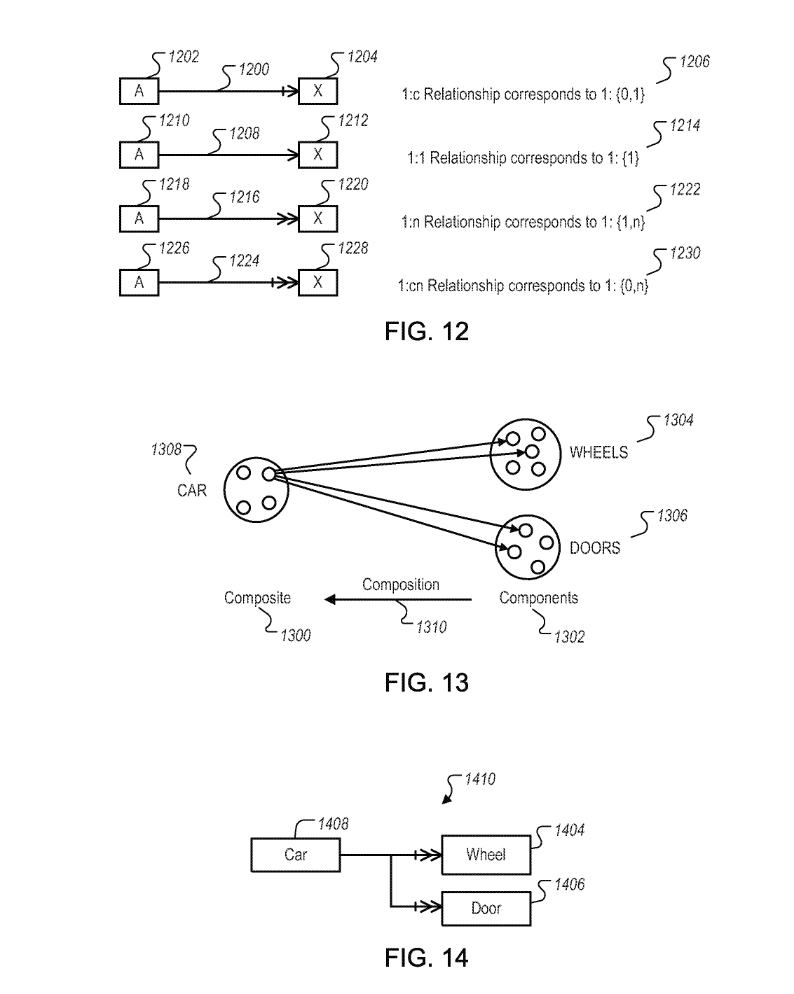

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

(2) Types of Relationships

(a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

(b) Aggregation

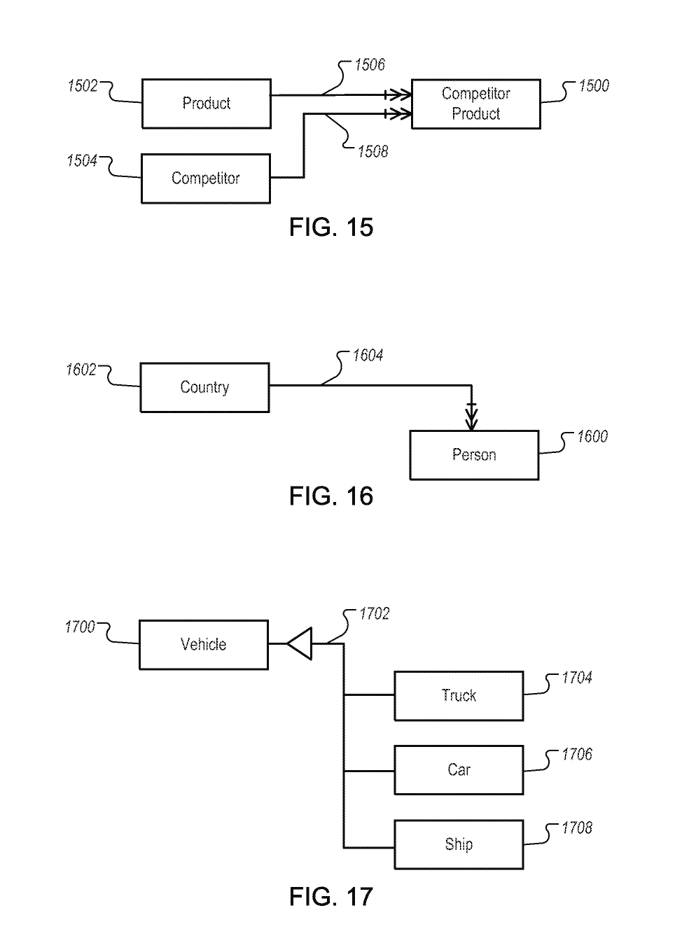

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

(c) Association

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

(3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

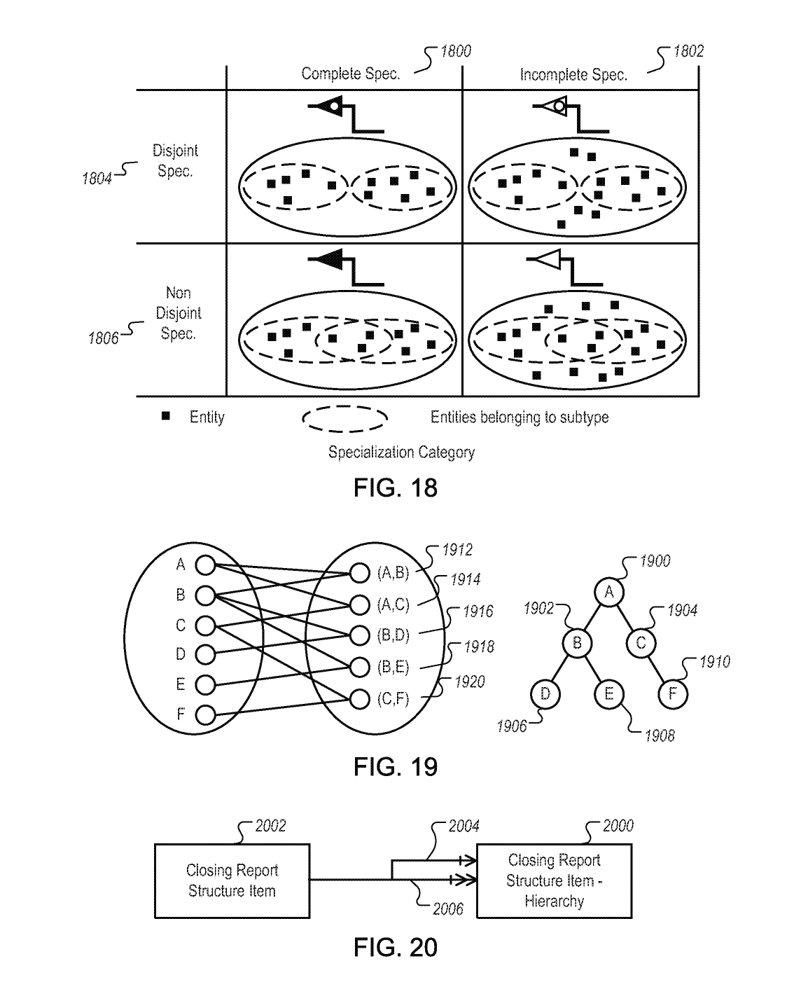

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

e) Structural Patterns

(1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

(2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

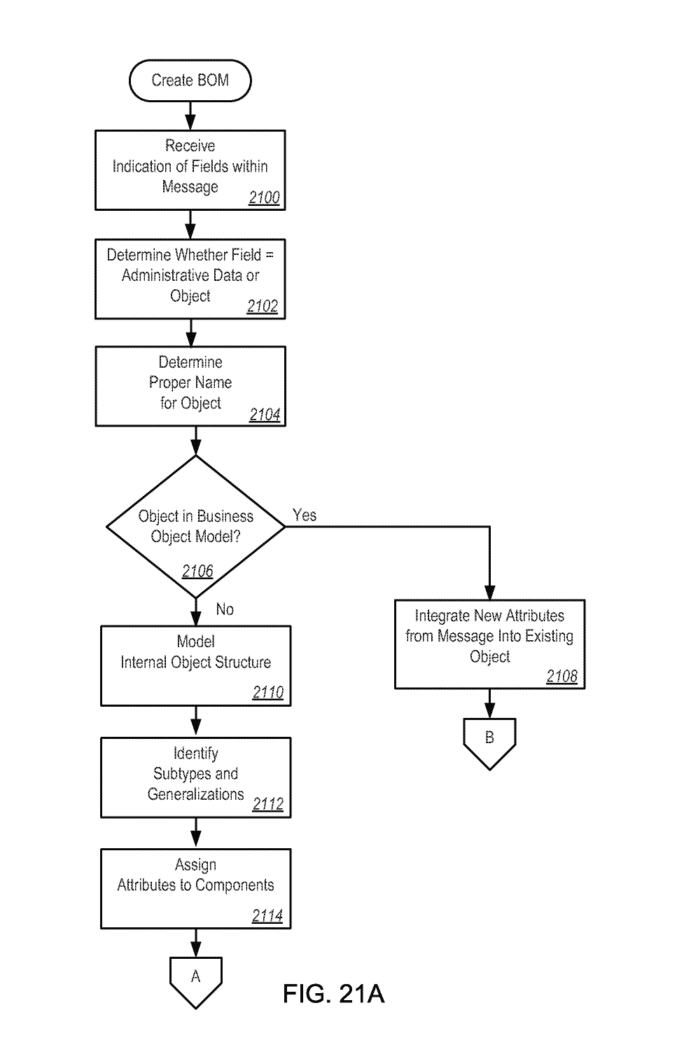

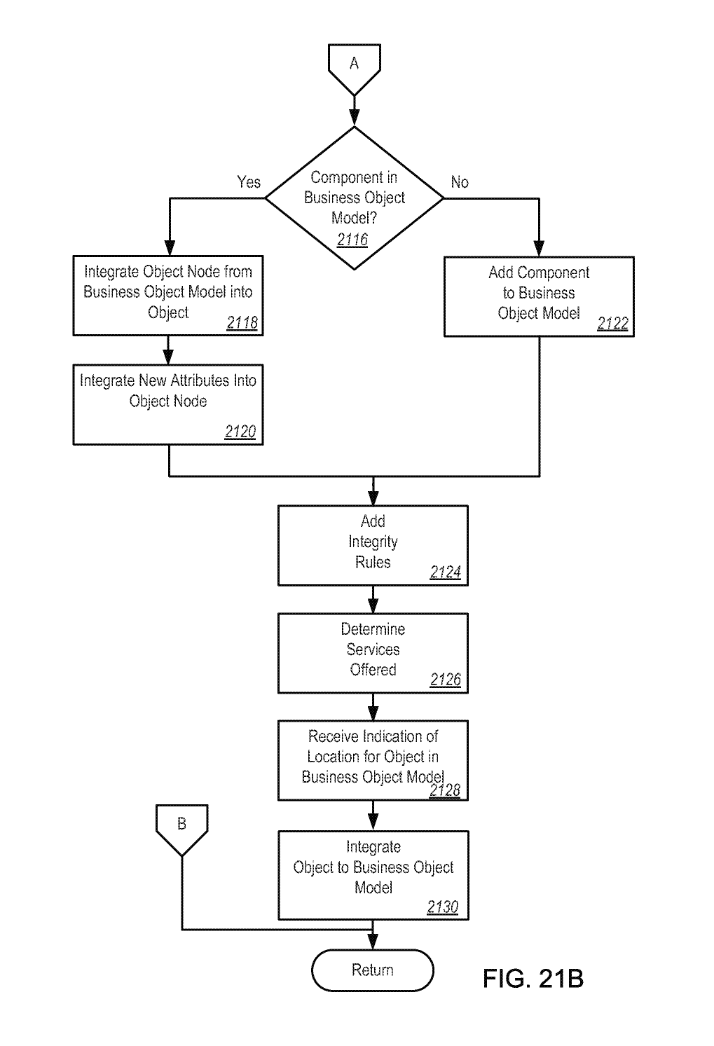

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | Main Object |
| AdditionalID | |
| PostingDate | |
| LastChangeDate | |
| AcceptanceStatus | |
| Note | |
| CompleteTransmission Indicator | |
| Buyer | |
| BuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionof Message | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | Purchase | | |
| AdditionalID | Order | | |
| PostingDate | | | |
| LastChangeDate | | | |
| AcceptanceStatus | | | |
| Note | | | |
| CompleteTransmission | | | |
| Indicator | | | |
| Buyer | | Buyer | |
| BuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | | Delivery- | |
| DeliveryPriority | | Terms | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionof | | | |
| Message | | | |
| FollowUpActivity | | | |
| ItemID | | Purchase | |
| ParentItemID | | Order | |
| HierarchyType | | Item | |
| ProductID | | | Product |
| ProductType | | | |
| ProductNote | | | |
| ProductCategoryID | | | ProductCategory |
| Amount | | | |
| BaseQuantity | | | |
| ConfirmedAmount | | | |
| ConfirmedBaseQuantity | | | |
| ItemBuyer | | | Buyer |
| ItemBuyerOrganisation | | | |
| Name | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartial | | | |
| Delivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| PurchaseOrder | | | | 1 |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | DeliveryTerms | | | 0 . . . 1 |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | CashDiscount | | | 0 . . . 1 |
| | Terms | | | |
| | | MaximumCashDiscount | | 0 . . . 1 |
| | | NormalCashDiscount | | 0 . . . 1 |
| | PaymentForm | | | 0 . . . 1 |
| | | PaymentCard | | 0 . . . 1 |
| | Attachment | | | 0 . . . n |
| | Description | | | 0 . . . 1 |
| | Confirmation | | | 0 . . . 1 |
| | Description | | | |
| | Item | | | 0 . . . n |
| | | HierarchyRelationship | | 0 . . . 1 |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | ConfirmationDescription | | 0 . . . 1 |
| | | ScheduleLine | | 0 . . . n |
| | | | DeliveryPeriod | 1 |
| | | ConfirmedScheduleLine | | 0 . . . n |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| Purchase | | | | | 1 |
| Order | | | | | |
| | PurchaseOrder | | | | |
| | Update | | | | |
| | | PurchaseOrder Request | | | |
| | | PurchaseOrder Change | | | |
| | | PurchaseOrder | | | |
| | | Confirmation | | | |
| | PurchaseOrder | | | | |
| | Cancellation | | | | |
| | PurchaseOrder | | | | |
| | Information | | | | |
| | Party | | | | |
| | | BuyerParty | | | 0 . . . 1 |
| | | | Address | | 0 . . . 1 |
| | | | ContactPerson | | 0 . . . 1 |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscount | | | | 0 . . . 1 |
| | Terms | | | | |
| | | MaximumCash Discount | | | 0 . . . 1 |
| | | NormalCashDiscount | | | 0 . . . 1 |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipTo | | 0 . . . 1 |
| | | | Location | | |
| | | | ShipFrom | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation | | | 0 . . . 1 |
| | | Description | | | |
| | | ScheduleLine | | | 0 . . . n |
| | | | Delivery | | 1 |
| | | | Period | | |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase- | | | | 1 |
| Order | | | | |
| | ID | | | 1 |
| | SellerID | | | 0 . . . 1 |
| | BuyerPosting- | | | 0 . . . 1 |
| | DateTime | | | |
| | BuyerLast- | | | 0 . . . 1 |
| | ChangeDate- | | | |
| | Time | | | |
| | SellerPosting- | | | 0 . . . 1 |
| | DateTime | | | |
| | SellerLast- | | | 0 . . . 1 |
| | ChangeDate- | | | |
| | Time | | | |
| | Acceptance- | | | 0 . . . 1 |
| | StatusCode | | | |
| | Note | | | 0 . . . 1 |
| | ItemList- | | | 0 . . . 1 |
| | Complete- | | | |
| | Transmission- | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product- | | | 0 . . . 1 |
| | RecipientParty | | | |
| | VendorParty | | | 0 . . . 1 |
| | Manufacturer- | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo- | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom- | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | | |
| | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

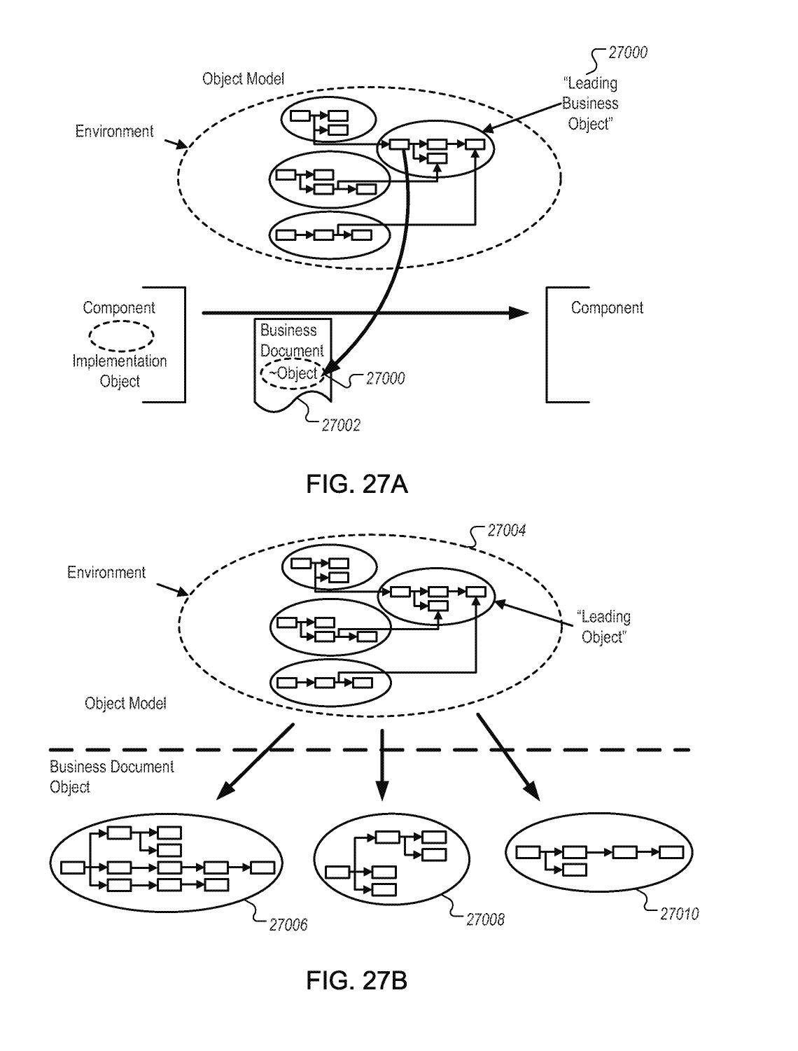

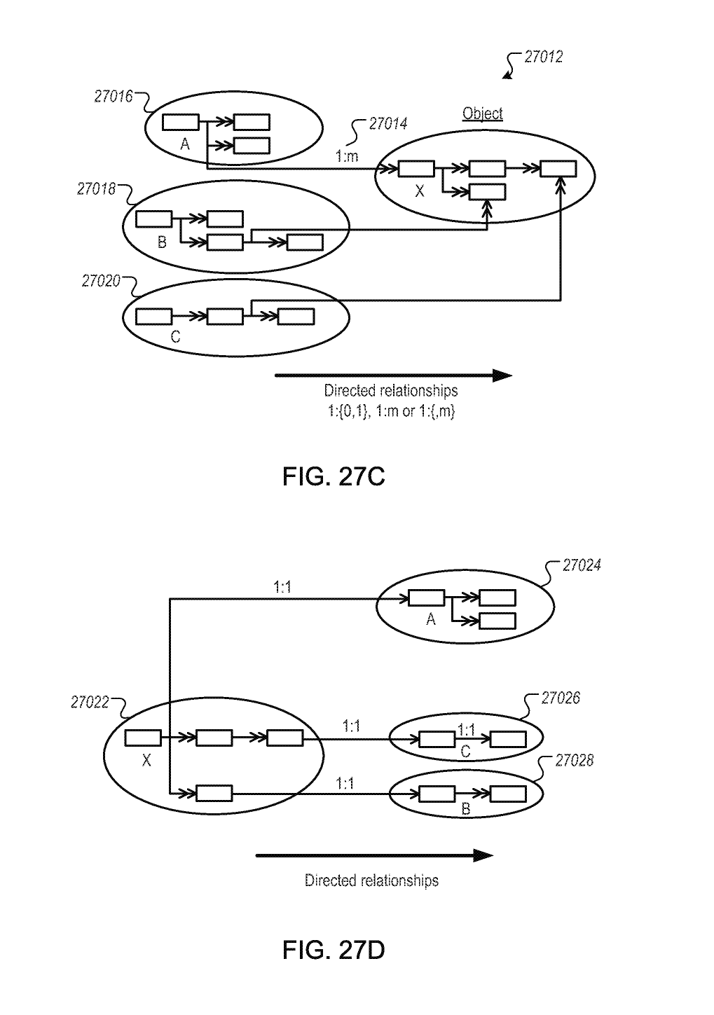

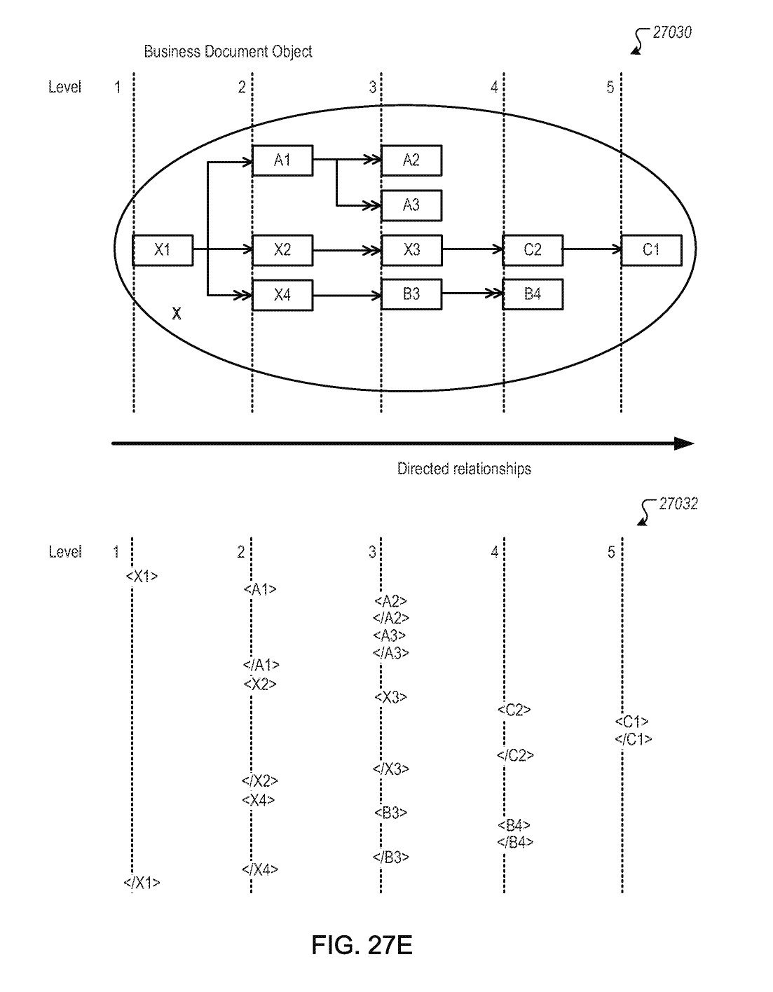

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) are hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role>Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderItemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message”. For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

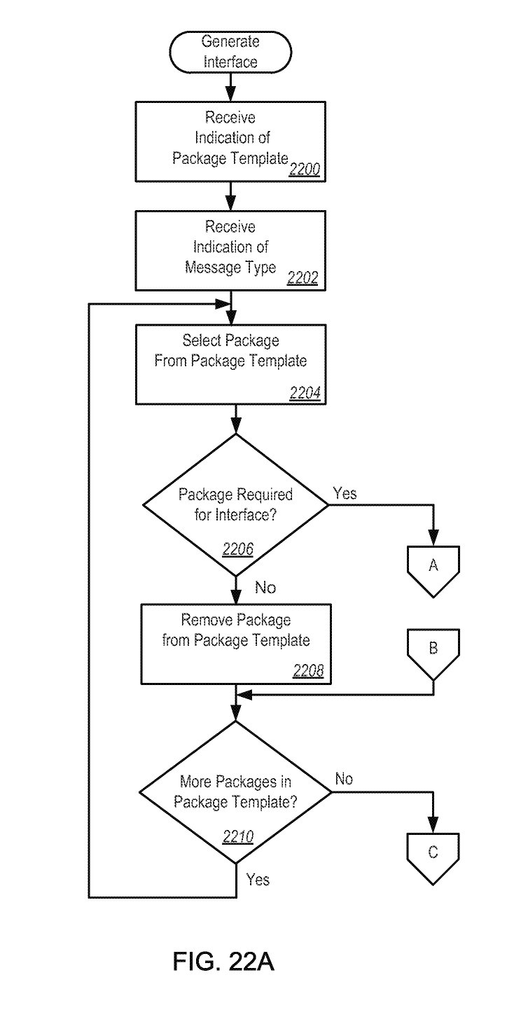

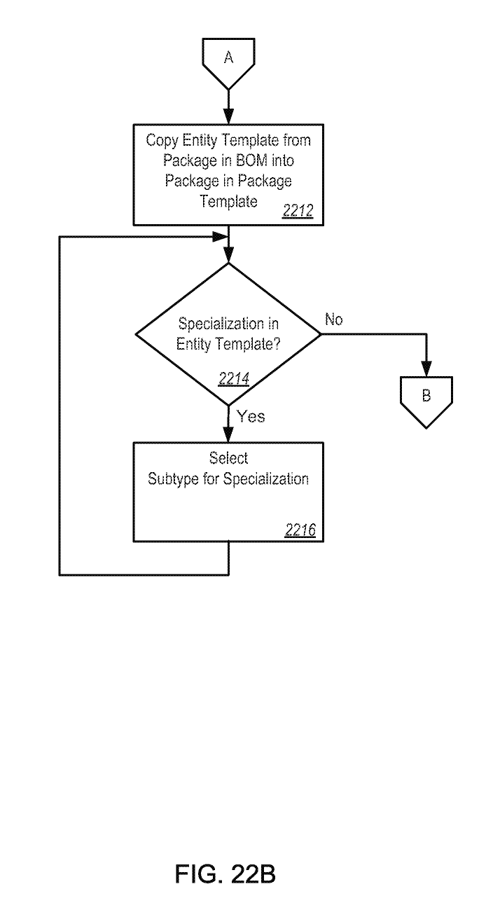

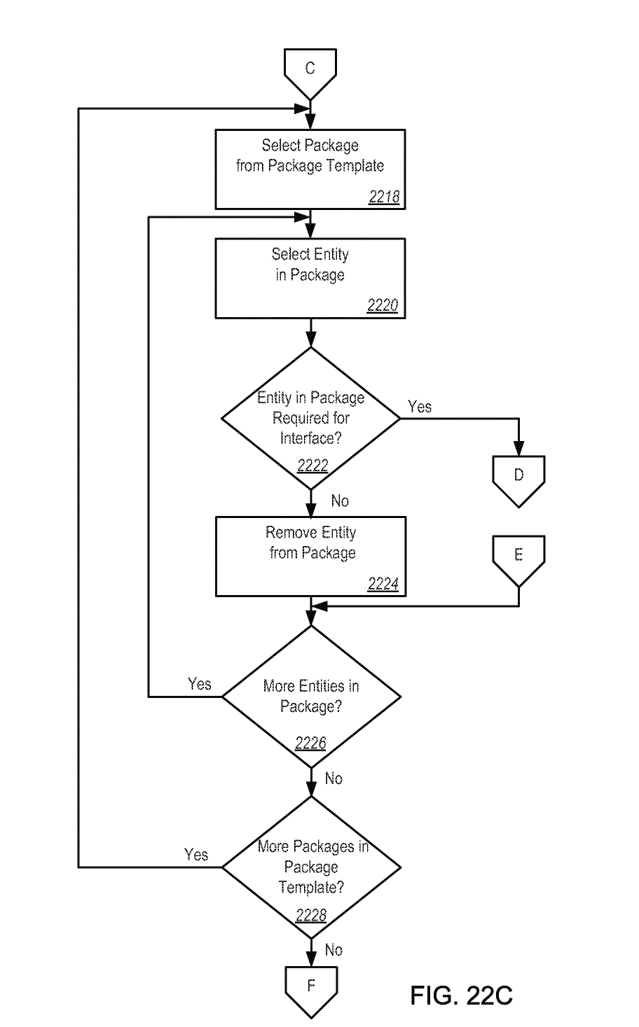

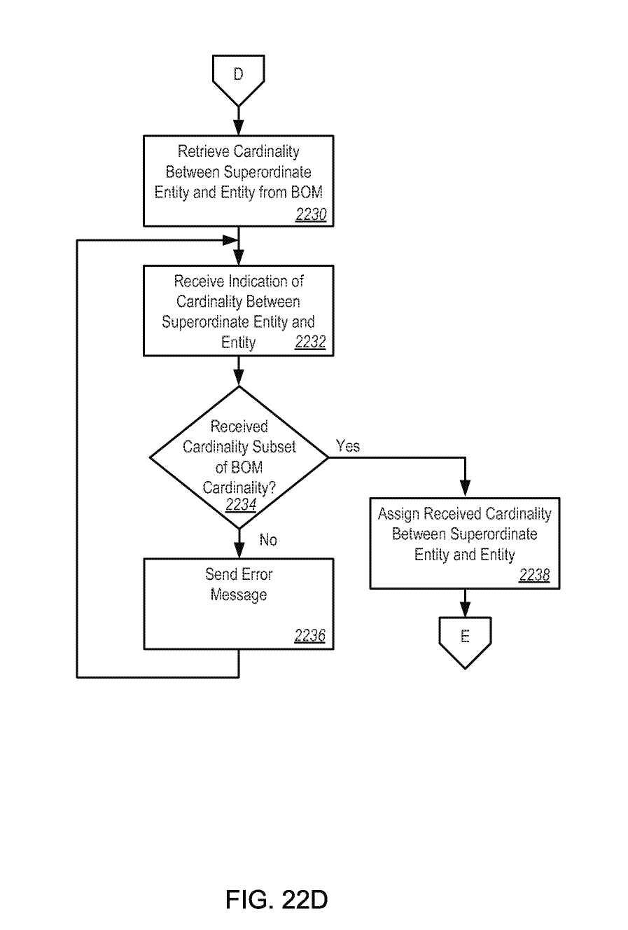

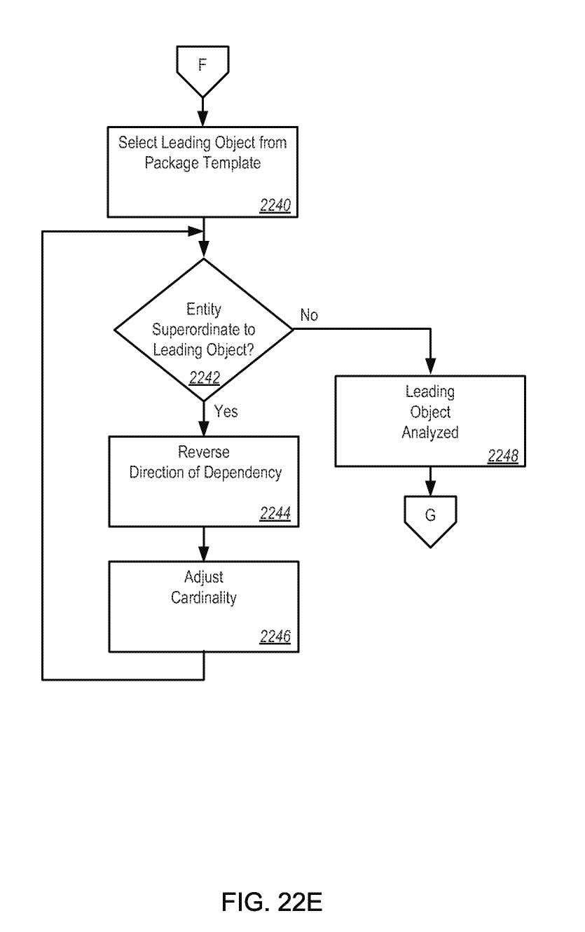

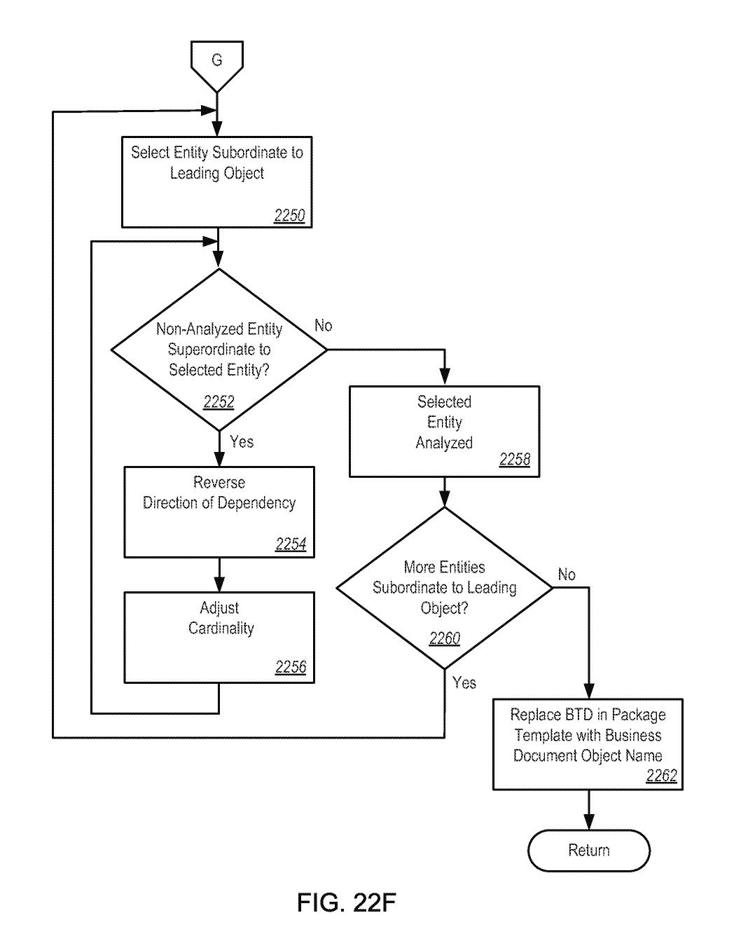

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

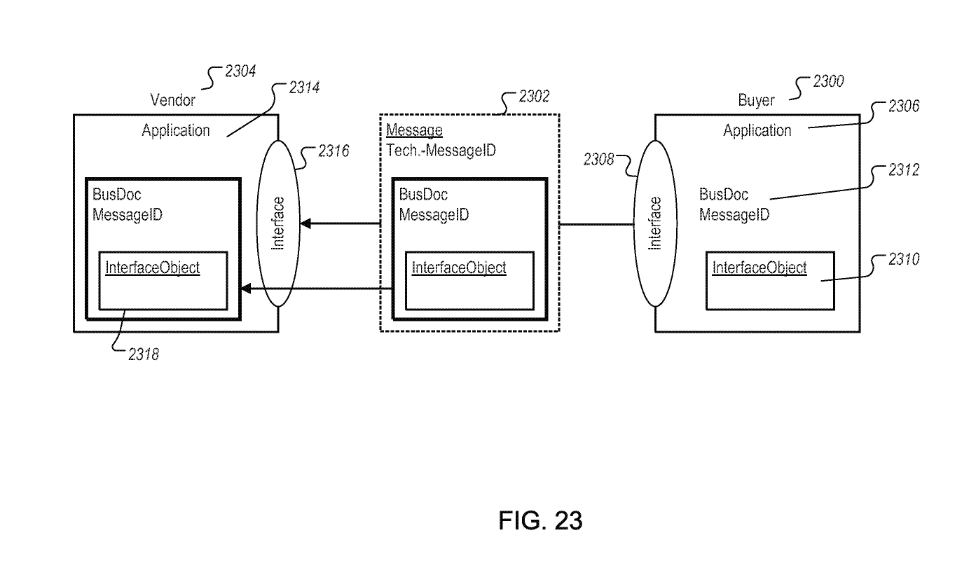

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

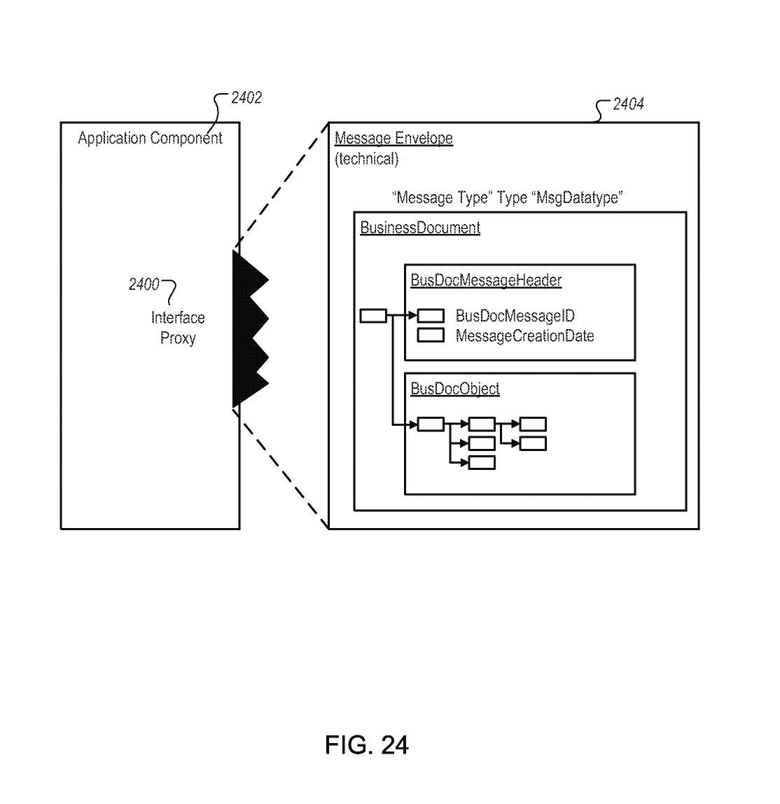

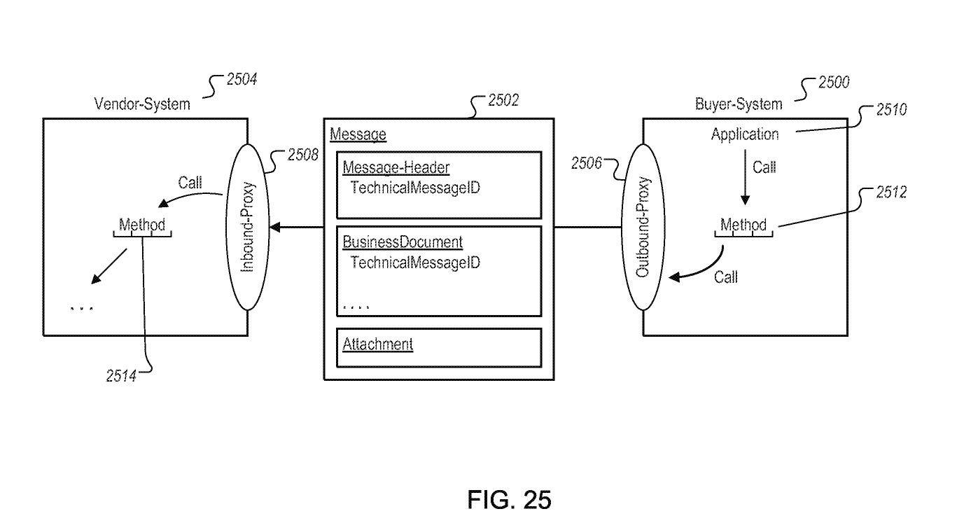

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

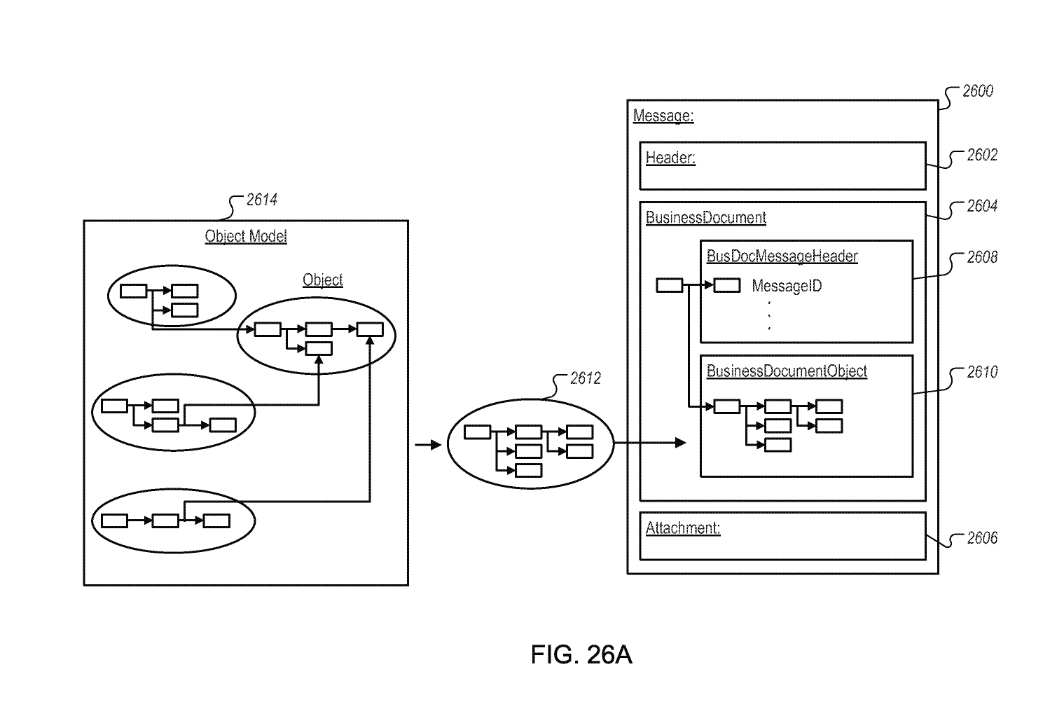

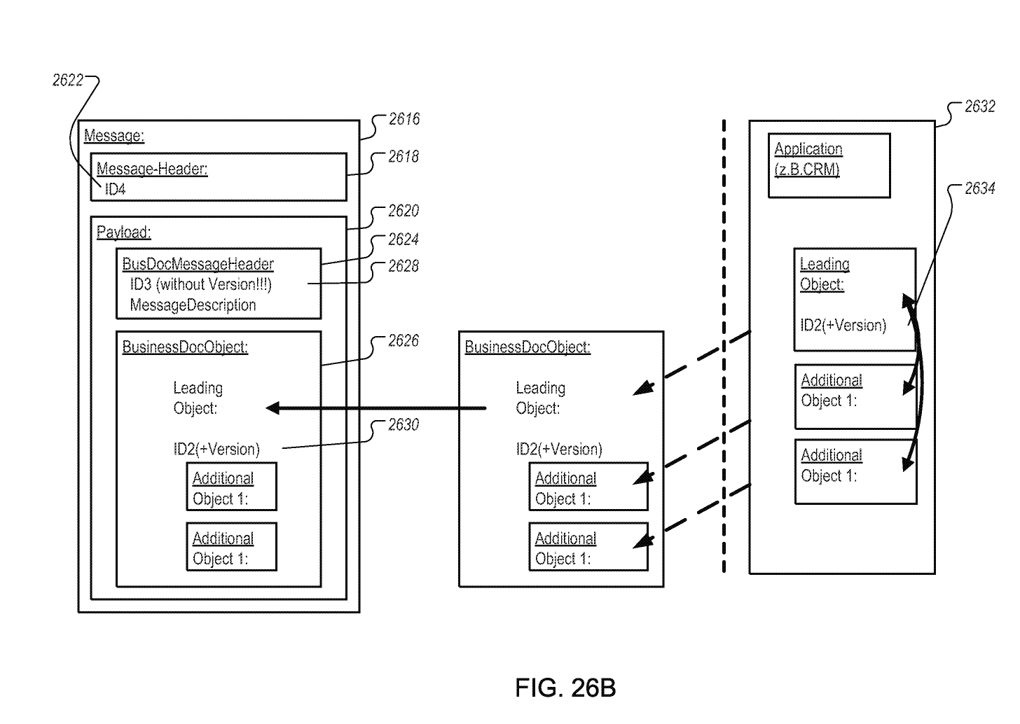

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

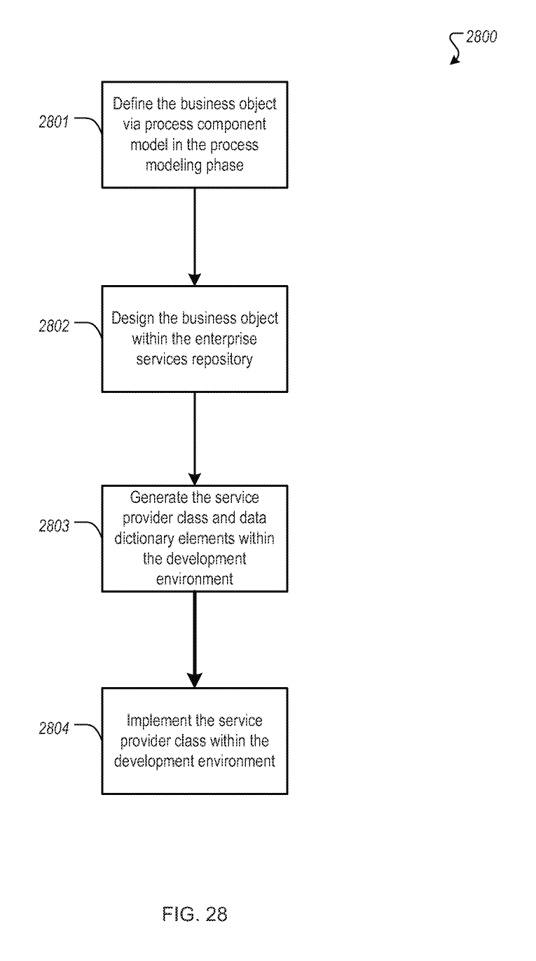

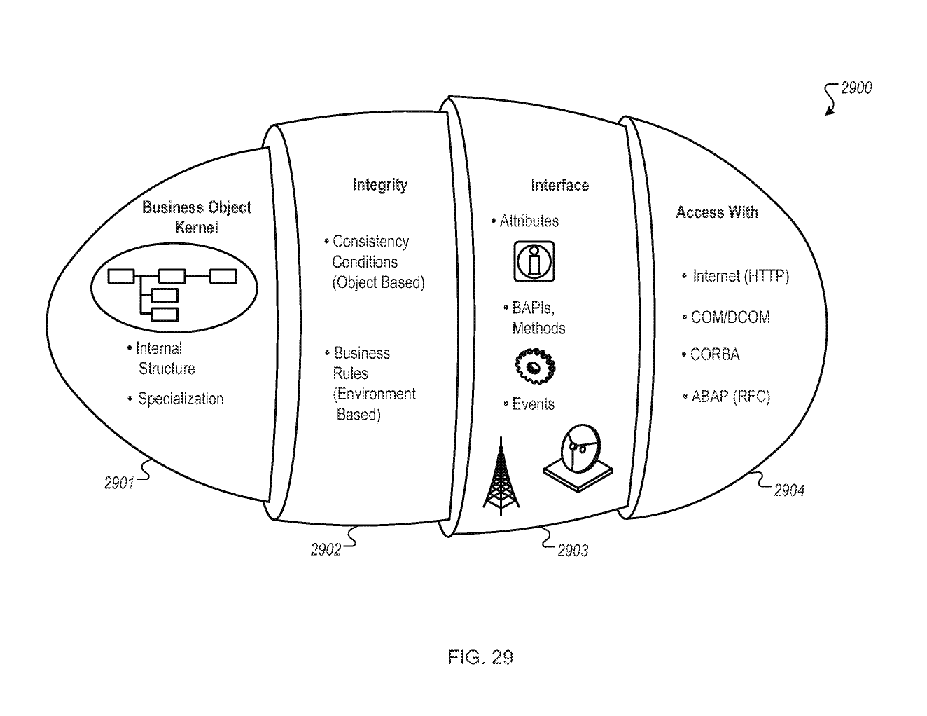

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

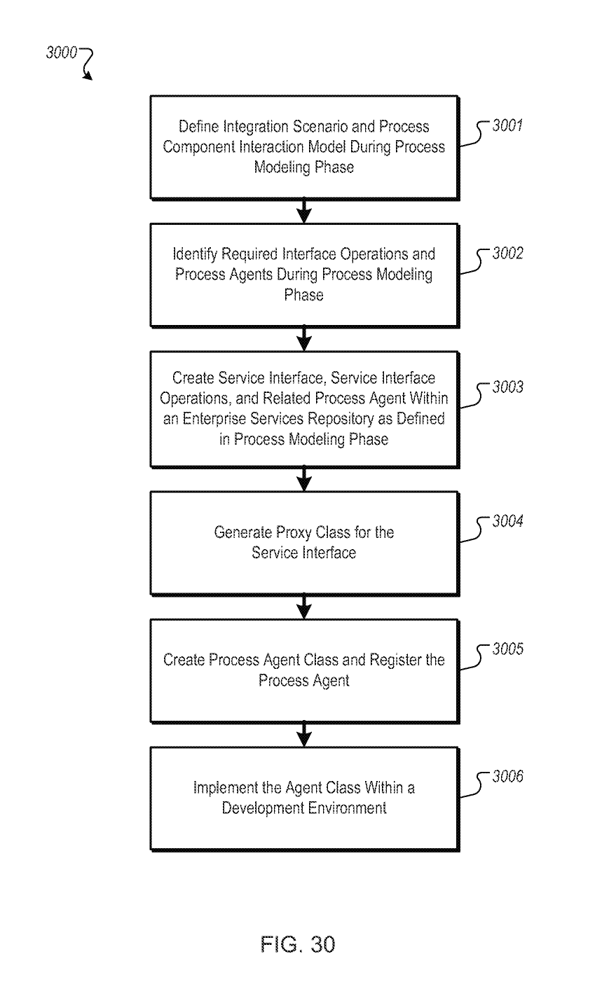

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

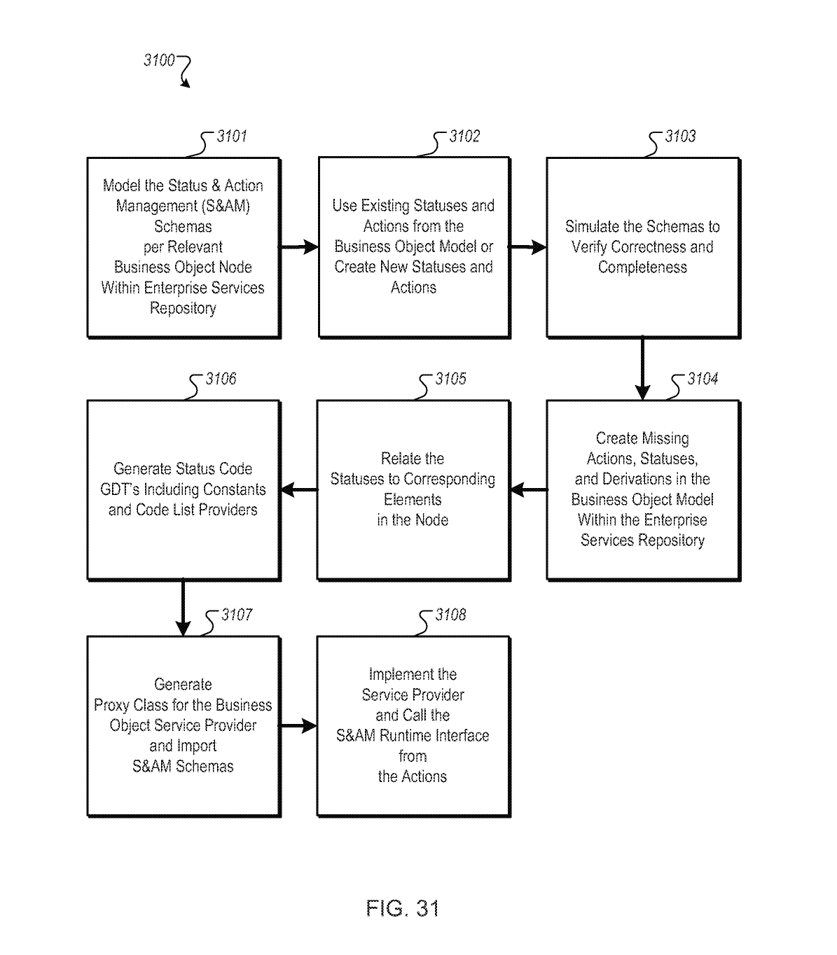

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

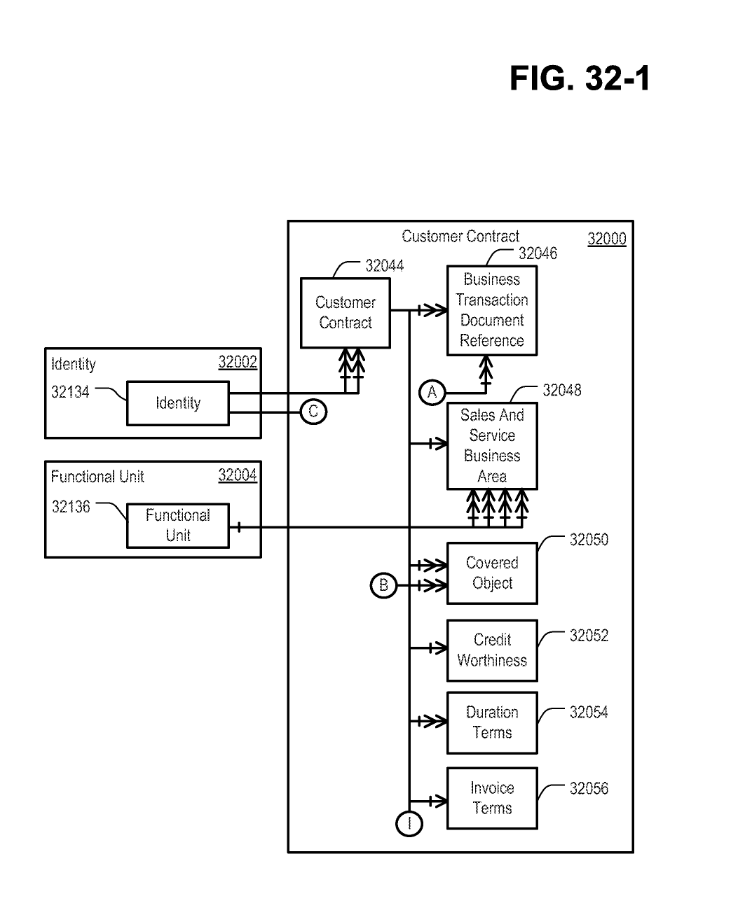

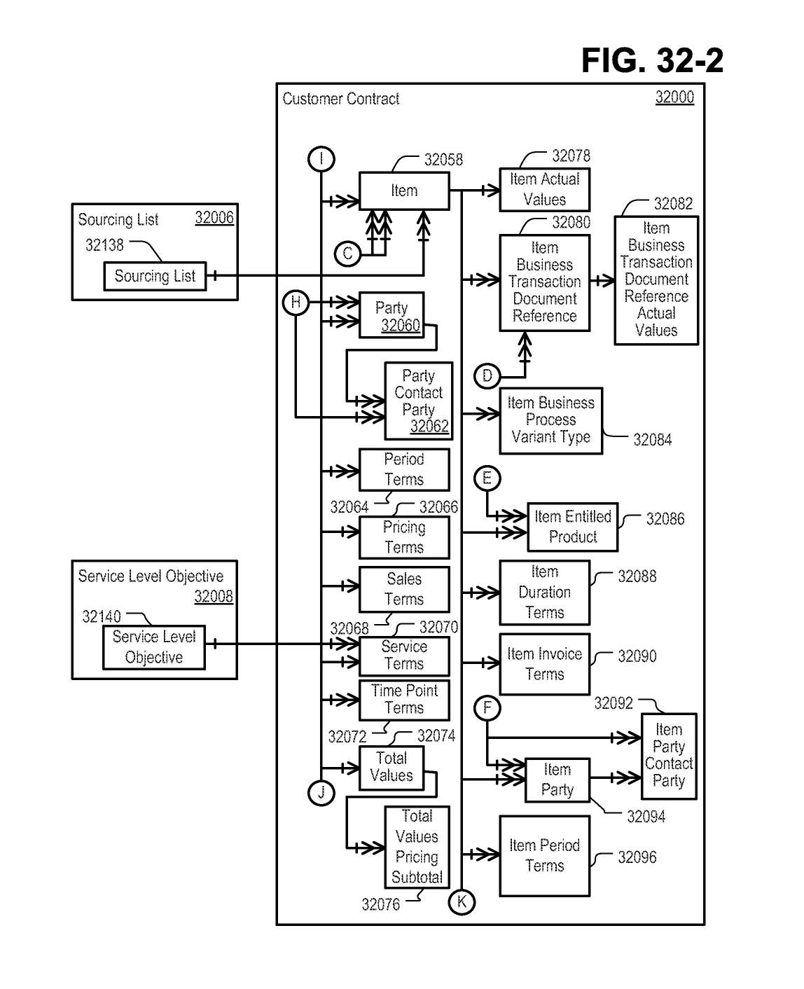

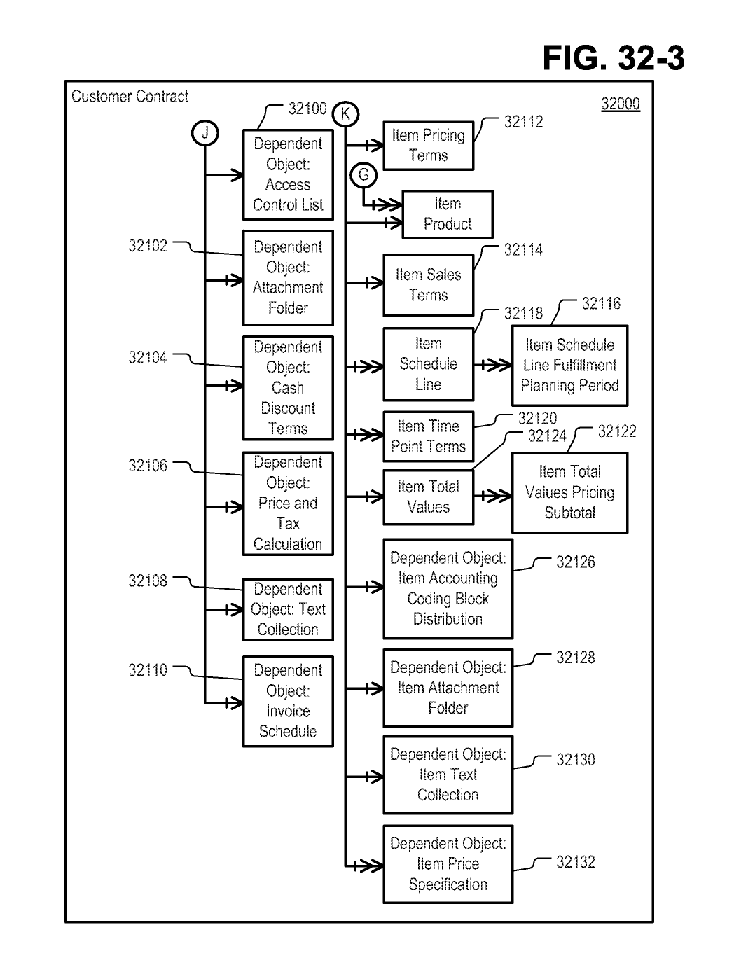

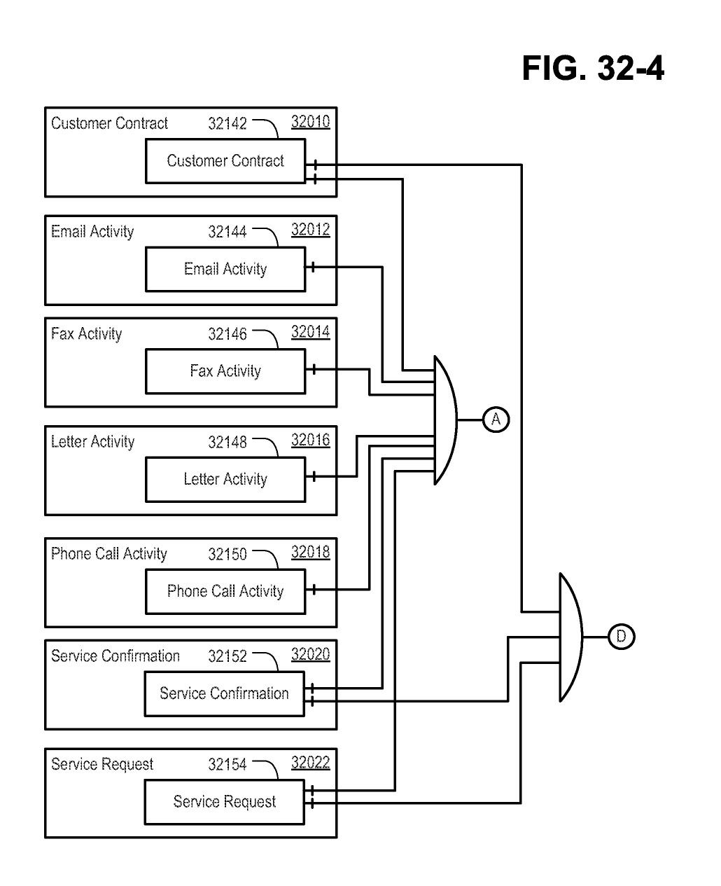

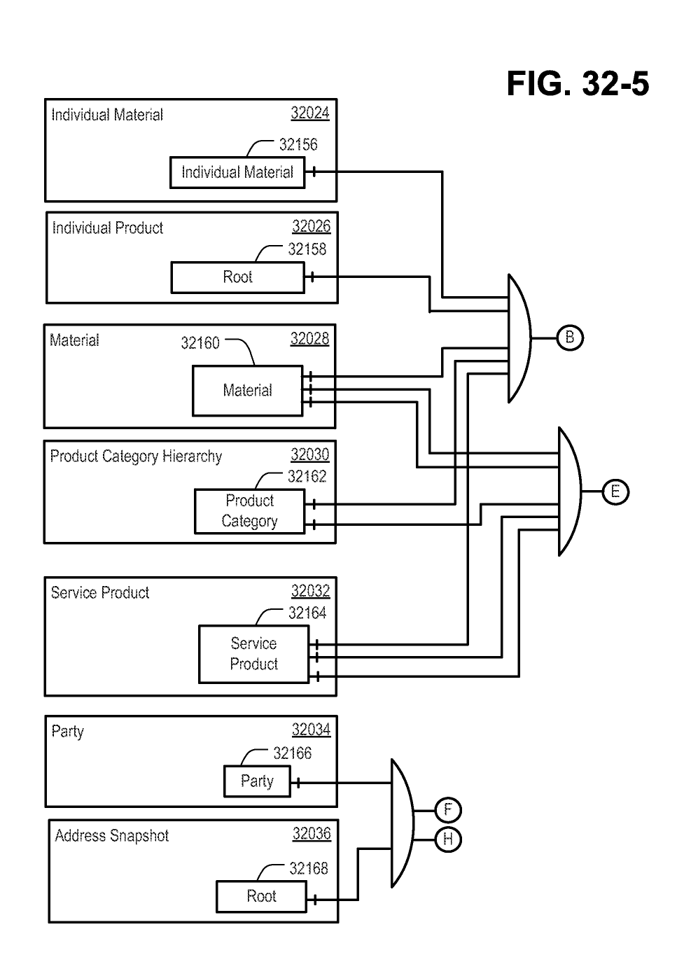

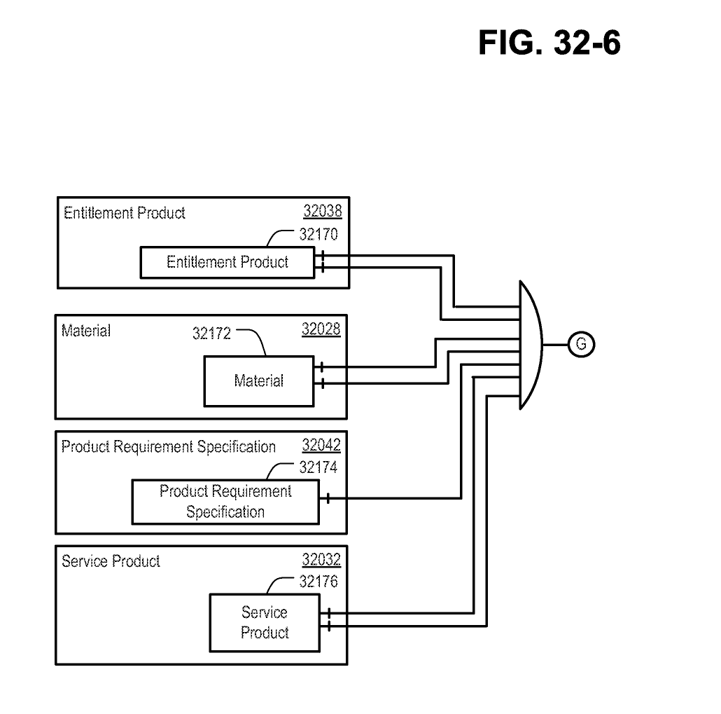

FIGS. 32-1 through 32-6 collectively illustrate an example object model for a Customer Contract business object 32000. Specifically, the object model depicts interactions among various components of the Customer Contract business object 32000, as well as external components that interact with the Customer Contract business object 32000 (shown here as 32002 through 32042 and 32134 through 32176). The Customer Contract business object 32000 includes elements 32044 through 32132, which can be hierarchical, as depicted. For example, the Customer Contract entity 32044 hierarchically includes one or more instances of the entities 32046 through 32056, among others. Some or all of the entities 32044 through 32132 can correspond to packages and/or entities in the message data types described below.

The business object Customer Contract is a legally binding agreement between a company and a customer for the provision of goods, services, and entitlements which describes specific conditions, such as price conditions, invoicing rules, renewal rules and cancellation terms. A customer contract represents a long-term relationship between a company and a customer. The Customer Contract business object belongs to the process component Customer Contract Processing. The Customer Contract business object belongs to the deployment unit Customer Relationship Management. The Customer Contract business object is a projection of Customer Transaction Document Template. The conditions of a customer contract can be negotiated individually or predefined by the company. In contrast to a sales or service order, a customer contract is an agreement over a specified period of time. For goods and services, target values and quantities can be defined. For services and service levels, covered objects can be defined. For entitlements, entitled services can be defined. Customer contracts are a basis for long-term relationship between the company and customers. With contracts, the company can secure capacity and workforce utilization for the future. The customer can count on a suppliers' fulfillment reliability and concentrate on a main line of business.

Consider an example of the selling of a customer support package “Platinum” or “Gold” which entitles a customer to extraordinary support. In this example, a customer contract can be sold which focuses on better and longer access possibilities, e.g. 24×7 hours, as well as on higher service levels. Consider another example of selling a product maintenance package of “Platinum”, “Gold” or “Standard”. In this example, a service contract can be sold which can include one or multiple aspects, such as regular preventive maintenance services, free-of-charge technical support or on-site visits, and price reductions for services and spare parts as well as for service levels.

A customer contract includes header data relevant for a whole contract and detail information about the items that are part of the contract. Example contracts are for services, entitlements and related expenses. The business object Customer Contract has an object category of Business Transaction Document and a technical category of Standard Business Object. The business object Customer Contract is involved in the following process component interactions: Accounting Coding Block Distribution Processing_Customer Contract Processing, Customer Contract Processing_Accounting, Customer Contract Processing_Customer Invoice Processing, Customer Contract Processing_Due Item Processing_Credit Usage, External Service, Performing And Charging System_Customer Contract Processing_Contract Information Query, and External Service Performing And Charging System_Service Confirmation Processing.

A service interface Credit Usage Out has a technical name of CustomerContractProcessingCreditUsageOut. The service interface Credit Usage Out is part of the process component interaction Customer Contract Processing_Due Item Processing_Credit Usage and is an interface to check creditworthiness. An operation Request Creditworthiness has a technical name of CustomerContractProcessingCreditUsageOut.RequestCreditworthiness, and can be based on message type Credit Worthiness Query derived from business object Sales Order and on message type Credit Worthiness Response derived from business object Sales Order.

A service interface Customer Contract Processing Service Order Accountability In has a technical name of CustomerContractProcessingServiceOrderAccountabilityIn. The service interface Customer Contract Processing Service Order Accountability in is part of the process component interaction Accounting Coding Block Distribution Processing_Customer Contract Processing. An operation CheckCustomerContractAccountability has a technical name of CustomerContractProcessingServiceOrderAccountabilityIn.CheckCustomerContractAccount ability and can be based on message type Accounting Object Check Confirmation derived from business object Accounting Coding Block Distribution and on message type Accounting Object Check Request derived from business object Accounting Coding Block Distribution.

A service interface External Service Performing And Charging System Request Service Confirmation Maintenance In has a technical name of ExternalServicePerformingAndChargingSystemRequestServiceConfirmationMaintenanceIn. The service interface External Service Performing And Charging System Request Service Confirmation Maintenance In is part of the process component interaction External Service Performing And Charging System_Service Confirmation Processing and is an interface to maintain a service confirmation with reference to a customer contract with data from an external service performing and charging system. An operation Create Service Confirmation has a technical name of ExternalServicePerformingAndChargingSystemRequestServiceConfirmationMaintenanceIn. CreateServiceConfirmation, can be used to create a service confirmation with reference to a customer contract with data from an external service performing and charging system, and can be based on message type External Service Performing And Charging System Service Confirmation Create Request derived from business object Service Confirmation.

A service interface Query Customer Contract In has a technical name of QueryCustomerContractIn. The service interface Query Customer Contract In is part of the process component interaction External Service Performing And Charging System_Customer Contract Processing_Contract Information Query, and is an interface to query customer contract data. An operation Find By Elements has a technical name of QueryCustomerContractIn.FindByElements, can be used to query customer contract data by elements, and can be based on message type Customer Contract By Elements Query_sync derived from business object Customer Contract and on message type Customer Contract By Elements Response_sync derived from business object Customer Contract.

A service interface Request Invoicing In has a technical name of CustomerContractProcessingRequestInvoicingIn. The service interface Request Invoicing In is part of the process component interaction Customer Contract Processing_Customer Invoice Processing, and is an interface to update a customer contract with information from invoicing. An operation Change Customer Contract based on Customer Invoice has a technical name of CustomerContractProcessingRequestInvoicingIn.ChangeCustomerContractBasedOnCustomerInvoice, can be used to update changes in a customer contract with data from a customer invoice, and can be based on message type Customer Invoice Issued Confirmation derived from business object Customer Invoice.

A service interface Request Invoicing Out has a technical name of CustomerContractProcessingRequestInvoicingOut. The service interface Request Invoicing Out is part of the process component interaction Customer Contract Processing_Customer Invoice Processing, and is an interface to request invoicing of a customer contract. An operation Request Invoicing has a technical name of CustomerContractProcessingRequestInvoicingOut.RequestInvoicing, can be used to request invoicing of a customer contract, and can be based on message type Customer Invoice Request Request derived from business object Customer Invoice Request.

A service interface Sales And Purchasing Accounting Out has a technical name of CustomerContractProcessingSalesAndPurchasingAccountingOut. The service interface Sales And Purchasing Accounting Out is part of the process component interaction Customer Contract Processing_Accounting, and is an interface to notify Accounting that a customer contract has been processed. An operation Notify of Customer Contract has a technical name of CustomerContractProcessingSalesAndPurchasingAccountingOut.NotifyOfCustomerContract, can be used to notify Accounting that a customer contract has been processed, and can be based on message type Sales And Purchasing Accounting Notification derived from business object Accounting Notification.

The business object Customer Contract has a Root node, which can be time dependent on Time Point. The elements located directly at the node Customer Contract are defined by the data type CustomerTransactionDocumentElements. These elements include: ID, BuyerID, TypeCode, ProcessingTypeCode, DateTime, Name, BuyerDateTime, BuyerName, DataOriginTypeCode, SystemAdministrativeData, UUID, FulfillmentBlockingReasonCode, MigratedDataAdaptationTypeCode, ServiceConfirmationCreationCode, and Status. Status can include Status/ItemListCancellationStatusCode, Status/ItemListFulfilmentProcessingStatusCode, Status/ConfirmationIssuingStatusCode, Status/ItemListInvoiceProcessingStatusCode, Status/ConsistencyStatusCode, Status/GeneralDataCompletenessStatus Code, Status/InvoicingBlockingStatusCode, Status/FulfilmentBlockingStatus Code, Status/ItemListCustomerContractLifeCycleStatusCode, Status/ItemListValidityStatusCode, and Status/ItemListReleaseStatusCode.

ID may be an alternative key, is a unique identifier assigned by a seller for a Customer Transaction Document, and may be based on datatype GDT: BusinessTransactionDocumentID. BuyerID is a unique identifier for a Customer Transaction Document, can be assigned by a buyer, and may be based on datatype GDT: BusinessTransactionDocumentID. TypeCode may be optional, is an encoded representation of a type of Customer Transaction Document, may be based on datatype GDT: BusinessTransactionDocumentTypeCode, can be set internally, can include a fixed value CustomerTransactionDocumentTemplate, and can be used to display the type in cross-business object lists, for example. ProcessingTypeCode is an encoded representation of Customer Transaction Document processing in a process component, may be based on datatype GDT: BusinessTransactionDocumentProcessingTypeCode, and can have a value, for example, of “transaction type” for standard orders. DateTime may be optional, is a creation date time of a Customer Transaction Document from a business perspective, and may be based on datatype GDT: GLOBAL_DateTime. Name is a name of a Customer Transaction Document, and may be based on datatype GDT: EXTENDED_Name. BuyerDateTime may be optional, is a date/time assigned by a buyer for a Customer Transaction Document, and may be based on datatype GDT: GLOBAL_DateTime, with a qualifier of Buyer. BuyerName is a short-text description for a Customer Transaction Document, can be assigned by a buyer, and may be based on datatype GDT: MEDIUM_Name. DataOriginTypeCode is a type of a source of a Customer Transaction Document, and may be based on datatype GDT: CustomerTransactionDocumentDataOriginTypeCode. SystemAdministrativeData includes administrative data stored in a system, such as system users and change dates/times, and may be based on datatype GDT: SystemAdministrativeData. UUID may be an alternative key, is a universally unique Customer Transaction Document identifier, can be assigned internally, and may be based on datatype GDT: UUID. FulfillmentBlockingReasonCode may be optional, specifies why a Customer Transaction Document document is blocked for the delivery of goods or the provision of services, and may be based on datatype GDT: CustomerTransactionDocumentFulfilmentBlockingReasonCode. MigratedDataAdaptationTypeCode may be optional, is a coded representation of a type of data adaptation performed during migration of a customer transaction document, and may be based on datatype GDT: MigratedDataAdaptationTypeCode. When migrating data from a source system to a target system, data may be adapted. For example, a business object or business document may be partially or completely taken over. The MigratedDataAdaptationTypeCode can be used when a CustomerTransactionDocument is migrated. ServiceConfirmationCreationCode indicates a possibility to create a service confirmation based on the content of a customer transaction document, and may be based on datatype GDT: CustomerTransactionDocumentServiceConfirmationCreationCode.

Status may be optional, describes one or more statuses of a Customer Transaction Document, and may be based on datatype BOIDT: CustomerTransactionDocumentStatus. Status/ItemListCancellationStatusCode may be optional, aggregates a cancellation status of one or more items, and may be based on datatype GDT: CancellationStatusCode. Status/ItemListFulfilmentProcessingStatusCode may be optional, aggregates a fulfillment status of one or more items, and may be based on datatype GDT: ProcessingStatusCode, with a qualifier of Fulfilment. Status/ConfirmationIssuingStatusCode may be optional, represents a state of an issuing process of a confirmation, and may be based on datatype GDT: IssuingStatusCode, with a qualifier of Confirmation. Issuing can involve printing or output via xml or by any other output method. Status/ItemListInvoiceProcessingStatusCode may be optional, represents an aggregated representation of InvoicingStatus of one or more items, and may be based on datatype GDT: ProcessingStatusCode, with a qualifier of Invoice. Status/ConsistencyStatusCode may be optional, describes a status consisting of errors, such as where business data is not consistent, or data that includes errors, and may be based on datatype GDT: ConsistencyStatusCode. Status/GeneralDataCompletenessStatusCode may be optional, indicates that all or part of general business data is missing, and may be based on datatype GDT: DataCompletenessStatusCode, with a qualifier of General. Status/InvoicingBlockingStatusCode may be optional, represents a block of an invoicing process, and may be based on datatype GDT: BlockingStatusCode, with a qualifier of Invoicing. Status/FulfilmentBlockingStatusCode may be optional, represents a block of the delivery of goods or the provision of services, and may be based on datatype GDT: BlockingStatusCode, with a qualifier of Fulfilment. Status/ItemListCustomerContractLifeCycleStatusCode may be optional, aggregates a contract life cycle status of one or more items, and may be based on datatype GDT: CustomerContractLifeCycleStatusCode_V1. Status/ItemListValidityStatusCode may be optional, aggregates a validity status of one or more items, and may be based on datatype GDT: ValidityStatusCode. Status/ItemListReleaseStatusCode may be optional, aggregates a release status of one or more items, and may be based on datatype GDT: ReleaseStatusCode.

The following composition relationships to subordinate nodes exist: BusinessTransactionDocumentReference, in a 1:CN cardinality relationship; SalesAndServiceBusinessArea, in a 1:C cardinality relationship; CoveredObject, in a 1:CN cardinality relationship; CreditWorthiness, in a 1:C cardinality relationship; DurationTerms, in a 1:CN cardinality relationship; InvoiceTerms, in a 1:C cardinality relationship; Item, in a 1:CN cardinality relationship; PeriodTerms, in a 1:CN cardinality relationship; PricingTerms, in a 1:C cardinality relationship; SalesTerms, in a 1:C cardinality relationship; ServiceTerms, in a 1:C cardinality relationship; TimePointTerms, in a 1:CN cardinality relationship; TotalValues, in a 1:C cardinality relationship; and Party, in a 1:CN cardinality relationship, which may be filtered. The filter elements are defined by the data type PartyFilterElements. These elements include: RoleCategoryCode and MainIndicator. RoleCategoryCode may be optional and may be based on datatype GDT: PartyRoleCategoryCode. MainIndicator may be optional and may be based on datatype GDT: Indicator.

The following composition relationships to dependent objects exist: AccessControlList, with a cardinality of 1:1, which is a list of access groups that have access to a CustomerTransactionDocument; AttachmentFolder, with a cardinality of 1:C, which is an AttachmentContainer that is a collection of documents attached for a CustomerTransactionDocument; CashDiscountTerms, with a cardinality of 1:C, which includes data used for a CustomerTransactionDocument for handling payments; PriceAndTaxCalculation, with a cardinality of 1:C, which includes price and tax components determined by a price and tax determination/valuation that are valid for a CustomerTransactionDocument; TextCollection, with a cardinality of 1:C, which is a collection of natural-language text that refers to a CustomerTransactionDocument; and Invoice Schedule, with a cardinality of 1:C.

The following inbound association relationships may exist: Creation Identity, from the business object Identity/node Identity, with a cardinality of 1:CN, which is an identity of a user that created a Customer Transaction Document; and Last Change Identity, from the business object Identity/node Identity, with a cardinality of 1:CN, which is an identity of a user that last changed a Customer Transaction Document.

The following specialization associations for navigation may exist to the business object Business Document Flow/node Business Document Flow: Business Document Flow, with a target cardinality of C, which is an association from BusinessDocumentFlow and which is a view on a set of preceding and succeeding business transaction documents for a current CustomerTransactionDocumentTemplate document. The following specialization associations for navigation may exist of the node Business Transaction Document Reference: Activity Reference target, with a cardinality of CN, which is an association to a reference that occurs in an EmailActivityReference specialization; Base Business Transaction Document Reference, with a target cardinality of C, which is an association to a reference that occurs in a specialization and is used as a basis, such as a sales order or a customer invoice, in the case of a return; Customer Invoice Reference, with a target cardinality of CN, which is an association to a reference that occurs in the InvoiceReference specialization; Purchase Order Reference, with a target cardinality of C, which is an association to a reference that occurs in the PurchaseOrderReference specialization; Sales Order Reference, with a target cardinality of CN, which is an association to a BTDReference that occurs in the SalesOrderReference specialization; Selected Document Reference, with a target cardinality of CN, which is an association for navigation to selected business document references that are important for a business document flow; ActivityReference, with a target cardinality of CN, which is an association to a reference that occurs in the ActivityReference specialization; Service Confirmation Reference, with a target cardinality of CN, which is an association to a reference that occurs in the ServiceConfirmationReference specialization; and Service Request Reference, with a target cardinality of C, which is an association to a reference that occurs in the ServiceRequestReference specialization.

The following specialization associations for navigation may exist to the node Covered Object Individual Covered Object, with a target cardinality of CN, which is a Covered Object that is an individual object; and Non Individual Covered Object, with a target cardinality of CN, which is a Covered Object that is not an individual object. The following specialization associations for navigation may exist to the node Duration Terms: Minimum Validity Duration, with a target cardinality of C, which is a minimum duration during which a customer transaction document is valid; Reminder Duration, with a target cardinality of C, which is a duration before which a reminder for a customer transaction document is to be triggered; and Validity Duration, with a target cardinality of C, which is a duration during which a customer transaction document is valid.

The following specialization associations for navigation may exist to the node Party: Administrator Party, with a target cardinality of C, which is a party that has an assigned administrator role category; Bill to Party, with a target cardinality of C, which is an association to a Party that occurs in the BillToParty specialization; Buyer Party, with a target cardinality of C, which is an association to a Party that occurs in the BuyerParty specialization; Contracting Unit Party, with a target cardinality of C, which is a party that has an assigned contracting unit role category; Contract Release Authorised Party, with a target cardinality of CN, which is a party that has an assigned contract release authorised party role; Employee Responsible Party, with a target cardinality of C, which is an association to a Party that occurs in the EmployeeResponsible specialization; Service Execution Team Party, with a target cardinality of C, which is an association to a Party that occurs in the ServiceExecutionTeam specialization; Payer Party, with a target cardinality of C, which is an association to a Party that occurs in the PayerParty specialization; Product Recipient Party, with a target cardinality of C, which is an association to a Party that occurs in the ProductRecipientParty specialization; Sales Unit Party, with a target cardinality of C, which is an association to a Party that occurs in the SalesUnit specialization; Seller Party, with a target cardinality of C, which is an association to a Party that occurs in the SellerParty specialization; Service Performer Party, with a target cardinality of C, which is an association to a Party that occurs in the ServicePerformer specialization; and Vendor Party, with a target cardinality of C, which is an association to a Party that occurs in the VendorParty specialization.

The following specialization associations for navigation may exist: Validity Period, to the node Period Terms, with a target cardinality of C, which is an association to a PeriodTerms that occurs in the ValidityPeriod specialization; Minimum Validity End Time Point, to the node Time Point Terms, with a target cardinality of C, which is a point in time by which a minimum validity of a customer transaction document ends; and Document Output Request, to the business object Document Output Request/node Document Output Request, with a target cardinality of C, which is a set of output requests and processed output requests related to a customer transaction document.

In some implementations, TypeCode and ProcessingTypeCode are not changed after being created. In some implementations, SystemAdministrativeData is set internally by the system and is not subsequently assigned or changed externally. In some implementations, once a CustomerTransactionDocumentTemplate has been created, the document may only be deleted if no subsequent processes have been started that are mapped via statuses that forbid a delete action. In such a case, the document can be canceled.

An Add Reference with Data Provision action adds a BusinessTransactionDocumentReference and provides relevant data from the referenced document to a CustomerTransactionDocument. The action elements are defined by the data type CustomerTransactionDocumentAddReferenceWithDataProvisionActionElements. These elements include BusinessTransactionDocumentKey. BusinessTransactionDocumentKey may be optional, is a unique key assigned by a seller for a Customer Transaction Document, and may be based on datatype KDT: BusinessTransactionDocumentKey. BusinessTransactionDocumentKey can include BusinessTransactionDocumentKey/BusinessTransactionDocumentID, which may be optional, is a unique identifier for a business transaction document, and may be based on datatype GDT: BusinessTransactionDocumentID. BusinessTransactionDocumentKey/BusinessTransactionDocumentTypeCode may be optional, is a coded representation of a document type that occurs in business transactions, can describe a business nature of similar documents, can define basic features of documents of the document type, and may be based on datatype GDT: BusinessTransactionDocumentTypeCode.

A Block Fulfilment action blocks an item for delivery by setting a delivery block. The Block Fulfillment action can be valid for those items that are relevant for delivery. The Block Fulfilment action sets a “Fulfilment blocking” status variable to “Blocked”. The action elements are defined by the data type CustomerTransactionDocumentBlockFulfilmentActionElements. These elements include CustomerTransactionDocumentFulfilmentBlockingReasonCode, which may be optional, specifies why delivery processing for a business transaction item is blocked, and may be based on datatype GDT: CustomerTransactionDocumentFulfilmentBlockingReasonCode.

A Block Invoicing action blocks a CustomerTransactionDocuments for invoicing by setting an invoicing block. The Block Invoicing action can be valid for invoice-relevant CustomerTransactionDocumentTemplate documents. The Block Invoicing action sets the status variable ‘InvoicingBlocking’ to ‘blocked’. The action elements are defined by the data type CustomerTransactionDocumentBlockInvoicingActionElements. These elements include InvoicingBlockingReasonCode, which may be optional, specifies why processing of invoicing documents is blocked for a business transaction item, and may be based on datatype GDT: InvoicingBlockingReasonCode.

A Check Creditworthiness action can be used to check the creditworthiness of a buyer party of a customer transaction document and can be applied to the root node of a customer transaction document. After such a check, the creditworthiness node includes information about the creditworthiness and the credit limit of the buyer party, compared with an amount to be checked. The action elements are defined by the data type CustomerTransactionDocumentCheckCreditWorthinessActionElements. These elements include Amount, which may be optional, is an amount for which the creditworthiness is checked, and may be based on datatype GDT: Amount,

A Check Consistency action checks a CustomerTransactionDocument for errors and can set a ConsistencyStatus to either ‘Consistent’ or ‘Inconsistent’. A Check General Data Completeness action checks for general data completeness.

A Copy action creates a customer transaction document from an existing customer transaction document, from which relevant data can be copied. The two customer transaction documents are not necessarily linked in a business sense. A Create From Business Partner action creates a CustomerTransactionDocument with a provided Business Partner as a buyer party. A Create from Sales Entitlement Item action can be used to create a customer transaction document based on a sales entitlement item that represents the sale of a customer contract, can be applied at the root node of a customer transaction document, and can be used for customer contracts.

A Create with Reference action creates a CustomerTransactionDocument with reference to an existing document, from which relevant data is transferred. A Finish Fulfilment Processing Of All Items action sets the FulfilmentProcessingStatus of all items in a customer transaction document to “Finished”. A Notify Of Confirmation Issue action notifies about the successful issuing of a confirmation, and changes a confirmation issuing status from “Issue requested” to “Issued”. A Request Confirmation Issue action is a request to issue a confirmation, and changes a ‘Confirmation issuing’ status variable from ‘Not issued’ to ‘Issue requested’.

An Unblock Fulfilment action resets a delivery block, can be applicable for those delivery-relevant items for which a delivery block has been set, and can change the “Fulfilment blocking” status variable from “Blocked” to “Not blocked”. An Unblock Invoicing action removes an invoice block, can be valid for invoice-relevant CustomerTransactionDocumentTemplate documents with an invoice block, and can change the InvoiceBlock status from ‘blocked’ to ‘not blocked’. A Finish Invoicing Processing Of All Items action sets the InvoicingProcessingStatus of all items in the customer transaction document to “Finished”. A Release All Items action sets a ReleaseStatus of all items in a customer transaction document to “Released”.

A Query By Elements query returns a list of CustomerTransactionDocumentTemplate documents including specified selection criteria. The selection criteria can be specified by a logical ‘AND’ combination of query elements. The query elements are defined by the data type CustomerTransactionDocumentElementsQueryElements. These elements include: ID, TypeCode, DateTime, Name, BuyerID, BuyerName, DataOriginTypeCode, SystemAdministrativeData, CreationBusinessPartnerCommonPersonNameGivenName, CreationBusinessPartnerCommonPersonNameFamilyName, LastChangeBusinessPartnerCommonPersonNameGivenName, LastChangeBusinessPartnerCommonPersonNameFamilyName, SalesAndServiceBusinessAreaSalesOrganisationID, SalesAndServiceBusinessAreaSalesGroupID, SalesAndServiceBusinessAreaSalesOfficeID, SalesAndServiceBusinessAreaDistributionChannelCode, SalesAndServiceBusinessAreaServiceOrganisationID, PartyBuyerPartyKey, BuyerPartyContactPartyPartyKey, PartySalesUnitPartyKey, PartyEmployeeResponsiblePartyKey, PartyProcessorPartyKey, PartyServicePerformerPartyKey, PartyServiceSupportTeamPartyKey, PartyPartyKey, PartyName, PartyAdditionalName, PartySortingFormattedName, PartyServiceExecutionTeamPartyKey, PartyRoleCode, ItemDescription, ItemProductProductKey, ItemProductProductInternalID, ItemProductProductBuyerID, ItemCustomerOrderLifeCycleStatus Code, ItemCustomerContractLifeCycleStatus Code, ItemLastChangeDateTime, ServiceTermsServiceIssueCategoryCatalogueCategoryKey, SolutionProposalCustomerProblemAndSolutionKey, IncidentServiceIssueCategoryMainServiceIssueCategoryCatalogueCategoryKey, BusinessTransactionDocumentReferenceBusinessTransactionDocumentReferenceID, BusinessTransactionDocumentReferenceBusinessTransactionDocumentReferenceTypeCode, TimePointTermsFirstReactionDueTimePoint, TimePointTermsCompletionDueTimePoint, ItemTimePointTermsCompletionDueTimePoint, TimePointTermsRequestInitialReceiptTimePoint, ValidityPeriod, TotalValuesNextAuthorisationDateTime, SearchText, and Status. Status can include Status/ItemListCancellationStatusCode, Status/ItemListFulfilmentProcessingStatusCode, Status/ItemListInvoiceProcessingStatusCode, Status/ConsistencyStatusCode, Status/GeneralDataCompletenessStatus Code, Status/InvoicingBlockingStatusCode, Status/FulfilmentBlockingStatusCode, Status/ItemListCustomerContractLifeCycleStatusCode, Status/ItemListValidityStatusCode, Status/ItemListReleaseStatusCode, Status/CustomerContractTemplateLifeCycleStatusCode, Status/CreditWorthinessStatusCode, Status/ItemListFollowUpProcessingStatusCode.

ID is a unique identifier assigned by a seller for a Customer Transaction Document, and may be based on datatype GDT: BusinessTransactionDocumentID. TypeCode is an encoded representation of a type of Customer Transaction Document, and may be based on datatype GDT: BusinessTransactionDocumentTypeCode. DateTime is a creation time posting time of a Customer Transaction Document, from a business perspective, and may be based on datatype GDT: GLOBAL_DateTime, with a qualifier of Posting. Name is a name of a Customer Transaction Document, and may be based on datatype GDT: MEDIUM_Name. BuyerID is a unique identifier for a Customer Transaction Document, can be assigned by a buyer, and may be based on datatype GDT: BusinessTransactionDocumentID. BuyerName is a short-text description for a Customer Transaction Document, can be assigned by a buyer, and may be based on datatype GDT: MEDIUM_Name. DataOriginTypeCode indicates a type of origin of a customer transaction document, and may be based on datatype GDT: CustomerTransactionDocumentDataOriginTypeCode. SystemAdministrativeData includes administrative data stored in a system, such as system users and change dates/times, and may be based on datatype GDT: SystemAdministrativeData. CreationBusinessPartnerCommonPersonNameGivenName may be based on datatype GDT: MEDIUM_Name. CreationBusinessPartnerCommonPersonNameFamilyName may be based on datatype GDT: MEDIUM_Name. LastChangeBusinessPartnerCommonPersonNameGivenName may be based on datatype GDT: MEDIUM_Name. LastChangeBusinessPartnerCommonPersonNameFamilyName may be based on datatype GDT: MEDIUM_Name. SalesAndServiceBusinessAreaSalesOrganisationID is an identifier for a sales organization that is responsible for a Customer Transaction Document, and may be based on datatype GDT: OrganisationalCentreID. SalesAndServiceBusinessAreaSalesGroupID is an identifier for a sales group that is responsible for a Customer Transaction Document, and may be based on datatype GDT: OrganisationalCentreID. SalesAndServiceBusinessAreaSalesOfficeID is an identifier for a sales office that is responsible for a Customer Transaction Document, and may be based on datatype GDT: OrganisationalCentreID. SalesAndServiceBusinessAreaDistributionChannelCode is a coded representation of a distribution channel by which goods and services reach customers, and may be based on datatype GDT: DistributionChannelCode. SalesAndServiceBusinessAreaServiceOrganisationID is an identifier for a service organization, and may be based on datatype GDT: OrganisationalCentreID.

PartyBuyerPartyKey is an identifier for a BuyerParty, and may be based on datatype KDT: PartyKey. PartyBuyerPartyKey can include PartyBuyerPartyKey/PartyID, which is an identifier for a party, and may be based on datatype GDT: PartyID. BuyerPartyContactPartyPartyKey may be based on datatype KDT: PartyKey. BuyerPartyContactPartyPartyKey may include BuyerPartyContactPartyPartyKey/PartyID, which is an identifier for a party, and may be based on datatype GDT: PartyID. PartySalesUnitPartyKey is a key to identify a sales unit party, and may be based on datatype KDT: PartyKey. PartySalesUnitPartyKey can include PartySalesUnitPartyKey/PartyID, which is an identifier for a party, and may be based on datatype GDT: PartyID. PartyEmployeeResponsiblePartyKey is an identifier of a responsible employee, and may be based on datatype KDT: PartyKey. PartyEmployeeResponsiblePartyKey can include PartyEmployeeResponsiblePartyKey/PartyID, which is an identifier for a party, and may be based on datatype GDT: PartyID. PartyProcessorPartyKey is an identifier of a processor of a Customer Transaction Document document, and may be based on datatype KDT: PartyKey. PartyServicePerformerPartyKey is an identifier of a service performer, and may be based on datatype KDT: PartyKey. PartyServicePerformerPartyKey can include PartyServicePerformerPartyKey/PartyID, which is an identifier for a party, and may be based on datatype GDT: PartyID. PartyServiceSupportTeamPartyKey may be based on datatype KDT: PartyKey. PartyPartyKey is an identifier for a Party or ItemParty in a business document, and may be based on datatype KDT: PartyKey. PartyPartyKey can include PartyPartyKey/PartyID, which is an identifier for a party, and may be based on datatype GDT: PartyID.

PartyName is a name of a party that occurs in a customer transaction document, such as a FamilyName of a business partner (e.g., BusinessPartnerCommonPersonNameFamilyName), and may be based on datatype GDT: MEDIUM_Name, with a qualifier of Party. PartyAdditionalName is an additional name of a party that occurs in a customer transaction document, such as a given name of a business partner (e.g., BusinessPartnerCommonPersonNameGivenName), and may be based on datatype GDT: LANGUAGEINDEPENDENT_MEDIUM_Name, with a qualifier of PartyAdditional. PartySortingFormattedName is a sorting formatted name of a party that occurs in a customer transaction document, such as a SortingFormattedName of a business partner (e.g., BusinessPartnerCommonSortingFormattedName), and may be based on datatype GDT: LONG_Name. PartyServiceExecutionTeamPartyKey may be based on datatype KDT: PartyKey. PartyServiceExecutionTeamPartyKey can include PartyServiceExecutionTeamPartyKey/PartyID, which is an identifier for a party, and may be based on datatype GDT: PartyID. PartyRoleCode indicates a party role for a Party or ItemParty in a business document. The PartyPartyRoleCode or the ItemPartyPartyRoleCode can correspond with the query element PartyRoleCode. PartyRoleCode may be based on datatype GDT: PartyRoleCode.

ItemDescription may be based on datatype GDT: SHORT_Description. ItemProductProductKey is an identifier specified for a product, and may be based on datatype KDT: ProductUnformattedKey. ItemProductProductKey can include ItemProductProductKey/ProductTypeCode, which is a coded representation of a product type, such as material or service, and may be based on datatype GDT: ProductTypeCode. ItemProductProductKey can include ItemProductProductKey/ProductidentifierTypeCode, which is a coded representation of a product identifier type, and may be based on datatype GDT: ProductidentifierTypeCode. ItemProductProductKey can include ItemProductProductKey/ProductID, which is an identifier for a product, and may be based on datatype GDT: NOCONVERSION_ProductID. ItemProductProductInternalID is a unique identifier for a product, can be assigned by a seller, and may be based on datatype GDT: ProductInternalID. ItemProductProductBuyerID is a unique identifier for a product, can be assigned by a buyer, and may be based on datatype GDT: ProductPartyID. ItemCustomerOrderLifeCycleStatusCode represents a basic processing progress on an item of a Customer Transaction Document, and may be based on datatype GDT: CustomerOrderLifeCycleStatusCode. ItemCustomerContractLifeCycleStatusCode may be based on datatype GDT: CustomerContractLifeCycleStatusCode_V1. ItemLastChangeDateTime is a date/time at which a customer transaction document was last changed, and may be based on datatype GDT: GLOBAL_DateTime.

ServiceTermsServiceIssueCategoryCatalogueCategoryKey is a key to identify a category that schedules a service business transaction, and may be based on datatype KDT: ServiceIssueCategoryCatalogueCategoryKey. SolutionProposalCustomerProblemAndSolutionKey is a key to identify a customer problem and solution, and may be based on datatype KDT: CustomerProblemAndSolutionKey. IncidentServiceIssueCategoryMainServiceIssueCategoryCatalogueCategoryKey is a key to identify a main category that is used to categorize an individual incident in a service process, and may be based on datatype KDT: ServiceIssueCategoryCatalogueCategoryKey. BusinessTransactionDocumentReferenceBusinessTransactionDocumentReferenceID is an identifier of a referenced business document. The BusinessTransactionDocumentReferenceBusinessTransactionDocumentReferenceID or the ItemBusinessTransactionDocumentReferenceBusinessTransactionDocumentReferenceID can correspond with the query element BusinessTransactionDocumentReferenceBusinessTransactionDocumentReferenceID. BusinessTransactionDocumentReferenceBusinessTransactionDocumentReferenceID may be based on datatype GDT: BusinessTransactionDocumentID. BusinessTransactionDocumentReferenceBusinessTransactionDocumentReferenceTypeCode is a type of a referenced business transaction document. The BusinessTransactionDocumentReferenceBusinessTransactionDocumentReferenceTypeCode or the ItemBusinessTransactionDocumentReferenceBusinessTransactionDocumentReferenceTypeC ode can correspond with the query element BusinessTransactionDocumentReferenceBusinessTransactionDocumentReferenceTypeCode. BusinessTransactionDocumentReferenceBusinessTransactionDocumentReferenceTypeCode may be based on datatype GDT: BusinessTransactionDocumentTypeCode.

TimePointTermsFirstReactionDueTimePoint is a point-in-time by which a response to a newly received service request or service order is required, and may be based on datatype GDT: Timepoint, with a qualifier of FirstReactionDue. TimePointTermsCompletionDueTimePoint is a point-in-time by which a service request or service order is to be fully processed, and may be based on datatype GDT: TimePoint, with a qualifier of CompletionDue. ItemTimePointTermsCompletionDueTimePoint is a point-in-time by which a service order item is to be fully processed, and may be based on datatype GDT: TimePoint, with a qualifier of CompletionDue. TimePointTermsRequestInitialReceiptTimePoint is a point-in-time by which a request is initially received, and may be based on datatype GDT: TimePoint, with a qualifier of RequestInitialReceipt. ValidityPeriod is a period when a Customer Transaction Document document is valid, and may be based on datatype GDT: TimePointPeriod, with a qualifier of Validity. TotalValuesNextAuthorisationDateTime may be based on datatype GDT: LOCALNORMALISED_DateTime, with a qualifier of Authorisation. SearchText includes free text including one or several word search terms used to search for a customer transaction document, and may be based on datatype GDT: SearchText.

Status represents one or more statuses of a Customer Transaction Document and can correspond to corresponding elements on the Root node. Status may be based on datatype BOIDT: CustomerTransactionDocumentStatus. Status/ItemListCancellation Status Code aggregates a cancellation status of one or more items, and may be based on datatype GDT: CancellationStatusCode. Status/ItemListFulfilmentProcessingStatusCode aggregates a fulfillment status of one or more items, and may be based on datatype GDT: ProcessingStatusCode, with a qualifier of Fulfilment. Status/ItemListInvoiceProcessingStatusCode represents an aggregated representation of InvoicingStatus of one or more items, and may be based on datatype GDT: ProcessingStatusCode, with a qualifier of Invoice. Status/ConsistencyStatusCode describes a status consisting of errors, where business data is not consistent, or data that otherwise includes errors, and may be based on datatype GDT: ConsistencyStatusCode. Status/GeneralDataCompletenessStatusCode indicates that all or part of general business data is missing, and may be based on datatype GDT: DataCompletenessStatusCode, with a qualifier of General. Status/InvoicingBlockingStatusCode indicates a block of an invoicing process, and may be based on datatype GDT: BlockingStatusCode, with a qualifier of Invoicing. Status/FulfilmentBlockingStatusCode represents a block of the delivery of goods or the provision of services, and may be based on datatype GDT: BlockingStatusCode, with a qualifier of Fulfilment. Status/ItemListCustomerContractLifeCycleStatusCode aggregates a contract life cycle status of one or more items, and may be based on datatype GDT: CustomerContractLifeCycleStatusCode_V1. Status/ItemListValidityStatusCode aggregates a validity status of one or more items, and may be based on datatype GDT: ValidityStatusCode. Status/ItemListReleaseStatusCode aggregates a release status of one or more items, and may be based on datatype GDT: ReleaseStatus Code. Status/CustomerContractTemplateLifeCycleStatusCode may be based on datatype GDT: CustomerContractTemplateLifeCycleStatus Code. Status/CreditWorthiness Status Code may be based on datatype GDT: CreditWorthinessStatusCode. Status/ItemListFollowUpProcessingStatusCode aggregates a follow-up processing status of one or more items, and may be based on datatype GDT: ProcessingStatusCode. A Select All query provides the NodeIDs of all instances of the node and can be used to enable an initial load of data for a Fast Search Infrastructure.

A BusinessTransactionDocumentReference is a unique reference between the CustomerTransactionDocument and another business document or another business document item. All references result in the business documents or business document items that are linked directly to the CustomerTransactionDocument. BusinessTransactionDocumentReference occurs in the following incomplete and disjoint specializations: PurchaseOrderReference, CustomerQuoteReference, SalesOrderReference, OutboundDeliveryReference, InboundDeliveryReference, CustomerInvoiceReference, ServiceRequestReference, ServiceContractReference, ServiceConfirmationReference, ServiceOrderReference, CustomerComplaintReference, EmailActivityReference, PhoneCallActivityReference, LetterActivityReference, FaxActivityReference, AppointmentActivityReference, OpportunityReference, and ActivityReference.

The elements located directly at the node Business Transaction Document Reference are defined by the data type CustomerTransactionDocumentBusinessTransactionDocumentReferenceElements. These elements include: BusinessTransactionDocumentReference, BusinessTransactionDocumentRelationshipRoleCode, and DataProviderIndicator. BusinessTransactionDocumentReference includes a unique reference to a business document or to an item of a business document, and may be based on datatype GDT: Business TransactionDocumentReference. BusinessTransactionDocumentRelationshipRoleCode may be optional, is a coded representation of a role that a referenced business document or item of a referenced business document adopts in a reference relationship, and may be based on datatype GDT: BusinessTransactionDocumentRelationshipRoleCode. DataProviderIndicator specifies whether a business document provides data for a referenced business document, and may be based on datatype GDT: Indicator, with a qualifier of DataProvider.

The following inbound association relationships may exist: Customer Contract, from the business object Customer Contract/node Customer Contract, with a cardinality of C:CN; EmailActivity, from the business object Email Activity/node Email Activity, with a cardinality of C:CN, which is EmailActivity that is referenced through specialisation EmailActivityReference; FaxActivity, from the business object Fax Activity/node Fax Activity, with a cardinality of C:CN, which is FaxActivity that is referenced through specialisation FaxActivity; LetterActivity, from the business object Letter Activity/node Letter Activity, with a cardinality of C:CN, which is LetterActivity that is referenced through specialisation LetterActivity; PhoneCallActivity, from the business object Phone Call Activity/node Phone Call Activity, with a cardinality of C:CN, which is PhoneCallActivity that is referenced through specialisation PhoneCallActivity; ServiceConfirmation, from the business object Service Confirmation/node Service Confirmation, with a cardinality of C:CN, which is a ServiceConfirmation that is referenced through specialisation ServiceConfirmationReference; and ServiceRequest, from the business object Service Request/node Service Request, with a cardinality of C:CN, which is a ServiceRequest that is referenced through specialisation ServiceRequestReference.

The following specialization associations for navigation may exist to the node Customer Contract Parent, with a target cardinality of 1; and Root, with a target cardinality of 1. In some implementations, BusinessTransactionDocumentReference includes one or more immediate neighbors of the CustomerTransaction-DocumentTemplate document. In some implementations, the following associations from the referenced business transaction documents are used by the listed projections of the CustomerTransactionDocuemnt_Template: for Service Request: ServiceRequest, ServiceOrder, EmailActivity, PhoneCallActivity, LetterActivity, FaxActivity, and AppointmentActivity; for Service Order: CustomerQuote, OutboundDelivery, CustomerInvoice, ServiceRequest, ServiceContract, ServiceConfirmation, ServiceOrder, CustomerComplaint, EmailActivity, PhoneCallActivity, LetterActivity, FaxActivity, and AppointmentActivity; for Service Confirmation: SalesOrder, OutboundDelivery, CustomerInvoice, ServiceRequest, ServiceConfirmation, ServiceOrder, EmailActivity, PhoneCallActivity, LetterActivity, FaxActivity, and AppointmentActivity; for Sales Order: PurchaseOrder, CustomerQuote, SalesOrder, OutboundDelivery, CustomerInvoice, ServiceConfirmation, and Opportunity; for Customer Quote: CustomerQuote, SalesOrder, and Opportunity; for Customer Return: SalesOrder, InboundDelivery, and CustomerInvoice; and for Support Request: ServiceRequest.

A SalesAndServiceBusinessArea is a business or service specific area within an enterprise that is valid for a CustomerTransactionDocument, such as, for example, a sales organization, service organization, distribution channel, or division. These elements are derived from the organizational unit Sales Unit or Service Unit (e.g., see Party responsible for the CustomerTransactionDocument), and can be overwritten manually.

The elements located directly at the node Sales And Service Business Area are defined by the data type CustomerTransactionDocumentSalesAndServiceBusinessAreaElements. These elements include: Sales OrganisationID, SalesGroupID, SalesOfficeID, DistributionChannelCode, ServiceOrganisationID, SalesOrganisationUUID, SalesGroupUUID, SalesOfficeUUID, and ServiceOrganisationUUID. SalesOrganisationID may be optional, is an identifier for a sales organization that is responsible for a Customer Transaction Document, and may be based on datatype GDT: OrganisationalCentreID. SalesGroupID may be optional, is an identifier for a sales group that is responsible for a Customer Transaction Document, and may be based on datatype GDT: OrganisationalCentreID. SalesOfficeID may be optional, is an identifier for a sales office that is responsible for a Customer Transaction Document, and may be based on datatype GDT: OrganisationalCentreID. DistributionChannelCode is a coded representation of a distribution channel by which goods and services reach customers, and may be based on datatype GDT: DistributionChannelCode. ServiceOrganisationID may be optional, is an identifier for a service organization, and may be based on datatype GDT: OrganisationalCentreID. SalesOrganisationUUID is a universally unique identifier for a sales organization, and may be based on datatype GDT: UUID. SalesGroupUUID is a universally unique identifier for a sales group, and may be based on datatype GDT: UUID. SalesOfficeUUID is a universally unique identifier for a sales office, and may be based on datatype GDT: UUID. ServiceOrganisationUUID is a universally unique identifier for a service organization, and may be based on datatype GDT: UUID.

The following inbound aggregation relationships may exist: Sales Group, from the business object Functional Unit/node Functional Unit, with a cardinality of C:CN, which is a Functional Unit within the specialisation Sales Group; Sales Office, from the business object Functional Unit/node Functional Unit, with a cardinality of C:CN, which is a Functional Unit within the specialization Sales Office; and Sales Organisation, from the business object Functional Unit/node Functional Unit, with a cardinality of C:CN, which is a FunctionalUnit with the specializations Sales Organisation; and Service Organisation, from the business object Functional Unit/node Functional Unit, with a cardinality of C:CN, which is a Functional Unit within the specialisation Service Organisation. The following specialization associations for navigation may exist to the node Customer Contract: Parent, with a target cardinality of 1; and Root, with a target cardinality of 1.

CoveredObject is an object that is covered by a CustomerTransactionDocument. Such an object can be a service product, a material, an individual material, or all products that are assigned to a particular product category. The elements located directly at the node Covered Object are defined by the data type CustomerTransactionDocumentCoveredObjectElements. These elements include: IndividualProductKey, IndividualProductKey, IndividualProductKey, IndividualProductSerialIDKey, ProductKey, ProductCategoryHierarchyProductCategoryIDKey, IndividualProductUUID, ProductUUID, ProductCategoryHierarchyProductCategoryUUID, and Description.

IndividualProductKey may be optional, is a grouping of elements that uniquely identifies an individual product in a covered object of a customer transaction document by product type, product identifier type, and product ID, and may be based on datatype KDT: ProductKey. IndividualProductKey can include IndividualProductKey/ProductTypeCode, which may be optional, is a coded representation of a product type such as a material or service, and may be based on datatype GDT: ProductTypeCode. IndividualProductKey can include IndividualProductKey/ProductidentifierTypeCode, which may be optional, is a coded representation of a product identifier type, and may be based on datatype GDT: ProductidentifierTypeCode. IndividualProductKey can include IndividualProductKey/ProductID, which may be optional, is an identifier for a product, and may be based on datatype GDT: ProductID. IndividualProductSerialIDKey may be optional, is a grouping of elements that uniquely identifies an individual product in a covered object of a customer transaction document by a universally unique reference product ID and serial number, and may be based on datatype KDT: IndividualProductSerialIDKey. IndividualProductSerialIDKey can include IndividualProductSerialIDKey/ReferenceProductUUID, which may be optional, is a universally unique identifier for a product, and may be based on datatype GDT: UUID. IndividualProductSerialIDKey can include IndividualProductSerialIDKey/SerialID, which may be optional, is a SerialID (e.g., serial number) that is an identifier for an individual product, and may be based on datatype GDT: SerialID. ProductKey may be optional, is a grouping of elements that uniquely identifies a product in a covered object of a customer transaction document by product type, product identifier type, and product ID, and may be based on datatype KDT: ProductKey. ProductKey can include ProductTypeCode, ProductidentifierTypeCode, and ProductID. ProductKey/ProductTypeCode may be optional, is a coded representation of a product type such as a material or service, and may be based on datatype GDT: ProductTypeCode. ProductKey/ProductidentifierTypeCode may be optional, is a coded representation of a product identifier type, and may be based on datatype GDT: ProductidentifierTypeCode. ProductKey/ProductID may be optional, is an identifier for a product, and may be based on datatype GDT: ProductID. ProductCategoryHierarchyProductCategoryIDKey may be optional, is a grouping of elements that uniquely identifies a product category of products covered by a customer transaction document, by product category hierarchy ID and product category ID, and may be based on datatype KDT: ProductCategoryHierarchyProductCategoryIDKey. ProductCategoryHierarchyProductCategoryIDKey can include ProductCategoryHierarchyID and ProductCategoryInternalID. ProductCategoryHierarchyProductCategoryIDKey/ProductCategoryHierarchyID may be optional, is an identifier for a product category hierarchy, and may be based on datatype GDT: ProductCategoryHierarchyID. ProductCategoryHierarchyProductCategoryIDKey/ProductCategoryInternalID may be optional, is an identifier for a product category, and may be based on datatype GDT: ProductCategoryInternalID. IndividualProductUUID may be optional, is a globally unique identifier for an individual product, and may be based on datatype GDT: UUID. ProductUUID may be optional, is a globally unique identifier for a product, and may be based on datatype GDT: UUID. ProductCategoryHierarchyProductCategoryUUID may be optional, is a globally unique identifier for a product category, and may be based on datatype GDT: UUID. Description may be optional, is a description of a covered object in a customer transaction document, and may be based on datatype GDT: MEDIUM_Description.

The following inbound aggregation relationships may exist: Individual Material, from the business object Individual Material/node Individual Material, with a cardinality of C:CN; Individual Product, from the business object IndividualProduct/node Root, with a cardinality of C:CN, which is an individual product covered by a customer transaction document; Material, from the business object Material/node Material, with a cardinality of C:CN, which is a material covered by a customer transaction document; Product Category Hierarchy, from the business object Product Category Hierarchy/node Product Category, with a cardinality of C:CN; and Service Product, from the business object Service Product/node Service Product, with a cardinality of C:CN, which is a service product covered by a customer transaction document. The following specialization associations for navigation may exist to the node Customer Contract: Parent, with a target cardinality of 1; and Root, with a target cardinality of 1. In some implementations, a ProductTypeCode is determined internally and is subsequently read-only. In some implementations, either a product or a product category can be specified, but not both at the same time.

Credit Worthiness includes information about a credit worthiness of a party (e.g., payer party) in a customer transaction document, such as data about an amount of a credit limit, credit exposure, and credit worthiness. Credit worthiness data can be transient. The elements located directly at the node Credit Worthiness are defined by the data type CustomerTransactionDocumentCreditWorthinessElements. These elements include: CreditLimitAmount, CreditExposureAmount, and Indicator. CreditLimitAmount is an amount up to which a credit can be used, and may be based on datatype GDT: Amount, with a qualifier of CreditLimit. CreditExposureAmount is an amount up to which a credit line has been used, and may be based on datatype GDT: Amount, with a qualifier of CreditExposure. Indicator indicates whether a payer is creditworthy, and may be based on datatype GDT: Indicator. The following specialization associations for navigation may exist to the node Customer Contract Parent, with a target cardinality of 1; and Root, with a target cardinality of 1.

DurationTerms is a duration related agreement for goods and services that can occur in a CustomerTransactionDocument. DurationTerms can occur in the following disjoint specializations incomplete with reference to a role of the duration DurationRoleCode: MaximumFirstReactionDuration, MaximumCompletionDuration, RequestMaximumProviderCompletionDuration, RequestTotalInitialReactionDuration, RequestTotalProcessingDuration, RequestTotalRequestorDuration, and RequestTotalProviderProcessingDuration. MaximumFirstReactionDuration is a duration before an expiration of which a reaction to a newly received service request, or a newly received service order is to occur, where the duration can be calculated from a Service Level Objective. MaximumCompletionDuration is a duration before an expiration of which a service request, or service order have is to have been completed, where the duration period can be calculated from a Service Level Objective. RequestMaximumProviderCompletionDuration is a duration before an expiration of which a provider is to complete a request, where the duration period is calculated from a Service Level Objective. RequestTotalInitialReactionDuration is a total duration that elapses before a request is accessed for processing, where the duration can be calculated using status changes of a document, and can be represented by the expression ‘“In Process since”—“Opened At”+TotalInitialReactionDurationold’. RequestTotalProcessingDuration is a total duration of the processing of a request, where the duration can be calculated using status changes of a document, and can be represented by the expression ‘“Finished At”—“Opened At”+“TotalProcessingDuration old”’. RequestTotalRequestorDuration is a total duration that a requestor uses for processing a request, where the duration can be calculated using status changes of a document, and can be represented by the expression “Finished At”—“Opened At”+“TotalRequestorDuration old”’. RequestTotalProviderProcessingDuration is a total duration that a provider uses for processing a request, where the duration can be calculated using status changes of a document, and can be represented by the expression ‘“Received from Provider At”—“Sent to Provider At”+“TotalProviderProcessingDuration old”’.

The elements located directly at the node Duration Terms are defined by the data type CustomerTransactionDocumentDurationTermsElements. These elements include: DurationRoleCode, Duration, and DateCalculationFunctionReference. DurationRoleCode is a role of a specified duration, and may be based on datatype GDT: DurationRoleCode. Duration is a specification of a duration, and may be based on datatype GDT: Duration. DateCalculationFunctionReference is a reference to a function with which a duration is calculated, and may be based on datatype GDT: DateCalculationFunctionReference. The following specialization associations for navigation may exist to the node Customer Contract: Parent, with a target cardinality of 1; and Root, with a target cardinality of 1.

InvoiceTerms are agreements that apply for invoicing goods and services in the CustomerTransactionDocument. The elements located directly at the node Invoice Terms are defined by the data type CustomerTransactionDocumentInvoiceTermsElements. These elements include: ProposedInvoiceDate, ProposedInvoiceDateDateCalculationFunctionReference, and InvoicingBlockingReasonCode. ProposedInvoiceDate may be optional, is a date on which an invoice is proposed to be created with a rule for automatic scheduling, and may be based on datatype GDT: Date, with a qualifier of Invoice. ProposedInvoiceDateDateCalculationFunctionReference is a date rule for determining a proposed price date, and may be based on datatype GDT: DateCalculationFunctionReference. InvoicingBlockingReasonCode may be optional, specifies why processing of invoicing documents is blocked for a business transaction item, and may be based on datatype GDT: InvoicingBlockingReasonCode. The following specialization associations for navigation may exist to the node Customer Contract: Parent, with a target cardinality of 1; and Root, with a target cardinality of 1. In some implementations, at least one of the elements is set.

Item is an item of a customer-specific business transaction that focuses on delivering goods or providing a service, on prices and on preparing an invoice. Item can include identifying and administrative item information in a CustomerTransactionDocument which, in addition to schedule lines, can include data that applies to an item, for example, product information, involved parties, sales, delivery, or customer-invoicing-specific agreements, and status. Item occurs in the following not complete, disjoint specializations: Sales Service Item, Sales Service Quote Item, Service Contract Item, Customer Service Confirmation Item, Customer Spare Part Quote Item, Customer Service Quote Item, Customer Spare Part Confirmation Item, Customer Service Item, Customer Spare Part Item, Sales Item, Sales Quote Item, Complaint Item, Customer Return Item, Compensation Delivery Item, Refund Item, and Sales Contract Item. In some implementations, a specialization type can be implemented by a Type attribute.

The elements located directly at the node Item are defined by the data type CustomerTransactionDocumentItemElements. These elements include: ID, BuyerID, TypeCode, ProcessingTypeCode, DateTime, Description, BuyerDateTime, BuyerName, HierarchyRelationship, HierarchyRelationship, HierarchyRelationship, HierarchyRelationship, UUID, SystemAdministrativeData, FulfilmentPartyCategoryCode, MigratedDataAdaptationTypeCode, and Status. Status can include Status/ConsistencyStatusCode, Status/GeneralDataCompletenessStatusCode, Status/FulfilmentProcessingStatusCode, Status/InvoiceProcessingStatusCode, Status/CancellationStatusCode, Status/Release Status Code, Status/CustomerContractLifeCycleStatusCode, StatusNalidityStatusCode, Status/FulfilmentBlockingStatusCode, and Status/InvoicingBlockingStatusCode.

ID is a unique identifier for an item of Customer Transaction Document assigned by a seller in a Customer Transaction Document document, and may be based on datatype GDT: BusinessTransactionDocumentItemID BuyerID may be optional, is a unique identifier for a Customer Transaction Document item assigned by a buyer, and may be based on datatype GDT: BusinessTransactionDocumentItemID TypeCode is a coded representation of a type of a Customer Transaction Document item, may be based on datatype GDT: Business TransactionDocumentItemTypeCode, and can be set internally from a ProcessingTypeCode and includes one of the permissible item specializations of a CustomerTransactionDocumentTemplate. An example of a TypeCode is a SalesItem. ProcessingTypeCode may be optional, is a coded representation of item processing of a Customer Transaction Document in a process component, and may be based on datatype GDT: BusinessTransactionDocumentItemProcessingTypeCode. ProcessingTypeCode “Item type” or “item category” can include standard order items, for example. DateTime may be optional, is a creation time posting time of a Customer Transaction Document item from a business perspective, and may be based on datatype GDT: GLOBAL_DateTime. Description is a short description of a Customer Transaction Document item, and may be based on datatype GDT: SHORT_Description. BuyerDateTime may be optional, is a date/time assigned by a buyer for a Customer Transaction Document item, and may be based on datatype GDT: GLOBAL_DateTime, with a qualifier of Buyer. BuyerName is a name of an item assigned by a buyer, and may be based on datatype GDT: MEDIUM_Name. HierarchyRelationship represents a relationship between a subitem and a main item to describe item hierarchies, and may be based on datatype BOIDT: CustomerTransactionDocumentItemHierarchyRelationship. HierarchyRelationship can include ParentItemID, ParentItemUUID, and TypeCode. HierarchyRelationship/ParentItemID may be optional, is an ID of a higher-level item in an item hierarchy of a Customer Transaction Document, and may be based on datatype GDT: BusinessTransactionDocumentItemID HierarchyRelationship/ParentItemUUID is a UUID of a higher-level item in an item hierarchy of a Customer Transaction Document, and may be based on datatype GDT: UUID. HierarchyRelationship/TypeCode is a relationship type of an item hierarchy in a customer transaction document, and may be based on datatype GDT: BusinessTransactionDocumentItemHierarchyRelationshipTypeCode. UUID may be an alternative key, is an identifier for a Customer Transaction Document item, can be assigned internally, and may be based on datatype GDT: UUID. UUID can serve as an alternate key, with which other business objects can define foreign keys. SystemAdministrativeData includes administrative data stored in a system, such as system users and change dates/times, and may be based on datatype GDT: SystemAdministrativeData. FulfilmentPartyCategoryCode indicates a Party category of a Fulfilment of a customer transaction document item, may be based on datatype GDT: FulfilmentPartyCategoryCode, and defines if a delivery of a material or provision of a service is done by the internal company or by an external supplier. MigratedDataAdaptationTypeCode may be optional, is a coded representation of a type of data adaption performed during migration of a customer transaction document item, and may be based on datatype GDT: MigratedDataAdaptationTypeCode. When migrating data from a source system to a target system, data may be adapted. For example, a business object or business document may be completely or partially taken over. The MigratedDataAdaptationTypeCode can be used when a CustomerTransactionDocument item is migrated.

Status may be optional, describes one or more statuses of a Customer Transaction Document on an item level, and may be based on datatype BOIDT: CustomerTransactionDocumentItemStatus. Status/ConsistencyStatusCode may be optional, denotes whether a Customer Transaction Document has errors, and may be based on datatype GDT: ConsistencyStatusCode. Status/GeneralDataCompletenessStatusCode may be optional, describes whether general data has been completely entered, and may be based on datatype GDT: DataCompletenessStatusCode, with a qualifier of General. Status/FulfilmentProcessingStatusCode may be optional, describes a processing progress regarding a delivery or provision of a service, and may be based on datatype GDT: ProcessingStatusCode, with a qualifier of Fulfilment. Status/InvoiceProcessingStatusCode may be optional, describes a processing progress during invoicing, and may be based on datatype GDT: ProcessingStatusCode, with a qualifier of Invoice. Status/CancellationStatusCode may be optional, indicates whether a cancellation for a Customer Transaction Document exists, and may be based on datatype GDT: CancellationStatusCode. Status/ReleaseStatusCode may be optional, represents a release of a customer transaction document item for subsequent processes, and may be based on datatype GDT: ReleaseStatusCode. Status/CustomerContractLifeCycleStatusCode may be optional, represents a basic processing progress on an item of a Customer Transaction Document, and may be based on datatype GDT: CustomerContractLifeCycleStatusCode_V1. Status/ValidityStatusCode may be optional, represents the validity of a customer transaction document item, and may be based on datatype GDT: ValidityStatusCode. Status/FulfilmentBlockingStatusCode may be optional, represents a block of a delivery of goods or a provision of services, and may be based on datatype GDT: BlockingStatusCode. Status/InvoicingBlockingStatusCode may be optional, represents a block of an invoicing process, and may be based on datatype GDT: BlockingStatusCode.

The following composition relationships to subordinate nodes exist: ItemActualValues, with a cardinality of 1:C; ItemBusinessTransactionDocumentReference, with a cardinality of 1:CN; ItemPeriodTerms, with a cardinality of 1:CN; ItemPricingTerms, with a cardinality of 1:C; ItemProduct, with a cardinality of 1:C; ItemSalesTerms, with a cardinality of 1:C; ItemScheduleLine, with a cardinality of 1:CN; ItemTimePointTerms, with a cardinality of 1:CN; ItemTotalValues, with a cardinality of 1:C; Item Entitled Product, with a cardinality of 1:CN; ItemDurationTerms, with a cardinality of 1:CN; ItemInvoiceTerms, with a cardinality of 1:C; ItemParty, with a cardinality of 1:CN, which may be filtered; and ItemBusinessProcessVariantType, with a cardinality of 1:N, which may be filtered. The filter elements for ItemParty are defined by the data type PartyFilterElements. These elements include: RoleCategoryCode and MainIndicator. RoleCategoryCode may be optional and may be based on datatype GDT: PartyRoleCategoryCode. MainIndicator may be optional and may be based on datatype GDT: Indicator. The filter elements for ItemBusinessProcessVariantType are defined by the data type BusinessProcessVariantTypeFilterElements. These elements include BusinessProcessVariantTypeCode, which may be optional and may be based on datatype GDT: BusinessProcessVariantTypeCode.

The following composition relationships to dependent objects can exist: ItemAttachmentFolder, with a cardinality of 1:C, which is a collection of documents attached for an item of a CustomerTransactionDocument; ItemTextCollection, with a cardinality of 1:C, which is a collection of natural-language texts that refer to an item in a CustomerTransactionDocument; Item Price Specification, with a cardinality of 1:CN; and Item Accounting Coding Block Distribution, with a cardinality of 1:C, which distributes value changes from a customer transaction document item to coding blocks, whereby the distribution may occur on the basis of amounts or quantities and where the distribution can be a distribution of coding blocks that includes an identification of the distribution and information that is valid for all coding blocks, such as a company performing reporting, a date on which the coding blocks are valid, or a quantity-based or amount-based total for which assignments are to be made.

The following inbound association relationships may exist: CreationIdentity, from the business object Identity/node Identity, with a cardinality of 1:CN, which is an identity of a user that created a Customer Transaction Document Item; Last Change Identity, from the business object Identity/node Identity, with a cardinality of 1:CN, which is an identity of a user that last changed a Customer Transaction Document Item; and SourcingList, from the business object Sourcing List/node Sourcing List, with a cardinality of C:CN, which is a sourcing list that includes sources of supplies that are valid for a customer transaction document item.

The following specialization associations for navigation may exist: Parent, to the node Customer Contract, with a target cardinality of 1; Root, to the node Customer Contract, with a target cardinality of 1; Price and Tax Calculation Item, to the node Item, with a target cardinality of C, which is an association to an item in the results of a price and tax calculation; and Main Item Business Process Variant Type, to the node Item Business Process Variant Type, with a target cardinality of C, which is an association to a main ItemBusinessProcessVariantType.

The following specialization associations for navigation may exist to the node Item Business Transaction Document Reference: Item Customer Invoice Item Reference, with a target cardinality of CN, which is an association to a reference that occurs in the ItemCustomerInvoiceItemReference specialization; Item Purchase Order Item Reference, with a target cardinality of C, which is an association to a reference that occurs in the ItemPurchaseOrderItemReference specialization; Item Service Confirmation Item Reference, with a target cardinality of CN, which is an association to a reference that occurs in the ItemServiceConfirmationitemReference specialization; and Base Item Business Transaction Document Item Reference, with a target cardinality of C, which is an association to a reference that occurs in a specialization, and is used as a basis. For returns, the BaseItemBusinessTransactionDocumentItemReference can be, for example, a sales order item or a customer invoice item.

The following specialization associations for navigation may exist to the node Item Duration Terms Minimum Validity Item Duration, with a target cardinality of C, which is a minimum duration during which a customer transaction document item is valid; Reminder Item Duration, with a target cardinality of C, which is a duration before which a reminder for a customer transaction document item is to be triggered; and Validity Item Duration, with a target cardinality of C, which is a duration during which a customer transaction document item is valid.

The following specialization associations for navigation may exist to the node Item Party: Product Recipient Item Party, with a target cardinality of C, which is an association to a Party that occurs in the ProductRecipientItemParty specialization; Seller Item Party, with a target cardinality of C, which is an association to a Party that occurs in a SellerItemParty specialization; Service Execution Team Item Party, with a target cardinality of C, which is an association to a Party that occurs in the specialization ServiceExecutionTeamItemParty; Service Performer Item Party, with a target cardinality of C, which is an association to a Party that occurs in the ServicePerformerItemParty specialization; ContractReleaseAuthorizedItemParty, with a target cardinality of C, which is an association to a Party that occurs in the ContractReleaseAuthorizedItemParty specialization; Tax Reporting Unit Item Party, with a target cardinality of C, which is a party that has an assigned tax reporting unit role category; and Vendor Item Party, with a target cardinality of C, which is an association to a Party that occurs in VendorItemParty.

The following specialization associations for navigation may exist: Validity Item Period, to the node Item Period Terms, with a target cardinality of C, which is a period in which a customer transaction document item is valid; First Requested Item Schedule Line, to the node Item Schedule Line, with a target cardinality of C, which is an association to a ScheduleLine that occurs in the RequestedItemScheduleLine specialization; Minimum Validity End Item Time Point, to the node Item Time Point Terms, with a target cardinality of C, which is a point in time by which a minimum validity of a customer transaction document item ends; and Invoice Schedule Item, to the node To-Be-Scheduled Item, with a target cardinality of C.

In some implementations, the BuyerID and the ID are not changed after an item has been created. In some implementations, the ParentItemID and the HierarchyRelationshipTypeCode are not changed after an item has been created. SystemAdministrativeData can be set internally by the system and such data might not be assigned or changed externally. In some implementations, the ParentItemID is not changed after an item has been created. In some implementations, the HierarchyRelationshipTypeCode is not changed after an item has been created. In some implementations, the ParentItemID, ParentItemUUID and HierarchyRelationshipTypeCode are set together.

A Cancel action cancels items by setting a cancellation reason. The Cancel action can be allowed if an item has not been cancelled or completed. The Cancel action sets the status variable ‘CancellationStatus’ to ‘Cancelled’. The action elements are defined by the data type CustomerTransactionDocumentItemCancelActionElements. These elements include CancellationReasonCode, which may be optional, is a reason for canceling a sales transaction, and may be based on datatype GDT: CancellationReasonCode.

A Check Consistency action checks a CustomerTransactionDocument for errors and can set a ConsistencyStatus to either ‘Consistent’ or ‘Inconsistent’. A Finish Fulfilment Processing action sets a FulfilmentProcessingStatus of an item of a CustomerTransactionDocument to “Finished” and can be valid for items that have a FulfillmentProcessingStatus of “In Process”. A Start Fulfilment Processing action sets the FulfilmentProcessingStatus of an item of a CustomerTransactionDocument to “In Process” and can be valid for items that have a FulfillmentProcessingStatus of “Open”.

A Check General Data Completeness action checks for general data completeness. A Confirm Customer Invoice Issue action updates an invoice quantity and sets an Invoicing status according to an update in the Customer Invoice Processing System. The action elements are defined by the data type CustomerTransactionDocumentItemConfirmCustomerInvoiceIssueActionElements. These elements include InvoiceProcessingStatusCode, which may be optional, describes a processing progress during invoicing, and may be based on datatype GDT: ProcessingStatusCode, with a qualifier of Invoice.

A Renew action can be used to renew a customer transaction document item and can be applied at an item node of a customer transaction document. The Renew action copies an item, renewed by a specified duration. The action elements are defined by the data type CustomerTransactionDocumentItemRenewActionElements. These elements include Duration, which may be optional, is a duration by which a customer transaction document item is to be renewed, and may be based on datatype GDT: Duration.

A Revoke Finish Fulfilment Processing action revokes the action Finish Fulfilment Processing. The Revoke Finish Fulfilment Processing action can be valid for items that have a FulfillmentProcessingStatus of “Finished” and a LifeCycleStatus of something other than “Completed”. The Revoke Finish Fulfilment Processing action changes the ‘FulfillmentProcessingStatus’ status variable from ‘Finished’ to ‘In Process’.

A Release action releases an item of CustomerTransactionDocument for subsequent processing. Preconditions of the Release action can include a Release status having a value of ‘Not Released’ and a Consistency status having a value of ‘Consistent’. The Release action changes the ‘Release’ status from ‘Not released’ to ‘Released’.

A Check Validity action sets a Validity status according to a contract item start date and a contract item end date. The action elements are defined by the data type CustomerTransactionDocumentItemCheckValidityActionElements. These elements include ValidityStatusCode, which may be optional, describes processing progress during invoicing, and may be based on datatype GDT: ValidityStatusCode.

A Finish Invoicing Processing action sets an InvoicingProcessingStatus of an item of a CustomerTransactionDocument to “Finished”. The Finish Invoicing Processing action can be valid for items that have an InvoicingProcessingStatus of “Not started” or “In Process”, a ReleaseStatus of “Released”, and a ConsistencyStatus of “Consistent”.

A Request Cancellation action requests a cancellation for an item by setting a cancellation reason. The Request Cancellation action can be allowed if an item has not been cancelled. The Request Cancellation action sets the status variable ‘CancellationStatus’ to ‘Cancellation Requested’. A Revoke Request Cancellation action revokes a requested cancellation for an item by deleting a cancellation reason. The Revoke Request Cancellation action can be allowed if an item has been requested for cancellation. The Revoke Request Cancellation action sets the status variable ‘CancellationStatus’ to ‘Not Cancelled’.

ItemActualValues include cumulated data quantities or values of an item in a CustomerTransactionDocument that is derived from a particular business process or a reference document. The elements located directly at the node Item Actual Values are defined by the data type CustomerTransactionDocumentItemActualValuesElements. These elements include: FulfilledQuantity, FulfilledQuantityTypeCode, AcceptedFulfilledQuantity, AcceptedFulfilledQuantityTypeCode, RejectedFulfilledQuantity, RejectedFulfilledQuantityTypeCode, InvoicedQuantity, InvoicedQuantityTypeCode, InvoicedAmount, OrderedQuantity, OrderedQuantityTypeCode, ConfirmedFulfilledQuantity, and ConfirmedFulfilledQuantityTypeCode.

FulfilledQuantity is a cumulated, fulfilled quantity in an item in a Customer Transaction Document document which can be used in a context of order and returns, and may be based on datatype GDT: Quantity, with a qualifier of Fulfilled. FulfilledQuantityTypeCode qualifies a type of a fulfilled quantity, and may be based on datatype GDT: QuantityTypeCode, with a qualifier of Fulfilled. AcceptedFulfilledQuantity is a cumulated, accepted fulfilled quantity in a Customer Transaction Document item which can be used in a context of returns, and may be based on datatype GDT: Quantity, with a qualifier of Fulfilled. AcceptedFulfilledQuantityTypeCode qualifies a type of an accepted fulfilled quantity, and may be based on datatype GDT: QuantityTypeCode, with a qualifier of Fulfilled. RejectedFulfilledQuantity is a cumulated, rejected fulfilled quantity in a Customer Transaction Document item which can be used in a context of returns, and may be based on datatype GDT: Quantity, with a qualifier of Fulfilled. RejectedFulfilledQuantityTypeCode qualifies a type of a rejected fulfilled quantity, and may be based on datatype GDT: QuantityTypeCode, with a qualifier of Fulfilled. InvoicedQuantity is a cumulated, invoiced quantity in a SalesOrder item, and may be based on datatype GDT: Quantity, with a qualifier of Invoiced. InvoicedQuantityTypeCode qualifies a type of an invoiced quantity, and may be based on datatype GDT: QuantityTypeCode, with a qualifier of Invoiced. InvoicedAmount is a cumulated, invoiced amount in a Customer Transaction Document item, and may be based on datatype GDT: Amount, with a qualifier of Invoiced. OrderedQuantity is a cumulated, ordered quantity for a Customer Transaction Document item which can be used in a context of quotes and contracts, and may be based on datatype GDT: Quantity, with a qualifier of Ordered. OrderedQuantityTypeCode qualifies a type of an ordered quantity, and may be based on datatype GDT: QuantityTypeCode, with a qualifier of Ordered. ConfirmedFulfilledQuantity is a cumulated, fulfilled quantity that has been confirmed in a customer transaction document item, and may be based on datatype GDT: Quantity, with a qualifier of Fulfilled. A confirmed fulfilled quantity represents a cumulated, fulfilled quantity of spare parts or services confirmed by a service performer, or materials confirmed by a customer. ConfirmedFulfilledQuantityTypeCode qualifies a type of a confirmed fulfilled quantity, and may be based on datatype GDT: QuantityTypeCode, with a qualifier of Fulfilled. The following specialization associations for navigation may exist: Root, to the node Customer Contract, with a target cardinality of 1; and Parent, to the node Item, with a target cardinality of 1.

An ItemBusinessTransactionDocumentReference is a unique reference between an item in a CustomerTransactionDocument and another business document or another business document item. All references can result in business documents or business document items that are linked directly to an item of the CustomerTransactionDocument. CRUD services can be available for a BTDItemReference. ItemBusinessTransactionDocumentReference occurs in the following incomplete and disjoint specializations: ItemPurchaseOrderItemReference, ItemCustomerQuotehemReference, ItemSalesOrderItemReference, ItemOutboundDeliveryItemReference, ItemInboundDeliveryItemReference, ItemConfirmedInboundDeliveryhemReference, ItemCustomerInvoiceItemReference, ItemServiceConfirmationhemReference, ItemServiceOrderItemReference, ItemCustomerComplainthemReference, ItemOpportunityhemReference, and ItemCustomerContractReference.

The elements located directly at the node Item Business Transaction Document Reference are defined by the data type CustomerTransactionDocumentItemBusinessTransactionDocumentReferenceElements. These elements include: BusinessTransactionDocumentReference, BusinessTransactionDocumentRelationshipRoleCode, and DataProviderIndicator. BusinessTransactionDocumentReference includes a unique reference to a business document or to an item of a business document, and may be based on datatype GDT: BusinessTransactionDocumentReference. BusinessTransactionDocumentRelationshipRoleCode may be optional, is a coded representation of a role that a referenced business document or item of a referenced business document adopts in a reference relationship, and may be based on datatype GDT: BusinessTransactionDocumentRelationshipRoleCode. DataProviderIndicator specifies whether a business document provides data for a referenced business document, and may be based on datatype GDT: Indicator, with a qualifier of DataProvider.

The following composition relationships to subordinate nodes exist: ItemBusinessTransactionDocumentReferenceActualValues, with a cardinality of 1:C. The following inbound association relationships may exist: CustomerContract, from the business object Customer Contract/node Customer Contract, with a cardinality of C:CN; ServiceConfirmation, from the business object Service Confirmation/node Service Confirmation, with a cardinality of C:CN, which is a ServiceConfirmation that is referenced through specialisation ItemServiceConfirmationitemReference; and ServiceRequest, from the business object Service Request/node Service Request, with a cardinality of C:CN, which is a ServiceRequest that is referenced through specialisation ItemServiceRequestItemReference. The following specialization associations for navigation may exist: Root, to the node Customer Contract, with a target cardinality of 1; and Parent, to the node Item, with a target cardinality of 1.

In some implementations, the ItemBusinessTransactionDocumentReference includes a CustomerTransactionDocument's direct neighbors. The following associations from the referenced business transaction document items can be used by the listed projections of the CustomerTransactionDocument_Template: for Service Order: CustomerQuote, OutboundDelivery, CustomerInvoice, ServiceConfirmation, ServiceOrder, and CustomerComplaint; for Service Confirmation: SalesOrder, OutboundDelivery, CustomerInvoice, and ServiceOrder; for Sales Order: PurchaseOrder, CustomerQuote, SalesOrder, OutboundDelivery, CustomerInvoice, ServiceConfirmation, and Opportunity; for Customer Quote CustomerQuote, SalesOrder, and Opportunity; for Customer Return: SalesOrder, InboundDelivery, and CustomerInvoice; for Customer Contract: PurchaseOrder, ServiceConfirmation, and CustomerInvoice. In some implementations, an association from a Customer Contract is used by a Sales Order.

An ItemBusinessTransactionDocumentReferenceActualValues includes data quantities and values of a reference of a CustomerTransactionDocument to a different document that is replicated from the referenced document. The elements located directly at the node Item Business Transaction Document Reference Actual Values are defined by the data type CustomerTransactionDocumentItemBusinessTransactionDocumentReferenceActualValuesElements. These elements include: QuantityRoleCode, Quantity, AmountRoleCode, Amount, TimePointRoleCode, and TimePoint. QuantityRoleCode may be optional, is a coded representation of a role of a quantity, and may be based on datatype GDT: QuantityRoleCode. Quantity is a non-monetary numeral specification of a quantity in a unit of measure, and may be based on datatype GDT: Quantity. An AmountRoleCode is a coded representation of a role of an amount, and may be based on datatype GDT: AmountRoleCode. An Amount is an amount with a corresponding currency unit, and may be based on datatype GDT: Amount. TimePointRoleCode is a coded representation of a role of a time, and may be based on datatype GDT: TimePointRoleCode. TimePoint is a unique time point in a specific time context, can be defined by means of a time and date value and a time zone, and may be based on datatype GDT: TimePoint. The following specialization associations for navigation may exist: Root, to the node Customer Contract, with a target cardinality of 1; and Parent, to the node Item Business Transaction Document Reference, with a target cardinality of 1.

ItemBusinessProcessVariantType defines a character of a business process variant of an item of a CustomerTransactionDocument and represents a typical way of processing an item of a CustomerTransactionDocument in a process component from a business point of view. The elements located directly at the node Item Business Process Variant Type are defined by the data type CustomerTransactionDocumentItemBusinessProcessVariantTypeElements. These elements include BusinessProcessVariantTypeCode and MainIndicator. A BusinessProcessVariantTypeCode is a coded representation of a business process variant type of a Customer Transaction Document item, and may be based on datatype GDT: BusinessProcessVariantTypeCode. MainIndicator specifies whether a current BusinessProcessVariantTypeCode indicates a main variant type, and may be based on datatype GDT: Indicator, with a qualifier of Main. The following specialization associations for navigation may exist: Root, to the node Customer Contract, with a target cardinality of 1; and Parent, to the node Item, with a target cardinality of 1.

ItemEntitledProduct is an identification and description of a product, or of products assigned to a product category that a customer is entitled to release with reference to a CustomerTransactionDocument item. Such a product can be a service product, including expense, or a material as a spare part. The elements located directly at the node Item Entitled Product are defined by the data type CustomerTransactionDocumentItemEntitledProductElements. These elements include: ProductKey, ProductUUID, ProductCategoryHierarchyProductCategoryUUID, Description, and ProductCategoryHierarchyProductCategoryIDKey. ProductKey can include ProductTypeCode, ProductidentifierTypeCode, and ProductID. ProductCategoryHierarchyProductCategoryIDKey can include ProductCategoryHierarchyID and ProductCategoryInternalID.

ProductKey may be optional, is a grouping of elements that uniquely identifies an entitled product in a customer transaction document item by product type, product identifier type, and product ID, and may be based on datatype KDT: ProductKey. ProductKey/ProductTypeCode may be optional, is a coded representation of a product type such as a material or service, and may be based on datatype GDT: ProductTypeCode. ProductKey/ProductidentifierTypeCode may be optional, is a coded representation of a product identifier type, and may be based on datatype GDT: ProductidentifierTypeCode. ProductKey/ProductID may be optional, is an identifier for a product, and may be based on datatype GDT: ProductID. ProductCategoryHierarchyProductCategoryIDKey may be optional, is a grouping of elements that uniquely identifies a product category assigned to a product, by product category hierarchy ID and product category ID, and may be based on datatype KDT: ProductCategoryHierarchyProductCategoryIDKey. ProductCategoryHierarchyProductCategoryIDKey/ProductCategoryHierarchyID may be optional, is an identifier for a product category hierarchy, and may be based on datatype GDT: ProductCategoryHierarchyID. ProductCategoryHierarchyProductCategoryIDKey/ProductCategoryInternalID may be optional, is an identifier for a product category, and may be based on datatype GDT: ProductCategoryInternalID. ProductUUID may be optional, is a globally unique identifier for a product, and may be based on datatype GDT: UUID. ProductCategoryHierarchyProductCategoryUUID may be optional, is a globally unique identifier for a product category, and may be based on datatype GDT: UUID. Description may be optional, is a description of an entitled product in a customer transaction document item, and may be based on datatype GDT: MEDIUM_Description.

The following inbound aggregation relationships may exist: Material, from the business object Material/node Material, with a cardinality of C:CN, which denotes a material in a customer transaction document item entitled product; Material_V1, from the business object Material/node Material, with a cardinality of C:CN, which is a material in a customer transaction document item entitled product; Product Category Hierarchy, from the business object Product Category Hierarchy/node Product Category, with a cardinality of C:CN; Service Product, from the business object Service Product/node Service Product, with a cardinality of C:CN; and ServiceProduct_V1, from the business object Service Product/node Service Product, with a cardinality of C:CN, which is a service product in a customer transaction document item entitled product.

The following specialization associations for navigation may exist: Root, to the node Customer Contract, with a target cardinality of 1; Parent, to the node Item, with a target cardinality of 1; and Item Price Specification, to the node Price Specification, with a target cardinality of CN. In some implementations, a ProductTypeCode is determined internally and can subsequently be read-only. In some implementations, either a product or a product category can be specified, but not both at the same time.

ItemDurationTerms is a duration related agreement for goods and services that can occur at an item level in a CustomerTransactionDocument. Item Duration Terms occurs in the following not complete, disjoint specializations: Maximum First Reaction Item Duration Terms, and Maximum Completion Item Duration Terms. In some implementations, a specialization type can be implemented by a Type attribute. The elements located directly at the node Item Duration Terms are defined by the data type CustomerTransactionDocumentItemDurationTermsElements. These elements include: DurationRoleCode, Duration, and DateCalculationFunctionReference. DurationRoleCode is a role of a specified duration, and may be based on datatype GDT: DurationRoleCode. Duration is a specification of a duration, and may be based on datatype GDT: Duration. DateCalculationFunctionReference is a reference to a function with which a duration is calculated, and may be based on datatype GDT: DateCalculationFunctionReference. The following specialization associations for navigation may exist: Root, to the node Customer Contract, with a target cardinality of 1; and Parent, to the node Item, with a target cardinality of 1.

ItemInvoiceTerms are item-specific agreements that apply for invoicing goods and services in a CustomerTransactionDocument. The elements located directly at the node Item Invoice Terms are defined by the data type CustomerTransactionDocumentItemInvoiceTermsElements. These elements include: ProposedInvoiceDate, ProposedInvoiceDateDateCalculationFunctionReference, ToBeInvoicedQuantity, and ToBeInvoicedQuantityTypeCode. ProposedInvoiceDate may be optional, is a date on which an invoice is proposed to be created with a rule for automatic scheduling, and may be based on datatype GDT: Date, with a qualifier of Invoice. ProposedInvoiceDateDateCalculationFunctionReference is a date rule for determining a proposed price date, and may be based on datatype GDT: DateCalculationFunctionReference. ToBeInvoicedQuantity is a quantity of a product to be invoiced, and may be based on datatype GDT: Quantity, with a qualifier of ToBeInvoiced. ToBeInvoicedQuantityTypeCode qualifies a type of quantity to be invoiced, and may be based on datatype GDT: QuantityTypeCode, with a qualifier of ToBeInvoiced. The following specialization associations for navigation may exist: Root, to the node Customer Contract, with a target cardinality of 1; and Parent, to the node Item, with a target cardinality of 1. In some implementations, ItemInvoiceTerms are proposed from InvoiceTerms and can be changed.

An ItemParty is a natural or legal person, organization, organizational unit or group that is involved in a CustomerTransactionDocument in a PartyRole. ItemParty can occur in the same specializations as those in the node Party, with the following exceptions: VendorParty. The elements located directly at the node Item Party are defined by the data type CustomerTransactionDocumentItemPartyElements. These elements include: PartyKey, PartyUUID, RoleCategoryCode, RoleCode, AddressReference, DeterminationMethodCode, and MainIndicator. PartyKey is an identifier for a party in a PartyRole in a business document, and may be based on datatype KDT: PartyKey. PartyKey may include PartyKey/PartyTypeCode, which is a coded representation of a type of party, and may be based on datatype GDT: BusinessObjectTypeCode. PartyKey can include PartyKey/PartyID, which is an identifier for a party, and may be based on datatype GDT: PartyID. PartyUUID is a unique identifier for a business partner, organizational unit or a corresponding specialization, and may be based on datatype GDT: UUID. RoleCategoryCode may be optional, indicates a Party Role Category of a party in a business document, and may be based on datatype GDT: PartyRoleCategoryCode. RoleCode may be optional, indicates a Party Role of a party in a business document, and may be based on datatype GDT: PartyRoleCode. AddressReference includes information to reference an address of a Party, and may be based on datatype GDT: PartyAddressReference. DeterminationMethodCode may be optional, is a coded representation of a PartyDeterminationMethod, and may be based on datatype GDT: PartyDeterminationMethodCode. MainIndicator specifies whether a current BusinessProcessVariantTypeCode is a main instance, and may be based on datatype GDT: Indicator, with a qualifier of Main.

The following composition relationships to subordinate nodes exist: ItemPartyContactParty, with a cardinality of 1:CN. The following inbound aggregation relationships may exist: Address Snapshot, from the business object Address Snapshot/node Root, with a cardinality of C:CN; and Party, from the business object Party/node Party, with a cardinality of C:CN, which is a referenced Party in Master Data. The following specialization associations for navigation may exist: Address Snapshot Overview, to the business object Address Snapshot/node Overview, with a target cardinality of C; Root, to the node Customer Contract, with a target cardinality of 1; Parent, to the node Item, with a target cardinality of 1; Main Party Contact Party, to the node Item Party Contact Party, with a target cardinality of C, which is an association to a PartyContact that occurs in the MainPartyContactParty specialization; and Used Address, to the business object Used Address/node Used Address, with a target cardinality of C.

In some implementations, ItemBuyerParty and its ContactParty do not deviate in the party node from the BuyerParty. In some implementations, ItemPayerParty and an associated ContactParty do not deviate in the party node from the PayerParty. In some implementations, ItemSalesUnitParty does not deviate in the party node from the SalesUnitParty. In some implementations, the BuyerParty is not changed after a document has been created. In some implementations, the PayerParty is not changed once the document has been created. In some implementations, there is one aggregation relationship to a business partner, the organizational unit, or to associated specializations. In some implementations, if the PartyUUID exists, the PartyTypeCode also exists. In some implementations, Parties are referenced via the Transformed Object Party that represents at least one of the following business objects: Company, SalesUnit, ServiceUnit, ReportingLineUnit, Supplier, Customer, Employee, or BusinessPartner.

An ItemPartyContactParty is a natural person or organizational unit that can be contacted for a respective ItemParty. The contact can be a contact person or a secretariat, for example. Communication data can be available for the contact. The elements located directly at the node Item Party Contact Party are defined by the data type CustomerTransactionDocumentItemPartyContactPartyElements. These elements include: PartyKey, PartyUUID, AddressReference, DeterminationMethodCode, and MainIndicator. PartyKey is an identifier for a contact party in a customer transaction document, and may be based on datatype KDT: PartyKey. PartyKey can include PartyKey/PartyTypeCode, which is a coded representation of a type of party, and may be based on datatype GDT: BusinessObjectTypeCode. PartyKey can include PartyKey/PartyID, which is an identifier for a party, and may be based on datatype GDT: PartyID. If a business partner or organizational unit are referenced, the PartyID attribute can includes associated identifiers. PartyUUID is a unique identifier for a business partner, organizational unit or associated specializations, and may be based on datatype GDT: UUID. AddressReference includes information to reference an address of a Party, and may be based on datatype GDT: PartyAddressReference. DeterminationMethodCode may be optional, is a coded representation of a PartyDeterminationMethod, and may be based on datatype GDT: PartyDeterminationMethodCode. MainIndicator may be optional, specifies whether a PartyContactParty is emphasized in a number of contacts with a same PartyRole, and may be based on datatype GDT: Indicator, with a qualifier of Main.

The following inbound aggregation relationships may exist: Address Snapshot, from the business object Address Snapshot/node Root, with a cardinality of C:CN; and Party, from the business object Party/node Party, with a cardinality of C:CN, which is a referenced Party in Master Data. The following specialization associations for navigation may exist: Address Snapshot Overview, to the business object Address Snapshot/node Overview, with a target cardinality of C; Root, to the node Customer Contract, with a target cardinality of 1; Parent, to the node Item Party, with a target cardinality of 1; and Used Address, to the business object Used Address/node Used Address, with a target cardinality of C, which is an address used for a Party. The address can be a referenced address of a master data object or a PartyAddress used via a composition relationship.

ItemPeriodTerms is a period related agreement for goods and services that can occur at an item level in a CustomerTransactionDocument. Item Period Terms can occur in the following not complete, disjoint specializations: Requested Fulfilment Item Period Terms, and Actual Fulfilment Item Period Terms. In some implementations, a specialization type can be implemented by a Type attribute. The elements located directly at the node Item Period Terms are defined by the data type CustomerTransactionDocumentItemPeriodTermsElements. These elements include: PeriodRoleCode, TimePointPeriod, StartTimePointDateCalculationFunctionReference, and EndTimePointDateCalculationFunctionReference. PeriodRoleCode is a role of a specified period, and may be based on datatype GDT: PeriodRoleCode. TimePointPeriod is a specification of a period, and may be based on datatype GDT: TimePointPeriod. StartTimePointDateCalculationFunctionReference is a reference to a function with which a start point-in-time of a period is calculated, and may be based on datatype GDT: DateCalculationFunctionReference. EndTimePointDateCalculationFunctionReference is a reference to a function with which an end point-in-time of a period is calculated, and may be based on datatype GDT: DateCalculationFunctionReference. The following specialization associations for navigation may exist: Root, to the node Customer Contract, with a target cardinality of 1; and Parent, to the node Item, with a target cardinality of 1.

ItemPricingTerms include item-specific characteristics used for pricing and value dating goods and services in a CustomerTransactionDocument. The elements located directly at the node Item Pricing Terms are defined by the data type CustomerTransactionDocumentItemPricingTermsElements. These elements include: CurrencyCode, CustomerPricingProcedureDeterminationCode, PriceDateTime, PriceSpecificationCustomerGroupCode, CustomerPriceListTypeCode, CustomerGroupCode, WarrantyGoodwillCode, PriceSpecificationLabourResourceGroupCode, PricePerPeriodIndicator, and GrossAmountIndicator. CurrencyCode may be optional, is a currency for the valuation of a goods and services ordered document currency, and may be based on datatype GDT: CurrencyCode. CustomerPricingProcedureDeterminationCode may be optional, is a customer scheme for determining a pricing procedure proposed by a buyer or an ordering party, and may be based on datatype GDT: CustomerPricingProcedureDeterminationCode. PriceDateTime is a price date used to determine price specifications using a rule for automatic scheduling, and may be based on datatype GDT: LOCALNORMALISED_DateTime, with a qualifier of Price. PriceSpecificationCustomerGroupCode is a group of LabourResources for which same price specifications are valid, and may be based on datatype GDT: PriceSpecificationCustomerGroupCode. CustomerPriceListTypeCode may be optional, indicates a customer price list type proposed by a buyer or ordering party, and may be based on datatype GDT: CustomerPriceListTypeCode. CustomerGroupCode indicates a group of customers for general purposes, such as pricing and statistics, proposed by a buyer or ordering party. CustomerGroupCode may be based on datatype GDT: CustomerGroupCode. WarrantyGoodwillCode specifies an extent to which a provision of services or materials are not or are only partially invoiced to a customer in the case of a warranty or compensation, and may be based on datatype GDT: WarrantyGoodwillCode. PriceSpecificationLabourResourceGroupCode indicates a group of LabourResources for which same price specifications are valid, and may be based on datatype GDT: PriceSpecificationLabourResourceGroupCode. PricePerPeriodIndicator may be optional, indicates whether a price is defined for a specific period, e.g. a month, and may be based on datatype GDT: Indicator. GrossAmountIndicator may be optional, specifies whether a price and/or value is given as a gross amount including taxes, and may be based on datatype GDT: Indicator, with a qualifier of GrossAmount.

The following specialization associations for navigation may exist: Root, to the node Customer Contract, with a target cardinality of 1; and Parent, to the node Item, with a target cardinality of 1. In some implementations, a currency, associated elements for currency conversion, and a calculation procedure are not changed at an item-level. In some implementations, ItemPricingTerms are set as defaults from the PricingTerms and can be changed.

ItemProduct is an identification, description and classification of a product material or ServiceProduct in an item. The elements located directly at the node Item Product are defined by the data type CustomerTransactionDocumentItemProductElements. These elements include: ProductKey, ProductInternalID, ProductStandardID, QuantityMeasureUnitCode, QuantityTypeCode, ProductBuyerID, ProductCategoryHierarchyProductCategoryIDKey, PriceSpecificationProductGroupCode, CashDiscountDeductibleIndicator, IdentifiedStockKey, ProductRequirementSpecificationKey, ProductRequirementSpecificationVersionUUID, ProductUUID, PricingProductKey, and PricingProductUUID. ProductKey can include ProductKey/ProductTypeCode, ProductKey/ProductidentifierTypeCode, and ProductKey/ProductID. PricingProductKey can include PricingProductKey/ProductTypeCode, PricingProductKey/ProductidentifierTypeCode, and PricingProductKey/ProductID.

ProductKey is a key to identify a product in a customer transaction document item, and may be based on datatype KDT: ProductUnformattedKey. ProductKey/ProductTypeCode is a coded representation of a product type, such as material or service, and may be based on datatype GDT: ProductTypeCode. ProductKey/ProductidentifierTypeCode is a coded representation of a product identifier type, and may be based on datatype GDT: ProductidentifierTypeCode. ProductKey/ProductID is an identifier for a product, and may be based on datatype GDT: NOCONVERSION_ProductID. ProductInternalID is an internal identifier of a product, and may be based on datatype GDT: ProductInternalID. ProductStandardID is a standard ID for a product, and may be based on datatype GDT: ProductStandardID. QuantityMeasureUnitCode may be optional, is a unit of measure in which quantities are used for a product in a Customer Transaction Document, and may be based on datatype GDT: MeasureUnitCode. QuantityTypeCode is a type code in which quantities are used for a product in a Customer Transaction Document, and may be based on datatype GDT: QuantityTypeCode. ProductBuyerID may be optional, is a unique identifier for a product assigned by a buyer, and may be based on datatype GDT: ProductPartyID. ProductCategoryHierarchyProductCategoryIDKey is a key to identify a product category assigned to a product, and may be based on datatype KDT: ProductCategoryHierarchyProductCategoryIDKey. ProductCategoryHierarchyProductCategoryIDKey can include ProductCategoryHierarchyProductCategoryIDKey/ProductCategoryHierarchyID, which is an identifier for a product category hierarchy, and may be based on datatype GDT: ProductCategoryHierarchyID. ProductCategoryHierarchyProductCategoryIDKey can include ProductCategoryHierarchyProductCategoryIDKey/ProductCategoryInternalID, which is an identifier for a product category, and may be based on datatype GDT: ProductCategoryInternalID. PriceSpecificationProductGroupCode is a coded representation of a product group to which a product is assigned and for which specific price specifications apply, and may be based on datatype GDT: PriceSpecificationProductGroupCode. CashDiscountDeductibleIndicator specifies if a discount can be granted for a product, and may be based on datatype GDT: Indicator, with a qualifier of CashDiscountDeductible. IdentifiedStockKey is a key to identify an Identified Stock related to a corresponding material, and may be based on datatype KDT: IdentifiedStockKey. IdentifiedStockKey/MaterialKey is a grouping of elements that uniquely identifies a material, a sub-quantity of which can be identified by the identified stock, and may be based on datatype KDT: ProductKey. ProductRequirementSpecificationKey is a key to identify a product requirement specification, and may be based on datatype KDT: RequirementSpecificationKey. ProductRequirementSpecificationKey can include ProductRequirementSpecificationKey/RequirementSpecificationID, which is an identifier for a requirement specification that is unique within the system, and may be based on datatype GDT: RequirementSpecificationID. ProductRequirementSpecificationKey can include ProductRequirementSpecificationKey/RequirementSpecificationVersionID, which is an identifier for a version of a requirement specification, and may be based on datatype GDT: VersionID. RequirementSpecificationVersionID can describe a collection of requirements for a corresponding product used in a customer transaction document item and can include corresponding specifications for fulfilling such requirements. In some implementations, a product requirement specification belongs to the corresponding product in a customer transaction document item. ProductRequirementSpecificationVersionUUID is a unique identification of a product requirement specification version, and may be based on datatype GDT: UUID. ProductUUID is a UUID of a product, and may be based on datatype GDT: UUID. PricingProductKey is an identification of a product that is used for Pricing, and may be based on datatype KDT: ProductKey. PricingProductKey/ProductTypeCode is a coded representation of a product type such as a material or service, and may be based on datatype GDT: ProductTypeCode. PricingProductKey/ProductidentifierTypeCode is a coded representation of a product identifier type, and may be based on datatype GDT: ProductidentifierTypeCode. PricingProductKey/ProductID is an identifier for a product, and may be based on datatype GDT: ProductID. PricingProductUUID is a UUID of a product that is used for Pricing, and may be based on datatype GDT: UUID.

The following inbound aggregation relationships may exist: EntitlementProduct, from the business object Entitlement Product/node Entitlement Product, with a cardinality of C:CN, which denotes an entitlement product in a customer transaction document item; EntitlementProduct_V1, from the business object Entitlement Product/node Entitlement Product, with a cardinality of C:CN, which is an entitlement product in a customer transaction document item; Material, from the business object Material/node Material, with a cardinality of C:CN, which denotes a material in a customer transaction document item; Material_V1, from the business object Material/node Material, with a cardinality of C:CN, which is a material in a customer transaction document item; ProductRequirementSpecification, from the business object Product Requirement Specification/node Product Requirement Specification, with a cardinality of C:CN, which denotes a product requirement specification in a customer transaction document item; ServiceProduct, from the business object Service Product/node Service Product, with a cardinality of C:CN, which denotes a service product in a customer transaction document item; and ServiceProduct_V1, from the business object Service Product/node Service Product, with a cardinality of C:CN, which is a service product in a customer transaction document item. The following specialization associations for navigation may exist: Root, to the node Customer Contract, with a target cardinality of 1; and Parent, to the node Item, with a target cardinality of 1. In some implementations, the ProductTypeCode is determined internally and is not subsequently changed. In some implementations, the elements of the ItemProduct are taken as defaults from the Material or the ServiceProduct and can be changed.

ItemSalesTerms are item-specific agreements and conditions that apply for selling goods and services in a CustomerTransactionDocument. The elements located directly at the node Item Sales Terms are defined by the data type CustomerTransactionDocumentItemSalesTermsElements. These elements include: IndustrialSectorCode, IndustryClassificationSystemCode, ProductUsageCode, CancellationReasonCode, ProbabilityPercent, CustomerContractCancellationAgreementCode, CancellationRequestDateTime, RequestedCancellationDateTime, CancellationEffectiveDateTime, CancellationDateTime, CustomerInvoiceRequestCancellationScopeCode, and CustomerContractRenewalAgreementCode.

IndustrialSectorCode indicates an industrial sector assigned to a buyer ordering party, and may be based on datatype GDT: IndustrialSectorCode. An industrial sector is a division of enterprises according to a focus of business activities. IndustryClassificationSystemCode indicates an industry system assigned to a buyer ordering party. An industry system or industry classification system is a systematically structured hierarchy, as the case may be for a directory of industrial sectors. IndustryClassificationSystemCode may be based on datatype GDT: IndustryClassificationSystemCode. ProductUsageCode defines what a buyer ordering party uses a product for in a current process, and may be based on datatype GDT: ProductUsageCode. CancellationReasonCode is a reason for canceling a sales transaction, can be set by both a buyer and a seller, and may be based on datatype GDT: CancellationReasonCode. ProbabilityPercent may be optional, is a probability of a sales order or contract arising from a quote, and may be based on datatype GDT: SMALLNONNEGATIVE_Percent. CustomerContractCancellationAgreementCode may be optional, is a coded representation of a customer contract cancellation agreement, and may be based on datatype GDT: CustomerContractCancellationAgreementCode. A customer contract cancellation agreement code specifies terms and conditions for cancellation of a customer contract as agreed upon by a customer and a supplier. CustomerContractCancellationAgreementCode can be part of an item sales terms node of a Customer Transaction Document business object and can refer to a cancellation of a customer contract item. CancellationRequestDateTime may be optional, is a point in time at which a cancellation of a customer transaction document item is requested, and may be based on datatype GDT: LOCALNORMALISED_DateTime. RequestedCancellationDateTime may be optional, is a point in time for which a cancellation of a customer transaction document item is requested, and may be based on datatype GDT: LOCALNORMALISED_DateTime. CancellationEffectiveDateTime may be optional, is a point in time at which a cancellation of a customer transaction document item comes into effect, and may be based on datatype GDT: LOCALNORMALISED_DateTime. CancellationDateTime may be optional, is a point in time at which a customer transaction document item is cancelled, and may be based on datatype GDT: LOCALNORMALISED_DateTime. CustomerInvoiceRequestCancellationScopeCode may be optional, is a coded representation of a cancellation scope for customer invoice requests, and may be based on datatype GDT: CustomerInvoiceRequestCancellationScopeCode. On cancellation of a customer contract item, related invoice requests that have not yet been invoiced can either be canceled or kept for further processing. CustomerContractRenewalAgreementCode may be optional, is a coded representation of a customer contract renewal agreement, and may be based on datatype GDT: CustomerContractRenewalAgreementCode. A customer contract renewal agreement code specifies terms and conditions for renewal of a customer contract as agreed upon by a company and a customer. CustomerContractRenewalAgreementCode can be part of an item sales terms node of a Customer Transaction Document business object and can refer to a renewal of a customer contract item.

The following specialization associations for navigation may exist: Root, to the node Customer Contract, with a target cardinality of 1; and Parent, to the node Item, with a target cardinality of 1. In some implementations, ItemSalesTerms are set as defaults from the SalesTerms and can be changed. In some implementations, the following elements are not overwritten on an item: RegionCode, IndustrialSectorCode, IndustryClassificationSystemCode and ProductUsageCode. In some implementations, ConfirmationFixeIndicator is always set.

An ItemScheduleLine is an agreement regarding when products of an item are requested or provided and in what amount. Item Schedule Line can occur in the following complete, disjoint specializations: Requested Item Schedule Line, Confirmed Item Schedule Line, Promised Item Schedule Line, and Fulfilled Item Schedule Line. In some implementations, a specialization type is implemented by a Type attribute. The elements located directly at the node Item Schedule Line are defined by the data type CustomerTransactionDocumentItemScheduleLineElements. These elements include: ID, BuyerID, TypeCode, Quantity, QuantityTypeCode, DateTimePeriod, ProductAvailabilityConfirmationCommitmentCode, UUID, RelatedUUID, and RelatedID. ID may be optional, is a unique identifier for an ItemScheduleLine assigned by a seller, and may be based on datatype GDT: BusinessTransactionDocumentItemScheduleLineID. BuyerID may be optional, is a unique identifier for an ItemScheduleLine assigned by a buyer, and may be based on datatype GDT: BusinessTransactionDocumentItemScheduleLineID. TypeCode may be optional, is a coded representation of a type of an ItemScheduleLine such as RequestedScheduleLine, and may be based on datatype GDT: BusinessTransactionDocumentItemScheduleLineTypeCode. In some implementations, for ServiceProductItem and BusinessTransactionDocumentItemScheduleLine, a TypeCode indicating “Requested” is allowed. In some implementations, for SparePartItem, BusinessTransactionDocumentItemScheduleLineTypeCodes indicating “Requested”, “Confirmed” and “Promised” are allowed. Quantity is a quantity with reference to a TypeCode, and may be based on datatype GDT: Quantity. QuantityTypeCode qualifies a type of a quantity, and may be based on datatype GDT: QuantityTypeCode. DateTimePeriod is a time period with reference to a TypeCode, and may be based on datatype GDT: UPPEROPEN_LOCALNORMALISED DateTimePeriod. ProductAvailabilityConfirmationCommitmentCode defines a binding character of a confirmed quantity and delivery period, and may be based on datatype GDT: ProductAvailabilityConfirmationCommitmentCode. UUID may be an alternative key, is a UUID of a scheduling line, and may be based on datatype GDT: UUID. RelatedUUID is a UUID of a corresponding schedule line that stands in relation to a current schedule line, and may be based on datatype GDT: UUID. RelatedID may be optional, is an ID of a corresponding schedule line that stands in relation to a current schedule line, and may be based on datatype GDT: BusinessTransactionDocumentItemScheduleLineID.

The following composition relationships to subordinate nodes exist: ItemScheduleLineFulfilmentPlanningPeriod, with a cardinality of 1:CN. The following specialization associations for navigation may exist: Root, to the node Customer Contract, with a target cardinality of 1; Parent, to the node Item, with a target cardinality of 1; Issue Item Schedule Line Fulfilment Planning Period, to the node Item Schedule Line Fulfilment Planning Period, with a target cardinality of C, which is an association to an ItemScheduleLineFulfillmentPlanningDate that occurs in the IssuePeriod specialization; RelatedItemScheduleLine, to node ItemScheduleLine, with a target cardinality of CN, which is an association to an ItemScheduleLine node which specifies a relationship between schedule lines (e.g., one ItemScheduleLine instance can refer to another ItemSchedule line instance, such as if a relationship specifies which confirmed schedule lines belong to a particular requested schedule line); and Positioning Item Schedule Line Fulfilment Planning Period, to the node ItemScheduleLine, with a target cardinality of C, which is an association to an ItemScheduleLineFulfillmentPlanningDate that occurs in the PositioningPeriod specialization. In some implementations, a time period for a requested schedule line is proposed from the RequestedFulfilmentPeriod, and can be changed. In some implementations, in service product items, one RequestedScheduleLine is allowed. In some implementations, all ItemScheduleLines for an item use a same unit of measure.

Item Schedule Line Fulfilment Planning Period includes dates for front-end process steps for delivery of goods or provision of services. Item Schedule Line Fulfilment Planning Period occurs in the following complete, disjoint specializations: Positioning Item Schedule Line Fulfilment Planning Period, and Issue Item Schedule Line Fulfilment Planning Period. A specialization type can be implemented by a Type attribute. The elements located directly at the node Item Schedule Line Fulfilment Planning Period are defined by the data type CustomerTransactionDocumentItemScheduleLineFulfilmentPlanningPeriodElements. These elements include: PeriodRoleCode and DateTimePeriod. PeriodRoleCode is a coded representation of semantics of an ItemScheduleLineFulfillmentPlanningDateTimePeriod, for example ConfirmedProductAvailabilityDateTimePeriod, and may be based on datatype GDT: PeriodRoleCode. DateTimePeriod is a time period with reference to PeriodRoleCode, and may be based on datatype GDT: UPPEROPEN_LOCALNORMALISED_DateTimePeriod. The following specialization associations for navigation may exist: Root, to the node Customer Contract, with a target cardinality of 1; and Parent, to the node Item Schedule Line, with a target cardinality of 1.

ItemTimePointTerms is a period related agreement for goods and services that can occur at an item level in a CustomerTransactionDocument. Item Time Point Terms can occur in the following not complete, disjoint specializations: First Reaction Due Item Time Point Terms, Completion Due Item Time Point Terms, and Completion Item Time Point Terms. A specialization type can be implemented by a Type attribute. The elements located directly at the node Item Time Point Terms are defined by the data type CustomerTransactionDocumentItemTimePointTermsElements. These elements include: TimePointRoleCode, TimePoint, and DateCalculationFunctionReference. TimePointRoleCode is a role of a specified point-in-time, and may be based on datatype GDT: TimePointRoleCode. TimePoint is a specification of a point-in-time, and may be based on datatype GDT: TimePoint. DateCalculationFunctionReference is a reference to a function with which the point-in-time is calculated, and may be based on datatype GDT: DateCalculationFunctionReference. The following specialization associations for navigation may exist: Root, to the node Customer Contract, with a target cardinality of 1; and Parent, to the node Item, with a target cardinality of 1.

ItemTotalValues include total values for an item resulting from the Item's dependent nodes. Examples include: a total desired delivery quantity or a confirmed quantity of an ItemScheduleLine, item-specific gross and net weight, a volume, a gross and net value and tax amount, and shipment costs. Quantities, weights, volumes and values can calculated by accumulation, and dates by special logic. The elements located directly at the node Item Total Values are defined by the data type CustomerTransactionDocumentItemTotalValuesElements. These elements include: RequestedQuantity, RequestedQuantityTypeCode, ConfirmedQuantity, ConfirmedQuantityTypeCode, LastConfirmedDateTime, GrossWeightMeasure, NetWeightMeasure, VolumeMeasure, NetAmount, NetPrice, TaxAmount, FreightChargeAmount, GrossAmount, NetWithoutFreightChargeAmount, and NetWithoutFreightChargePrice. RequestedQuantity is a total quantity requested of a Customer Transaction Document item, and may be based on datatype GDT: Quantity, with a qualifier of Requested. RequestedQuantityTypeCode qualifies a type of a requested quantity, and may be based on datatype GDT: QuantityTypeCode, with a qualifier of Requested. ConfirmedQuantity is a total confirmed quantity of a Customer Transaction Document item, and may be based on datatype GDT: Quantity, with a qualifier of Confirmed. ConfirmedQuantityTypeCode qualifies a type of a confirmed quantity, and may be based on datatype GDT: QuantityTypeCode, with a qualifier of Confirmed. LastConfirmedDateTime is a last confirmed date for a Customer Transaction Document item, and may be based on datatype GDT: LOCALNORMALISED_DateTime, with a qualifier of LastConfirmed. GrossWeightMeasure is a total gross weight of a product in a Customer Transaction Document item, and may be based on datatype GDT: Measure, with a qualifier of GrossWeight. NetWeightMeasure is a total net weight of a product in a Customer Transaction Document item, and may be based on datatype GDT: Measure, with a qualifier of NetWeight. VolumeMeasure is a total volume of a product in a Customer Transaction Document item, and may be based on datatype GDT: Measure, with a qualifier of Volume. NetAmount is a net amount of a Customer Transaction Document item, and may be based on datatype GDT: Amount, with a qualifier of Net. Net Price is a net price of a product in a CustomerTransacationDocumentTemplate item, and may be based on datatype GDT: Price, with a qualifier of Net. TaxAmount is a tax amount of a Customer Transaction Document item, and may be based on datatype GDT: Amount, with a qualifier of Tax. FreightChargeAmount is a freight charge for a Customer Transaction Document item, and may be based on datatype GDT: Amount, with a qualifier of FreightCharge. GrossAmount is a gross amount of a Customer Transaction Document item, and may be based on datatype GDT: Amount, with a qualifier of Gross. NetWithoutFreightChargeAmount is a net value of a Customer Transaction Document item excluding freight charge, and may be based on datatype GDT: Amount, with a qualifier of NetWithoutFreightCharge. NetWithoutFreightChargePrice is a net price of a Customer Transaction Document item excluding freight charge, and may be based on datatype GDT: Price, with a qualifier of NetWithoutFreightCharge.

The following composition relationships to subordinate nodes exist: ItemTotalValuesPricingSubtotal, with a cardinality of 1:CN. The following specialization associations for navigation may exist: Root, to the node Customer Contract, with a target cardinality of 1; and Parent, to the node Item, with a target cardinality of 1. In some implementations, the ItemTotalValues cannot be changed after being initialized.

TotalValuesPricingSubtotal is a condition subtotal of a specific type in a total value of all items that can result from Pricing. The condition subtotals can be freely defined in a configuration for Pricing, and can be transferred together with a code from Pricing. The elements located directly at the node Item Total Values Pricing Subtotal are defined by the data type CustomerTransactionDocumentItemTotalValuesPricingSubtotalElements. These elements include: TypeCode and Amount. TypeCode is a coded representation of a subtotal in a price calculation, and may be based on datatype GDT: PricingSubtotalTypeCode. Amount is a value of a condition subtotal, and may be based on datatype GDT: Amount. The following specialization associations for navigation may exist: Root, to the node Customer Contract, with a target cardinality of 1; and Parent, to the node Item Total Values, with a target cardinality of 1. In some implementations, the ItemTotalValuesPriceSubtotal cannot be changed.

A Party is a natural or legal person, organization, organizational unit or group that is involved in a CustomerTransactionDocument in a PartyRole. Party occurs in the following incomplete and disjoint specializations: BuyerParty, SellerParty, ProductRecipientParty, VendorParty, BillToParty, PayerParty, SalesUnitParty, ServiceSupportTeamParty, ResponsibleEmployeeParty, ServiceExecutionTeamParty, ServicePerformerParty, ContractReleaseAuthorisedParty, ProcessorParty, FreightForwarderParty ContractReleaseAuthorisedParty, and SalesPartnerParty. A BuyerParty is a party Customer that purchases a product or service which can occur in a role of a buyer or ordering party with whom a contractual agreement is concluded. A SellerParty is a party that sells goods or services that represents a selling company that has a contractual agreement with a BuyerParty. A ProductRecipientParty is a party Customer, Supplier, or Company to whom goods are delivered or services are provided, which fulfills a role of a customer who receives goods. A VendorParty is a party Company, Customer or Supplier who delivers goods or provides services and who performs a role of a delivering enterprise or of an external vendor or, in the case of returns, a customer. A BillToParty is a party Customer to whom an invoice for goods or services is sent. A PayerParty is a party Customer that pays for a product or a service. A SalesUnitParty is a party Sales Unit that is responsible for the sale of goods and services. A ServiceSupportTeamParty is a party Service Unit that is responsible for the processing of service requests and customer complaints as well as for planning and preparation of services. A ResponsibleEmployeeParty is a party Employee that is responsible for the processing of sales or services. A ServiceExecutionTeamParty is a party Service Unit that is responsible for executing service orders. A ServicePerformerParty is a party Employee that provides services for a company. A ProcessorParty is a party Employee that processes a CustomerTransactionDocumentTemplate document. A ContractReleaseAuthorisedParty is a party that is authorized to release goods or services from a contract. A FreightForwarderParty is a party Business Partner that supplements a service by subcontracting transportation and other associated services. A SalesPartnerParty is a party that initiates and implements business transactions for another company. A Party can be a reference to a business partner or to an associated specialization, such as Customer, Supplier, or Employee. A Party can be a reference to one of the following specializations of an organizational unit: Company, FunctionalUnit, or ReportingLineUnit.

The elements located directly at the node Party are defined by the data type CustomerTransactionDocumentPartyElements. These elements include: PartyKey, PartyUUID, RoleCategoryCode, RoleCode, AddressReference, DeterminationMethodCode, and MainIndicator. PartyKey is an identifier for a party in a PartyRole in a business document, and may be based on datatype KDT: PartyKey. PartyKey can include PartyKey/PartyTypeCode, which is a coded representation of a type of party, and may be based on datatype GDT: BusinessObjectTypeCode. PartyKey can include PartyKey/PartyID, which is an identifier for a party, and may be based on datatype GDT: PartyID. If a business partner or organizational unit are referenced, the PartyID attribute can include corresponding identifiers. If an unidentified identifier is entered, for example by the user, the PartyID attribute can include such an identifier. PartyUUID is a unique identifier for a business partner, organizational unit, or associated specialization, and may be based on datatype GDT: UUID. RoleCategoryCode may be optional, indicates a Party Role Category of a party in a business document, and may be based on datatype GDT: PartyRoleCategoryCode. RoleCode may be optional, indicates a Party Role of a party in a business document, and may be based on datatype GDT: PartyRoleCode. AddressReference includes information used to reference an address of a Party, and may be based on datatype GDT: PartyAddressReference. DeterminationMethodCode may be optional, is a coded representation of a PartyDeterminationMethod, and may be based on datatype GDT: PartyDeterminationMethodCode. MainIndicator specifies whether a party is emphasized with a same PartyRole in a number of parties or not, and may be based on datatype GDT: Indicator, with a qualifier of Main.

The following composition relationships to subordinate nodes exist: PartyContactParty, with a cardinality of 1:CN. The following inbound aggregation relationships may exist: Address Snapshot, from the business object Address Snapshot/node Root, with a cardinality of C:CN; and Party, from the business object Party/node Party, with a cardinality of C:CN, which is a referenced Party in Master Data. The following specialization associations for navigation may exist: Address Snapshot Overview, to the business object Address Snapshot/node Overview, with a target cardinality of C; Parent, to the node Customer Contract, with a target cardinality of 1; Root, to the node Customer Contract, with a target cardinality of 1; Main Party Contact Party, to the node Party Contact Party, with a target cardinality of C, which is an association to a PartyContact that occurs in the MainPartyContactParty specialization; and Used Address, to the business object Used Address/node Used Address, with a target cardinality of C.

In some implementations, a BuyerParty cannot be changed after a document has been created. In some implementations, the PayerParty cannot be changed once the document has been created. In some implementations, there may be one aggregation relationship to a business partner, an organizational unit, or to associated specializations. In some implementations, if the PartyUUID exists, the PartyTypeCode also exists. In some implementations, parties may be referenced via the Transformed Object Party that represents at least one of the following business objects: Company, SalesUnit, ServiceUnit, ReportingLineUnit, Supplier, Customer, Employee, or BusinessPartner.

A PartyContactParty is a natural person or an organizational unit that can be contacted for a respective party. The contact can be a contact person or a secretariat, for example. Communication data can be available for the contact. The elements located directly at the node Party Contact Party are defined by the data type CustomerTransactionDocumentPartyContactPartyElements. These elements include: PartyKey, PartyUUID, AddressReference, DeterminationMethodCode, and MainIndicator. PartyKey is an identifier for a contact party in a customer transaction document, and may be based on datatype KDT: PartyKey. PartyKey can include PartyKey/PartyTypeCode, which is a coded representation of a type of party, and may be based on datatype GDT: BusinessObjectTypeCode. PartyKey can include PartyKey/PartyID, which is an identifier for a party, and may be based on datatype GDT: PartyID. In some implementations, if a business partner or organizational unit are referenced, the PartyID attribute includes corresponding identifiers. PartyUUID is a unique identifier for a business partner, organizational unit or an associated specialization, and may be based on datatype GDT: UUID. AddressReference includes information to reference an address of a Party, and may be based on datatype GDT: PartyAddressReference. DeterminationMethodCode may be optional, is a coded representation of a PartyDeterminationMethod, and may be based on datatype GDT: PartyDeterminationMethodCode. MainIndicator may be optional, specifies whether a PartyContactParty is emphasized in a number of contacts with a same PartyRole, and may be based on datatype GDT: Indicator, with a qualifier of Main.

The following inbound aggregation relationships may exist: Address Snapshot, from the business object Address Snapshot/node Root, with a cardinality of C:CN; and Party, from the business object Party/node Party, with a cardinality of C:CN, which is a referenced Party in Master Data. The following specialization associations for navigation may exist: Address Snapshot Overview, to the business object Address Snapshot/node Overview, with a target cardinality of C; Root, to the node Customer Contract, with a target cardinality of 1; Parent, to the node Party, with a target cardinality of 1; and Used Address, to the business object Used Address/node Used Address, with a target cardinality of C, which is an Address used for a Party. The address can be a referenced address of a master data object or a PartyAddress used via a composition relationship.

PeriodTerms is a period related agreement for goods and services that can occur in a CustomerTransactionDocument. PeriodTerms can occur in the following disjoint specializations incomplete with reference to a role of the period PeriodRoleCode: RequestedFulfilmentPeriod, which is a period in which a delivery of goods or a provision of services is requested; and ValidityPeriod, which is a period during which a CustomerTransactionDocumentTemplate document is valid. The elements located directly at the node Period Terms are defined by the data type CustomerTransactionDocumentPeriodTermsElements. These elements include: PeriodRoleCode, TimePointPeriod, StartTimePointDateCalculationFunctionReference, and EndTimePointDateCalculationFunctionReference. PeriodRoleCode is a role of a specified period, and may be based on datatype GDT: PeriodRoleCode. TimePointPeriod is a specification of a period, and may be based on datatype GDT: TimePointPeriod. StartTimePointDateCalculationFunctionReference is a reference to a function with which a start point-in-time of a period is calculated, and may be based on datatype GDT: DateCalculationFunctionReference. EndTimePointDateCalculationFunctionReference is a reference to a function with which an end point-in-time of a period is calculated, and may be based on datatype GDT: DateCalculationFunctionReference. The following specialization associations for navigation may exist to the node Customer Contract: Parent, with a target cardinality of 1; and Root, with a target cardinality of 1.

PricingTerms include characteristics used for pricing and valuation of goods and services in a CustomerTransactionDocument. The elements located directly at the node Pricing Terms are defined by the data type CustomerTransactionDocumentPricingTermsElements. These elements include: CurrencyCode, CustomerPricingProcedureDeterminationCode, PriceDateTime, PriceSpecificationCustomerGroupCode, CustomerPriceListTypeCode, CustomerGroupCode, WarrantyGoodwillCode, and GrossAmountIndicator. CurrencyCode may be optional, is a currency for a valuation of a goods and services ordered document currency, and may be based on datatype GDT: CurrencyCode. CustomerPricingProcedureDeterminationCode may be optional, is a customer scheme for determining a pricing procedure proposed by a buyer or an ordering party, and may be based on datatype GDT: CustomerPricingProcedureDeterminationCode. PriceDateTime is a price date at which price specifications are determined using a rule for automatic scheduling, and may be based on datatype GDT: LOCALNORMALISED_DateTime, with a qualifier of Price. PriceSpecificationCustomerGroupCode indicates a group of customers for whom same price specifications apply, can be suggested by a buyer or ordering party, and may be based on datatype GDT: PriceSpecificationCustomerGroupCode. CustomerPriceListTypeCode may be optional, is a customer price list type proposed by a buyer or ordering party, and may be based on datatype GDT: CustomerPriceListTypeCode. CustomerGroupCode indicates a group of customers for general purposes, such as pricing and statistics, can be proposed by a buyer or ordering party, and may be based on datatype GDT: CustomerGroupCode. WarrantyGoodwillCode specifies an extent to which a provision of services or materials are not or are only partially invoiced to a customer in a case of a warranty or compensation, and may be based on datatype GDT: WarrantyGoodwillCode. GrossAmountIndicator may be optional, specifies whether a price and/or value is given as a gross amount including taxes, and may be based on datatype GDT: Indicator, with a qualifier of GrossAmount. The following specialization associations for navigation may exist to the node Customer Contract: Parent, with a target cardinality of 1; and Root, with a target cardinality of 1. In some implementations, the exchange rate elements ExchangeRate are set together.

SalesTerms are agreements and conditions applicable for a sale of goods and services in a CustomerTransactionDocument. The elements located directly at the node Sales Terms are defined by the data type CustomerTransactionDocumentSalesTermsElements. These elements include: IndustrialSectorCode, IndustryClassificationSystemCode, ProductUsageCode, CancellationReasonCode, ProbabilityPercent, CustomerContractCancellationAgreementCode, CancellationRequestDateTime, RequestedCancellationDateTime, CancellationEffectiveDateTime, CancellationDateTime, CustomerInvoiceRequestCancellationScopeCode, and CustomerContractRenewalAgreementCode. IndustrialSectorCode indicates an industrial sector assigned to a buyer ordering party. An industrial sector is a division of enterprises according to a focus of business activities, and may be based on datatype GDT: IndustrialSectorCode. IndustryClassificationSystemCode indicates an industry system assigned to a buyer ordering party. An industry system or industry classification system is a systematically structured hierarchy, as a case may be for a directory of industrial sectors, and may be based on datatype GDT: IndustryClassificationSystemCode. ProductUsageCode defines what a buyer ordering party uses a product for in a current process, and may be based on datatype GDT: ProductUsageCode. CancellationReasonCode is a reason for canceling a sales transaction, can be set by both a buyer and seller, and may be based on datatype GDT: CancellationReasonCode. ProbabilityPercent may be optional, is a probability of a sales order or contract arising from a quote, and may be based on datatype GDT: SMALLNONNEGATIVE_Percent, with a qualifier of Probability. CustomerContractCancellationAgreementCode may be optional, is a coded representation of a customer contract cancellation agreement, and may be based on datatype GDT: CustomerContractCancellationAgreementCode. A customer contract cancellation agreement code specifies terms and conditions for cancellation of a customer contract as agreed upon by a customer and a supplier. CancellationRequestDateTime may be optional, is a point in time at which a cancellation of a customer transaction document is requested, and may be based on datatype GDT: LOCALNORMALISED_DateTime. RequestedCancellationDateTime may be optional, is a point in time for which a cancellation of a customer transaction document is requested, and may be based on datatype GDT: LOCALNORMALISED_DateTime. CancellationEffectiveDateTime may be optional, is a point in time at which a cancellation of a customer transaction document comes into effect, and may be based on datatype GDT: LOCALNORMALISED_DateTime. CancellationDateTime may be optional, is a point in time at which a customer transaction document is cancelled, and may be based on datatype GDT: LOCALNORMALISED_DateTime. CustomerInvoiceRequestCancellationScopeCode may be optional, is a coded representation of a cancellation scope for customer invoice requests, and may be based on datatype GDT: CustomerInvoiceRequestCancellationScopeCode.

On cancellation of a customer contract item, related invoice requests that have not yet been invoiced can either be canceled or kept for further processing. CustomerContractRenewalAgreementCode may be optional, is a coded representation of a customer contract renewal agreement, and may be based on datatype GDT: CustomerContractRenewalAgreementCode. The following specialization associations for navigation may exist to the node Customer Contract: Parent, with a target cardinality of 1; and Root, with a target cardinality of 1.

ServiceTerms are conditions and agreements that apply for an execution of a service activity in a CustomerTransactionDocument and which can control processing. The elements located directly at the node Service Terms are defined by the data type CustomerTransactionDocumentServiceTermsElements. These elements include: ServiceLevelObjectiveID, ServiceLevelObjectiveUUID, ServiceLevelDeterminationMethodCode, and AllObjectsCoveredIndicator. ServiceLevelObjectiveID is an identifier for a Service Level Objective that specifies one or more objectives for execution of services, and may be based on datatype GDT: ServiceLevelObjectiveID. ServiceLevelObjectiveUUID is a universally unique identifier for a Service Level Objective that specifies one or more objectives for execution of services, and may be based on datatype GDT: UUID. ServiceLevelDeterminationMethodCode may be optional, is a coded representation of a method by which a service level is determined in a customer transaction document, and may be based on datatype GDT: ServiceLevelDeterminationMethodCode. In a service request or a service order, a service level can be determined either automatically by determination rules, or a level can be copied from an assigned customer contract. In some implementations, when a service level has been copied from an assigned customer contract, the level will not be re-determined automatically by determination rules. In a customer contract, a service level can be entered manually. AllObjectsCoveredIndicator may be optional, specifies whether all objects are covered, and may be based on datatype GDT: Indicator. If AllObjectsCoveredIndicator is set, products or product categories might not be specified in a covered objects node.

The following inbound aggregation relationships may exist: ServiceLevelObjective, from the business object Service Level Objective/node Service Level Objective, with a cardinality of C:CN, which is a ServiceLevelObjective which specifies one or more objectives for execution of services. The following specialization associations for navigation may exist to the node Customer Contract: Parent, with a target cardinality of 1; and Root, with a target cardinality of 1.

TimePointTerms is a point-in-time related agreement for goods and services that can occur in a CustomerTransactionDocument. TimePointTerms can occur in the following disjoint specializations incomplete with reference to the role of the point-in-timeTimePointRoleCode: FirstReactionDueTimePoint, CompletionDueTimePoint, RequestInitialReceiptTimePoint, RequestReceiptTimePoint, RequestInProcessAtTimePoint, RequestFinishedAtTimePoint, RequestClosedAtTimePoint, RequestSentToProviderAtTimePoint, RequestCompletionByProviderDueTimePoint, RequestReceivedFromProviderAtTimePoint, CompletionTimePoint, ExecutionReleaseTimePoint, Actual Arrival At Customer Time Point, Planned Arrival At Customer Time Point, and Incident Completion Time Point.

A FirstReactionDueTimePoint is a point-in-time by which a response to a newly-received service request or service order is required. A CompletionDueTimePoint is a point-in-time by which a service request or service order is to be fully processed. RequestInitialReceiptTimePoint is a point-in-time when a request is first received. RequestReceiptTimePoint is a point-in-time when a request is received or updated. RequestInProcessAtTimePoint is a point-in-time when a request is put in process. RequestFinishedAtTimePoint is a point-in-time when a processing of a request is finished. RequestClosedAtTimePoint is a point-in-time when a request is considered as being finally closed. RequestSentToProviderAtTimePoint is a point-in-time when a request is forwarded to a provider. RequestCompletionByProviderDueTimePoint is a point-in-time by which a provider is to complete the processing of a request. RequestReceivedFromProviderAtTimePoint is a point-in-time by which a provider has completed the processing of a request. A point-in-time status change “In process” can come from a partner. A CompletionTimePoint is a point-in-time by which a customer transaction document is completed. An ExecutionReleaseTimePoint is a point-in-time at which a customer transaction document is released for execution. Actual Arrival At Customer Time Point is an actual point of time at which a service performer arrived at a customer. Planned Arrival At Customer Time Point is a time point at which a service performer is planned to arrive at a customer. Incident Completion Time Point is a time point at which an incident is completed.

The elements located directly at the node Time Point Terms are defined by the data type CustomerTransactionDocumentTimePointTermsElements. These elements include: TimePointRoleCode, TimePoint, and DateCalculationFunctionReference. TimePointRoleCode is a role of a specified point-in-time, and may be based on datatype GDT: TimePointRoleCode. TimePoint is a specification of a point-in-time, and may be based on datatype GDT: TimePoint. DateCalculationFunctionReference is a reference to a function with which a point-in-time is calculated, and may be based on datatype GDT: DateCalculationFunctionReference. The following specialization associations for navigation may exist to the node Customer Contract: Parent, with a target cardinality of 1; and Root, with a target cardinality of 1.

TotalValues are cumulated total values that can occur in a CustomerTransactionDocument, for example, a total gross and net weight, volume, gross and net amount, tax amount, and freight costs. Quantities, weights, volumes and values can be calculated by accumulation, and dates by special logic. The elements located directly at the node Total Values are defined by the data type CustomerTransactionDocumentTotalValuesElements. These elements include: GrossWeightMeasure, NetWeightMeasure, GrossVolumeMeasure, GrossAmount, NetAmount, TaxAmount, FreightChargeAmount, NetWithoutFreightChargeAmount, LastPromisedDateTime, LastConfirmedDateTime, NextAuthorisationDateTime, and ServicePlannedDuration. GrossWeightMeasure is a total gross weight in a customer transaction document, and may be based on datatype GDT: Measure, with a qualifier of GrossWeight. NetWeightMeasure is a total net weight in a Customer Transaction Document document, and may be based on datatype GDT: Measure, with a qualifier of NetWeight. GrossVolumeMeasure is a total gross volume in a Customer Transaction Document document, and may be based on datatype GDT: Measure, with a qualifier of GrossVolume. GrossAmount is a total gross amount in a Customer Transaction Document document, and may be based on datatype GDT: Amount, with a qualifier of Gross. NetAmount is a total net amount in a Customer Transaction Document document, and may be based on datatype GDT: Amount, with a qualifier of Net. TaxAmount is a total tax amount in a Customer Transaction Document document, and may be based on datatype GDT: Amount, with a qualifier of Tax. FreightChargeAmount includes total freight charges in a Customer Transaction Document document, and may be based on datatype GDT: Amount, with a qualifier of FreightCharge. NetWithoutFreightChargeAmount is a total net amount excluding freight charges, and may be based on datatype GDT: Amount, with a qualifier of NetWithoutFreightCharge. LastPromisedDateTime is a last promised date in a Customer Transaction Document document, and may be based on datatype GDT: LOCALNORMALISED_DateTime, with a qualifier of LastPromised.

LastConfirmedDateTime is a last confirmed date in a Customer Transaction Document document, and may be based on datatype GDT: LOCALNORMALISED_DateTime, with a qualifier of LastConfirmed. NextAuthorisationDateTime is a time point when a next authorisation is due for a customer transaction document, may be based on datatype GDT: LOCALNORMALISED_DateTime, with a qualifier of Authorisation, and can be calculated as a lesser of a time when an authorisation expires or when an item for delivery is next due for authorisation in a current authorisation horizon. ServicePlannedDuration may be optional, includes total planned durations of services in a customer transaction document, and may be based on datatype GDT: Duration, with a qualifier of Planned.

The following composition relationships to subordinate nodes exist: TotalValuesPricingSubtotal, with a cardinality of 1:CN. The following specialization associations for navigation may exist to the node Customer Contract: Parent, with a target cardinality of 1; and Root, with a target cardinality of 1. In some implementations, TotalValues are not changed externally.

TotalValuesPricingSubtotal is a condition subtotal of a specific type in a total value of all items that result from Pricing. The condition subtotals can be freely defined in a configuration for Pricing, and can be transferred together with a code from Pricing. The elements located directly at the node Total Values Pricing Subtotal are defined by the data type CustomerTransactionDocumentTotalValuesPricingSubtotalElements. These elements include: TypeCode and Amount. TypeCode is a coded representation of a subtotal in a price calculation, and may be based on datatype GDT: PricingSubtotalTypeCode. Amount is a value of a condition subtotal, and may be based on datatype GDT: Amount. The following specialization associations for navigation may exist: Root, to the node Customer Contract, with a target cardinality of 1; and Parent, to the node Total Values, with a target cardinality of 1.

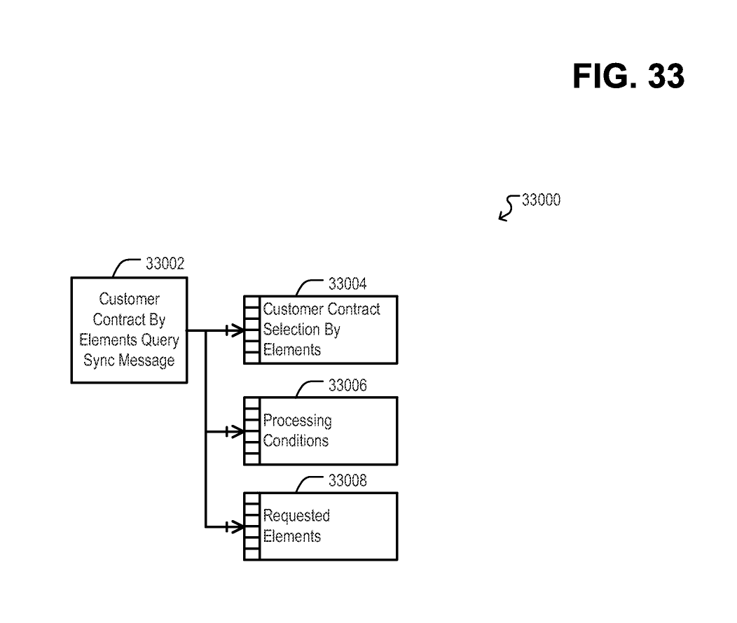

FIG. 33 illustrates one example logical configuration of a Customer Contract By Elements Query Sync Message 33000. Specifically, this figure depicts the arrangement and hierarchy of various components such as one or more levels of packages, entities, and data types, shown here as 33000 through 33008. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Customer Contract By Elements Query Sync Message 33000 includes, among other things, the Customer Contract Selection By Elements entity 33004. Accordingly, heterogeneous applications may communicate using this consistent message configured as such.

The message type Customer Contract By Elements Query_sync is derived from the business object Customer Contract as a leading object together with its operation signature. The message type Customer Contract By Elements Query_sync is a query about customer contract data by elements. The structure of the message type Customer Contract By Elements Query_sync is determined by the message data type CustomerContractByElementsQuery_sync. The message data type CustomerContractByElementsQuery_sync includes a typing data type for a customer contract read request. The message data type CustomerContractByElementsQuery_sync includes the CustomerContractSelectionByElements package, the ProcessingConditions package, and the RequestedElements package.

The package CustomerContractSelectionByElements includes the entity CustomerContractSelectionByElements. CustomerContractSelectionByElements includes the following non-node elements: SelectionByID, SelectionByItemListCustomerContractLifeCycleStatusCode, SelectionByBuyerPartyID, and SelectionByLastChangedDateTime. SelectionByID may have a multiplicity of 0 . . . * and may be based on datatype MIDT:CustomerContractByElementsQuerySelectionByID. SelectionByID can include InclusionExclusionCode, IntervalBoundaryTypeCode, LowerBoundaryID, and UpperBoundaryID. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryID may have a multiplicity of 0 . . . 1 and may be based on datatype BGDT:BusinessTransactionDocumentID. UpperBoundaryID may have a multiplicity of 0 . . . 1 and may be based on datatype BGDT: BusinessTransactionDocumentID.

SelectionByItemListCustomerContractLifeCycleStatusCode may have a multiplicity of 0 . . . * and may be based on datatype MIDT:CustomerContractByElementsQuerySelectionByStatusItemListCustomerContractLife CycleStatusCode. SelectionByItemListCustomerContractLifeCycleStatusCode can include InclusionExclusionCode, IntervalBoundaryTypeCode, LowerBoundaryItemListCustomerContractLifeCycleStatusCode, and UpperBoundaryItemListCustomerContractLifeCycleStatusCode. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryItemListCustomerContractLifeCycleStatusCode may have a multiplicity of 0 . . . 1 and may be based on datatype BGDT:CustomerContractLifeCycleStatusCode_V1. UpperBoundaryItemListCustomerContractLifeCycleStatusCode may have a multiplicity of 0 . . . 1 and may be based on datatype BGDT:CustomerContractLifeCycleStatusCode_V1.

SelectionByBuyerPartyID may have a multiplicity of 0 . . . * and may be based on datatype MIDT:CustomerContractByElementsQuerySelectionByPartyID. SelectionByBuyerPartyID may include InclusionExclusionCode, IntervalBoundaryTypeCode, LowerBoundaryID, and UpperBoundaryID. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryID may have a multiplicity of 0 . . . 1 and may be based on datatype BGDT:PartyID. UpperBoundaryID may have a multiplicity of 0 . . . 1 and may be based on datatype BGDT:PartyID.

SelectionByLastChangedDateTime may have a multiplicity of 0 . . . * and may be based on datatype MIDT:CustomerContractByElementsQuerySelectionByDateTime. SelectionByLastChangedDateTime may include InclusionExclusionCode, IntervalBoundaryTypeCode, LowerBoundaryDateTime, and UpperBoundaryDateTime. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryDateTime may have a multiplicity of 0 . . . 1 and may be based on datatype CDT:GLOBAL_DateTime. UpperBoundaryDateTime may have a multiplicity of 0 . . . 1 and may be based on datatype CDT:GLOBAL_DateTime.

The package RequestedElements includes the entity RequestedElements. RequestedElements includes the customerContractTransmissionRequestCode attribute, which may have a multiplicity of 0 . . . 1 and may be based on datatype BGDT:TransmissionRequestCode. RequestedElements includes the following non-node elements: CustomerContract and itemTransmissionRequestCode. CustomerContract may have a multiplicity of 0 . . . 1 and may be based on datatype MIDT:CustomerContractByElementsQueryRequestedElementsCustomerContract. itemTransmissionRequestCode may have a multiplicity of 0 . . . 1 and may be based on datatype BGDT:TransmissionRequestCode.

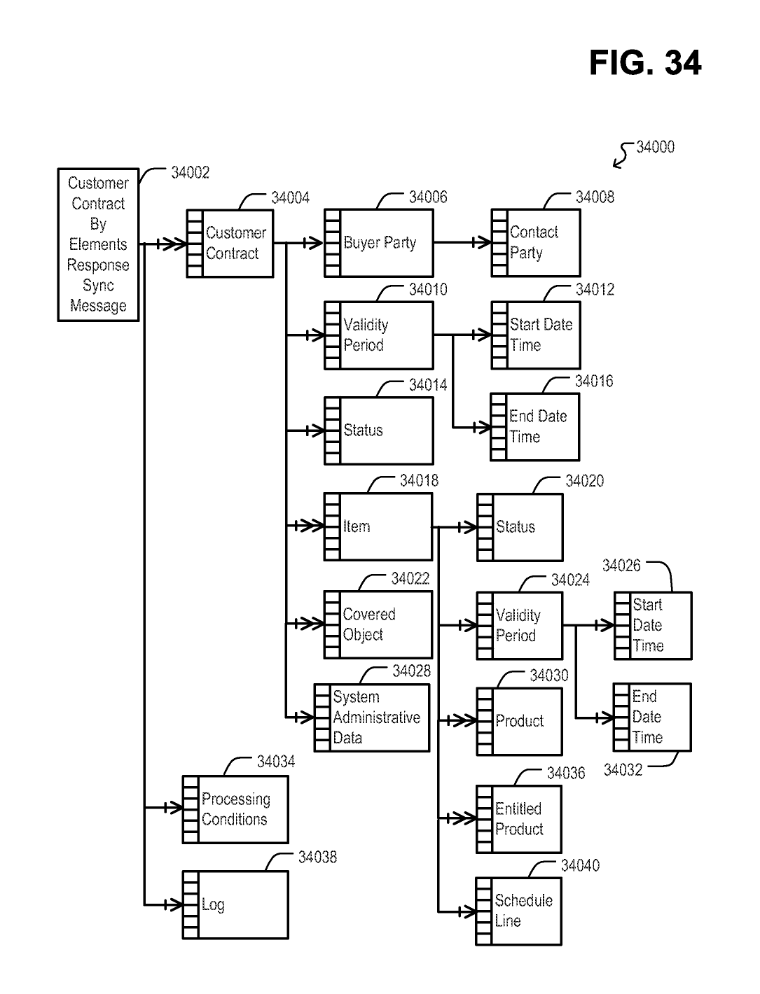

FIG. 34 illustrates one example logical configuration of a Customer Contract By Elements Response Sync Message 34000. Specifically, this figure depicts the arrangement and hierarchy of various components such as one or more levels of packages, entities, and data types, shown here as 34000 through 34040. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Customer Contract By Elements Response Sync Message 34000 includes, among other things, the Buyer Party entity 34006. Accordingly, heterogeneous applications may communicate using this consistent message configured as such.

The message type Customer Contract By Elements Response_sync is derived from the business object Customer Contract as a leading object together with its operation signature. The message type Customer Contract By Elements Response_sync is a response concerning an inquiry about customer contract data that includes the requested customer contract data as well as processing conditions. Corresponding system messages can be provided as log items. The structure of the message type Customer Contract By Elements Response_sync is determined by the message data type CustomerContractByElementsResponseMessage_sync. The message data type CustomerContractByElementsResponseMessage_sync includes the CustomerContract package, the ProcessingConditions package, and the Log package.

The package CustomerContract includes the sub-packages Party, ValidityPeriod, Status, Item, CoveredObject, and SystemAdministrativeData, and the entity CustomerContract. CustomerContract includes the following non-node elements: ID, UUID, Name, and ServiceConfirmationCreationCode. ID may have a multiplicity of 0 . . . 1 and may be based on datatype BGDT:BusinessTransactionDocumentID. UUID may have a multiplicity of 0 . . . 1 and may be based on datatype BGDT:UUID. Name may have a multiplicity of 0 . . . 1 and may be based on datatype CDT:EXTENDED_Name. ServiceConfirmationCreationCode may have a multiplicity of 0 . . . 1 and may be based on datatype BGDT:CustomerTransactionDocumentServiceConfirmationCreationCode. CustomerContract includes the following node elements: BuyerParty, in a 1:C cardinality relationship; ValidityPeriod, in a 1:C cardinality relationship; Status, in a 1:C cardinality relationship; Item, in a 1:CN cardinality relationship; CoveredObject, in a 1:CN cardinality relationship; and SystemAdministrativeData, in a 1:C cardinality relationship.

The package CustomerContractParty includes the entity BuyerParty. BuyerParty includes the PartyID non-node element, which may have a multiplicity of 0 . . . 1 and may be based on datatype BGDT:PartyID. BuyerParty includes the following node elements: ContactParty, in a 1:C cardinality relationship. The package CustomerContractParty includes the entity ContactParty. ContactParty includes the PartyID non-node element, which may have a multiplicity of 0 . . . 1 and may be based on datatype BGDT:PartyID.

The package CustomerContractValidityPeriod includes the entity ValidityPeriod. ValidityPeriod includes the following node elements: StartDateTime, in a 1:C cardinality relationship; and EndDateTime, in a 1:C cardinality relationship. The package CustomerContractValidityPeriod includes the entities StartDateTime and EndDateTime. StartDateTime is typed by datatype LOCALNORMALISED_DateTime. EndDateTime is typed by datatype LOCALNORMALISED_DateTime.

The package CustomerContractStatus includes the entity Status. Status includes the following non-node elements: ItemListCustomerContractLifeCycleStatusCode, ItemListValidityStatusCode, and FulfilmentBlockingStatusCode. ItemListCustomerContractLifeCycleStatusCode may have a multiplicity of 0 . . . 1 and may be based on datatype BGDT:CustomerContractLifeCycleStatusCode_V1. ItemListValidityStatusCode may have a multiplicity of 0 . . . 1 and may be based on datatype BGDT:ValidityStatusCode. FulfilmentBlockingStatusCode may have a multiplicity of 0 . . . 1 and may be based on datatype BGDT:BlockingStatusCode.

The package CustomerContractItem includes the sub-packages Status, ValidityPeriod, ProductInformation, and ScheduleLine, and the entity Item. Item includes the following non-node elements: ID and Description. ID may have a multiplicity of 0 . . . 1 and may be based on datatype BGDT:BusinessTransactionDocumentItemID Description may have a multiplicity of 0 . . . 1 and may be based on datatype BGDT:SHORT_Description. Item includes the following node elements: Status, in a 1:C cardinality relationship; ValidityPeriod, in a 1:C cardinality relationship; Product, in a 1:C cardinality relationship; EntitledProduct, in a 1:CN cardinality relationship; and ScheduleLine, in a 1:C cardinality relationship.

The package CustomerContractItemStatus includes the entity Status. Status includes the following non-node elements: CustomerContractLifeCycleStatusCode, Validity Status Code, and FulfilmentBlockingStatusCode. CustomerContractLifeCycleStatusCode may have a multiplicity of 0 . . . 1 and may be based on datatype BGDT:CustomerContractLifeCycleStatusCode_V1. ValidityStatusCode may have a multiplicity of 0 . . . 1 and may be based on datatype BGDT:ValidityStatusCode. FulfilmentBlockingStatusCode may have a multiplicity of 0 . . . 1 and may be based on datatype BGDT:BlockingStatusCode.

The package CustomerContractItemValidityPeriod includes the entity ValidityPeriod. ValidityPeriod includes the following node elements: StartDateTime, in a 1:C cardinality relationship; and EndDateTime, in a 1:C cardinality relationship. The package CustomerContractItemValidityPeriod includes the entities StartDateTime and EndDateTime. StartDateTime is typed by datatype LOCALNORMALISED_DateTime. EndDateTime is typed by datatype LOCALNORMALISED_DateTime.

The package CustomerContractItemProductInformation includes the entities Product and EntitledProduct. Product includes the following non-node elements: ProductID, ProductStandardID, ProductBuyerID, UnitOfMeasure, and TypeCode. ProductID may have a multiplicity of 0 . . . 1 and may be based on datatype BGDT:NOCONVERSION_ProductID. ProductStandardID may have a multiplicity of 0 . . . 1 and may be based on datatype BGDT:ProductStandardID. ProductBuyerID may have a multiplicity of 0 . . . 1 and may be based on datatype BGDT:ProductPartyID. UnitOfMeasure may have a multiplicity of 0 . . . 1 and may be based on datatype BGDT:MeasureUnitCode. TypeCode may have a multiplicity of 0 . . . 1 and may be based on datatype BGDT:ProductTypeCode.

EntitledProduct includes the following non-node elements: ProductID, ProductCategoryHierarchyID, ProductCategoryInternalID, ProductCategoryHierarchyProductCategoryUUID, Description, and TypeCode. ProductID may have a multiplicity of 0 . . . 1 and may be based on datatype BGDT:NOCONVERSIONProductID. ProductCategoryHierarchyID may have a multiplicity of 0 . . . 1 and may be based on datatype BGDT:ProductCategoryHierarchyID. ProductCategoryInternalID may have a multiplicity of 0 . . . 1 and may be based on datatype BGDT:ProductCategoryInternalID. ProductCategoryHierarchyProductCategoryUUID may have a multiplicity of 0 . . . 1 and may be based on datatype BGDT:UUID. Description may have a multiplicity of 0 . . . 1 and may be based on datatype BGDT:MEDIUM_Description. TypeCode may have a multiplicity of 0 . . . 1 and may be based on datatype BGDT:ProductTypeCode.

The package CustomerContractItemScheduleLine includes the entity ScheduleLine. ScheduleLine includes the Quantity non-node element, which may have a multiplicity of 0 . . . 1 and may be based on datatype CDT:Quantity.

The package CustomerContractCoveredObject includes the entity CoveredObject. CoveredObject includes the following non-node elements: IndividualProductID, ProductID, ProductCategoryHierarchyID, ProductCategoryInternalID, and Description. IndividualProductID may have a multiplicity of 0 . . . 1 and may be based on datatype BGDT:ProductID. ProductID may have a multiplicity of 0 . . . 1 and may be based on datatype BGDT:ProductID. ProductCategoryHierarchyID may have a multiplicity of 0 . . . 1 and may be based on datatype BGDT:ProductCategoryHierarchyID. ProductCategoryInternalID may have a multiplicity of 0 . . . 1 and may be based on datatype BGDT:ProductCategoryInternalID. Description may have a multiplicity of 0 . . . 1 and may be based on datatype BGDT:MEDIUM_Description.

The package CustomerContractSystemAdministrativeData includes the entity SystemAdministrativeData. SystemAdministrativeData is typed by datatype SystemAdministrativeData. The package ProcessingConditions includes the entity ProcessingConditions. ProcessingConditions is typed by datatype ResponseProcessingConditions. The package Log includes the entity Log. Log is typed by datatype Log.

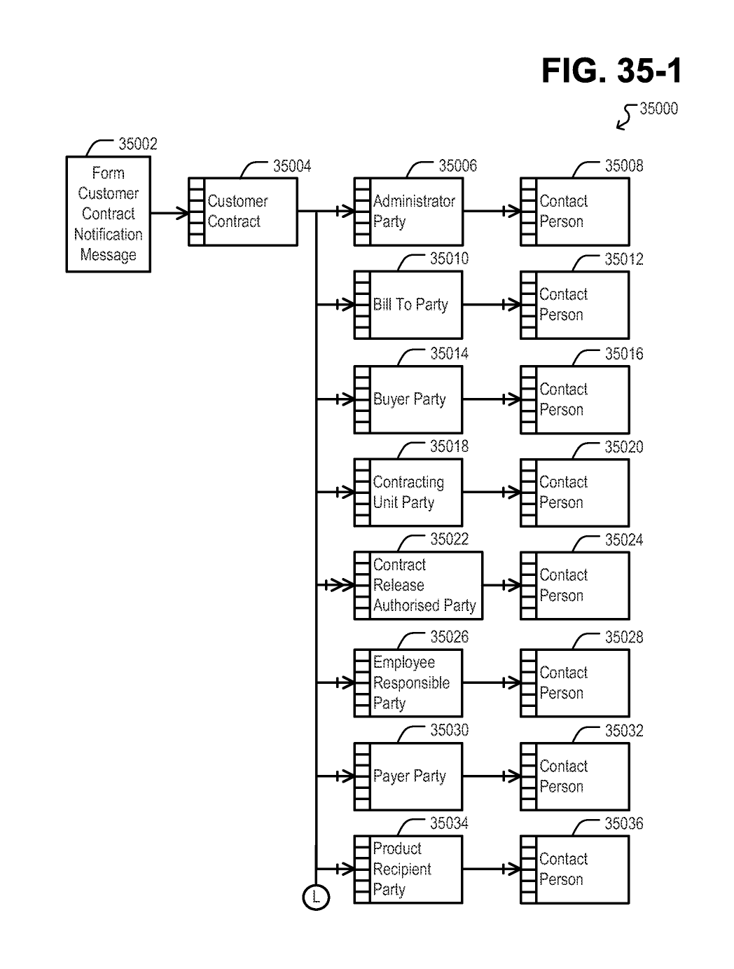

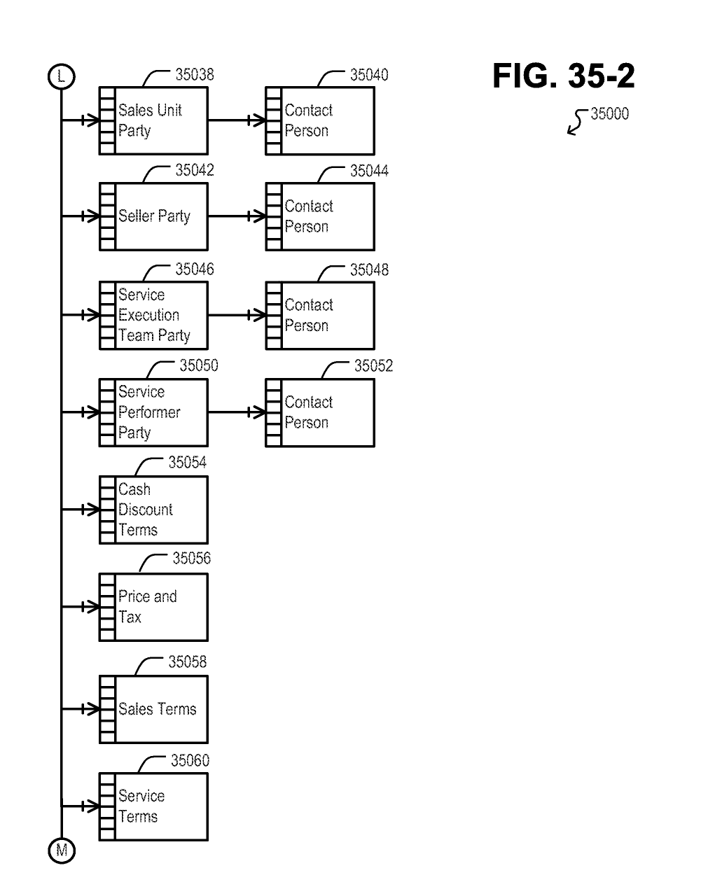

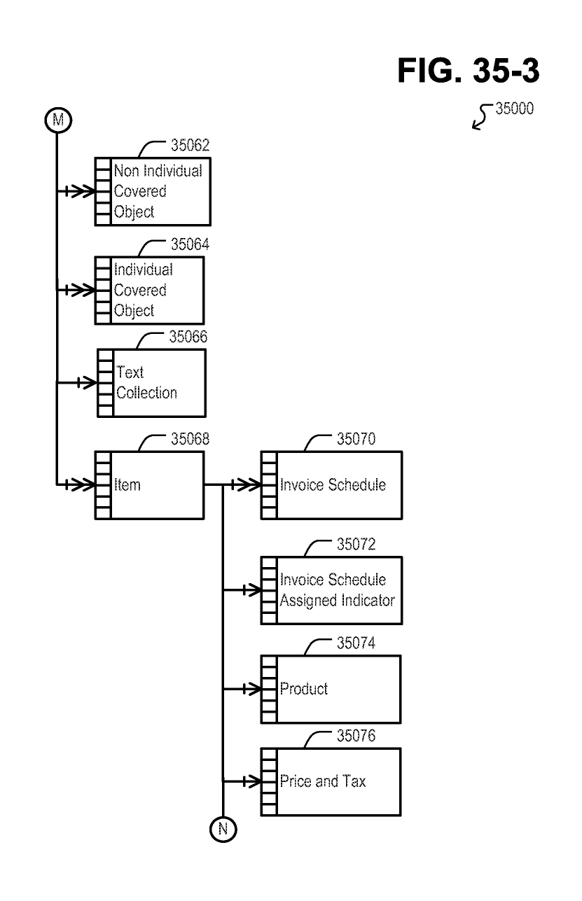

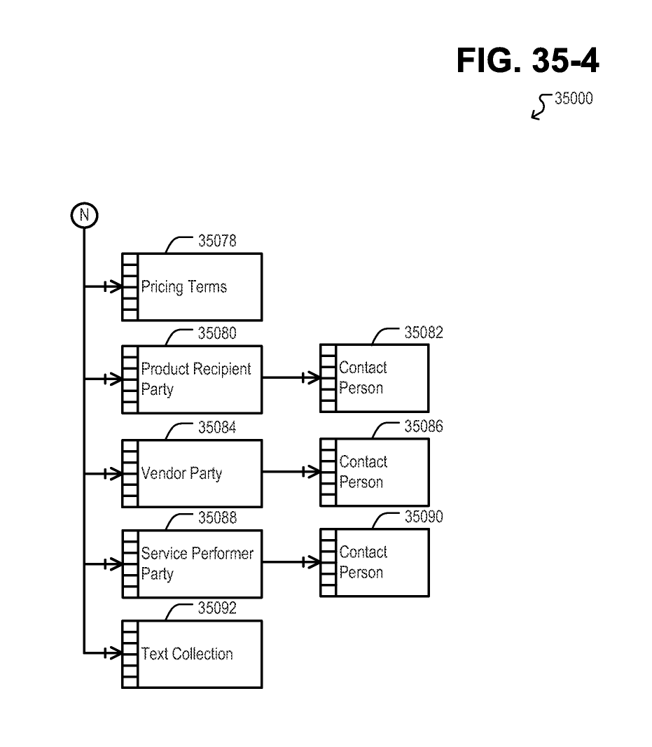

FIGS. 35-1 through 35-4 collectively illustrate one example logical configuration of a Form Customer Contract Notification Message 35000. Specifically, these figures depict the arrangement and hierarchy of various components such as one or more levels of packages, entities, and data types, shown here as 35000 through 35092. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Form Customer Contract Notification Message 35000 includes, among other things, the Administrator Party entity 35006. Accordingly, heterogeneous applications may communicate using this consistent message configured as such.

The message type Form Customer Contract Notification is derived from the business object Customer Contract as a leading object together with its operation signature. The message type Form Customer Contract Notification is a message type to enable form-based output for a customer contract notification. The structure of this message type is determined by the message data type FormCustomerContractMessage. The message data type FormCustomerContractMessage includes the CustomerContract package.

The package CustomerContract includes the sub-packages Party, PaymentInformation, PriceInformation, SalesTerms, ServiceTerms, CoveredObject, Description, and Item, and the entity CustomerContract.

CustomerContract includes the following non-node elements: ID, BuyerID, Date, DateTime, Name, PredecessorSalesOrderReference, ItemID, Description, ValidityPeriodStartDate, ValidityPeriodEndDate, ValidityDurationDescription, MinimumValidityEndDate, MinimumValidityEndDateTime, MinimumValidityDurationDescription, and WatermarkName. ID may have a multiplicity of 1, is an identifier for a customer contract as assigned by a company, and may be based on datatype BGDT:BusinessTransactionDocumentID. BuyerID may have a multiplicity of 0 . . . 1, is an identifier for a customer contract as assigned by a customer for a corresponding purchasing contract, and may be based on datatype BGDT:BusinessTransactionDocumentID. Date may have a multiplicity of 0 . . . 1, is a date on which a customer contract is created, and may be based on datatype CDT:Date. DateTime may have a multiplicity of 0 . . . 1, is a point in time at which a customer contract is created, and may be based on datatype CDT:LOCAL_DateTime. Name may have a multiplicity of 0 . . . 1, is a name of a customer contract, and may be based on datatype CDT:EXTENDED_Name. PredecessorSalesOrderReference may have a multiplicity of 0 . . . 1, is a reference to a predecessor sales order by which a customer contract is sold, and may be based on datatype FMIDT:FormCustomerContractPredecessorSalesOrderReference. ItemID may have a multiplicity of 0 . . . 1 and may be based on datatype BGDT:BusinessTransactionDocumentItemID Description may have a multiplicity of 0 . . . 1 and may be based on datatype BGDT:SHORT_Description. ValidityPeriodStartDate may have a multiplicity of 0 . . . 1, is a date on which a customer contract begins, and may be based on datatype CDT:Date. ValidityPeriodEndDateTime may have a multiplicity of 0 . . . 1, is a point in time at which a customer contract ends, and may be based on datatype CDT:LOCAL_DateTime. ValidityDurationDescription may have a multiplicity of 0 . . . 1, is a description of a duration during which a customer contract is valid, and may be based on datatype BGDT:LONG_Description. MinimumValidityEndDate may have a multiplicity of 0 . . . 1, is a date by which a minimum validity period of a customer contract ends, and may be based on datatype CDT:Date. MinimumValidityEndDateTime may have a multiplicity of 0 . . . 1, is a point in time by which a minimum validity period of a customer contract ends, and may be based on datatype CDT:LOCAL_DateTime. MinimumValidityDurationDescription may have a multiplicity of 0 . . . 1, is a description of a minimum duration during which a customer contract is valid, and may be based on datatype BGDT:LONG_Description. WatermarkName may have a multiplicity of 0 . . . 1 and may be based on datatype CDT:LANGUAGEINDEPENDENT_MEDIUM_Name.

CustomerContract includes the following node elements: AdministratorParty, with a cardinality of 1:C; BillToParty, with a cardinality of 1:C; BuyerParty, with a cardinality of 1:C; ContractingUnitParty, with a cardinality of 1:C; ContractReleaseAuthorisedParty, with a cardinality of 1:CN; EmployeeResponsibleParty, with a cardinality of 1:C; PayerParty, with a cardinality of 1:C; ProductRecipientParty, with a cardinality of 1:C; SalesUnitParty, with a cardinality of 1:C; SellerParty, with a cardinality of 1:C; ServiceExecutionTeamParty, with a cardinality of 1:C; ServicePerformerParty, with a cardinality of 1:C; CashDiscountTerms, with a cardinality of 1:C; PriceAndTax, with a cardinality of 1:C; SalesTerms, with a cardinality of 1:C; ServiceTerms, with a cardinality of 1:C; NonIndividualCoveredObject, with a cardinality of 1:CN; IndividualCoveredObject, with a cardinality of 1:CN; TextCollection, with a cardinality of 1:C; and Item, with a cardinality of 1:CN.

The package CustomerContractParty includes the entities AdministratorParty, BillToParty, BuyerParty, ContractingUnitParty, ContractReleaseAuthorisedParty, EmployeeResponsibleParty, PayerParty, ProductRecipientParty, SalesUnitParty, SellerParty, ServiceExecutionTeamParty, and ServicePerformerParty.

AdministratorParty is a party that has an assigned administrator role category. AdministratorParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormAddress, and FormattedName. InternalID may have a multiplicity of 0 . . . 1 and may be based on datatype BGDT:PartyInternalID. StandardID may have a multiplicity of 0 . . . * and may be based on datatype BGDT:PartyStandardID. BuyerID may have a multiplicity of 0 . . . 1 and may be based on datatype BGDT:PartyPartyID. SellerID may have a multiplicity of 0 . . . 1 and may be based on datatype BGDT:PartyPartyID. ProductRecipientID may have a multiplicity of 0 . . . 1 and may be based on datatype BGDT:PartyPartyID. VendorID may have a multiplicity of 0 . . . 1 and may be based on datatype BGDT:PartyPartyID. BillToID may have a multiplicity of 0 . . . 1 and may be based on datatype BGDT:PartyPartyID. BillFromID may have a multiplicity of 0 . . . 1 and may be based on datatype BGDT:PartyPartyID. BidderID may have a multiplicity of 0 . . . 1 and may be based on datatype BGDT:PartyPartyID. PaymentTransactionInitiatorID may have a multiplicity of 0 . . . 1 and may be based on datatype BGDT:PartyPartyID. PaymentTransactionDestinatedID may have a multiplicity of 0 . . . 1 and may be based on datatype BGDT:PartyPartyID. TaxID may have a multiplicity of 0 . . . 1 and may be based on datatype BGDT:PartyTaxID. TypeCode may have a multiplicity of 0 . . . 1 and may be based on datatype BGDT:BusinessObjectTypeCode. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

AdministratorParty includes the following node elements: ContactPerson, with a cardinality of 1:C. ContactPerson includes the following non-node elements: InternalID, BuyerID, SellerID, ProductRecipientID, VendorID, BillToID, BillFromID, BidderID, FormAddress, and FormattedName. InternalID may have a multiplicity of 0 . . . 1, is a proprietary identifier that is used when both sender and recipient can access shared master data, and may be based on datatype BGDT:ContactPersonInternalID, with a qualifier of Internal. BuyerID may have a multiplicity of 0 . . . 1 and may be based on datatype BGDT:ContactPersonPartyID. SellerID may have a multiplicity of 0 . . . 1, is an identifier that is used by a SellerParty proprietarily for a location, and may be based on datatype BGDT:ContactPersonPartyID, with a qualifier of Seller. ProductRecipientID may have a multiplicity of 0 . . . 1, is an identifier that is used by a ProductRecipientParty proprietarily for a location, and may be based on datatype BGDT:ContactPersonPartyID, with a qualifier of Product Recipient. VendorID may have a multiplicity of 0 . . . 1 and may be based on datatype BGDT:ContactPersonPartyID. BillToID may have a multiplicity of 0 . . . 1 and may be based on datatype BGDT:ContactPersonPartyID. BillFromID may have a multiplicity of 0 . . . 1 and may be based on datatype BGDT:ContactPersonPartyID. BidderID may have a multiplicity of 0 . . . 1 and may be based on datatype BGDT:ContactPersonPartyID. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

BillToParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormAddress, and FormattedName. InternalID may have a multiplicity of 0 . . . 1 and may be based on datatype BGDT:PartyInternalID. StandardID may have a multiplicity of 0 . . . * and may be based on datatype BGDT:PartyStandardID. BuyerID may have a multiplicity of 0 . . . 1 and may be based on datatype BGDT:PartyPartyID. SellerID may have a multiplicity of 0 . . . 1 and may be based on datatype BGDT:PartyPartyID. ProductRecipientID may have a multiplicity of 0 . . . 1 and may be based on datatype BGDT:PartyPartyID. VendorID may have a multiplicity of 0 . . . 1 and may be based on datatype BGDT:PartyPartyID. BillToID may have a multiplicity of 0 . . . 1 and may be based on datatype BGDT:PartyPartyID. BillFromID may have a multiplicity of 0 . . . 1 and may be based on datatype BGDT:PartyPartyID. BidderID may have a multiplicity of 0 . . . 1 and may be based on datatype BGDT:PartyPartyID. PaymentTransactionInitiatorID may have a multiplicity of 0 . . . 1 and may be based on datatype BGDT:PartyPartyID. PaymentTransactionDestinatedID may have a multiplicity of 0 . . . 1 and may be based on datatype BGDT:PartyPartyID. TaxID may have a multiplicity of 0 . . . 1 and may be based on datatype BGDT:PartyTaxID. TypeCode may have a multiplicity of 0 . . . 1 and may be based on datatype BGDT:BusinessObjectTypeCode. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

BillToParty includes the following node elements: ContactPerson, with a cardinality of 1:C. ContactPerson includes the following non-node elements: InternalID, BuyerID, SellerID, ProductRecipientID, VendorID, BillToID, BillFromID, BidderID, FormAddress, and FormattedName. InternalID may have a multiplicity of 0 . . . 1, is a proprietary identifier that is used when both sender and recipient can access shared master data, and may be based on datatype BGDT:ContactPersonInternalID, with a qualifier of Internal. BuyerID may have a multiplicity of 0 . . . 1 and may be based on datatype BGDT:ContactPersonPartyID. SellerID may have a multiplicity of 0 . . . 1, is an identifier that is used by a SellerParty proprietarily for a location, and may be based on datatype BGDT:ContactPersonPartyID, with a qualifier of Seller. ProductRecipientID may have a multiplicity of 0 . . . 1, is an identifier that is used by a ProductRecipientParty proprietarily for a location, and may be based on datatype BGDT:ContactPersonPartyID, with a qualifier of Product Recipient. VendorID may have a multiplicity of 0 . . . 1 and may be based on datatype BGDT:ContactPersonPartyID. BillToID may have a multiplicity of 0 . . . 1 and may be based on datatype BGDT:ContactPersonPartyID. BillFromID may have a multiplicity of 0 . . . 1 and may be based on datatype BGDT:ContactPersonPartyID. BidderID may have a multiplicity of 0 . . . 1 and may be based on datatype BGDT:ContactPersonPartyID. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

BuyerParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormAddress, and FormattedName. InternalID may have a multiplicity of 0 . . . 1 and may be based on datatype BGDT:PartyInternalID. StandardID may have a multiplicity of 0 . . . * and may be based on datatype BGDT:PartyStandardID. BuyerID may have a multiplicity of 0 . . . 1 and may be based on datatype BGDT:PartyPartyID. SellerID may have a multiplicity of 0 . . . 1 and may be based on datatype BGDT:PartyPartyID. ProductRecipientID may have a multiplicity of 0 . . . 1 and may be based on datatype BGDT:PartyPartyID. VendorID may have a multiplicity of 0 . . . 1 and may be based on datatype BGDT:PartyPartyID. BillToID may have a multiplicity of 0 . . . 1 and may be based on datatype BGDT:PartyPartyID. BillFromID may have a multiplicity of 0 . . . 1 and may be based on datatype BGDT:PartyPartyID. BidderID may have a multiplicity of 0 . . . 1 and may be based on datatype BGDT:PartyPartyID. PaymentTransactionInitiatorID may have a multiplicity of 0 . . . 1 and may be based on datatype BGDT:PartyPartyID. PaymentTransactionDestinatedID may have a multiplicity of 0 . . . 1 and may be based on datatype BGDT:PartyPartyID. TaxID may have a multiplicity of 0 . . . 1 and may be based on datatype BGDT:PartyTaxID. TypeCode may have a multiplicity of 0 . . . 1 and may be based on datatype BGDT:BusinessObjectTypeCode. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

BuyerParty includes the following node elements: ContactPerson, with a cardinality of 1:C. ContactPerson includes the following non-node elements: InternalID, BuyerID, SellerID, ProductRecipientID, VendorID, BillToID, BillFromID, BidderID, FormAddress, and FormattedName. InternalID may have a multiplicity of 0 . . . 1, is a proprietary identifier that is used when both sender and recipient can access shared master data, and may be based on datatype BGDT:ContactPersonInternalID, with a qualifier of Internal. BuyerID may have a multiplicity of 0 . . . 1 and may be based on datatype BGDT:ContactPersonPartyID. SellerID may have a multiplicity of 0 . . . 1, is an identifier that is used by a SellerParty proprietarily for a location, and may be based on datatype BGDT:ContactPersonPartyID, with a qualifier of Seller. ProductRecipientID may have a multiplicity of 0 . . . 1, is an identifier that is used by a ProductRecipientParty proprietarily for a location, and may be based on datatype BGDT:ContactPersonPartyID, with a qualifier of Product Recipient. VendorID may have a multiplicity of 0 . . . 1 and may be based on datatype BGDT:ContactPersonPartyID. BillToID may have a multiplicity of 0 . . . 1 and may be based on datatype BGDT:ContactPersonPartyID. BillFromID may have a multiplicity of 0 . . . 1 and may be based on datatype BGDT:ContactPersonPartyID. BidderID may have a multiplicity of 0 . . . 1 and may be based on datatype BGDT:ContactPersonPartyID. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

ContractingUnitParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormAddress, and FormattedName. InternalID may have a multiplicity of 0 . . . 1 and may be based on datatype BGDT:PartyInternalID. StandardID may have a multiplicity of 0 . . . * and may be based on datatype BGDT:PartyStandardID. BuyerID may have a multiplicity of 0 . . . 1 and may be based on datatype BGDT:PartyPartyID. SellerID may have a multiplicity of 0 . . . 1 and may be based on datatype BGDT:PartyPartyID. ProductRecipientID may have a multiplicity of 0 . . . 1 and may be based on datatype BGDT:PartyPartyID. VendorID may have a multiplicity of 0 . . . 1 and may be based on datatype BGDT:PartyPartyID. BillToID may have a multiplicity of 0 . . . 1 and may be based on datatype BGDT:PartyPartyID. BillFromID may have a multiplicity of 0 . . . 1 and may be based on datatype BGDT:PartyPartyID. BidderID may have a multiplicity of 0 . . . 1 and may be based on datatype BGDT:PartyPartyID. PaymentTransactionInitiatorID may have a multiplicity of 0 . . . 1 and may be based on datatype BGDT:PartyPartyID. PaymentTransactionDestinatedID may have a multiplicity of 0 . . . 1 and may be based on datatype BGDT:PartyPartyID. TaxID may have a multiplicity of 0 . . . 1 and may be based on datatype BGDT:PartyTaxID. TypeCode may have a multiplicity of 0 . . . 1 and may be based on datatype BGDT:BusinessObjectTypeCode. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

ContractingUnitParty includes the following node elements: ContactPerson, with a cardinality of 1:C. ContactPerson includes the following non-node elements: InternalID, BuyerID, SellerID, ProductRecipientID, VendorID, BillToID, BillFromID, BidderID, FormAddress, and FormattedName. InternalID may have a multiplicity of 0 . . . 1, is a proprietary identifier that is used when both sender and recipient can access shared master data, and may be based on datatype BGDT:ContactPersonInternalID, with a qualifier of Internal. BuyerID may have a multiplicity of 0 . . . 1 and may be based on datatype BGDT:ContactPersonPartyID. SellerID may have a multiplicity of 0 . . . 1, is an identifier that is used by a SellerParty proprietarily for a location, and may be based on datatype BGDT:ContactPersonPartyID, with a qualifier of Seller. ProductRecipientID may have a multiplicity of 0 . . . 1, is an identifier that is used by a ProductRecipientParty proprietarily for a location, and may be based on datatype BGDT:ContactPersonPartyID, with a qualifier of Product Recipient. VendorID may have a multiplicity of 0 . . . 1 and may be based on datatype BGDT:ContactPersonPartyID. BillToID may have a multiplicity of 0 . . . 1 and may be based on datatype BGDT:ContactPersonPartyID. BillFromID may have a multiplicity of 0 . . . 1 and may be based on datatype BGDT:ContactPersonPartyID. BidderID may have a multiplicity of 0 . . . 1 and may be based on datatype BGDT:ContactPersonPartyID. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

ContractReleaseAuthorisedParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormAddress, and FormattedName. InternalID may have a multiplicity of 0 . . . 1 and may be based on datatype BGDT:PartyInternalID. StandardID may have a multiplicity of 0 . . . * and may be based on datatype BGDT:PartyStandardID. BuyerID may have a multiplicity of 0 . . . 1 and may be based on datatype BGDT:PartyPartyID. SellerID may have a multiplicity of 0 . . . 1 and may be based on datatype BGDT:PartyPartyID. ProductRecipientID may have a multiplicity of 0 . . . 1 and may be based on datatype BGDT:PartyPartyID. VendorID may have a multiplicity of 0 . . . 1 and may be based on datatype BGDT:PartyPartyID. BillToID may have a multiplicity of 0 . . . 1 and may be based on datatype BGDT:PartyPartyID. BillFromID may have a multiplicity of 0 . . . 1 and may be based on datatype BGDT:PartyPartyID. BidderID may have a multiplicity of 0 . . . 1 and may be based on datatype BGDT:PartyPartyID. PaymentTransactionInitiatorID may have a multiplicity of 0 . . . 1 and may be based on datatype BGDT:PartyPartyID. PaymentTransactionDestinatedID may have a multiplicity of 0 . . . 1 and may be based on datatype BGDT:PartyPartyID. TaxID may have a multiplicity of 0 . . . 1 and may be based on datatype BGDT:PartyTaxID. TypeCode may have a multiplicity of 0 . . . 1 and may be based on datatype BGDT:BusinessObjectTypeCode. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

ContractReleaseAuthorisedParty includes the following node elements: ContactPerson, with a cardinality of 1:C. ContactPerson includes the following non-node elements: InternalID, BuyerID, SellerID, ProductRecipientID, VendorID, BillToID, BillFromID, BidderID, FormAddress, and FormattedName. InternalID may have a multiplicity of 0 . . . 1, is a proprietary identifier that is used when both sender and recipient can access shared master data, and may be based on datatype BGDT:ContactPersonInternalID, with a qualifier of Internal. BuyerID may have a multiplicity of 0 . . . 1 and may be based on datatype BGDT:ContactPersonPartyID. SellerID may have a multiplicity of 0 . . . 1, is an identifier that is used by a SellerParty proprietarily for a location, and may be based on datatype BGDT:ContactPersonPartyID, with a qualifier of Seller. ProductRecipientID may have a multiplicity of 0 . . . 1, is an identifier that is used by a ProductRecipientParty proprietarily for a location, and may be based on datatype BGDT:ContactPersonPartyID, with a qualifier of Product Recipient. VendorID may have a multiplicity of 0 . . . 1 and may be based on datatype BGDT:ContactPersonPartyID. BillToID may have a multiplicity of 0 . . . 1 and may be based on datatype BGDT:ContactPersonPartyID. BillFromID may have a multiplicity of 0 . . . 1 and may be based on datatype BGDT:ContactPersonPartyID. BidderID may have a multiplicity of 0 . . . 1 and may be based on datatype BGDT:ContactPersonPartyID. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

EmployeeResponsibleParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormAddress, and FormattedName. InternalID may have a multiplicity of 0 . . . 1 and may be based on datatype BGDT:PartyInternalID. StandardID may have a multiplicity of 0 . . . * and may be based on datatype BGDT:PartyStandardID. BuyerID may have a multiplicity of 0 . . . 1 and may be based on datatype BGDT:PartyPartyID. SellerID may have a multiplicity of 0 . . . 1 and may be based on datatype BGDT:PartyPartyID. ProductRecipientID may have a multiplicity of 0 . . . 1 and may be based on datatype BGDT:PartyPartyID. VendorID may have a multiplicity of 0 . . . 1 and may be based on datatype BGDT:PartyPartyID. BillToID may have a multiplicity of 0 . . . 1 and may be based on datatype BGDT:PartyPartyID. BillFromID may have a multiplicity of 0 . . . 1 and may be based on datatype BGDT:PartyPartyID. BidderID may have a multiplicity of 0 . . . 1 and may be based on datatype BGDT:PartyPartyID. PaymentTransactionInitiatorID may have a multiplicity of 0 . . . 1 and may be based on datatype BGDT:PartyPartyID. PaymentTransactionDestinatedID may have a multiplicity of 0 . . . 1 and may be based on datatype BGDT:PartyPartyID. TaxID may have a multiplicity of 0 . . . 1 and may be based on datatype BGDT:PartyTaxID. TypeCode may have a multiplicity of 0 . . . 1 and may be based on datatype BGDT:BusinessObjectTypeCode. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

EmployeeResponsibleParty includes the following node elements: ContactPerson, with a cardinality of 1:C. ContactPerson includes the following non-node elements: InternalID, BuyerID, SellerID, ProductRecipientID, VendorID, BillToID, BillFromID, BidderID, FormAddress, and FormattedName. InternalID may have a multiplicity of 0 . . . 1, is a proprietary identifier that is used when both sender and recipient can access shared master data, and may be based on datatype BGDT:ContactPersonInternalID, with a qualifier of Internal. BuyerID may have a multiplicity of 0 . . . 1 and may be based on datatype BGDT:ContactPersonPartyID. SellerID may have a multiplicity of 0 . . . 1, is an identifier that is used by a SellerParty proprietarily for a location, and may be based on datatype BGDT:ContactPersonPartyID, with a qualifier of Seller. ProductRecipientID may have a multiplicity of 0 . . . 1, is an identifier that is used by a ProductRecipientParty proprietarily for a location, and may be based on datatype BGDT:ContactPersonPartyID, with a qualifier of Product Recipient. VendorID may have a multiplicity of 0 . . . 1 and may be based on datatype BGDT:ContactPersonPartyID. BillToID may have a multiplicity of 0 . . . 1 and may be based on datatype BGDT:ContactPersonPartyID. BillFromID may have a multiplicity of 0 . . . 1 and may be based on datatype BGDT:ContactPersonPartyID. BidderID may have a multiplicity of 0 . . . 1 and may be based on datatype BGDT:ContactPersonPartyID. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

PayerParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormAddress, and FormattedName. InternalID may have a multiplicity of 0 . . . 1 and may be based on datatype BGDT:PartyInternalID. StandardID may have a multiplicity of 0 . . . * and may be based on datatype BGDT:PartyStandardID. BuyerID may have a multiplicity of 0 . . . 1 and may be based on datatype BGDT:PartyPartyID. SellerID may have a multiplicity of 0 . . . 1 and may be based on datatype BGDT:PartyPartyID. ProductRecipientID may have a multiplicity of 0 . . . 1 and may be based on datatype BGDT:PartyPartyID. VendorID may have a multiplicity of 0 . . . 1 and may be based on datatype BGDT:PartyPartyID. BillToID may have a multiplicity of 0 . . . 1 and may be based on datatype BGDT:PartyPartyID. BillFromID may have a multiplicity of 0 . . . 1 and may be based on datatype BGDT:PartyPartyID. BidderID may have a multiplicity of 0 . . . 1 and may be based on datatype BGDT:PartyPartyID. PaymentTransactionInitiatorID may have a multiplicity of 0 . . . 1 and may be based on datatype BGDT:PartyPartyID. PaymentTransactionDestinatedID may have a multiplicity of 0 . . . 1 and may be based on datatype BGDT:PartyPartyID. TaxID may have a multiplicity of 0 . . . 1 and may be based on datatype BGDT:PartyTaxID. TypeCode may have a multiplicity of 0 . . . 1 and may be based on datatype BGDT:BusinessObjectTypeCode. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

PayerParty includes the following node elements: ContactPerson, with a cardinality of 1:C. ContactPerson includes the following non-node elements: InternalID, BuyerID, SellerID, ProductRecipientID, VendorID, BillToID, BillFromID, BidderID, FormAddress, and FormattedName. InternalID may have a multiplicity of 0 . . . 1, is a proprietary identifier that is used when both sender and recipient can access shared master data, and may be based on datatype BGDT:ContactPersonInternalID, with a qualifier of Internal. BuyerID may have a multiplicity of 0 . . . 1 and may be based on datatype BGDT:ContactPersonPartyID. SellerID may have a multiplicity of 0 . . . 1, is an identifier that is used by a SellerParty proprietarily for a location, and may be based on datatype BGDT:ContactPersonPartyID, with a qualifier of Seller. ProductRecipientID may have a multiplicity of 0 . . . 1, is an identifier that is used by a ProductRecipientParty proprietarily for a location, and may be based on datatype BGDT:ContactPersonPartyID, with a qualifier of Product Recipient. VendorID may have a multiplicity of 0 . . . 1 and may be based on datatype BGDT:ContactPersonPartyID. BillToID may have a multiplicity of 0 . . . 1 and may be based on datatype BGDT:ContactPersonPartyID. BillFromID may have a multiplicity of 0 . . . 1 and may be based on datatype BGDT:ContactPersonPartyID. BidderID may have a multiplicity of 0 . . . 1 and may be based on datatype BGDT:ContactPersonPartyID. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

ProductRecipientParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormAddress, and FormattedName. InternalID may have a multiplicity of 0 . . . 1 and may be based on datatype BGDT:PartyInternalID. StandardID may have a multiplicity of 0 . . . * and may be based on datatype BGDT:PartyStandardID. BuyerID may have a multiplicity of 0 . . . 1 and may be based on datatype BGDT:PartyPartyID. SellerID may have a multiplicity of 0 . . . 1 and may be based on datatype BGDT:PartyPartyID. ProductRecipientID may have a multiplicity of 0 . . . 1 and may be based on datatype BGDT:PartyPartyID. VendorID may have a multiplicity of 0 . . . 1 and may be based on datatype BGDT:PartyPartyID. BillToID may have a multiplicity of 0 . . . 1 and may be based on datatype BGDT:PartyPartyID. BillFromID may have a multiplicity of 0 . . . 1 and may be based on datatype BGDT:PartyPartyID. BidderID may have a multiplicity of 0 . . . 1 and may be based on datatype BGDT:PartyPartyID. PaymentTransactionInitiatorID may have a multiplicity of 0 . . . 1 and may be based on datatype BGDT:PartyPartyID. PaymentTransactionDestinatedID may have a multiplicity of 0 . . . 1 and may be based on datatype BGDT:PartyPartyID. TaxID may have a multiplicity of 0 . . . 1 and may be based on datatype BGDT:PartyTaxID. TypeCode may have a multiplicity of 0 . . . 1 and may be based on datatype BGDT:BusinessObjectTypeCode. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

ProductRecipientParty includes the following node elements: ContactPerson, with a cardinality of 1:C. ContactPerson includes the following non-node elements: InternalID, BuyerID, SellerID, ProductRecipientID, VendorID, BillToID, BillFromID, BidderID, FormAddress, and FormattedName. InternalID may have a multiplicity of 0 . . . 1, is a proprietary identifier that is used when both sender and recipient can access shared master data, and may be based on datatype BGDT:ContactPersonInternalID, with a qualifier of Internal. BuyerID may have a multiplicity of 0 . . . 1 and may be based on datatype BGDT:ContactPersonPartyID. SellerID may have a multiplicity of 0 . . . 1, is an identifier that is used by a SellerParty proprietarily for a location, and may be based on datatype BGDT:ContactPersonPartyID, with a qualifier of Seller. ProductRecipientID may have a multiplicity of 0 . . . 1, is an identifier that is used by a ProductRecipientParty proprietarily for a location, and may be based on datatype BGDT:ContactPersonPartyID, with a qualifier of Product Recipient. VendorID may have a multiplicity of 0 . . . 1 and may be based on datatype BGDT:ContactPersonPartyID. BillToID may have a multiplicity of 0 . . . 1 and may be based on datatype BGDT:ContactPersonPartyID. BillFromID may have a multiplicity of 0 . . . 1 and may be based on datatype BGDT:ContactPersonPartyID. BidderID may have a multiplicity of 0 . . . 1 and may be based on datatype BGDT:ContactPersonPartyID. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

SalesUnitParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormAddress, and FormattedName. InternalID may have a multiplicity of 0 . . . 1 and may be based on datatype BGDT:PartyInternalID. StandardID may have a multiplicity of 0 . . . * and may be based on datatype BGDT:PartyStandardID. BuyerID may have a multiplicity of 0 . . . 1 and may be based on datatype BGDT:PartyPartyID. SellerID may have a multiplicity of 0 . . . 1 and may be based on datatype BGDT:PartyPartyID. ProductRecipientID may have a multiplicity of 0 . . . 1 and may be based on datatype BGDT:PartyPartyID. VendorID may have a multiplicity of 0 . . . 1 and may be based on datatype BGDT:PartyPartyID. BillToID may have a multiplicity of 0 . . . 1 and may be based on datatype BGDT:PartyPartyID. BillFromID may have a multiplicity of 0 . . . 1 and may be based on datatype BGDT:PartyPartyID. BidderID may have a multiplicity of 0 . . . 1 and may be based on datatype BGDT:PartyPartyID. PaymentTransactionInitiatorID may have a multiplicity of 0 . . . 1 and may be based on datatype BGDT:PartyPartyID. PaymentTransactionDestinatedID may have a multiplicity of 0 . . . 1 and may be based on datatype BGDT:PartyPartyID. TaxID may have a multiplicity of 0 . . . 1 and may be based on datatype BGDT:PartyTaxID. TypeCode may have a multiplicity of 0 . . . 1 and may be based on datatype BGDT:BusinessObjectTypeCode. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

SalesUnitParty includes the following node elements: ContactPerson, with a cardinality of 1:C. ContactPerson includes the following non-node elements: InternalID, BuyerID, SellerID, ProductRecipientID, VendorID, BillToID, BillFromID, BidderID, FormAddress, and FormattedName. InternalID may have a multiplicity of 0 . . . 1, is a proprietary identifier that is used when both sender and recipient can access shared master data, and may be based on datatype BGDT:ContactPersonInternalID, with a qualifier of Internal. BuyerID may have a multiplicity of 0 . . . 1 and may be based on datatype BGDT:ContactPersonPartyID. SellerID may have a multiplicity of 0 . . . 1, is an identifier that is used by a SellerParty proprietarily for a location, and may be based on datatype BGDT:ContactPersonPartyID, with a qualifier of Seller. ProductRecipientID may have a multiplicity of 0 . . . 1, is an identifier that is used by a ProductRecipientParty proprietarily for a location, and may be based on datatype BGDT:ContactPersonPartyID, with a qualifier of Product Recipient. VendorID may have a multiplicity of 0 . . . 1 and may be based on datatype BGDT:ContactPersonPartyID. BillToID may have a multiplicity of 0 . . . 1 and may be based on datatype BGDT:ContactPersonPartyID. BillFromID may have a multiplicity of 0 . . . 1 and may be based on datatype BGDT:ContactPersonPartyID. BidderID may have a multiplicity of 0 . . . 1 and may be based on datatype BGDT:ContactPersonPartyID. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

SellerParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormAddress, and FormattedName. InternalID may have a multiplicity of 0 . . . 1 and may be based on datatype BGDT:PartyInternalID. StandardID may have a multiplicity of 0 . . . * and may be based on datatype BGDT:PartyStandardID. BuyerID may have a multiplicity of 0 . . . 1 and may be based on datatype BGDT:PartyPartyID. SellerID may have a multiplicity of 0 . . . 1 and may be based on datatype BGDT:PartyPartyID. ProductRecipientID may have a multiplicity of 0 . . . 1 and may be based on datatype BGDT:PartyPartyID. VendorID may have a multiplicity of 0 . . . 1 and may be based on datatype BGDT:PartyPartyID. BillToID may have a multiplicity of 0 . . . 1 and may be based on datatype BGDT:PartyPartyID. BillFromID may have a multiplicity of 0 . . . 1 and may be based on datatype BGDT:PartyPartyID. BidderID may have a multiplicity of 0 . . . 1 and may be based on datatype BGDT:PartyPartyID. PaymentTransactionInitiatorID may have a multiplicity of 0 . . . 1 and may be based on datatype BGDT:PartyPartyID. PaymentTransactionDestinatedID may have a multiplicity of 0 . . . 1 and may be based on datatype BGDT:PartyPartyID. TaxID may have a multiplicity of 0 . . . 1 and may be based on datatype BGDT:PartyTaxID. TypeCode may have a multiplicity of 0 . . . 1 and may be based on datatype BGDT:BusinessObjectTypeCode. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

SellerParty includes the following node elements: ContactPerson, with a cardinality of 1:C. ContactPerson includes the following non-node elements: InternalID, BuyerID, SellerID, ProductRecipientID, VendorID, BillToID, BillFromID, BidderID, FormAddress, and FormattedName. InternalID may have a multiplicity of 0 . . . 1, is a proprietary identifier that is used when both sender and recipient can access shared master data, and may be based on datatype BGDT:ContactPersonInternalID, with a qualifier of Internal. BuyerID may have a multiplicity of 0 . . . 1 and may be based on datatype BGDT:ContactPersonPartyID. SellerID may have a multiplicity of 0 . . . 1, is an identifier that is used by a SellerParty proprietarily for a location, and may be based on datatype BGDT:ContactPersonPartyID, with a qualifier of Seller. ProductRecipientID may have a multiplicity of 0 . . . 1, is an identifier that is used by a ProductRecipientParty proprietarily for a location, and may be based on datatype BGDT:ContactPersonPartyID, with a qualifier of Product Recipient. VendorID may have a multiplicity of 0 . . . 1 and may be based on datatype BGDT:ContactPersonPartyID. BillToID may have a multiplicity of 0 . . . 1 and may be based on datatype BGDT:ContactPersonPartyID. BillFromID may have a multiplicity of 0 . . . 1 and may be based on datatype BGDT:ContactPersonPartyID. BidderID may have a multiplicity of 0 . . . 1 and may be based on datatype BGDT:ContactPersonPartyID. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

ServiceExecutionTeamParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormAddress, and FormattedName. InternalID may have a multiplicity of 0 . . . 1 and may be based on datatype BGDT:PartyInternalID. StandardID may have a multiplicity of 0 . . . * and may be based on datatype BGDT:PartyStandardID. BuyerID may have a multiplicity of 0 . . . 1 and may be based on datatype BGDT:PartyPartyID. SellerID may have a multiplicity of 0 . . . 1 and may be based on datatype BGDT:PartyPartyID. ProductRecipientID may have a multiplicity of 0 . . . 1 and may be based on datatype BGDT:PartyPartyID. VendorID may have a multiplicity of 0 . . . 1 and may be based on datatype BGDT:PartyPartyID. BillToID may have a multiplicity of 0 . . . 1 and may be based on datatype BGDT:PartyPartyID. BillFromID may have a multiplicity of 0 . . . 1 and may be based on datatype BGDT:PartyPartyID. BidderID may have a multiplicity of 0 . . . 1 and may be based on datatype BGDT:PartyPartyID. PaymentTransactionInitiatorID may have a multiplicity of 0 . . . 1 and may be based on datatype BGDT:PartyPartyID. PaymentTransactionDestinatedID may have a multiplicity of 0 . . . 1 and may be based on datatype BGDT:PartyPartyID. TaxID may have a multiplicity of 0 . . . 1 and may be based on datatype BGDT:PartyTaxID. TypeCode may have a multiplicity of 0 . . . 1 and may be based on datatype BGDT:BusinessObjectTypeCode. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

ServiceExecutionTeamParty includes the following node elements: ContactPerson, with a cardinality of 1:C. ContactPerson includes the following non-node elements: InternalID, BuyerID, SellerID, ProductRecipientID, VendorID, BillToID, BillFromID, BidderID, FormAddress, and FormattedName. InternalID may have a multiplicity of 0 . . . 1, is a proprietary identifier that is used when both sender and recipient can access shared master data, and may be based on datatype BGDT:ContactPersonInternalID, with a qualifier of Internal. BuyerID may have a multiplicity of 0 . . . 1 and may be based on datatype BGDT:ContactPersonPartyID. SellerID may have a multiplicity of 0 . . . 1, is an identifier that is used by a SellerParty proprietarily for a location, and may be based on datatype BGDT:ContactPersonPartyID, with a qualifier of Seller. ProductRecipientID may have a multiplicity of 0 . . . 1, is an identifier that is used by a ProductRecipientParty proprietarily for a location, and may be based on datatype BGDT:ContactPersonPartyID, with a qualifier of Product Recipient. VendorID may have a multiplicity of 0 . . . 1 and may be based on datatype BGDT:ContactPersonPartyID. BillToID may have a multiplicity of 0 . . . 1 and may be based on datatype BGDT:ContactPersonPartyID. BillFromID may have a multiplicity of 0 . . . 1 and may be based on datatype BGDT:ContactPersonPartyID. BidderID may have a multiplicity of 0 . . . 1 and may be based on datatype BGDT:ContactPersonPartyID. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

ServicePerformerParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormAddress, and FormattedName. InternalID may have a multiplicity of 0 . . . 1 and may be based on datatype BGDT:PartyInternalID. StandardID may have a multiplicity of 0 . . . * and may be based on datatype BGDT:PartyStandardID. BuyerID may have a multiplicity of 0 . . . 1 and may be based on datatype BGDT:PartyPartyID. SellerID may have a multiplicity of 0 . . . 1 and may be based on datatype BGDT:PartyPartyID. ProductRecipientID may have a multiplicity of 0 . . . 1 and may be based on datatype BGDT:PartyPartyID. VendorID may have a multiplicity of 0 . . . 1 and may be based on datatype BGDT:PartyPartyID. BillToID may have a multiplicity of 0 . . . 1 and may be based on datatype BGDT:PartyPartyID. BillFromID may have a multiplicity of 0 . . . 1 and may be based on datatype BGDT:PartyPartyID. BidderID may have a multiplicity of 0 . . . 1 and may be based on datatype BGDT:PartyPartyID. PaymentTransactionInitiatorID may have a multiplicity of 0 . . . 1 and may be based on datatype BGDT:PartyPartyID. PaymentTransactionDestinatedID may have a multiplicity of 0 . . . 1 and may be based on datatype BGDT:PartyPartyID. TaxID may have a multiplicity of 0 . . . 1 and may be based on datatype BGDT:PartyTaxID. TypeCode may have a multiplicity of 0 . . . 1 and may be based on datatype BGDT:BusinessObjectTypeCode. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

ServicePerformerParty includes the following node elements: ContactPerson, with a cardinality of 1:C. ContactPerson includes the following non-node elements: InternalID, BuyerID, SellerID, ProductRecipientID, VendorID, BillToID, BillFromID, BidderID, FormAddress, and FormattedName. InternalID may have a multiplicity of 0 . . . 1, is a proprietary identifier that is used when both sender and recipient can access shared master data, and may be based on datatype BGDT:ContactPersonInternalID, with a qualifier of Internal. BuyerID may have a multiplicity of 0 . . . 1 and may be based on datatype BGDT:ContactPersonPartyID. SellerID may have a multiplicity of 0 . . . 1, is an identifier that is used by a SellerParty proprietarily for a location, and may be based on datatype BGDT:ContactPersonPartyID, with a qualifier of Seller. ProductRecipientID may have a multiplicity of 0 . . . 1, is an identifier that is used by a ProductRecipientParty proprietarily for a location, and may be based on datatype BGDT:ContactPersonPartyID, with a qualifier of Product Recipient. VendorID may have a multiplicity of 0 . . . 1 and may be based on datatype BGDT:ContactPersonPartyID. BillToID may have a multiplicity of 0 . . . 1 and may be based on datatype BGDT:ContactPersonPartyID. BillFromID may have a multiplicity of 0 . . . 1 and may be based on datatype BGDT:ContactPersonPartyID. BidderID may have a multiplicity of 0 . . . 1 and may be based on datatype BGDT:ContactPersonPartyID. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

The package CustomerContractPaymentInformation includes the entity CashDiscountTerms. CashDiscountTerms is typed by datatype CashDiscountTerms. The package CustomerContractPriceInformation includes the entity PriceAndTax. PriceAndTax includes the following non-node elements: NetAmount, TaxAmount, GrossAmount, PriceComponent, Description, MajorLevelOrdinalNumberValue, MinorLevelOrdinalNumberValue, TypeCode, TypeName, CategoryCode, CategoryName, PurposeCode, PurposeName, Rate, RateBaseQuantityTypeCode, RateBaseQuantityTypeName, RateBaseMeasureUnitName, CalculationBasis, CalculationBasisBaseName, CalculationBasisQuantityMeasureUnitName, CalculationBasisQuantityTypeName, CalculatedAmount, and GrossAmountIndicator.

NetAmount may have a multiplicity of 1, is a total net amount in a customer quote, and may be based on datatype CDT:Amount. TaxAmount may have a multiplicity of 0 . . . 1, is a total tax amount in a customer quote, and may be based on datatype CDT:Amount. GrossAmount may have a multiplicity of 1, is a total gross amount in a customer quote, and may be based on datatype CDT:Amount. PriceComponent may have a multiplicity of 0.*, includes one or more price components in a customer quote, and may be based on datatype FMIDT:FormPriceComponent. Description may have a multiplicity of 0 . . . 1 and may be based on datatype BGDT:Description. MajorLevelOrdinalNumberValue may have a multiplicity of 1 and may be based on datatype BGDT:OrdinalNumberValue. MinorLevelOrdinalNumberValue may have a multiplicity of 1 and may be based on datatype BGDT:OrdinalNumberValue. TypeCode may have a multiplicity of 0 . . . 1 and may be based on datatype BGDT:PriceSpecificationElementTypeCode. TypeName may have a multiplicity of 0 . . . 1 and may be based on datatype CDT:EXTENDED_Name. CategoryCode may have a multiplicity of 0 . . . 1 and may be based on datatype BGDT:PriceSpecificationElementCategoryCode. CategoryName may have a multiplicity of 0 . . . 1 and may be based on datatype CDT:EXTENDED_Name. PurposeCode may have a multiplicity of 0 . . . 1 and may be based on datatype BGDT:PriceSpecificationElementPurposeCode. PurposeName may have a multiplicity of 0 . . . 1 and may be based on datatype CDT:EXTENDED_Name. Rate may have a multiplicity of 1 and may be based on datatype AGDT:Rate. RateBaseQuantityTypeCode may have a multiplicity of 0 . . . 1 and may be based on datatype BGDT:QuantityTypeCode. RateBaseQuantityTypeName may have a multiplicity of 0 . . . 1 and may be based on datatype CDT:EXTENDED_Name. RateBaseMeasureUnitName may have a multiplicity of 0 . . . 1 and may be based on datatype CDT:EXTENDED_Name. CalculationBasis may have a multiplicity of 1 and may be based on datatype AGDT:PriceComponentCalculationBasis. CalculationBasisBaseName may have a multiplicity of 1 and may be based on datatype CDT:EXTENDED_Name. CalculationBasisQuantityMeasureUnitName may have a multiplicity of 0 . . . 1 and may be based on datatype CDT:EXTENDED_Name. CalculationBasisQuantityTypeName may have a multiplicity of 0 . . . 1 and may be based on datatype CDT:EXTENDED_Name. CalculatedAmount may have a multiplicity of 1 and may be based on datatype CDT:Amount. GrossAmountIndicator may have a multiplicity of 0 . . . 1 and may be based on datatype CDT:Indicator.

The package CustomerContractSalesTerms includes the entity SalesTerms. SalesTerms includes the following non-node elements: CustomerContractCancellationAgreementCode, CustomerContractCancellationAgreementName, CancellationRequestDateTime, RequestedCancellationDateTime, CancellationEffectiveDateTime, CancellationDateTime, CustomerInvoiceRequestCancellationScopeCode, CustomerInvoiceRequestCancellationScopeName, CustomerContractRenewalAgreementCode, and CustomerContractRenewalAgreementName. CustomerContractCancellationAgreementCode may have a multiplicity of 0 . . . 1 and may be based on datatype BGDT:CustomerContractCancellationAgreementCode. CustomerContractCancellationAgreementName may have a multiplicity of 0 . . . 1, is a name of a customer contract cancellation agreement, and may be based on datatype CDT:LANGUAGEINDEPENDENT_LONG_Name. CancellationRequestDateTime may have a multiplicity of 0 . . . 1, is a point in time at which a cancellation of a customer contract is requested, and may be based on datatype CDT:LOCAL_DateTime. RequestedCancellationDateTime may have a multiplicity of 0 . . . 1, is a point in time for which a cancellation of a customer contract is requested, and may be based on datatype CDT:LOCAL_DateTime. CancellationEffectiveDateTime may have a multiplicity of 0 . . . 1, is a point in time at which a cancellation of a customer contract comes into effect, and may be based on datatype CDT:LOCAL_DateTime. CancellationDateTime may have a multiplicity of 0 . . . 1, is a point in time at which a customer contract is cancelled, and may be based on datatype CDT:LOCAL_DateTime. CustomerInvoiceRequestCancellationScopeCode may have a multiplicity of 0 . . . 1 and may be based on datatype BGDT:CustomerInvoiceRequestCancellationScopeCode. CustomerInvoiceRequestCancellationScopeName may have a multiplicity of 0 . . . 1, is a name of a cancellation scope code for customer invoice requests, and may be based on datatype CDT:LANGUAGEINDEPENDENT_LONG_Name. CustomerContractRenewalAgreementCode may have a multiplicity of 0 . . . 1 and may be based on datatype BGDT:CustomerContractRenewalAgreementCode. CustomerContractRenewalAgreementName may have a multiplicity of 0 . . . 1, is a name of a customer contract renewal agreement, and may be based on datatype CDT:LANGUAGEINDEPENDENT_LONG_Name.

The package CustomerContractServiceTerms includes the entity ServiceTerms. ServiceTerms includes the following non-node elements: ServiceLevelObjectiveID, ServiceLevelObjectiveName, ServiceLevelObjectiveDescription, and AllObjectsCoveredIndicator. ServiceLevelObjectiveID may have a multiplicity of 0 . . . 1 and may be based on datatype BGDT:ServiceLevelObjectiveID. ServiceLevelObjectiveName may have a multiplicity of 0 . . . 1 and may be based on datatype CDT:LANGUAGEINDEPENDENT_MEDIUM_Name. ServiceLevelObjectiveDescription may have a multiplicity of 0 . . . 1 and may be based on datatype BGDT:LONG_Description. AllObjectsCoveredIndicator may have a multiplicity of 0 . . . 1, is an indicator that specifies whether all objects are covered by a customer contract, and may be based on datatype CDT:Indicator.

The package CustomerContractCoveredObject includes the entities NonIndividualCoveredObject and IndividualCoveredObject. NonIndividualCoveredObject is a covered object that is not an individual object. NonIndividualCoveredObject includes the following non-node elements: ProductID, ProductTypeCode, ProductTypeName, ProductidentifierTypeCode, ProductidentifierTypeName, ProductCategoryHierarchyID, ProductCategoryInternalID, and Description. ProductID may have a multiplicity of 0 . . . 1, is an identifier for a non-individual product covered by a customer contract, and may be based on datatype BGDT:ProductID. ProductTypeCode may have a multiplicity of 0 . . . 1, is a coded representation of a product type of a non-individual product covered by a customer contract, and may be based on datatype BGDT:ProductTypeCode. ProductTypeName may have a multiplicity of 0 . . . 1, is a name of a product type of a non-individual product covered by a customer contract, and may be based on datatype CDT:LANGUAGEINDEPENDENT_MEDIUM_Name. ProductidentifierTypeCode may have a multiplicity of 0 . . . 1, is a coded representation of a product identifier type of a non-individual product covered by a customer contract, and may be based on datatype BGDT:ProductidentifierTypeCode. ProductidentifierTypeName may have a multiplicity of 0 . . . 1, is a name of a product identifier type of a non-individual product covered by a customer contract, and may be based on datatype CDT:LANGUAGEINDEPENDENT_MEDIUM_Name. ProductCategoryHierarchyID may have a multiplicity of 0 . . . 1, is an identifier for a product category hierarchy of a product category covered by a customer contract, and may be based on datatype BGDT:ProductCategoryHierarchyID. ProductCategoryInternalID may have a multiplicity of 0 . . . 1, is an identifier for a product category covered by a customer contract, and may be based on datatype BGDT:ProductCategoryInternalID. Description may have a multiplicity of 0 . . . 1, is a description of an object covered by a customer contract, and may be based on datatype BGDT:MEDIUM_Description.

IndividualCoveredObject is a covered object that is an individual object. IndividualCoveredObject includes the following non-node elements: IndividualProductID, IndividualProductTypeCode, IndividualProductTypeName, IndividualProductidentifierTypeCode, IndividualProductidentifierTypeName, Description, IndividualProductReferencedProductID, IndividualProductReferencedProductTypeCode, IndividualProductReferencedProductTypeName, IndividualProductReferencedProductidentifierTypeCode, IndividualProductReferencedProductidentifierTypeName, and IndividualProductReferencedProductDescription. IndividualProductID may have a multiplicity of 0 . . . 1, is an identifier for an individual product covered by a customer contract, and may be based on datatype BGDT:ProductID. IndividualProductTypeCode may have a multiplicity of 0 . . . 1, is a coded representation of a product type of an individual product covered by a customer contract, and may be based on datatype BGDT:ProductTypeCode. IndividualProductTypeName may have a multiplicity of 0 . . . 1, is a name of a product type of an individual product covered by a customer contract, and may be based on datatype CDT:LANGUAGEINDEPENDENT_MEDIUM_Name. IndividualProductidentifierTypeCode may have a multiplicity of 0 . . . 1, is a coded representation of a product identifier type of an individual product covered by a customer contract, and may be based on datatype BGDT:ProductidentifierTypeCode. IndividualProductidentifierTypeName may have a multiplicity of 0 . . . 1, is a name of a product identifier type of an individual product covered by a customer contract, and may be based on datatype CDT:LANGUAGEINDEPENDENT_MEDIUM_Name. Description may have a multiplicity of 0 . . . 1, is a description of an individual product as a covered object in a customer contract, and may be based on datatype BGDT:MEDIUM_Description. IndividualProductReferencedProductID may have a multiplicity of 0 . . . 1, is an identifier for a reference product of an individual product covered by a customer contract, and may be based on datatype BGDT:ProductID. IndividualProductReferencedProductTypeCode may have a multiplicity of 0 . . . 1, is a coded representation of a product type of a reference product of a non-individual product covered by a customer contract, and may be based on datatype BGDT:ProductTypeCode. IndividualProductReferencedProductTypeName may have a multiplicity of 0 . . . 1, is a name of a product type of a reference product of an individual product covered by a customer contract, and may be based on datatype CDT:LANGUAGEINDEPENDENT_MEDIUM_Name. IndividualProductReferencedProductidentifierTypeCode may have a multiplicity of 0 . . . 1, is a coded representation of a product identifier type of a reference product of an individual product covered by a customer contract, and may be based on datatype BGDT:ProductidentifierTypeCode. IndividualProductReferencedProductidentifierTypeName may have a multiplicity of 0 . . . 1, is a name of a product identifier type of a reference product of an individual product covered by a customer contract, and may be based on datatype CDT:LANGUAGEINDEPENDENT_MEDIUM_Name. IndividualProductReferencedProductDescription may have a multiplicity of 0 . . . 1, is a description of a reference product of an individual product covered by a customer contract, and may be based on datatype BGDT:MEDIUM_Description.

The package CustomerContractDescription includes the entity TextCollection. TextCollection is a collection of natural-language texts with additional information about a customer contract. TextCollection includes the following non-node elements: Text, TypeCode, TypeName, SystemAdministrativeData, CreationDateTime, CreationIdentityUUID, CreationUserAccountID, CreationBusinessPartnerFormattedName, LastChangeDateTime, LastChangeIdentityUUID, LastChangeUserAccountID, LastChangeBusinessPartnerFormattedName, CreationDateTime, and ContentText. Text may have a multiplicity of 0 . . . * and may be based on datatype FMIDT:FormTextCollectionText. TypeCode may have a multiplicity of 0 . . . 1 and may be based on datatype BGDT:TextCollectionTextTypeCode. TypeName may have a multiplicity of 0 . . . 1 and may be based on datatype CDT:LANGUAGEINDEPENDENT_MEDIUM_Name. SystemAdministrativeData may have a multiplicity of 0 . . . 1 and may be based on datatype FMIDT:FormSystemAdministrativeData. CreationDateTime may have a multiplicity of 1 and may be based on datatype CDT:LOCAL_DateTime. CreationIdentityUUID may have a multiplicity of 0 . . . 1 and may be based on datatype BGDT:UUID. CreationUserAccountID may have a multiplicity of 0 . . . 1 and may be based on datatype BGDT:UserAccountID. CreationBusinessPartnerFormattedName may have a multiplicity of 0 . . . 1 and may be based on datatype CDT:LANGUAGEINDEPENDENT_LONG_Name. LastChangeDateTime may have a multiplicity of 0 . . . 1 and may be based on datatype CDT:LOCAL_DateTime. LastChangeIdentityUUID may have a multiplicity of 0 . . . 1 and may be based on datatype BGDT:UUID. LastChangeUserAccountID may have a multiplicity of 0 . . . 1 and may be based on datatype BGDT:UserAccountID. LastChangeBusinessPartnerFormattedName may have a multiplicity of 0 . . . 1 and may be based on datatype CDT:LANGUAGEINDEPENDENT_LONG_Name. CreationDateTime may have a multiplicity of 0 . . . 1 and may be based on datatype CDT:LOCAL_DateTime. ContentText may have a multiplicity of 1 and may be based on datatype CDT:Text.

The package CustomerContractItem includes the sub-packages InvoiceSchedule, ProductInformation, PriceInformation, Party, and Description, and the entity Item. Item includes the following non-node elements: ID, Quantity, QuantityMeasureUnitName, Description, ValidityPeriodStartDate, ValidityPeriodStartDateTime, ValidityPeriodEndDate, ValidityPeriodEndDateTime, Date, DateTime, CustomerContractLifeCycleStatusCode, and CustomerContractLifeCycleStatusName. ID may have a multiplicity of 0 . . . 1, is an identifier for a customer contract item, and may be based on datatype BGDT:BusinessTransactionDocumentItemID Quantity may have a multiplicity of 0 . . . 1, is a quantity of a customer contract item, and may be based on datatype CDT:Quantity. QuantityMeasureUnitName may have a multiplicity of 0 . . . 1, is a unit of measure of a customer contract item quantity, and may be based on datatype CDT:Name. Description may have a multiplicity of 0 . . . 1, is a description of a customer contract item, and may be based on datatype BGDT:SHORT_Description. ValidityPeriodStartDate may have a multiplicity of 0 . . . 1 and may be based on datatype CDT:Date. ValidityPeriodStartDateTime may have a multiplicity of 0 . . . 1 and may be based on datatype CDT:LOCAL_DateTime. ValidityPeriodEndDate may have a multiplicity of 0 . . . 1 and may be based on datatype CDT:Date. ValidityPeriodEndDateTime may have a multiplicity of 0 . . . 1 and may be based on datatype CDT:LOCAL_DateTime. Date may have a multiplicity of 0 . . . 1, is a date on which a customer contract item is created, and may be based on datatype CDT:Date. DateTime may have a multiplicity of 0 . . . 1, is a point in time at which a customer contract item is created, and may be based on datatype CDT:LOCAL_DateTime. CustomerContractLifeCycleStatusCode may have a multiplicity of 0 . . . 1 and may be based on datatype BGDT:CustomerContractLifeCycleStatusCode_V1. CustomerContractLifeCycleStatusName may have a multiplicity of 0 . . . 1 and may be based on datatype CDT:LANGUAGEINDEPENDENT_LONG_Name.

Item includes the following node elements: InvoiceSchedule, with a cardinality of 1:CN; InvoiceScheduleAssignedIndicator, with a cardinality of 1:C; Product, with a cardinality of 1:C; PriceAndTax, with a cardinality of 1:C; PricingTerms, with a cardinality of 1:C; ProductRecipientParty, with a cardinality of 1:C; VendorParty, with a cardinality of 1:C; ServicePerformerParty, with a cardinality of 1:C; and TextCollection, with a cardinality of 1:C.

The package CustomerContractItemInvoiceSchedule includes the entities InvoiceSchedule and InvoiceScheduleAssignedIndicator. InvoiceScheduleAssignedIndicator is an indicator that specifies whether an invoice schedule is assigned to a customer contract item. InvoiceScheduleAssignedIndicator can be typed by datatype Indicator. InvoiceSchedule is an invoice schedule assigned to a customer contract item. InvoiceSchedule includes the following non-node elements: ProposedInvoiceDate, ProjectMilestoneID, ProjectMilestoneName, Percent, Amount, AmountCurrencyName, Quantity, QuantityMeasureUnitCodeName, QuantityTypeCode, and QuantityTypeCodeName. ProposedInvoiceDate may have a multiplicity of 0 . . . 1 and may be based on datatype CDT:Date. ProjectMilestoneID may have a multiplicity of 0 . . . 1 and may be based on datatype BGDT:ProjectElementID. ProjectMilestoneName may have a multiplicity of 0 . . . 1 and may be based on datatype CDT:MEDIUM_Name. Percent may have a multiplicity of 0 . . . 1 and may be based on datatype CDT:Percent. Amount may have a multiplicity of 0 . . . 1 and may be based on datatype CDT:Amount. AmountCurrencyName may have a multiplicity of 0 . . . 1 and may be based on datatype CDT:MEDIUM_Name. Quantity may have a multiplicity of 0 . . . 1 and may be based on datatype CDT:Quantity. QuantityMeasureUnitCodeName may have a multiplicity of 0 . . . 1 and may be based on datatype CDT:Name. QuantityTypeCode may have a multiplicity of 0 . . . 1 and may be based on datatype BGDT:QuantityTypeCode. QuantityTypeCodeName may have a multiplicity of 0 . . . 1 and may be based on datatype CDT:Name.

The package CustomerContractItemProductInformation includes the entity Product. Product includes the following non-node elements: InternalID, StandardID, BuyerID, SellerID, ProductRecipientID, VendorID, ManufacturerID, BillToID, BillFromID, BidderID, TypeCode, TypeName, and Note. InternalID may have a multiplicity of 0 . . . 1 and may be based on datatype BGDT:ProductInternalID. StandardID may have a multiplicity of 0 . . . * and may be based on datatype BGDT:ProductStandardID. BuyerID may have a multiplicity of 0 . . . 1 and may be based on datatype BGDT:ProductPartyID. SellerID may have a multiplicity of 0 . . . 1 and may be based on datatype BGDT:ProductPartyID. ProductRecipientID may have a multiplicity of 0 . . . 1 and may be based on datatype BGDT:ProductPartyID. VendorID may have a multiplicity of 0 . . . 1 and may be based on datatype BGDT:ProductPartyID. ManufacturerID may have a multiplicity of 0 . . . 1 and may be based on datatype BGDT:ProductPartyID. BillToID may have a multiplicity of 0 . . . 1 and may be based on datatype BGDT:ProductPartyID. BillFromID may have a multiplicity of 0 . . . 1 and may be based on datatype BGDT:ProductPartyID. BidderID may have a multiplicity of 0 . . . 1 and may be based on datatype BGDT:ProductPartyID. TypeCode may have a multiplicity of 0 . . . 1 and may be based on datatype BGDT:ProductTypeCode. TypeName may have a multiplicity of 0 . . . 1 and may be based on datatype CDT:Name. Note may have a multiplicity of 0 . . . 1 and may be based on datatype BGDT:Note.

The package CustomerContractItemPriceInformation includes the entities PriceAndTax and PricingTerms. PricingTerms includes the PricePerPeriodIndicator non-node element, which may have a multiplicity of 0 . . . 1 and may be based on datatype CDT:Indicator. PriceAndTax includes the following non-node elements: NetAmount, TaxAmount, GrossAmount, PriceComponent, Description, Maj or LevelOrdinalNumberValue, MinorLevelOrdinalNumberValue, TypeCode, TypeName, CategoryCode, CategoryName, PurposeCode, PurposeName, Rate, RateBaseQuantityTypeCode, RateBaseQuantityTypeName, RateBaseMeasureUnitName, CalculationBasis, CalculationBasisBaseName, CalculationBasisQuantityMeasureUnitName, CalculationBasisQuantityTypeName, CalculatedAmount, NetPrice, Amount, BaseQuantity, BaseQuantityTypeCode, and BaseQuantityMeasureUnitName. NetAmount may have a multiplicity of 1, is a total net amount in a customer quote, and may be based on datatype CDT:Amount. TaxAmount may have a multiplicity of 0 . . . 1, is a total tax amount in a customer quote, and may be based on datatype CDT:Amount. GrossAmount may have a multiplicity of 1, is a total gross amount in a customer quote, and may be based on datatype CDT:Amount. PriceComponent may have a multiplicity of 0.*, includes price components in a customer quote, and may be based on datatype FMIDT:FormPriceComponent. Description may have a multiplicity of 0 . . . 1 and may be based on datatype BGDT:Description. MajorLevelOrdinalNumberValue may have a multiplicity of 1 and may be based on datatype BGDT:OrdinalNumberValue. MinorLevelOrdinalNumberValue may have a multiplicity of 1 and may be based on datatype BGDT:OrdinalNumberValue. TypeCode may have a multiplicity of 0 . . . 1 and may be based on datatype BGDT:PriceSpecificationElementTypeCode. TypeName may have a multiplicity of 0 . . . 1 and may be based on datatype CDT:EXTENDED_Name. CategoryCode may have a multiplicity of 0 . . . 1 and may be based on datatype BGDT:PriceSpecificationElementCategoryCode. CategoryName may have a multiplicity of 0 . . . 1 and may be based on datatype CDT:EXTENDED_Name. PurposeCode may have a multiplicity of 0 . . . 1 and may be based on datatype BGDT:PriceSpecificationElementPurposeCode. PurposeName may have a multiplicity of 0 . . . 1 and may be based on datatype CDT:EXTENDED_Name. Rate may have a multiplicity of 1 and may be based on datatype AGDT:Rate. RateBaseQuantityTypeCode may have a multiplicity of 0 . . . 1 and may be based on datatype BGDT:QuantityTypeCode. RateBaseQuantityTypeName may have a multiplicity of 0 . . . 1 and may be based on datatype CDT:EXTENDED_Name. RateBaseMeasureUnitName may have a multiplicity of 0 . . . 1 and may be based on datatype CDT:EXTENDED_Name. CalculationBasis may have a multiplicity of 1 and may be based on datatype AGDT:PriceComponentCalculationBasis. CalculationBasisBaseName may have a multiplicity of 1 and may be based on datatype CDT:EXTENDED_Name. CalculationBasisQuantityMeasureUnitName may have a multiplicity of 0 . . . 1 and may be based on datatype CDT:EXTENDED_Name. CalculationBasisQuantityTypeName may have a multiplicity of 0 . . . 1 and may be based on datatype CDT:EXTENDED_Name. CalculatedAmount may have a multiplicity of 1 and may be based on datatype CDT:Amount. NetPrice may have a multiplicity of 1 and may be based on datatype FMIDT:FormPrice. Amount may have a multiplicity of 1 and may be based on datatype CDT:Amount. BaseQuantity may have a multiplicity of 1 and may be based on datatype CDT:Quantity, with a qualifier of Base. BaseQuantityTypeCode may have a multiplicity of 0 . . . 1 and may be based on datatype BGDT:QuantityTypeCode, with a qualifier of Base. BaseQuantityMeasureUnitName may have a multiplicity of 1 and may be based on datatype CDT:Name.

The package CustomerContractItemParty includes the entities ProductRecipientParty, VendorParty, and ServicePerformerParty. ProductRecipientParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormAddress, and FormattedName. InternalID may have a multiplicity of 0 . . . 1 and may be based on datatype BGDT:PartyInternalID. StandardID may have a multiplicity of 0 . . . * and may be based on datatype BGDT:PartyStandardID. BuyerID may have a multiplicity of 0 . . . 1 and may be based on datatype BGDT:PartyPartyID. SellerID may have a multiplicity of 0 . . . 1 and may be based on datatype BGDT:PartyPartyID. ProductRecipientID may have a multiplicity of 0 . . . 1 and may be based on datatype BGDT:PartyPartyID. VendorID may have a multiplicity of 0 . . . 1 and may be based on datatype BGDT:PartyPartyID. BillToID may have a multiplicity of 0 . . . 1 and may be based on datatype BGDT:PartyPartyID. BillFromID may have a multiplicity of 0 . . . 1 and may be based on datatype BGDT:PartyPartyID. BidderID may have a multiplicity of 0 . . . 1 and may be based on datatype BGDT:PartyPartyID. PaymentTransactionInitiatorID may have a multiplicity of 0 . . . 1 and may be based on datatype BGDT:PartyPartyID. PaymentTransactionDestinatedID may have a multiplicity of 0 . . . 1 and may be based on datatype BGDT:PartyPartyID. TaxID may have a multiplicity of 0 . . . 1 and may be based on datatype BGDT:PartyTaxID. TypeCode may have a multiplicity of 0 . . . 1 and may be based on datatype BGDT:BusinessObjectTypeCode. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

ProductRecipientParty includes the following node elements: ContactPerson, with a cardinality of 1:C. ContactPerson includes the following non-node elements: InternalID, BuyerID, SellerID, ProductRecipientID, VendorID, BillToID, BillFromID, BidderID, FormAddress, and FormattedName. InternalID may have a multiplicity of 0 . . . 1, is a proprietary identifier that is used when both sender and recipient can access shared master data, and may be based on datatype BGDT:ContactPersonInternalID, with a qualifier of Internal. BuyerID may have a multiplicity of 0 . . . 1 and may be based on datatype BGDT:ContactPersonPartyID. SellerID may have a multiplicity of 0 . . . 1, is an identifier that is used by a SellerParty proprietarily for a location, and may be based on datatype BGDT:ContactPersonPartyID, with a qualifier of Seller. ProductRecipientID may have a multiplicity of 0 . . . 1, is an identifier that is used by a ProductRecipientParty proprietarily for a location, and may be based on datatype BGDT:ContactPersonPartyID, with a qualifier of Product Recipient. VendorID may have a multiplicity of 0 . . . 1 and may be based on datatype BGDT:ContactPersonPartyID. BillToID may have a multiplicity of 0 . . . 1 and may be based on datatype BGDT:ContactPersonPartyID. BillFromID may have a multiplicity of 0 . . . 1 and may be based on datatype BGDT:ContactPersonPartyID. BidderID may have a multiplicity of 0 . . . 1 and may be based on datatype BGDT:ContactPersonPartyID. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

VendorParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormAddress, and FormattedName. InternalID may have a multiplicity of 0 . . . 1 and may be based on datatype BGDT:PartyInternalID. StandardID may have a multiplicity of 0 . . . * and may be based on datatype BGDT:PartyStandardID. BuyerID may have a multiplicity of 0 . . . 1 and may be based on datatype BGDT:PartyPartyID. SellerID may have a multiplicity of 0 . . . 1 and may be based on datatype BGDT:PartyPartyID. ProductRecipientID may have a multiplicity of 0 . . . 1 and may be based on datatype BGDT:PartyPartyID. VendorID may have a multiplicity of 0 . . . 1 and may be based on datatype BGDT:PartyPartyID. BillToID may have a multiplicity of 0 . . . 1 and may be based on datatype BGDT:PartyPartyID. BillFromID may have a multiplicity of 0 . . . 1 and may be based on datatype BGDT:PartyPartyID. BidderID may have a multiplicity of 0 . . . 1 and may be based on datatype BGDT:PartyPartyID. PaymentTransactionInitiatorID may have a multiplicity of 0 . . . 1 and may be based on datatype BGDT:PartyPartyID. PaymentTransactionDestinatedID may have a multiplicity of 0 . . . 1 and may be based on datatype BGDT:PartyPartyID. TaxID may have a multiplicity of 0 . . . 1 and may be based on datatype BGDT:PartyTaxID. TypeCode may have a multiplicity of 0 . . . 1 and may be based on datatype BGDT:BusinessObjectTypeCode. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

VendorParty includes the following node elements: ContactPerson, with a cardinality of 1:C. ContactPerson includes the following non-node elements: InternalID, BuyerID, SellerID, ProductRecipientID, VendorID, BillToID, BillFromID, BidderID, FormAddress, and FormattedName. InternalID may have a multiplicity of 0 . . . 1, is a proprietary identifier that is used when both sender and recipient can access shared master data, and may be based on datatype BGDT:ContactPersonInternalID, with a qualifier of Internal. BuyerID may have a multiplicity of 0 . . . 1 and may be based on datatype BGDT:ContactPersonPartyID. SellerID may have a multiplicity of 0 . . . 1, is an identifier that is used by a SellerParty proprietarily for a location, and may be based on datatype BGDT:ContactPersonPartyID, with a qualifier of Seller. ProductRecipientID may have a multiplicity of 0 . . . 1, is an identifier that is used by a ProductRecipientParty proprietarily for a location, and may be based on datatype BGDT:ContactPersonPartyID, with a qualifier of Product Recipient. VendorID may have a multiplicity of 0 . . . 1 and may be based on datatype BGDT:ContactPersonPartyID. BillToID may have a multiplicity of 0 . . . 1 and may be based on datatype BGDT:ContactPersonPartyID. BillFromID may have a multiplicity of 0 . . . 1 and may be based on datatype BGDT:ContactPersonPartyID. BidderID may have a multiplicity of 0 . . . 1 and may be based on datatype BGDT:ContactPersonPartyID. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

ServicePerformerParty includes the following non-node elements: InternalID, StandardID, BuyerID, SellerID, ProductRecipientID, VendorID, BillToID, BillFromID, BidderID, PaymentTransactionInitiatorID, PaymentTransactionDestinatedID, TaxID, TypeCode, FormAddress, and FormattedName. InternalID may have a multiplicity of 0 . . . 1 and may be based on datatype BGDT:PartyInternalID. StandardID may have a multiplicity of 0 . . . * and may be based on datatype BGDT:PartyStandardID. BuyerID may have a multiplicity of 0 . . . 1 and may be based on datatype BGDT:PartyPartyID. SellerID may have a multiplicity of 0 . . . 1 and may be based on datatype BGDT:PartyPartyID. ProductRecipientID may have a multiplicity of 0 . . . 1 and may be based on datatype BGDT:PartyPartyID. VendorID may have a multiplicity of 0 . . . 1 and may be based on datatype BGDT:PartyPartyID. BillToID may have a multiplicity of 0 . . . 1 and may be based on datatype BGDT:PartyPartyID. BillFromID may have a multiplicity of 0 . . . 1 and may be based on datatype BGDT:PartyPartyID. BidderID may have a multiplicity of 0 . . . 1 and may be based on datatype BGDT:PartyPartyID. PaymentTransactionInitiatorID may have a multiplicity of 0 . . . 1 and may be based on datatype BGDT:PartyPartyID. PaymentTransactionDestinatedID may have a multiplicity of 0 . . . 1 and may be based on datatype BGDT:PartyPartyID. TaxID may have a multiplicity of 0 . . . 1 and may be based on datatype BGDT:PartyTaxID. TypeCode may have a multiplicity of 0 . . . 1 and may be based on datatype BGDT:BusinessObjectTypeCode. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

ServicePerformerParty includes the following node elements: ContactPerson, with a cardinality of 1:C. ContactPerson includes the following non-node elements: InternalID, BuyerID, SellerID, ProductRecipientID, VendorID, BillToID, BillFromID, BidderID, FormAddress, and FormattedName. InternalID may have a multiplicity of 0 . . . 1, is a proprietary identifier that is used when both sender and recipient can access shared master data, and may be based on datatype BGDT:ContactPersonInternalID, with a qualifier of Internal. BuyerID may have a multiplicity of 0 . . . 1 and may be based on datatype BGDT:ContactPersonPartyID. SellerID may have a multiplicity of 0 . . . 1, is an identifier that is used by a SellerParty proprietarily for a location, and may be based on datatype BGDT:ContactPersonPartyID, with a qualifier of Seller. ProductRecipientID may have a multiplicity of 0 . . . 1, is an identifier that is used by a ProductRecipientParty proprietarily for a location, and may be based on datatype BGDT:ContactPersonPartyID, with a qualifier of Product Recipient. VendorID may have a multiplicity of 0 . . . 1 and may be based on datatype BGDT:ContactPersonPartyID. BillToID may have a multiplicity of 0 . . . 1 and may be based on datatype BGDT:ContactPersonPartyID. BillFromID may have a multiplicity of 0 . . . 1 and may be based on datatype BGDT:ContactPersonPartyID. BidderID may have a multiplicity of 0 . . . 1 and may be based on datatype BGDT:ContactPersonPartyID. FormAddress may have a multiplicity of 0 . . . 1 and may be based on datatype AGDT:FormAddress. FormattedName may have a multiplicity of 0 . . . 1 and may be based on datatype CDT:LANGUAGEINDEPENDENT_LONG_Name.

The package CustomerContractItemDescription includes the entity TextCollection. TextCollection is a collection of natural-language texts with additional information about a customer contract item. TextCollection includes the following non-node elements: Text, TypeCode, TypeName, SystemAdministrativeData, CreationDateTime, CreationIdentityUUID, CreationUserAccountID, CreationBusinessPartnerFormattedName, LastChangeDateTime, LastChangeIdentityUUID, LastChangeUserAccountID, LastChangeBusinessPartnerFormattedName, CreationDateTime, and ContentText. Text may have a multiplicity of 0 . . . * and may be based on datatype FMIDT:FormTextCollectionText. TypeCode may have a multiplicity of 0 . . . 1 and may be based on datatype BGDT:TextCollectionTextTypeCode. TypeName may have a multiplicity of 0 . . . 1 and may be based on datatype CDT:LANGUAGEINDEPENDENT_MEDIUM_Name. SystemAdministrativeData may have a multiplicity of 0 . . . 1 and may be based on datatype FMIDT:FormSystemAdministrativeData. CreationDateTime may have a multiplicity of 1 and may be based on datatype CDT:LOCAL_DateTime. CreationIdentityUUID may have a multiplicity of 0 . . . 1 and may be based on datatype BGDT:UUID. CreationUserAccountID may have a multiplicity of 0 . . . 1 and may be based on datatype BGDT:UserAccountID. CreationBusinessPartnerFormattedName may have a multiplicity of 0 . . . 1 and may be based on datatype CDT:LANGUAGEINDEPENDENT_LONG_Name. LastChangeDateTime may have a multiplicity of 0 . . . 1 and may be based on datatype CDT:LOCAL_DateTime. LastChangeIdentityUUID may have a multiplicity of 0 . . . 1 and may be based on datatype BGDT:UUID. LastChangeUserAccountID may have a multiplicity of 0 . . . 1 and may be based on datatype BGDT:UserAccountID. LastChangeBusinessPartnerFormattedName may have a multiplicity of 0 . . . 1 and may be based on datatype CDT:LANGUAGEINDEPENDENT_LONG_Name. CreationDateTime may have a multiplicity of 0 . . . 1 and may be based on datatype CDT:LOCAL_DateTime. ContentText may have a multiplicity of 1 and may be based on datatype CDT:Text.

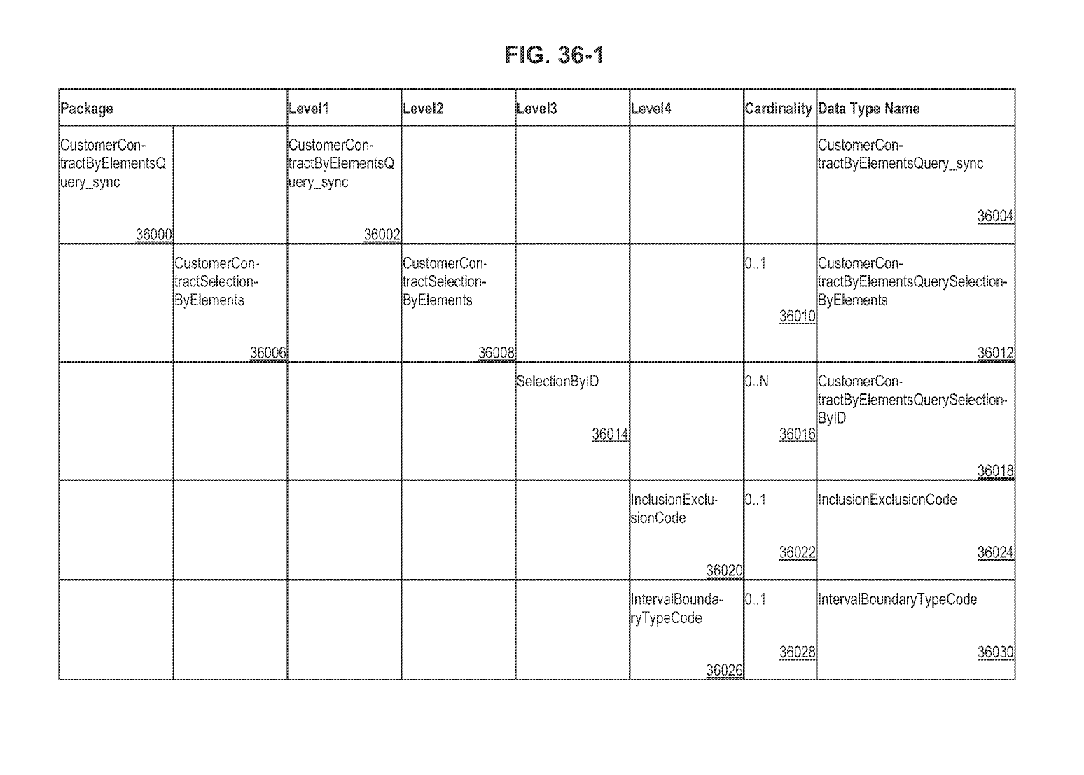

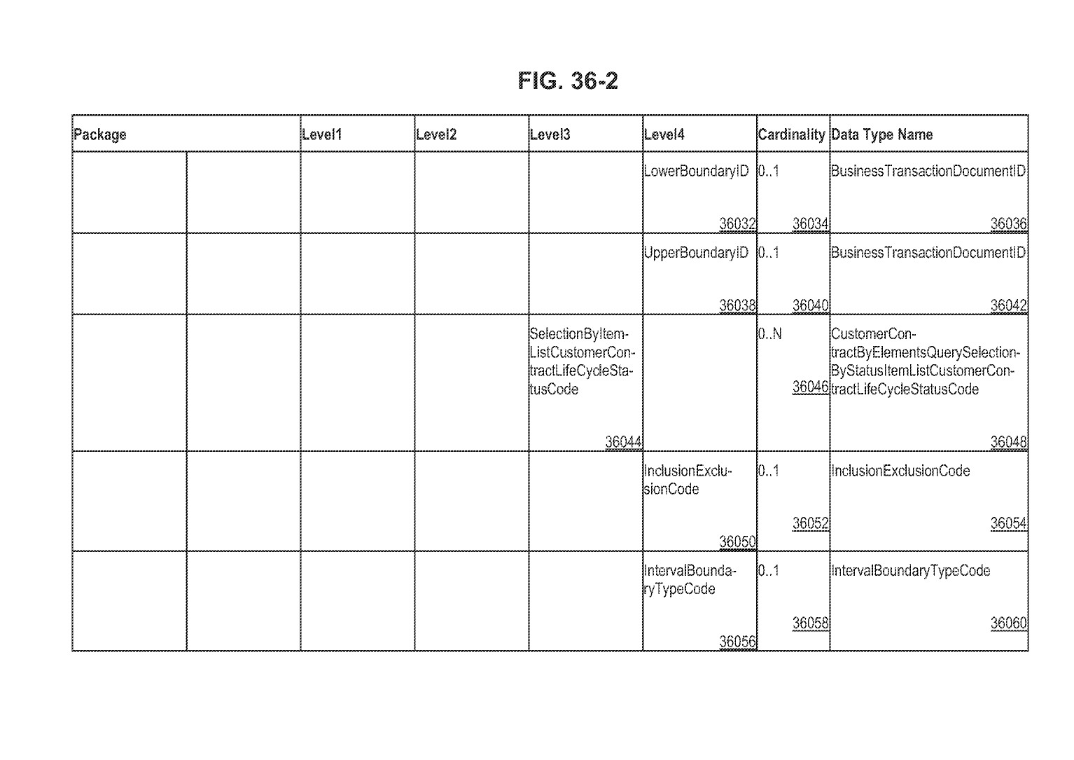

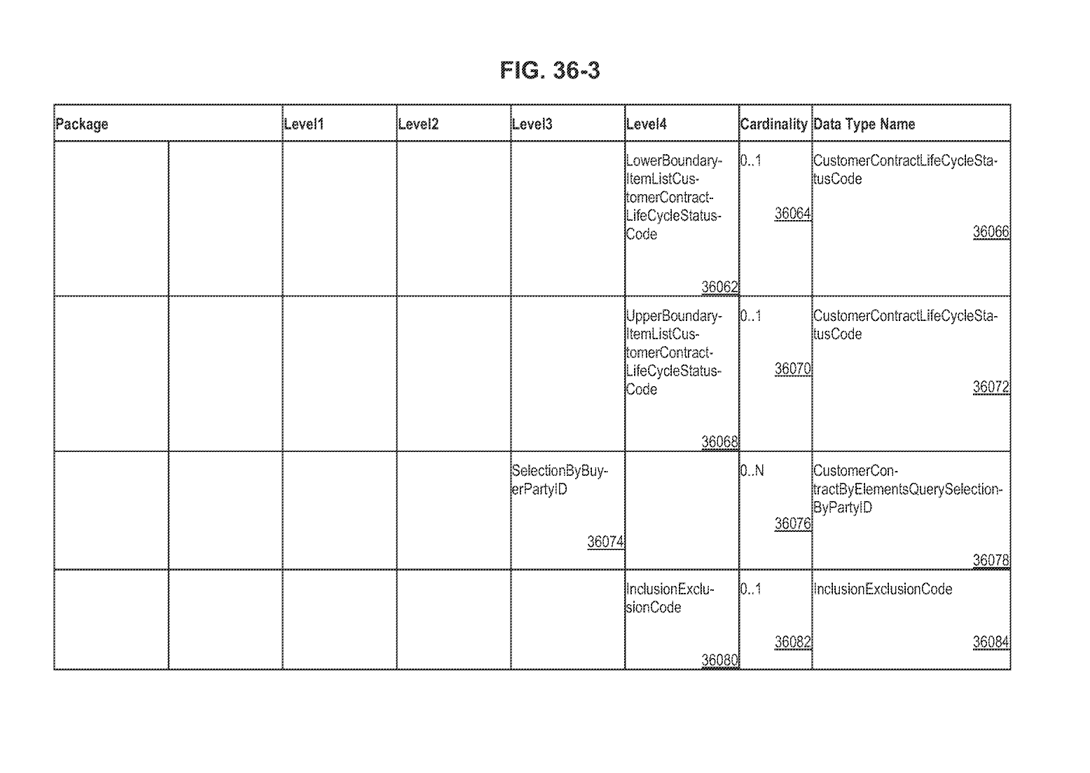

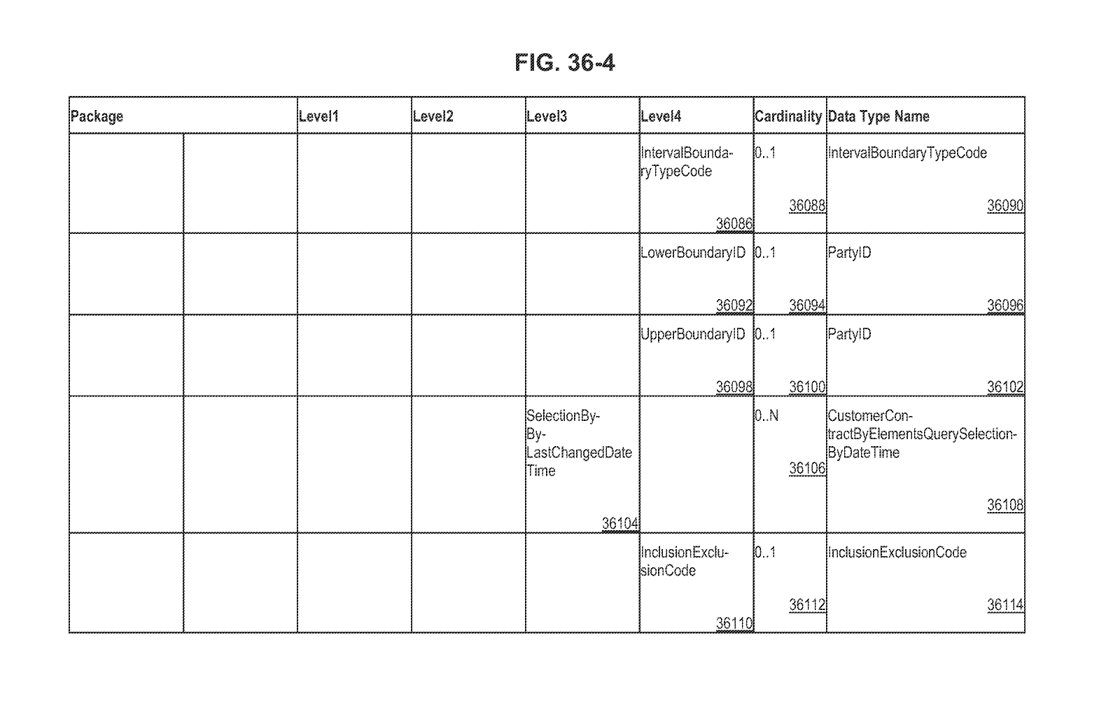

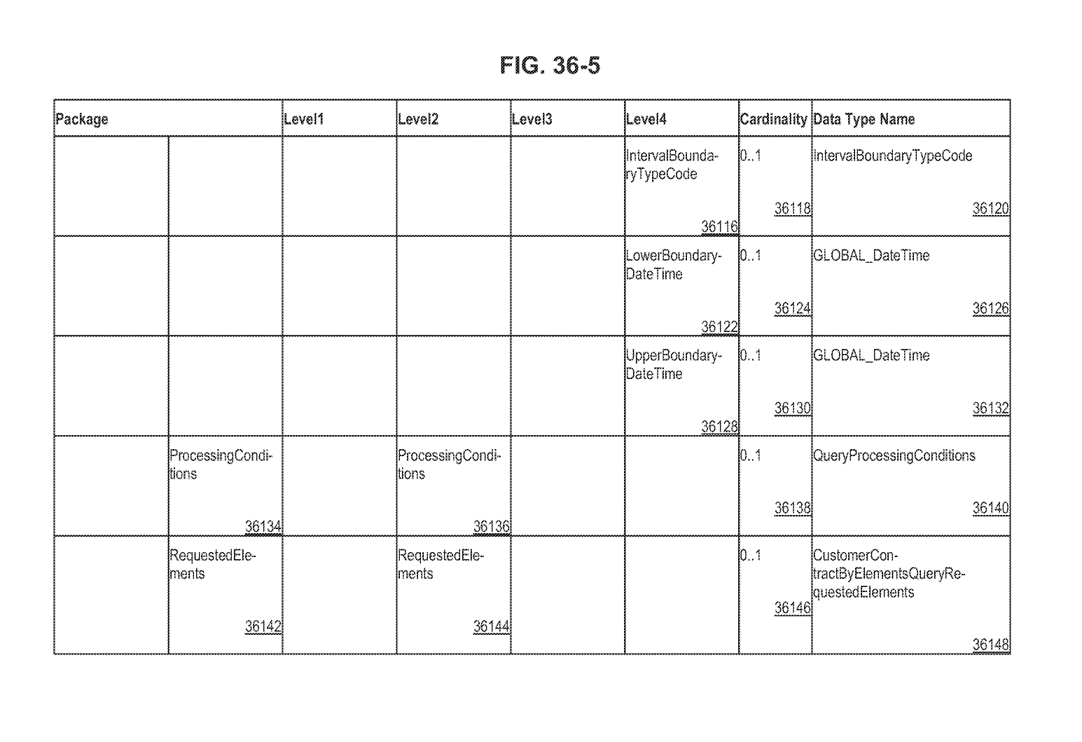

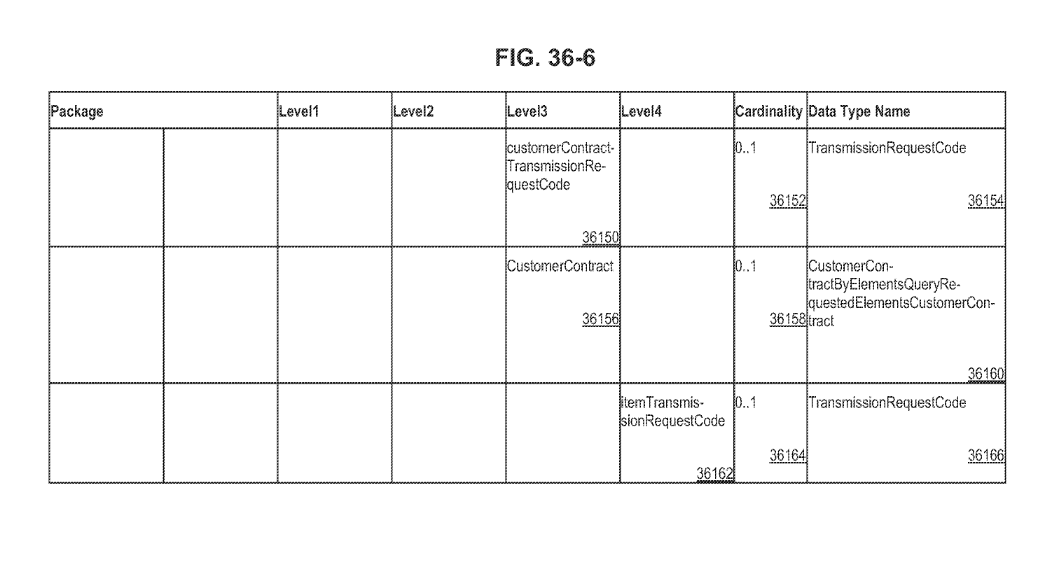

FIGS. 36-1 through 36-6 show an example configuration of an Element Structure that includes a CustomerContractByElementsQuerysync 36000 package. Specifically, these figures depict the arrangement and hierarchy of various components such as one or more levels of packages, entities, and datatypes, shown here as 36000 through 36166. As described above, packages may be used to represent hierarchy levels. Entities are discrete business elements that are used during a business transaction. Data types are used to type object entities and interfaces with a structure. For example, the CustomerContractByElementsQuery_sync 36000 includes, among other things, a CustomerContractByElementsQuery_sync 36002. Accordingly, heterogeneous applications may communicate using this consistent message configured as such.

The CustomerContractByElementsQuerysync 36000 package is a CustomerContractByElementsQuery_sync 36004 data type. The CustomerContractByElementsQuery_sync 36000 package includes a CustomerContractByElementsQuery_sync 36002 entity. The CustomerContractByElementsQuery_sync 36000 package includes various packages, namely a CustomerContractSelectionByElements 36006, a ProcessingConditions 36134 and a RequestedElements 36142.

The CustomerContractSelectionByElements 36006 package is a CustomerContractByElementsQuerySelectionByElements 36012 data type. The CustomerContractSelectionByElements 36006 package includes a CustomerContractSelectionByElements 36008 entity. The CustomerContractSelectionByElements 36008 entity has a cardinality of 0 . . . 1 36010 meaning that for each instance of the CustomerContractSelectionByElements 36006 package there may be one CustomerContractSelectionByElements 36008 entity. The CustomerContractSelectionByElements 36008 entity includes various subordinate entities, namely a SelectionByID 36014, a SelectionByItemListCustomerContractLifeCycleStatusCode 36044, a SelectionByBuyerPartyID 36074 and a SelectionByLastChangedDateTime 36104.

The SelectionByID 36014 entity has a cardinality of 0 . . . N 36016 meaning that for each instance of the CustomerContractSelectionByElements 36008 entity there may be one or more SelectionByID 36014 entities. The SelectionByID 36014 entity includes various attributes, namely an InclusionExclusionCode 36020, an IntervalBoundaryTypeCode 36026, a LowerBoundaryID 36032 and an UpperBoundaryID 36038.

The InclusionExclusionCode 36020 attribute is an InclusionExclusionCode 36024 data type. The InclusionExclusionCode 36020 attribute has a cardinality of 0 . . . 1 36022 meaning that for each instance of the SelectionByID 36014 entity there may be one InclusionExclusionCode 36020 attribute. The IntervalBoundaryTypeCode 36026 attribute is an IntervalBoundaryTypeCode 36030 data type. The IntervalBoundaryTypeCode 36026 attribute has a cardinality of 0 . . . 1 36028 meaning that for each instance of the SelectionByID 36014 entity there may be one IntervalBoundaryTypeCode 36026 attribute.

The LowerBoundaryID 36032 attribute is a BusinessTransactionDocumentID 36036 data type. The LowerBoundaryID 36032 attribute has a cardinality of 0 . . . 1 36034 meaning that for each instance of the SelectionByID 36014 entity there may be one LowerBoundaryID 36032 attribute. The UpperBoundaryID 36038 attribute is a BusinessTransactionDocumentID 36042 data type. The UpperBoundaryID 36038 attribute has a cardinality of 0 . . . 1 36040 meaning that for each instance of the SelectionByID 36014 entity there may be one UpperBoundaryID 36038 attribute.

The SelectionByItemListCustomerContractLifeCycleStatusCode 36044 entity has a cardinality of 0 . . . N 36046 meaning that for each instance of the CustomerContractSelectionByElements 36008 entity there may be one or more SelectionByhemListCustomerContractLifeCycleStatusCode 36044 entities. The SelectionByItemListCustomerContractLifeCycleStatusCode 36044 entity includes various attributes, namely an InclusionExclusionCode 36050, an IntervalBoundaryTypeCode 36056, a LowerBoundaryhemListCustomerContractLifeCycleStatusCode 36062 and an UpperBoundaryItemListCustomerContractLifeCycleStatusCode 36068.

The InclusionExclusionCode 36050 attribute is an InclusionExclusionCode 36054 data type. The InclusionExclusionCode 36050 attribute has a cardinality of 0 . . . 1 36052 meaning that for each instance of the SelectionByItemListCustomerContractLifeCycleStatusCode 36044 entity there may be one InclusionExclusionCode 36050 attribute. The IntervalBoundaryTypeCode 36056 attribute is an IntervalBoundaryTypeCode 36060 data type. The IntervalBoundaryTypeCode 36056 attribute has a cardinality of 0 . . . 1 36058 meaning that for each instance of the SelectionByItemListCustomerContractLifeCycleStatusCode 36044 entity there may be one IntervalBoundaryTypeCode 36056 attribute.

The LowerBoundaryItemListCustomerContractLifeCycleStatusCode 36062 attribute is a CustomerContractLifeCycleStatusCode 36066 data type. The LowerBoundaryhemListCustomerContractLifeCycleStatusCode 36062 attribute has a cardinality of 0 . . . 1 36064 meaning that for each instance of the SelectionByhemListCustomerContractLifeCycleStatusCode 36044 entity there may be one LowerBoundaryhemListCustomerContractLifeCycleStatusCode 36062 attribute. The UpperBoundaryItemListCustomerContractLifeCycleStatusCode 36068 attribute is a CustomerContractLifeCycleStatusCode 36072 data type. The UpperBoundaryItemListCustomerContractLifeCycleStatusCode 36068 attribute has a cardinality of 0 . . . 1 36070 meaning that for each instance of the SelectionByItemListCustomerContractLifeCycleStatusCode 36044 entity there may be one UpperBoundaryItemListCustomerContractLifeCycleStatusCode 36068 attribute.

The SelectionByBuyerPartyID 36074 entity has a cardinality of 0 . . . N 36076 meaning that for each instance of the CustomerContractSelectionByElements 36008 entity there may be one or more SelectionByBuyerPartyID 36074 entities. The SelectionByBuyerPartyID 36074 entity includes various attributes, namely an InclusionExclusionCode 36080, an IntervalBoundaryTypeCode 36086, a LowerBoundaryID 36092 and an UpperBoundaryID 36098.

The InclusionExclusionCode 36080 attribute is an InclusionExclusionCode 36084 data type. The InclusionExclusionCode 36080 attribute has a cardinality of 0 . . . 1 36082 meaning that for each instance of the SelectionByBuyerPartyID 36074 entity there may be one InclusionExclusionCode 36080 attribute. The IntervalBoundaryTypeCode 36086 attribute is an IntervalBoundaryTypeCode 36090 data type. The IntervalBoundaryTypeCode 36086 attribute has a cardinality of 0 . . . 1 36088 meaning that for each instance of the SelectionByBuyerPartyID 36074 entity there may be one IntervalBoundaryTypeCode 36086 attribute.

The LowerBoundaryID 36092 attribute is a PartyID 36096 data type. The LowerBoundaryID 36092 attribute has a cardinality of 0 . . . 1 36094 meaning that for each instance of the SelectionByBuyerPartyID 36074 entity there may be one LowerBoundaryID 36092 attribute. The UpperBoundaryID 36098 attribute is a PartyID 36102 data type. The UpperBoundaryID 36098 attribute has a cardinality of 0 . . . 1 36100 meaning that for each instance of the SelectionByBuyerPartyID 36074 entity there may be one UpperBoundaryID 36098 attribute.

The SelectionByLastChangedDateTime 36104 entity has a cardinality of 0 . . . N 36106 meaning that for each instance of the CustomerContractSelectionByElements 36008 entity there may be one or more SelectionByLastChangedDateTime 36104 entities. The SelectionByLastChangedDateTime 36104 entity includes various attributes, namely an InclusionExclusionCode 36110, an IntervalBoundaryTypeCode 36116, a LowerBoundaryDateTime 36122 and an UpperBoundaryDateTime 36128.

The InclusionExclusionCode 36110 attribute is an InclusionExclusionCode 36114 data type. The InclusionExclusionCode 36110 attribute has a cardinality of 0 . . . 1 36112 meaning that for each instance of the SelectionByLastChangedDateTime 36104 entity there may be one InclusionExclusionCode 36110 attribute. The IntervalBoundaryTypeCode 36116 attribute is an IntervalBoundaryTypeCode 36120 data type. The IntervalBoundaryTypeCode 36116 attribute has a cardinality of 0 . . . 1 36118 meaning that for each instance of the SelectionByLastChangedDateTime 36104 entity there may be one IntervalBoundaryTypeCode 36116 attribute.

The LowerBoundaryDateTime 36122 attribute is a GLOBAL_DateTime 36126 data type. The LowerBoundaryDateTime 36122 attribute has a cardinality of 0 . . . 1 36124 meaning that for each instance of the SelectionByLastChangedDateTime 36104 entity there may be one LowerBoundaryDateTime 36122 attribute. The UpperBoundaryDateTime 36128 attribute is a GLOBAL_DateTime 36132 data type. The UpperBoundaryDateTime 36128 attribute has a cardinality of 0 . . . 1 36130 meaning that for each instance of the SelectionByLastChangedDateTime 36104 entity there may be one UpperBoundaryDateTime 36128 attribute.

The ProcessingConditions 36134 package is a QueryProcessingConditions 36140 data type. The ProcessingConditions 36134 package includes a ProcessingConditions 36136 entity. The ProcessingConditions 36136 entity has a cardinality of 0 . . . 1 36138 meaning that for each instance of the ProcessingConditions 36134 package there may be one ProcessingConditions 36136 entity.

The RequestedElements 36142 package is a CustomerContractByElementsQueryRequestedElements 36148 data type. The RequestedElements 36142 package includes a RequestedElements 36144 entity. The RequestedElements 36144 entity has a cardinality of 0 . . . 1 36146 meaning that for each instance of the RequestedElements 36142 package there may be one RequestedElements 36144 entity. The RequestedElements 36144 entity includes a customerContractTransmissionRequestCode 36150 attribute. The RequestedElements 36144 entity includes a CustomerContract 36156 subordinate entity.

The customerContractTransmissionRequestCode 36150 attribute is a TransmissionRequestCode 36154 data type. The customerContractTransmissionRequestCode 36150 attribute has a cardinality of 0 . . . 1 36152 meaning that for each instance of the RequestedElements 36144 entity there may be one customerContractTransmissionRequestCode 36150 attribute.

The CustomerContract 36156 entity has a cardinality of 0 . . . 1 36158 meaning that for each instance of the RequestedElements 36144 entity there may be one CustomerContract 36156 entity. The CustomerContract 36156 entity includes an itemTransmissionRequestCode 36162 attribute. The itemTransmissionRequestCode 36162 attribute is a TransmissionRequestCode 36166 data type. The itemTransmissionRequestCode 36162 attribute has a cardinality of 0 . . . 1 36164 meaning that for each instance of the CustomerContract 36156 entity there may be one itemTransmissionRequestCode 36162 attribute.

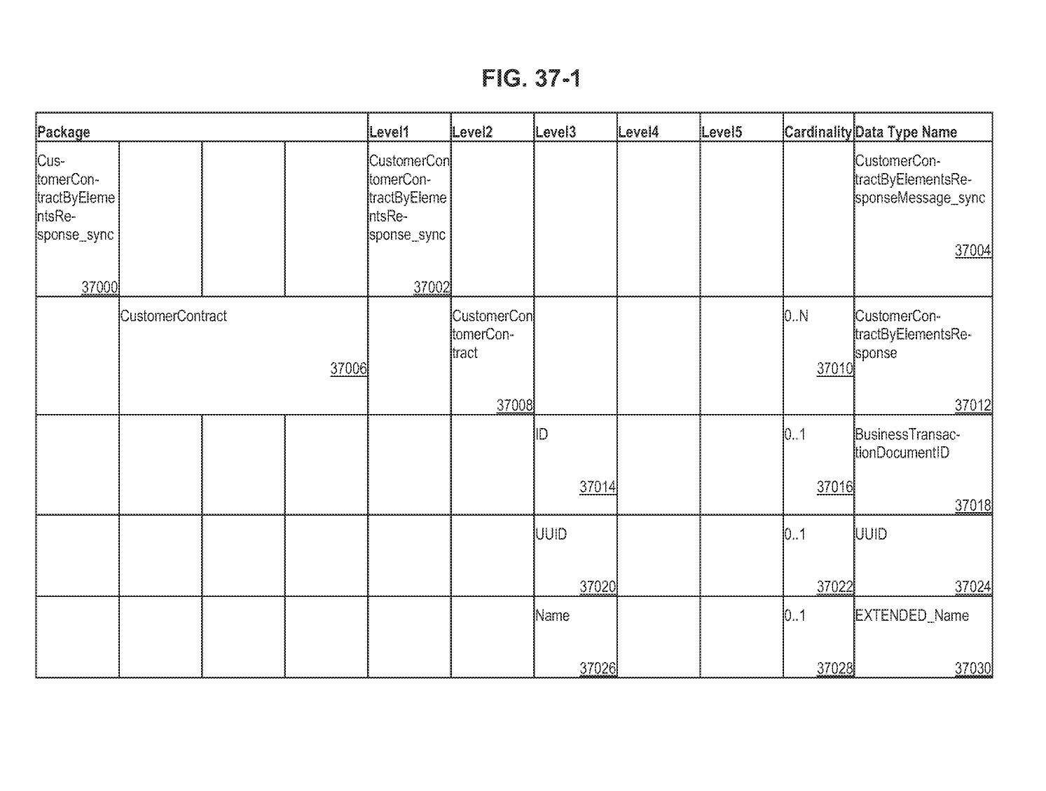

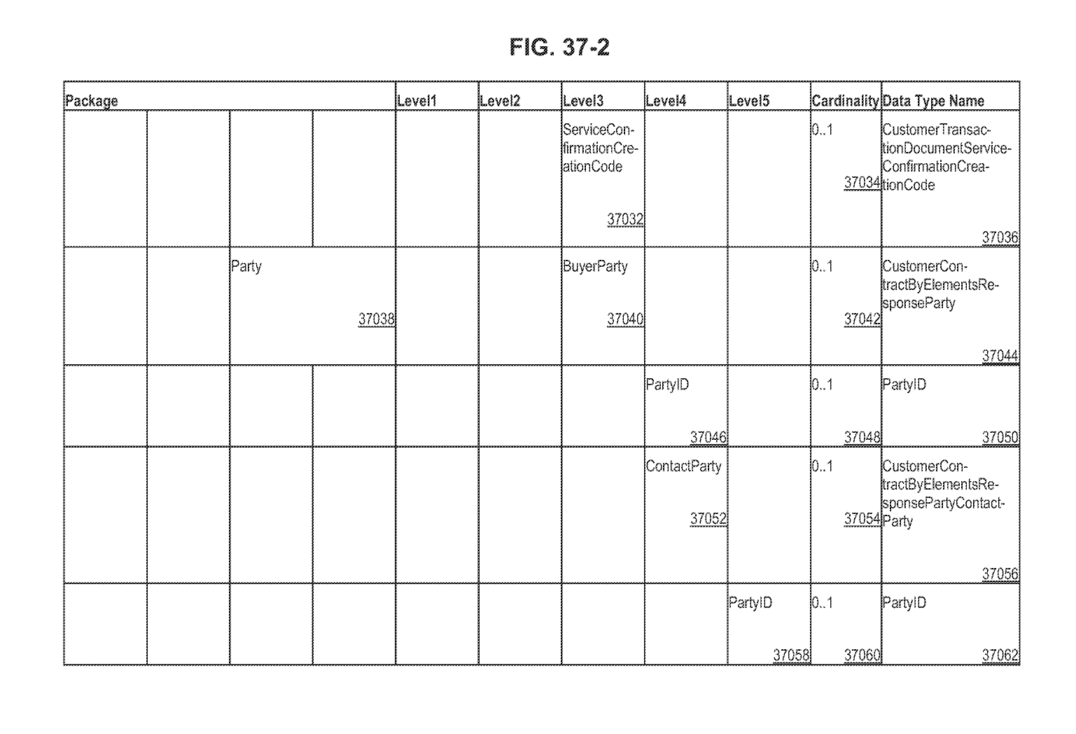

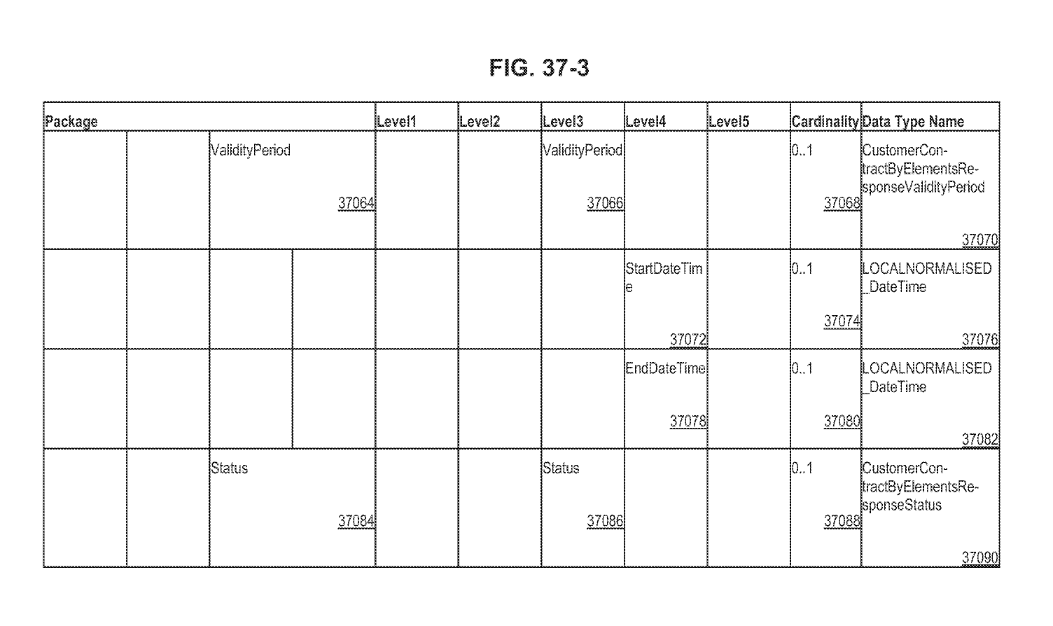

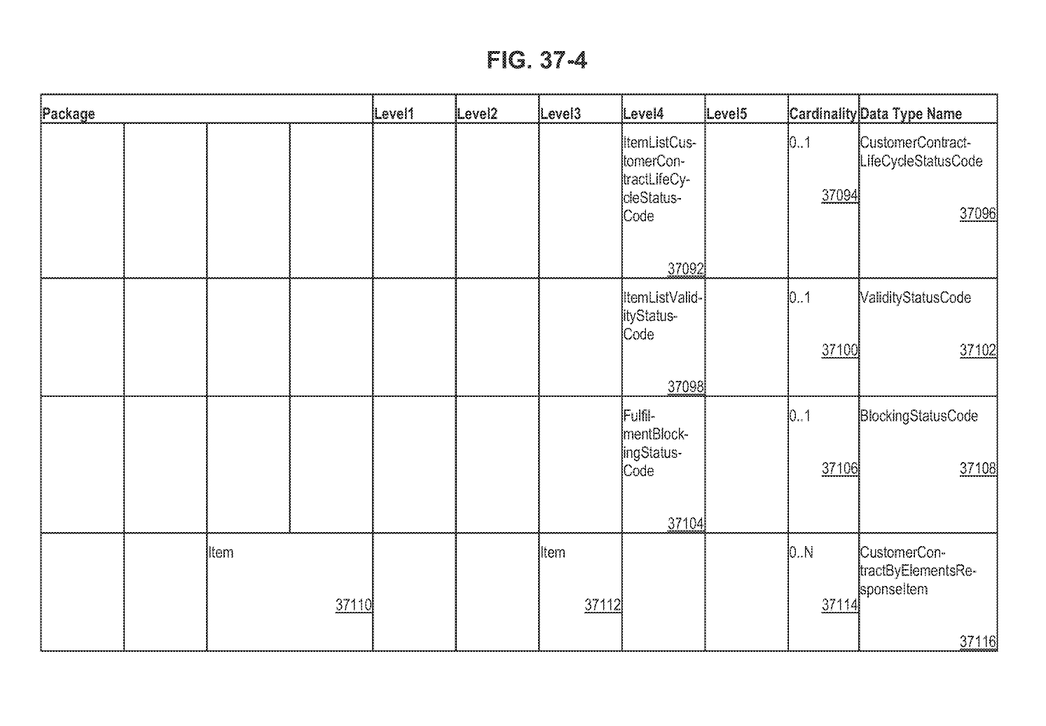

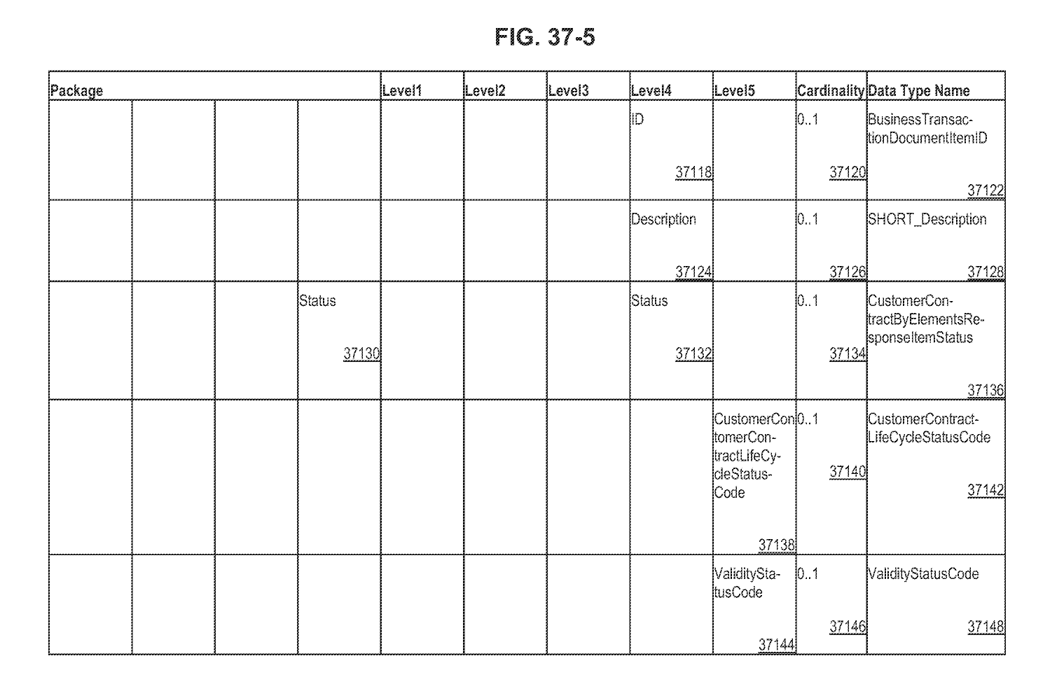

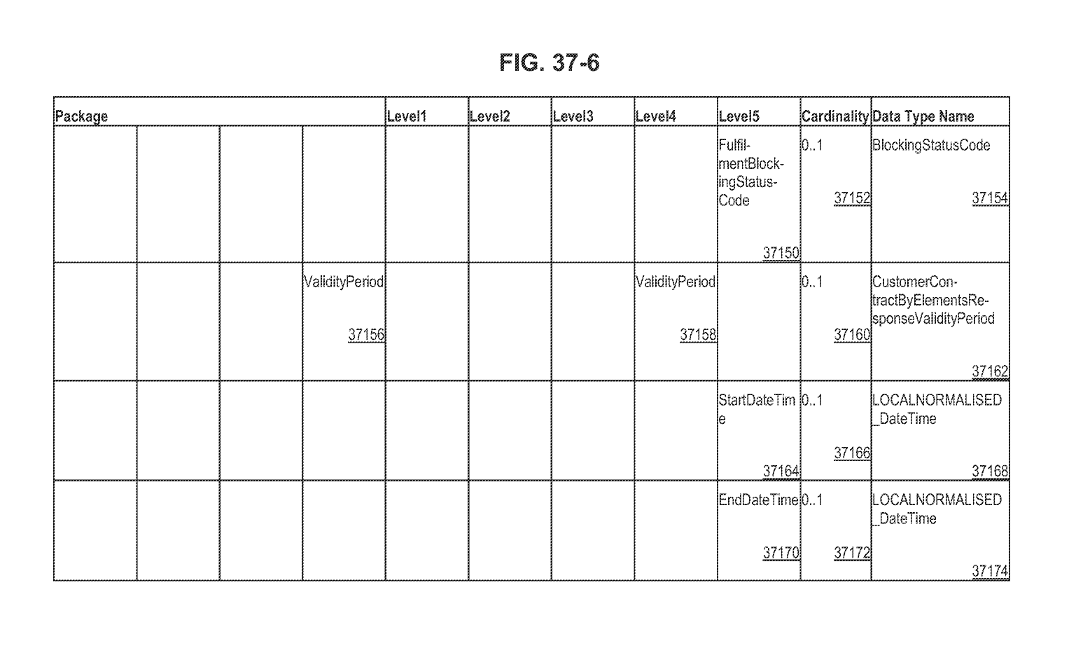

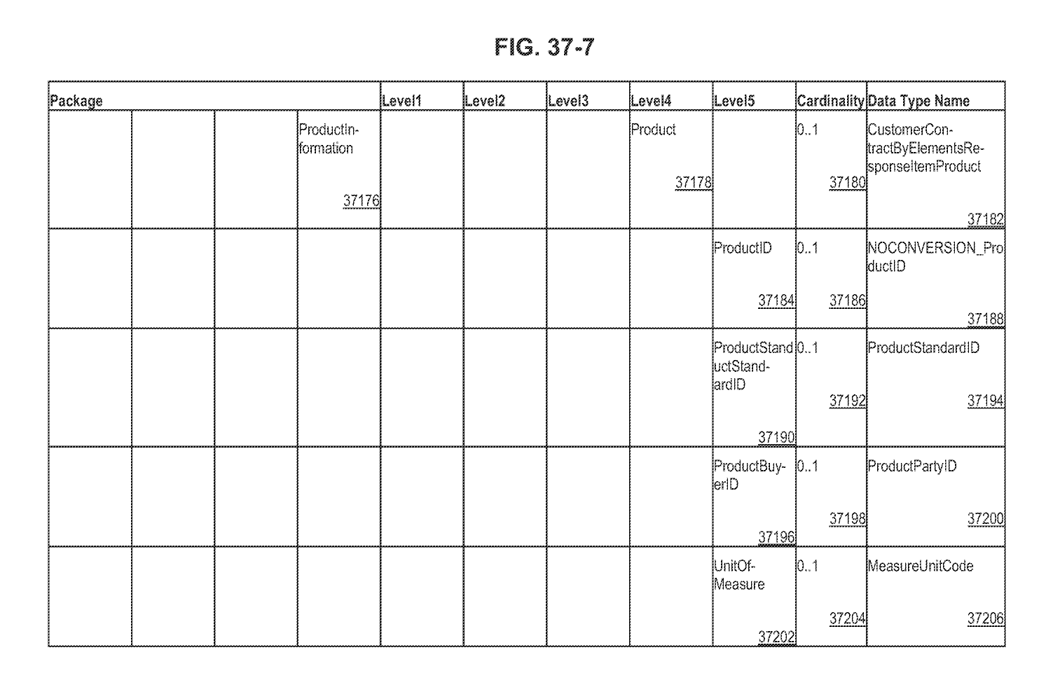

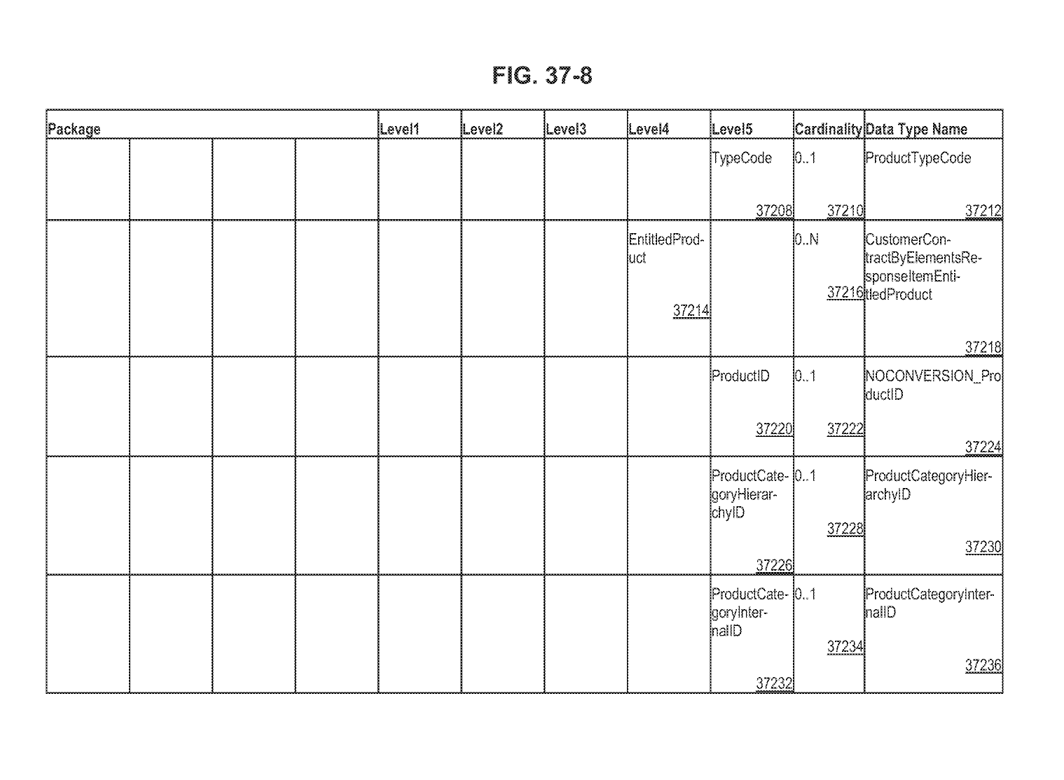

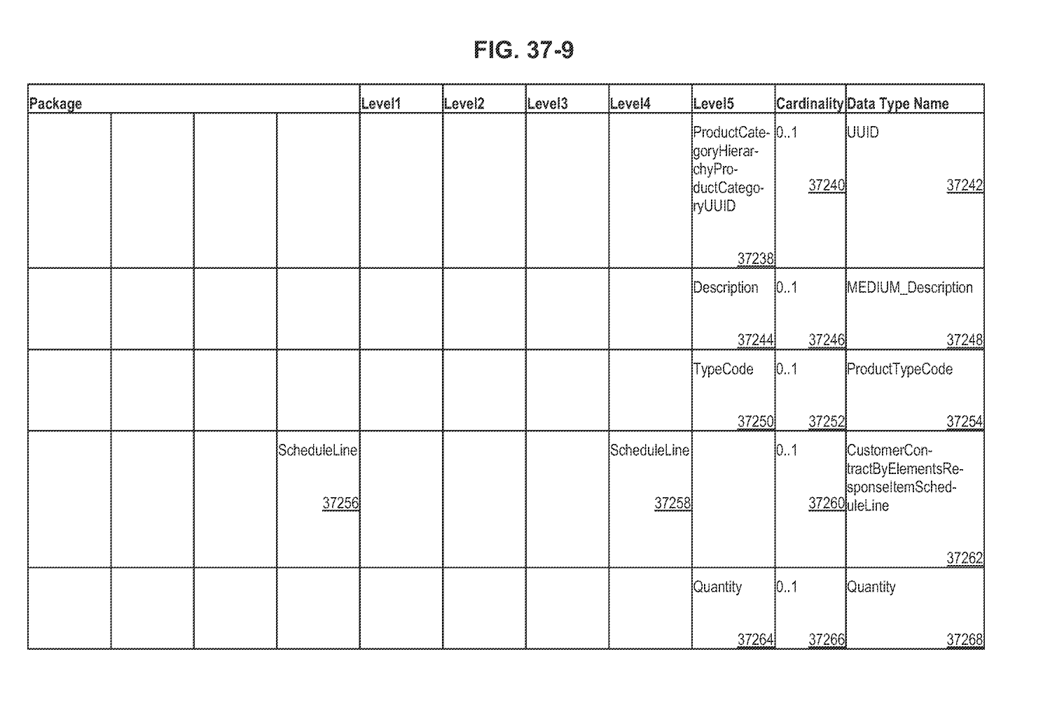

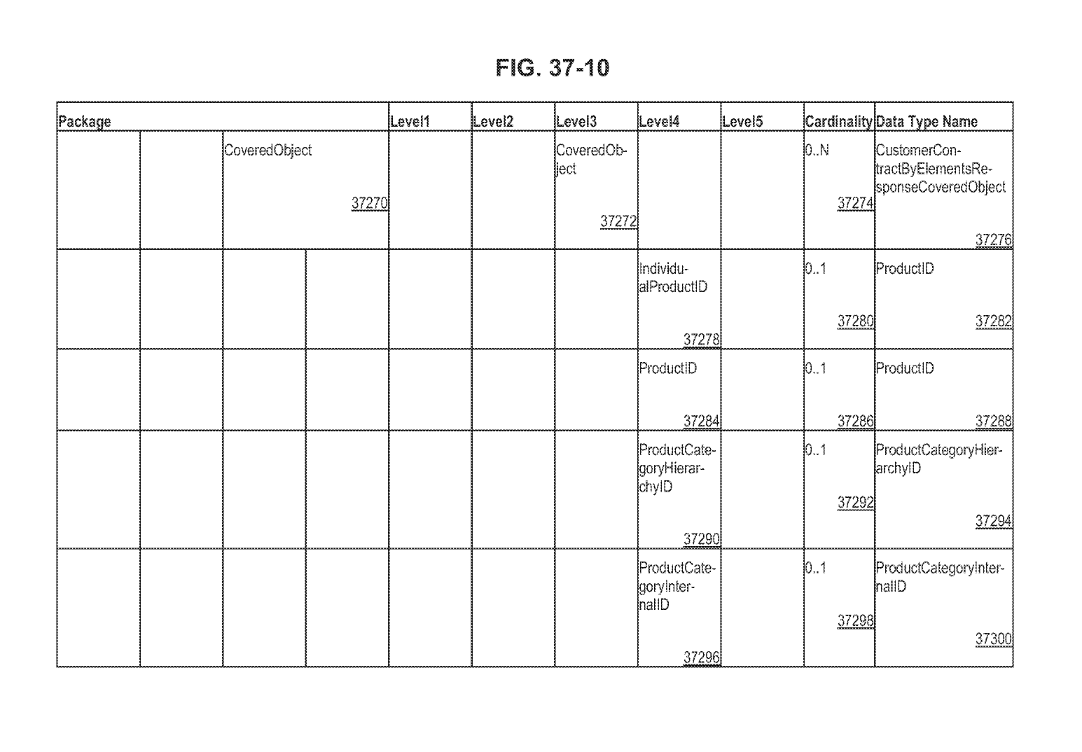

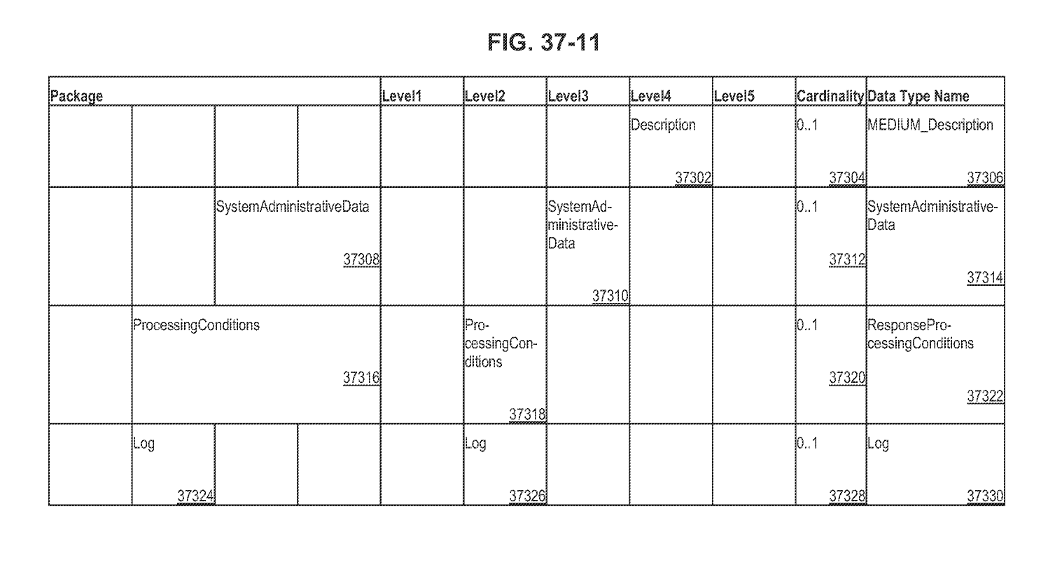

FIGS. 37-1 through 37-11 show an example configuration of an Element Structure that includes a CustomerContractByElementsResponse_sync 37000 package. Specifically, these figures depict the arrangement and hierarchy of various components such as one or more levels of packages, entities, and datatypes, shown here as 37000 through 37330. As described above, packages may be used to represent hierarchy levels. Entities are discrete business elements that are used during a business transaction. Data types are used to type object entities and interfaces with a structure. For example, the CustomerContractByElementsResponse_sync 37000 includes, among other things, a CustomerContractByElementsResponse_sync 37002. Accordingly, heterogeneous applications may communicate using this consistent message configured as such.

The CustomerContractByElementsResponsesync 37000 package is a CustomerContractByElementsResponseMessage_sync 37004 data type. The CustomerContractByElementsResponse_sync 37000 package includes a CustomerContractByElementsResponse_sync 37002 entity. The CustomerContractByElementsResponse_sync 37000 package includes various packages, namely a CustomerContract 37006, a ProcessingConditions 37316 and a Log 37324.

The CustomerContract 37006 package is a CustomerContractByElementsResponse 37012 data type. The CustomerContract 37006 package includes a CustomerContract 37008 entity. The CustomerContract 37006 package includes various packages, namely a Party 37038, a ValidityPeriod 37064, a Status 37084, an Item 37110, a CoveredObject 37270 and a SystemAdministrativeData 37308. The CustomerContract 37008 entity has a cardinality of 0 . . . N 37010 meaning that for each instance of the CustomerContract 37006 package there may be one or more CustomerContract 37008 entities. The CustomerContract 37008 entity includes various attributes, namely an ID 37014, an UUID 37020, a Name 37026 and a ServiceConfirmationCreationCode 37032.

The ID 37014 attribute is a BusinessTransactionDocumentID 37018 data type. The ID 37014 attribute has a cardinality of 0 . . . 1 37016 meaning that for each instance of the CustomerContract 37008 entity there may be one ID 37014 attribute. The UUID 37020 attribute is an UUID 37024 data type. The UUID 37020 attribute has a cardinality of 0 . . . 1 37022 meaning that for each instance of the CustomerContract 37008 entity there may be one UUID 37020 attribute.

The Name 37026 attribute is an EXTENDED_Name 37030 data type. The Name 37026 attribute has a cardinality of 0 . . . 1 37028 meaning that for each instance of the CustomerContract 37008 entity there may be one Name 37026 attribute. The ServiceConfirmationCreationCode 37032 attribute is a CustomerTransactionDocumentServiceConfirmationCreationCode 37036 data type. The ServiceConfirmationCreationCode 37032 attribute has a cardinality of 0 . . . 1 37034 meaning that for each instance of the CustomerContract 37008 entity there may be one ServiceConfirmationCreationCode 37032 attribute.

The Party 37038 package is a CustomerContractByElementsResponseParty 37044 data type. The Party 37038 package includes a BuyerParty 37040 entity. The BuyerParty 37040 entity has a cardinality of 0 . . . 1 37042 meaning that for each instance of the Party 37038 package there may be one BuyerParty 37040 entity. The BuyerParty 37040 entity includes a PartyID 37046 attribute. The BuyerParty 37040 entity includes a ContactParty 37052 subordinate entity. The PartyID 37046 attribute is a PartyID 37050 data type. The PartyID 37046 attribute has a cardinality of 0 . . . 1 37048 meaning that for each instance of the BuyerParty 37040 entity there may be one PartyID 37046 attribute.

The ContactParty 37052 entity has a cardinality of 0 . . . 1 37054 meaning that for each instance of the BuyerParty 37040 entity there may be one ContactParty 37052 entity. The ContactParty 37052 entity includes a PartyID 37058 attribute. The PartyID 37058 attribute is a PartyID 37062 data type. The PartyID 37058 attribute has a cardinality of 0 . . . 1 37060 meaning that for each instance of the ContactParty 37052 entity there may be one PartyID 37058 attribute.

The ValidityPeriod 37064 package is a CustomerContractByElementsResponseValidityPeriod 37070 data type. The ValidityPeriod 37064 package includes a ValidityPeriod 37066 entity. The ValidityPeriod 37066 entity has a cardinality of 0 . . . 1 37068 meaning that for each instance of the ValidityPeriod 37064 package there may be one ValidityPeriod 37066 entity. The ValidityPeriod 37066 entity includes various attributes, namely a StartDateTime 37072 and an EndDateTime 37078.

The StartDateTime 37072 attribute is a LOCALNORMALISED_DateTime 37076 data type. The StartDateTime 37072 attribute has a cardinality of 0 . . . 1 37074 meaning that for each instance of the ValidityPeriod 37066 entity there may be one StartDateTime 37072 attribute. The EndDateTime 37078 attribute is a LOCALNORMALISED_DateTime 37082 data type. The EndDateTime 37078 attribute has a cardinality of 0 . . . 1 37080 meaning that for each instance of the ValidityPeriod 37066 entity there may be one EndDateTime 37078 attribute.

The Status 37084 package is a CustomerContractByElementsResponseStatus 37090 data type. The Status 37084 package includes a Status 37086 entity. The Status 37086 entity has a cardinality of 0 . . . 1 37088 meaning that for each instance of the Status 37084 package there may be one Status 37086 entity. The Status 37086 entity includes various attributes, namely an ItemListCustomerContractLifeCycleStatusCode 37092, an ItemListValidityStatusCode 37098 and a FulfilmentBlockingStatusCode 37104.

The ItemListCustomerContractLifeCycleStatusCode 37092 attribute is a CustomerContractLifeCycleStatusCode 37096 data type. The ItemListCustomerContractLifeCycleStatusCode 37092 attribute has a cardinality of 0 . . . 1 37094 meaning that for each instance of the Status 37086 entity there may be one ItemListCustomerContractLifeCycleStatusCode 37092 attribute. The ItemListValidityStatusCode 37098 attribute is a ValidityStatusCode 37102 data type. The ItemListValidityStatusCode 37098 attribute has a cardinality of 0 . . . 1 37100 meaning that for each instance of the Status 37086 entity there may be one ItemListValidityStatusCode 37098 attribute. The FulfilmentBlockingStatusCode 37104 attribute is a BlockingStatusCode 37108 data type. The FulfilmentBlockingStatusCode 37104 attribute has a cardinality of 0 . . . 1 37106 meaning that for each instance of the Status 37086 entity there may be one FulfilmentBlockingStatusCode 37104 attribute.

The Item 37110 package is a CustomerContractByElementsResponseItem 37116 data type. The Item 37110 package includes an Item 37112 entity. The Item 37110 package includes various packages, namely a Status 37130, a ValidityPeriod 37156, a ProductInformation 37176 and a ScheduleLine 37256. The Item 37112 entity has a cardinality of 0 . . . N 37114 meaning that for each instance of the Item 37110 package there may be one or more Item 37112 entities. The Item 37112 entity includes various attributes, namely an ID 37118 and a Description 37124.

The ID 37118 attribute is a BusinessTransactionDocumentItemID 37122 data type. The ID 37118 attribute has a cardinality of 0 . . . 1 37120 meaning that for each instance of the Item 37112 entity there may be one ID 37118 attribute. The Description 37124 attribute is a SHORT_Description 37128 data type. The Description 37124 attribute has a cardinality of 0 . . . 1 37126 meaning that for each instance of the Item 37112 entity there may be one Description 37124 attribute.

The Status 37130 package is a CustomerContractByElementsResponseItemStatus 37136 data type. The Status 37130 package includes a Status 37132 entity. The Status 37132 entity has a cardinality of 0 . . . 1 37134 meaning that for each instance of the Status 37130 package there may be one Status 37132 entity. The Status 37132 entity includes various attributes, namely a CustomerContractLifeCycleStatusCode 37138, a ValidityStatusCode 37144 and a FulfilmentBlockingStatusCode 37150.

The CustomerContractLifeCycleStatusCode 37138 attribute is a CustomerContractLifeCycleStatusCode 37142 data type. The CustomerContractLifeCycleStatusCode 37138 attribute has a cardinality of 0 . . . 1 37140 meaning that for each instance of the Status 37132 entity there may be one CustomerContractLifeCycleStatusCode 37138 attribute. The ValidityStatusCode 37144 attribute is a ValidityStatusCode 37148 data type. The ValidityStatusCode 37144 attribute has a cardinality of 0 . . . 1 37146 meaning that for each instance of the Status 37132 entity there may be one ValidityStatusCode 37144 attribute. The FulfilmentBlockingStatusCode 37150 attribute is a BlockingStatusCode 37154 data type. The FulfilmentBlockingStatusCode 37150 attribute has a cardinality of 0 . . . 1 37152 meaning that for each instance of the Status 37132 entity there may be one FulfilmentBlockingStatusCode 37150 attribute.

The ValidityPeriod 37156 package is a CustomerContractByElementsResponseValidityPeriod 37162 data type. The ValidityPeriod 37156 package includes a ValidityPeriod 37158 entity. The ValidityPeriod 37158 entity has a cardinality of 0 . . . 1 37160 meaning that for each instance of the ValidityPeriod 37156 package there may be one ValidityPeriod 37158 entity. The ValidityPeriod 37158 entity includes various attributes, namely a StartDateTime 37164 and an EndDateTime 37170.

The StartDateTime 37164 attribute is a LOCALNORMALISED_DateTime 37168 data type. The StartDateTime 37164 attribute has a cardinality of 0 . . . 1 37166 meaning that for each instance of the ValidityPeriod 37158 entity there may be one StartDateTime 37164 attribute. The EndDateTime 37170 attribute is a LOCALNORMALISED_DateTime 37174 data type. The EndDateTime 37170 attribute has a cardinality of 0 . . . 1 37172 meaning that for each instance of the ValidityPeriod 37158 entity there may be one EndDateTime 37170 attribute.

The ProductInformation 37176 package is a CustomerContractByElementsResponseItemProduct 37182 data type. The ProductInformation 37176 package includes various entities, namely a Product 37178 and an EntitledProduct 37214. The Product 37178 entity has a cardinality of 0 . . . 1 37180 meaning that for each instance of the ProductInformation 37176 package there may be one Product 37178 entity. The Product 37178 entity includes various attributes, namely a ProductID 37184, a ProductStandardID 37190, a ProductBuyerID 37196, an UnitOfMeasure 37202 and a TypeCode 37208.

The ProductID 37184 attribute is a NOCONVERSION_ProductID 37188 data type. The ProductID 37184 attribute has a cardinality of 0 . . . 1 37186 meaning that for each instance of the Product 37178 entity there may be one ProductID 37184 attribute. The ProductStandardID 37190 attribute is a ProductStandardID 37194 data type. The ProductStandardID 37190 attribute has a cardinality of 0 . . . 1 37192 meaning that for each instance of the Product 37178 entity there may be one ProductStandardID 37190 attribute.

The ProductBuyerID 37196 attribute is a ProductPartyID 37200 data type. The ProductBuyerID 37196 attribute has a cardinality of 0 . . . 1 37198 meaning that for each instance of the Product 37178 entity there may be one ProductBuyerID 37196 attribute. The UnitOfMeasure 37202 attribute is a MeasureUnitCode 37206 data type. The UnitOfMeasure 37202 attribute has a cardinality of 0 . . . 1 37204 meaning that for each instance of the Product 37178 entity there may be one UnitOfMeasure 37202 attribute. The TypeCode 37208 attribute is a ProductTypeCode 37212 data type. The TypeCode 37208 attribute has a cardinality of 0 . . . 1 37210 meaning that for each instance of the Product 37178 entity there may be one TypeCode 37208 attribute.

The EntitledProduct 37214 entity has a cardinality of 0 . . . N 37216 meaning that for each instance of the ProductInformation 37176 package there may be one or more EntitledProduct 37214 entities. The EntitledProduct 37214 entity includes various attributes, namely a ProductID 37220, a ProductCategoryHierarchyID 37226, a ProductCategoryInternalID 37232, a ProductCategoryHierarchyProductCategoryUUID 37238, a Description 37244 and a TypeCode 37250.

The ProductID 37220 attribute is a NOCONVERSION_ProductID 37224 data type. The ProductID 37220 attribute has a cardinality of 0 . . . 1 37222 meaning that for each instance of the EntitledProduct 37214 entity there may be one ProductID 37220 attribute. The ProductCategoryHierarchyID 37226 attribute is a ProductCategoryHierarchyID 37230 data type. The ProductCategoryHierarchyID 37226 attribute has a cardinality of 0 . . . 1 37228 meaning that for each instance of the EntitledProduct 37214 entity there may be one ProductCategoryHierarchyID 37226 attribute.

The ProductCategoryInternalID 37232 attribute is a ProductCategoryInternalID 37236 data type. The ProductCategoryInternalID 37232 attribute has a cardinality of 0 . . . 1 37234 meaning that for each instance of the EntitledProduct 37214 entity there may be one ProductCategoryInternalID 37232 attribute. The ProductCategoryHierarchyProductCategoryUUID 37238 attribute is an UUID 37242 data type. The ProductCategoryHierarchyProductCategoryUUID 37238 attribute has a cardinality of 0 . . . 1 37240 meaning that for each instance of the EntitledProduct 37214 entity there may be one ProductCategoryHierarchyProductCategoryUUID 37238 attribute.

The Description 37244 attribute is a MEDIUM_Description 37248 data type. The Description 37244 attribute has a cardinality of 0 . . . 1 37246 meaning that for each instance of the EntitledProduct 37214 entity there may be one Description 37244 attribute. The TypeCode 37250 attribute is a ProductTypeCode 37254 data type. The TypeCode 37250 attribute has a cardinality of 0 . . . 1 37252 meaning that for each instance of the EntitledProduct 37214 entity there may be one TypeCode 37250 attribute.

The ScheduleLine 37256 package is a CustomerContractByElementsResponseItemScheduleLine 37262 data type. The ScheduleLine 37256 package includes a ScheduleLine 37258 entity. The ScheduleLine 37258 entity has a cardinality of 0 . . . 1 37260 meaning that for each instance of the ScheduleLine 37256 package there may be one ScheduleLine 37258 entity. The ScheduleLine 37258 entity includes a Quantity 37264 attribute. The Quantity 37264 attribute is a Quantity 37268 data type. The Quantity 37264 attribute has a cardinality of 0 . . . 1 37266 meaning that for each instance of the ScheduleLine 37258 entity there may be one Quantity 37264 attribute.

The CoveredObject 37270 package is a CustomerContractByElementsResponseCoveredObject 37276 data type. The CoveredObject 37270 package includes a CoveredObject 37272 entity. The CoveredObject 37272 entity has a cardinality of 0 . . . N 37274 meaning that for each instance of the CoveredObject 37270 package there may be one or more CoveredObject 37272 entities. The CoveredObject 37272 entity includes various attributes, namely an IndividualProductID 37278, a ProductID 37284, a ProductCategoryHierarchyID 37290, a ProductCategoryInternalID 37296 and a Description 37302.

The IndividualProductID 37278 attribute is a ProductID 37282 data type. The IndividualProductID 37278 attribute has a cardinality of 0 . . . 1 37280 meaning that for each instance of the CoveredObject 37272 entity there may be one IndividualProductID 37278 attribute. The ProductID 37284 attribute is a ProductID 37288 data type. The ProductID 37284 attribute has a cardinality of 0 . . . 1 37286 meaning that for each instance of the CoveredObject 37272 entity there may be one ProductID 37284 attribute.

The ProductCategoryHierarchyID 37290 attribute is a ProductCategoryHierarchyID 37294 data type. The ProductCategoryHierarchyID 37290 attribute has a cardinality of 0 . . . 1 37292 meaning that for each instance of the CoveredObject 37272 entity there may be one ProductCategoryHierarchyID 37290 attribute. The ProductCategoryInternalID 37296 attribute is a ProductCategoryInternalID 37300 data type. The ProductCategoryInternalID 37296 attribute has a cardinality of 0 . . . 1 37298 meaning that for each instance of the CoveredObject 37272 entity there may be one ProductCategoryInternalID 37296 attribute. The Description 37302 attribute is a MEDIUM_Description 37306 data type. The Description 37302 attribute has a cardinality of 0 . . . 1 37304 meaning that for each instance of the CoveredObject 37272 entity there may be one Description 37302 attribute.

The SystemAdministrativeData 37308 package is a SystemAdministrativeData 37314 data type. The SystemAdministrativeData 37308 package includes a SystemAdministrativeData 37310 entity. The SystemAdministrativeData 37310 entity has a cardinality of 0 . . . 1 37312 meaning that for each instance of the SystemAdministrativeData 37308 package there may be one SystemAdministrativeData 37310 entity.

The ProcessingConditions 37316 package is a ResponseProcessingConditions 37322 data type. The ProcessingConditions 37316 package includes a ProcessingConditions 37318 entity. The ProcessingConditions 37318 entity has a cardinality of 0 . . . 1 37320 meaning that for each instance of the ProcessingConditions 37316 package there may be one ProcessingConditions 37318 entity.

The Log 37324 package is a Log 37330 data type. The Log 37324 package includes a Log 37326 entity. The Log 37326 entity has a cardinality of 0 . . . 1 37328 meaning that for each instance of the Log 37324 package there may be one Log 37326 entity.

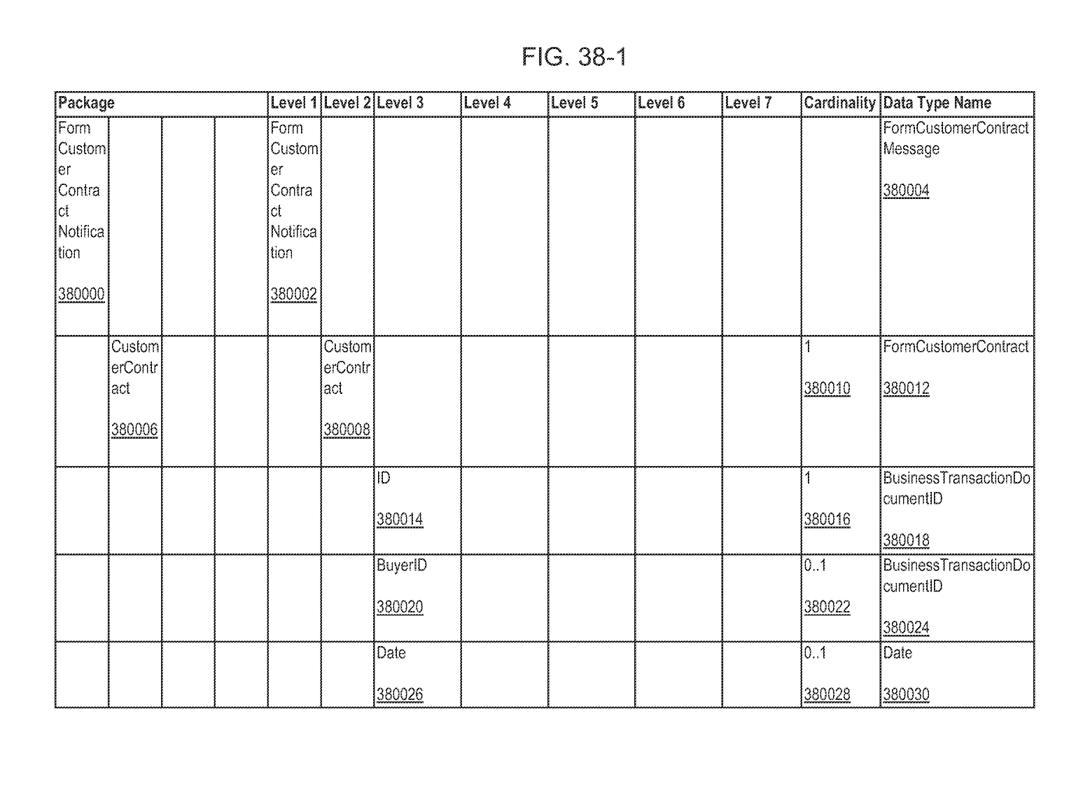

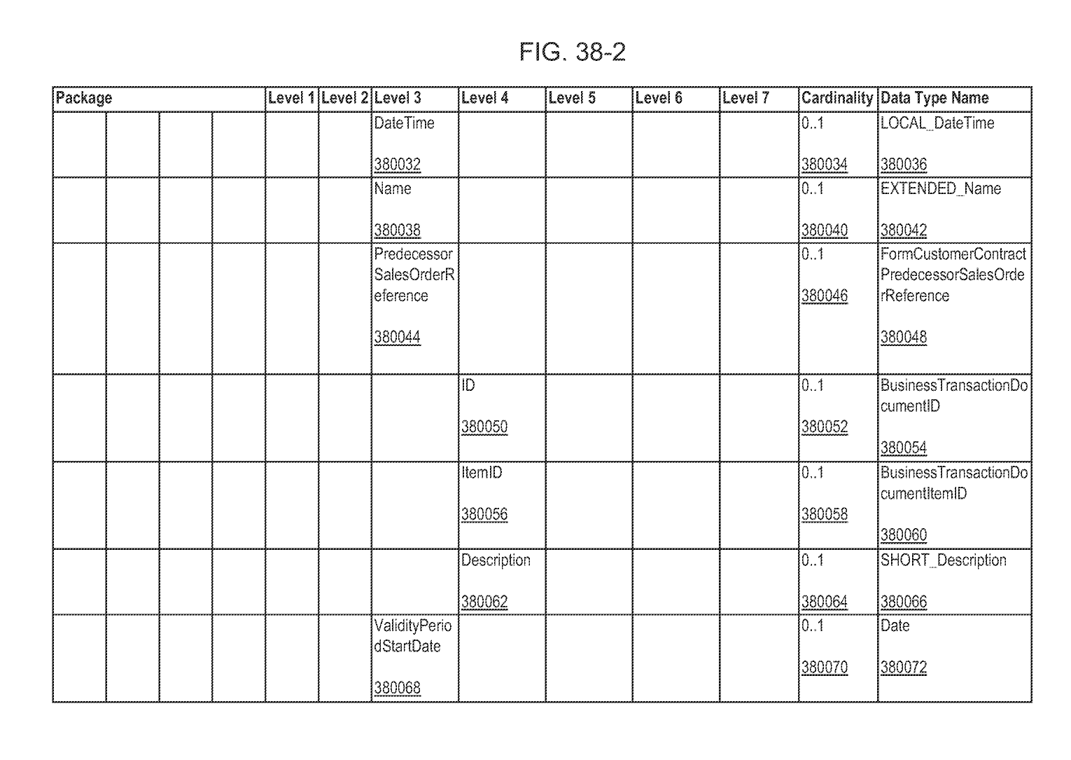

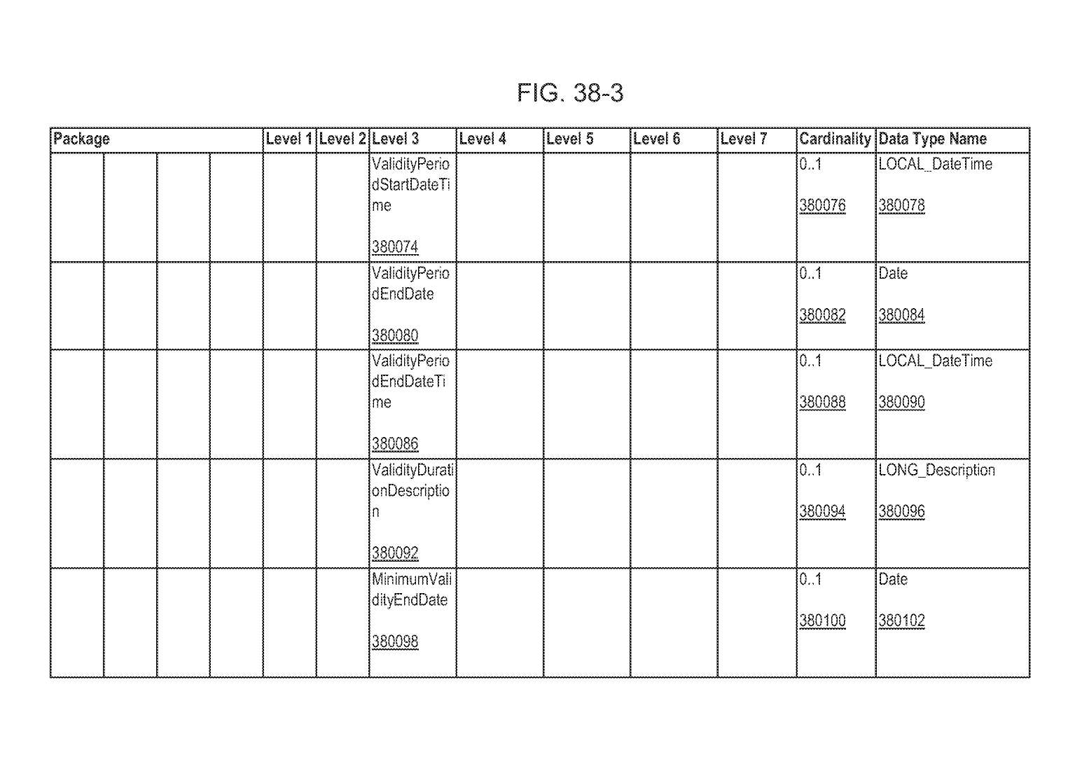

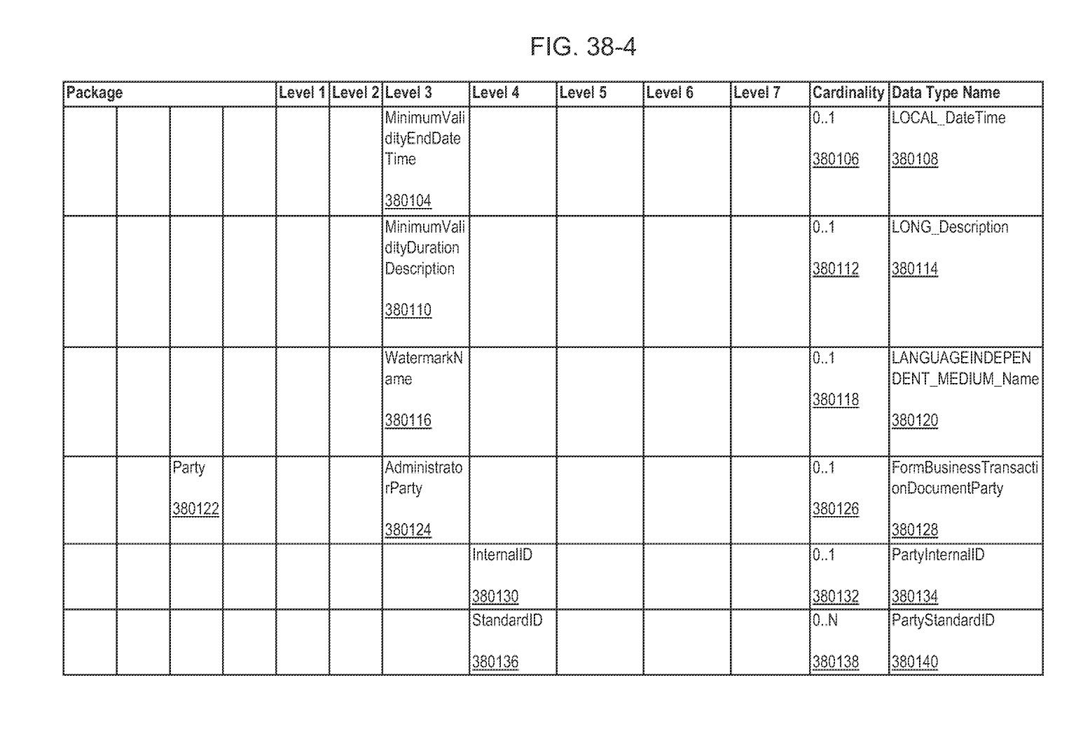

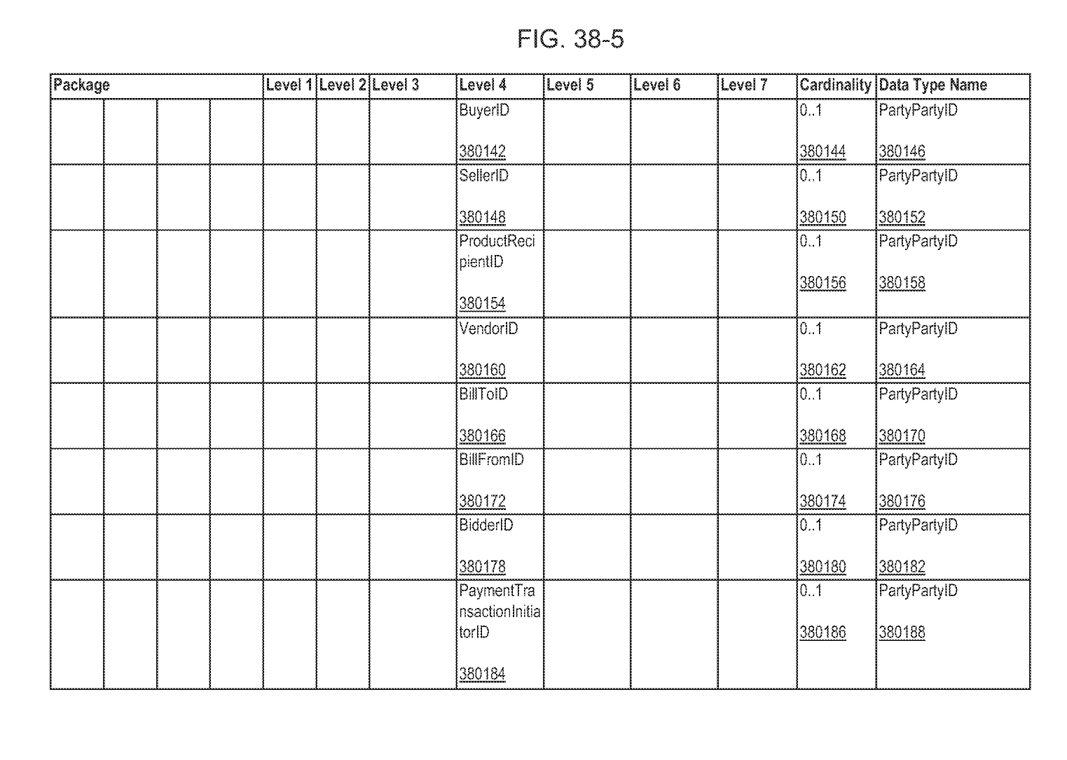

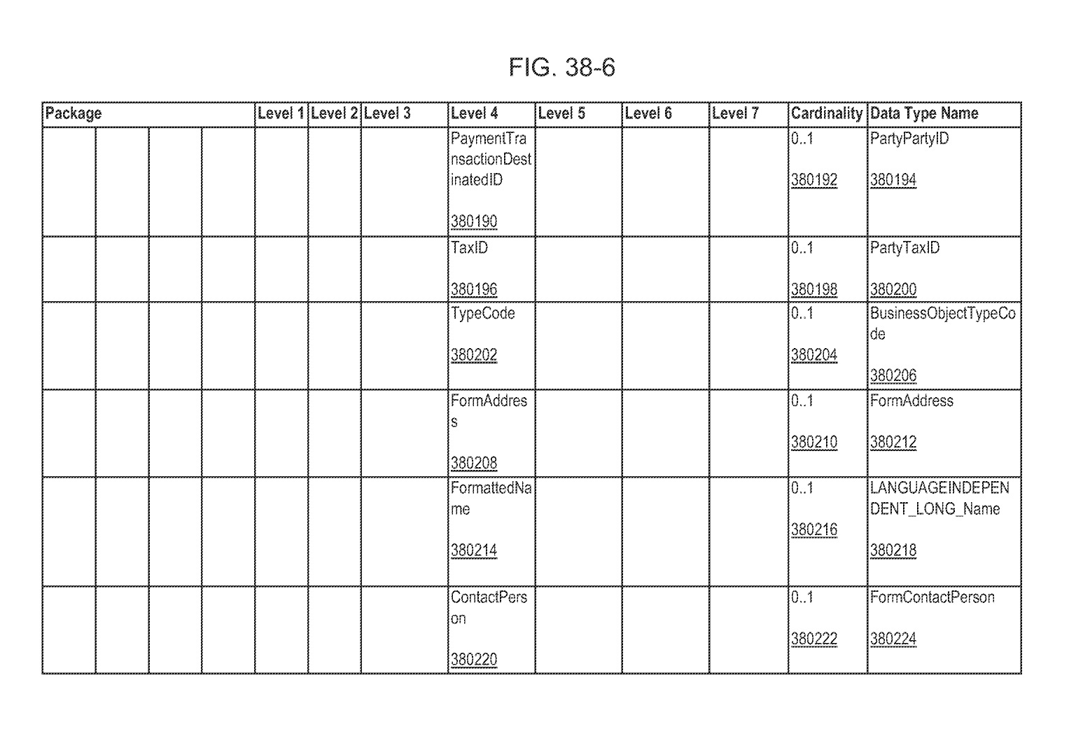

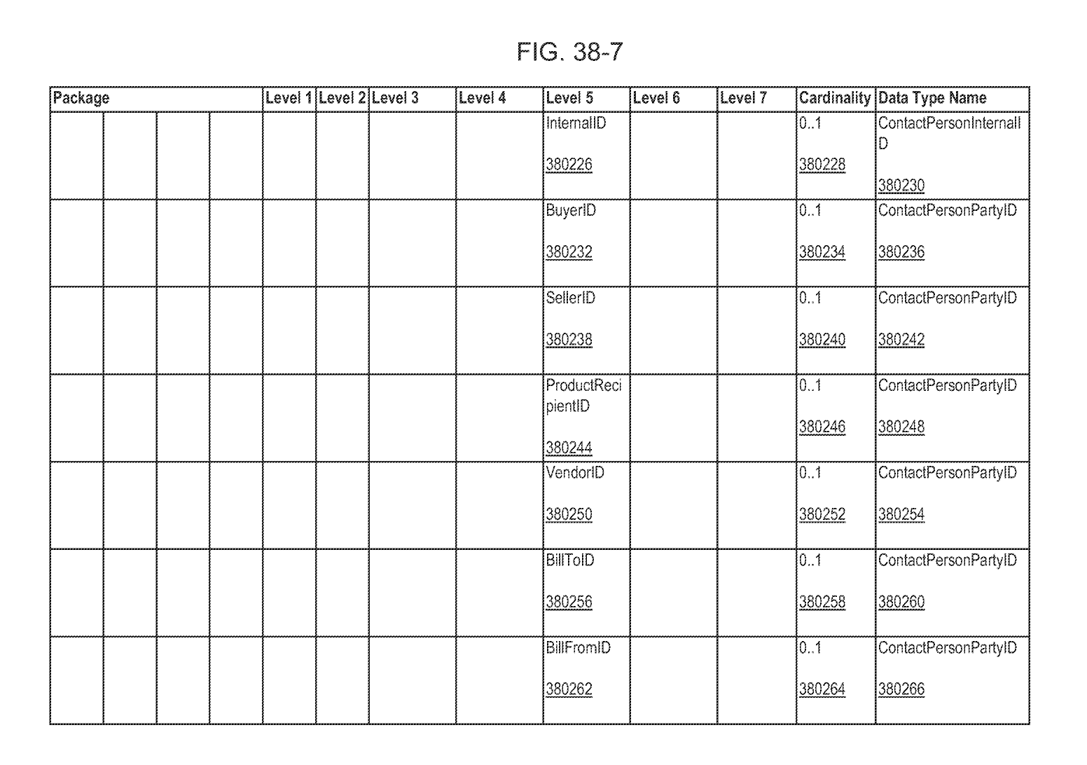

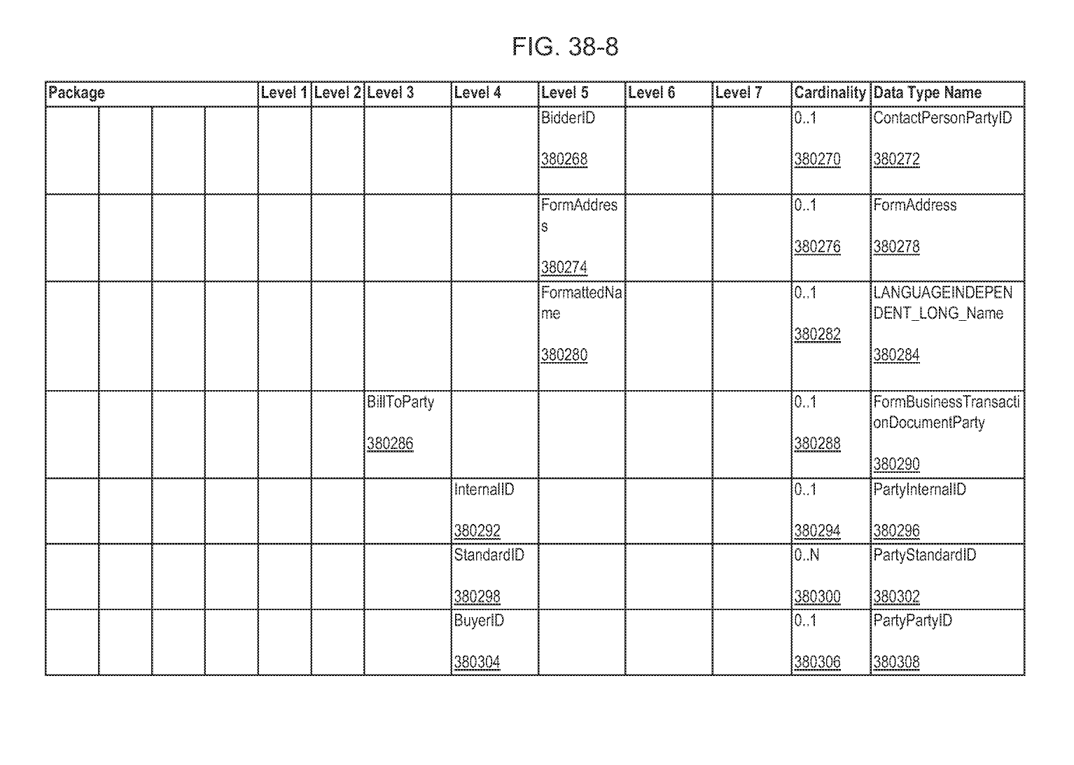

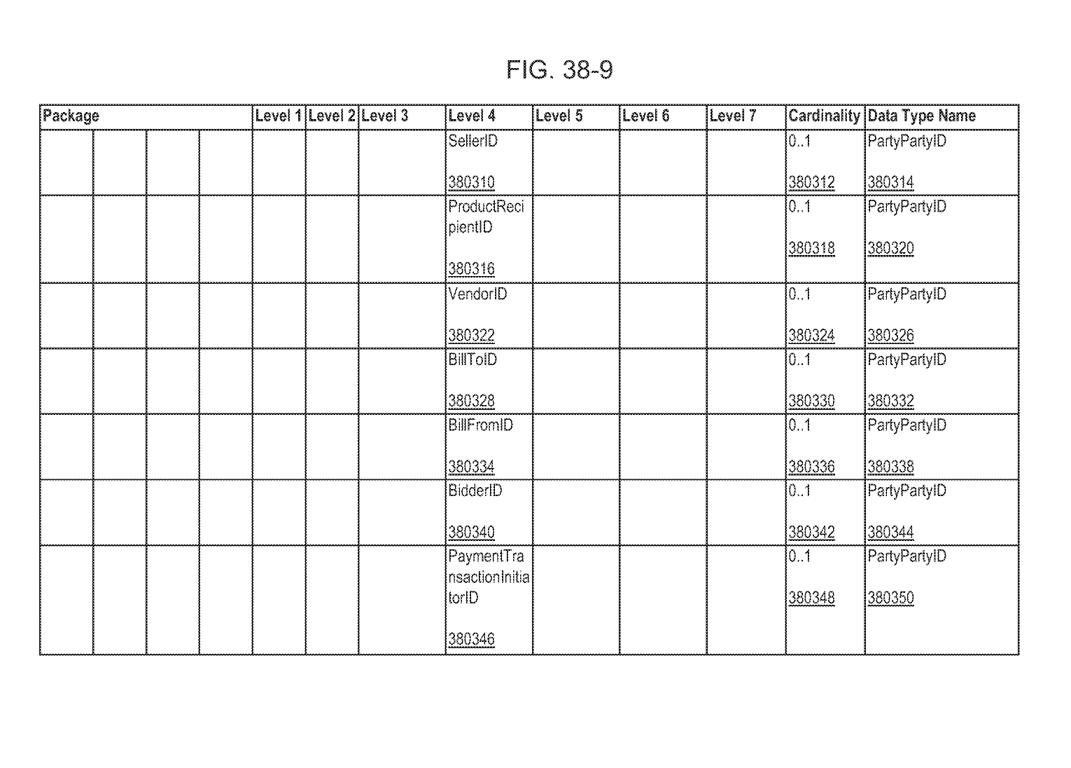

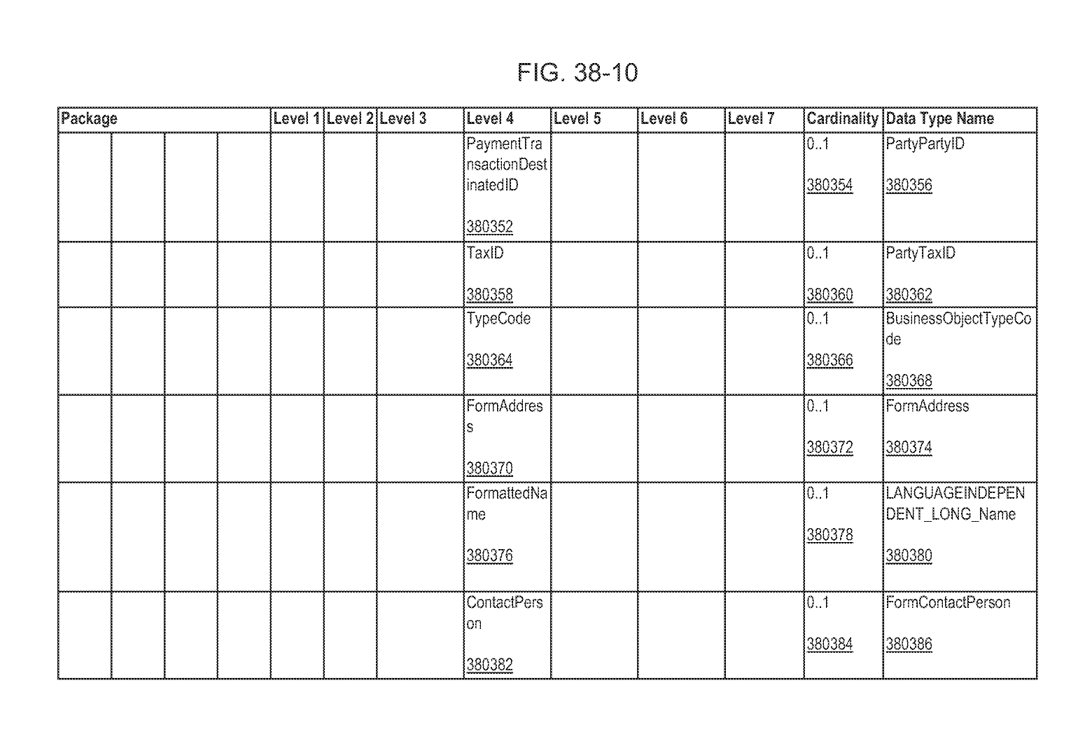

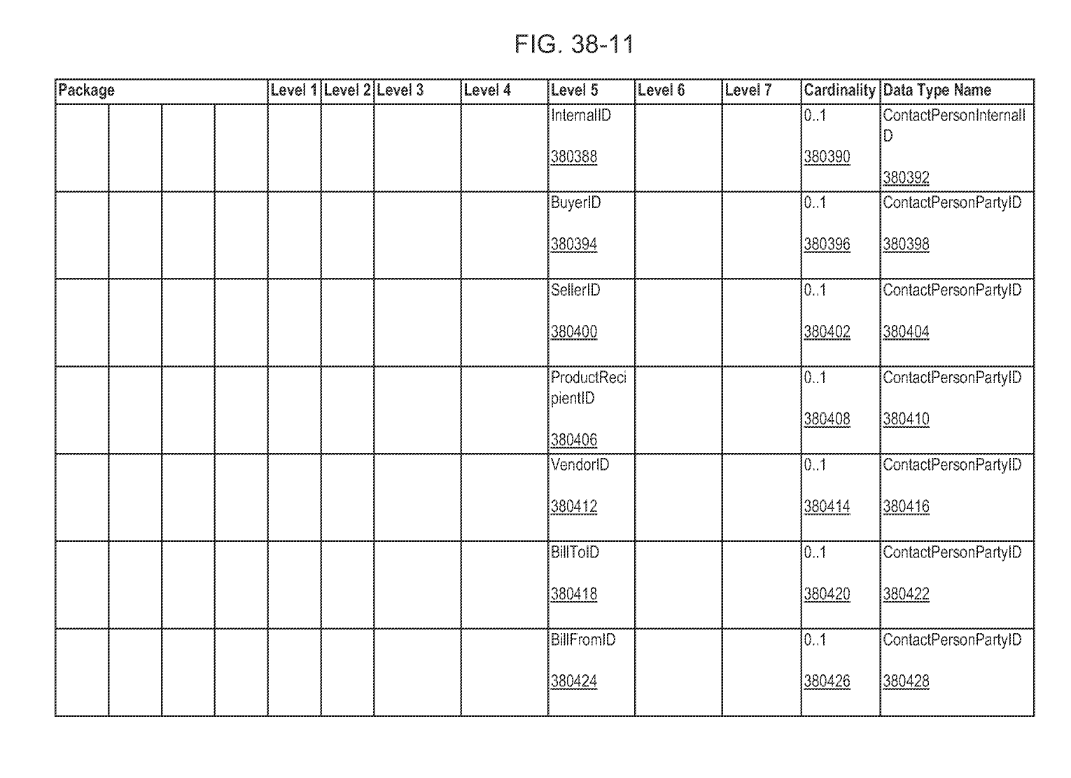

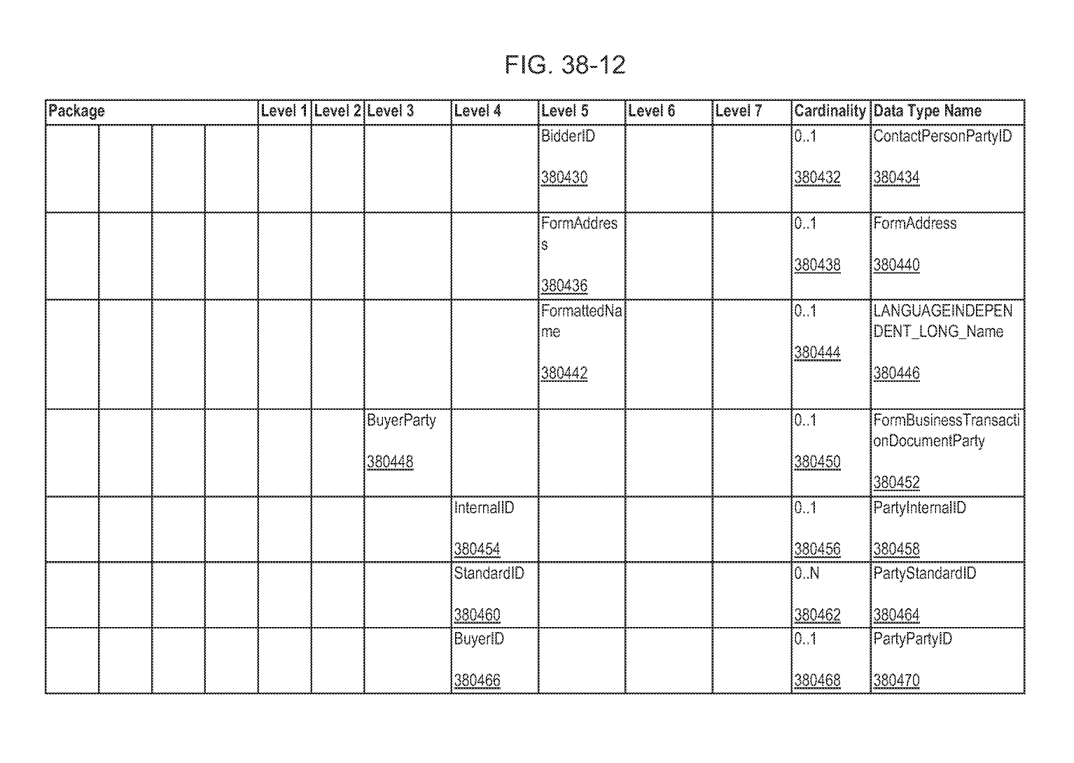

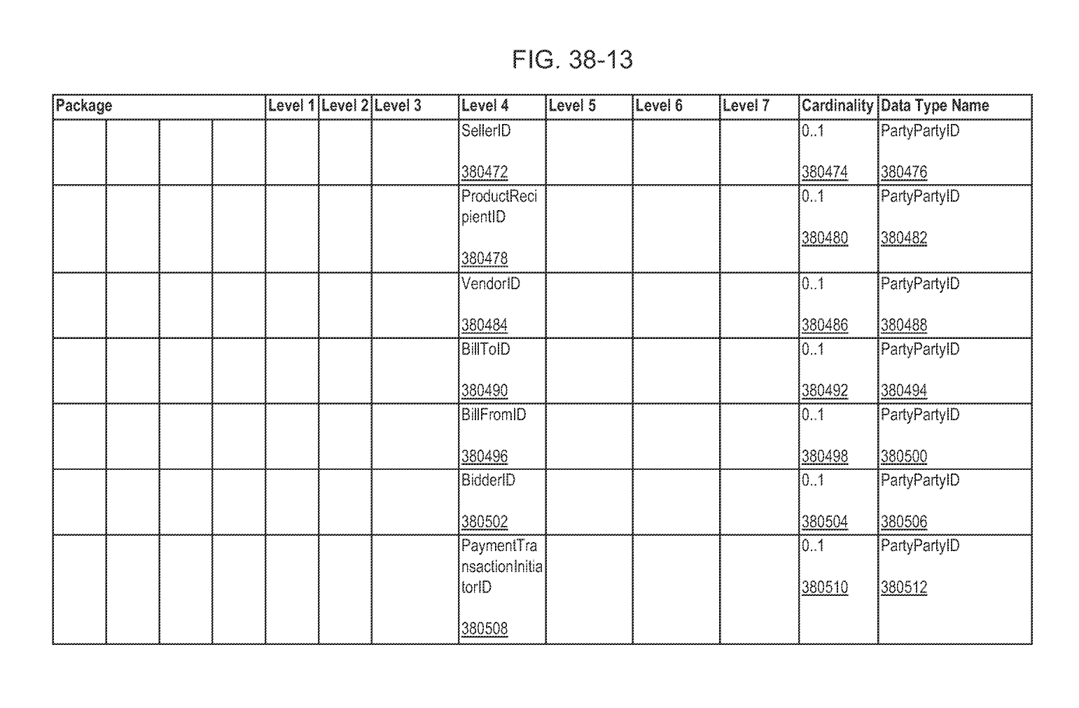

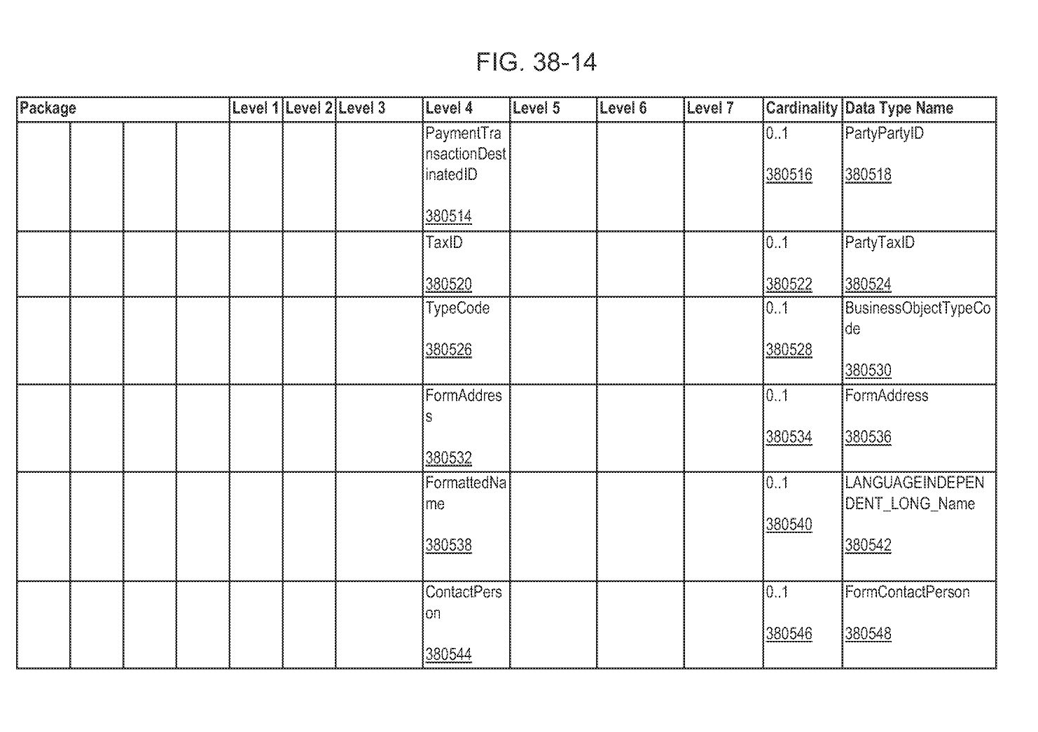

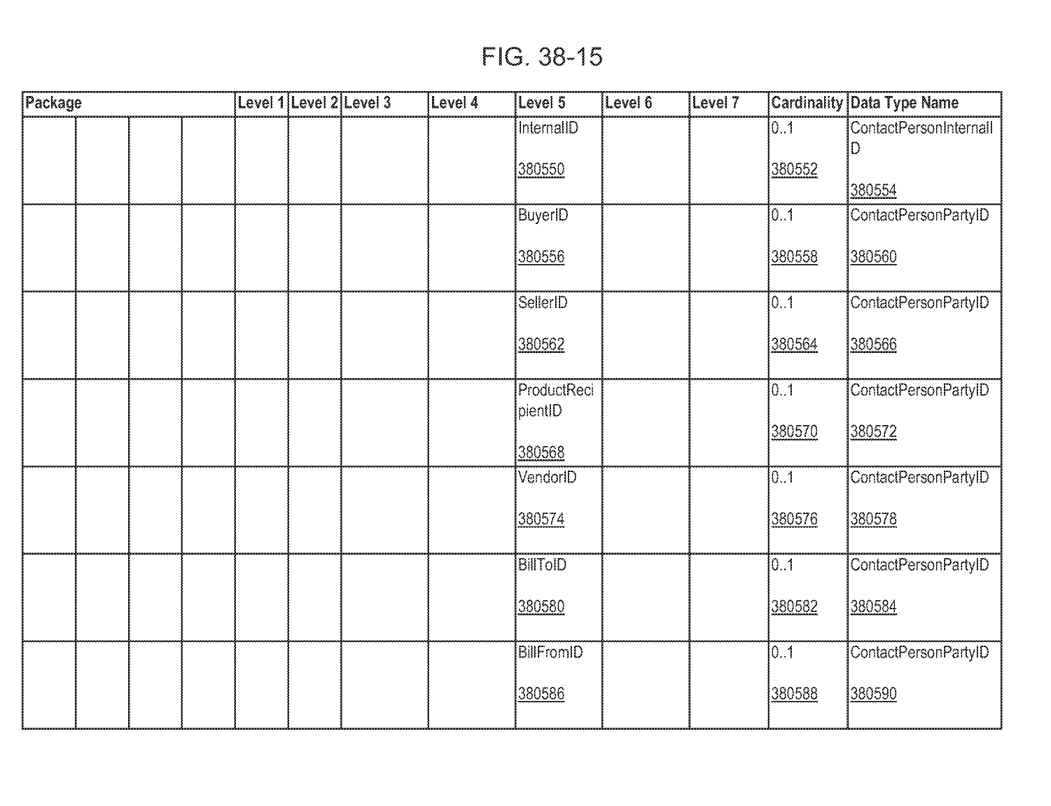

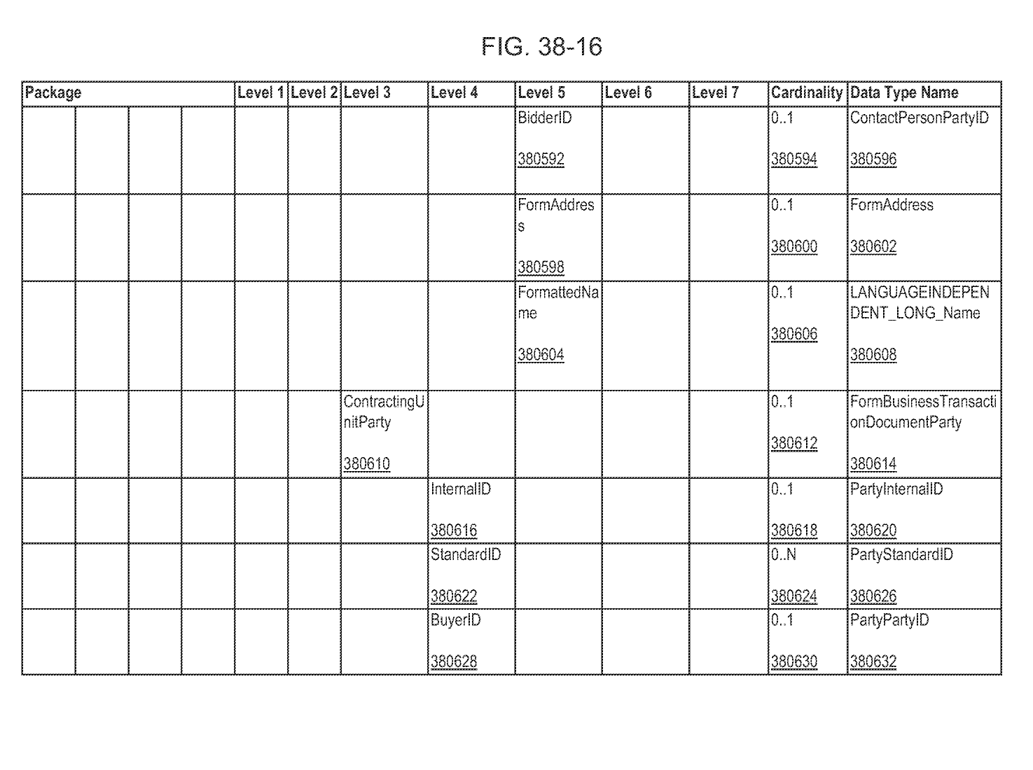

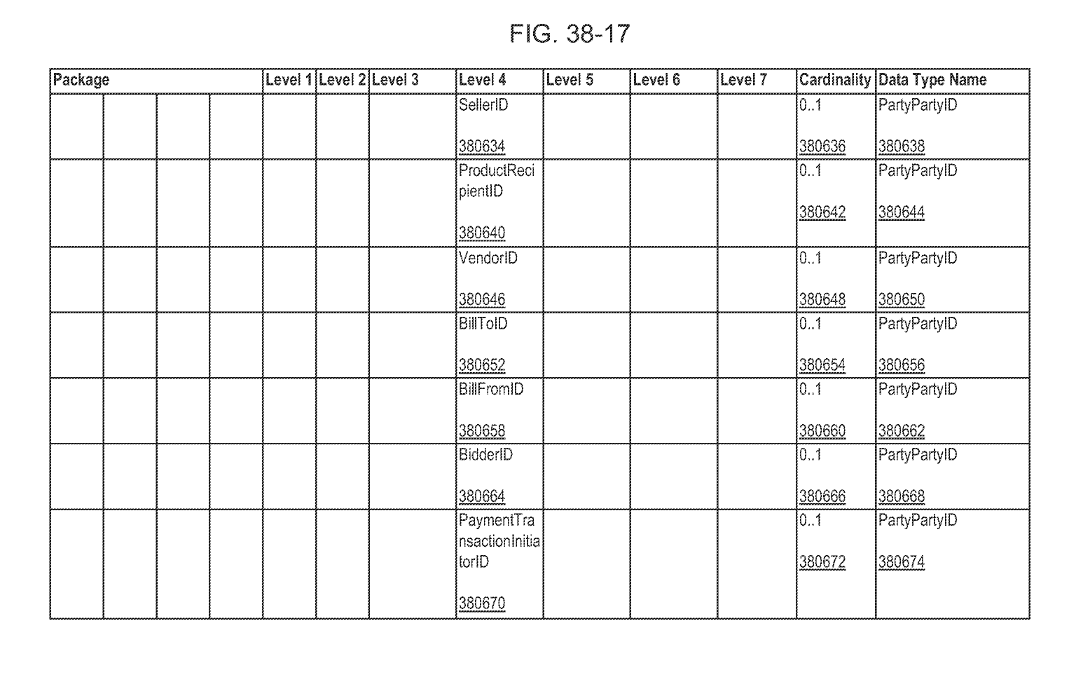

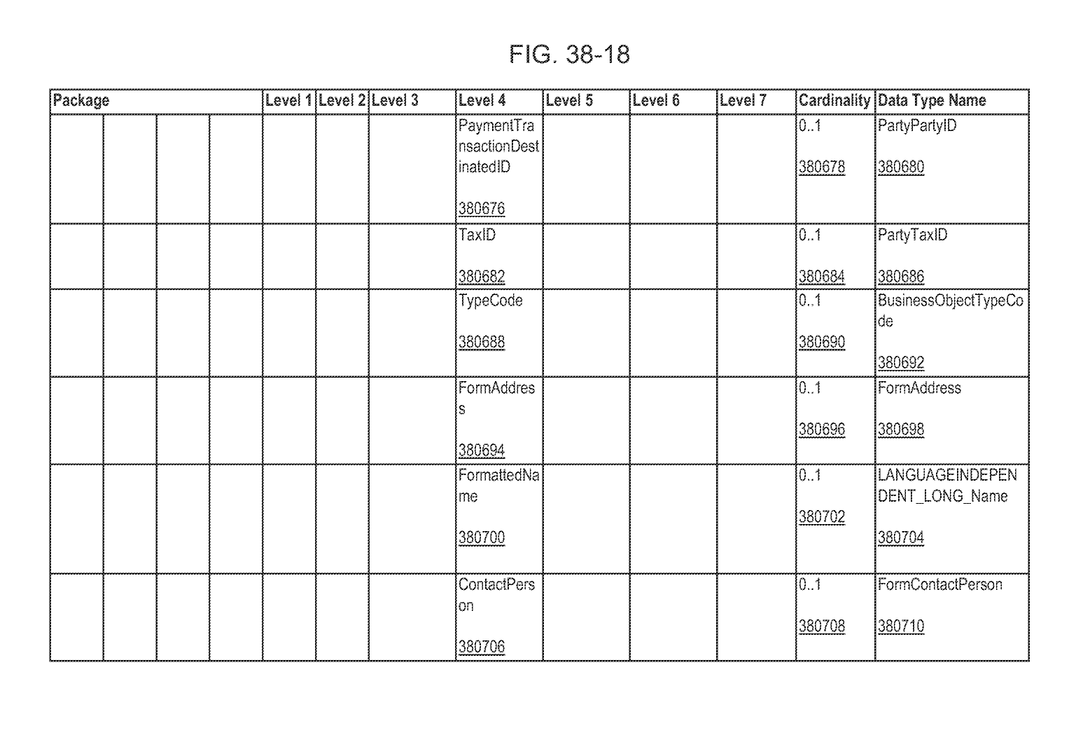

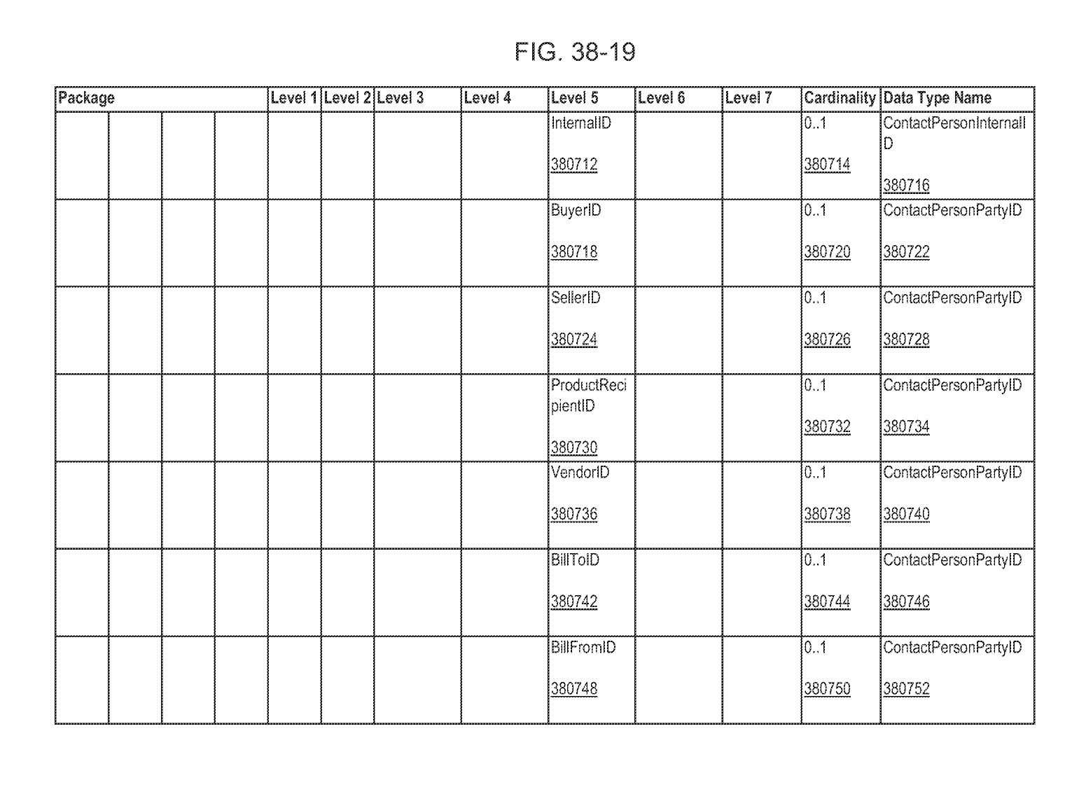

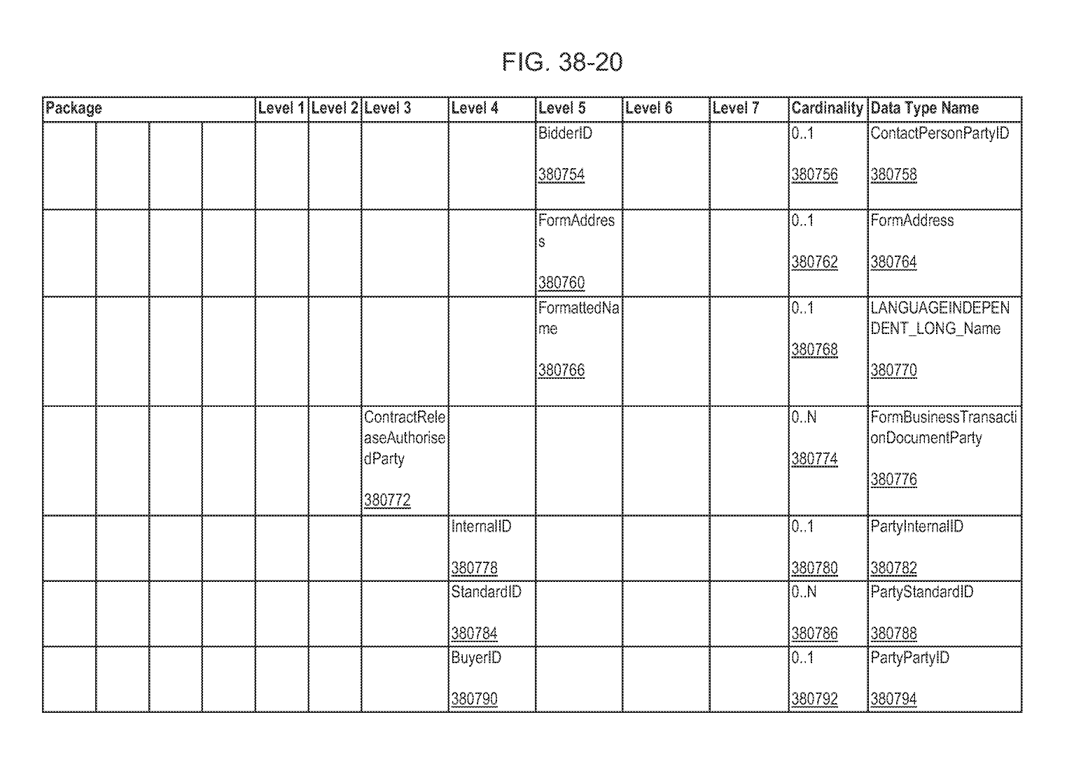

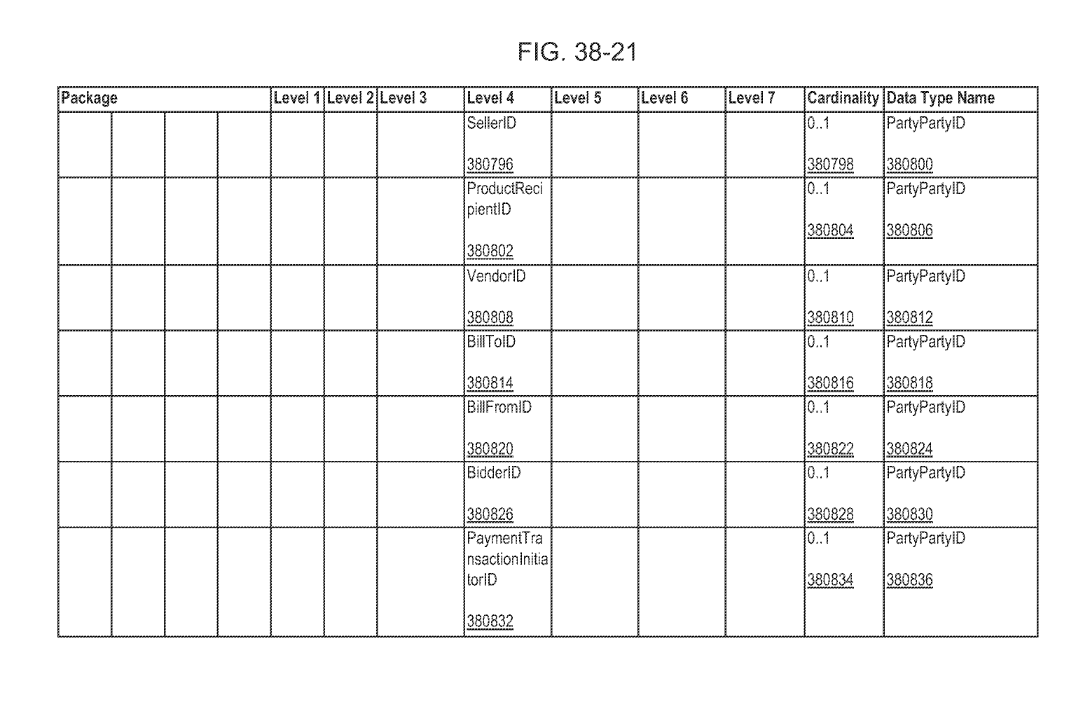

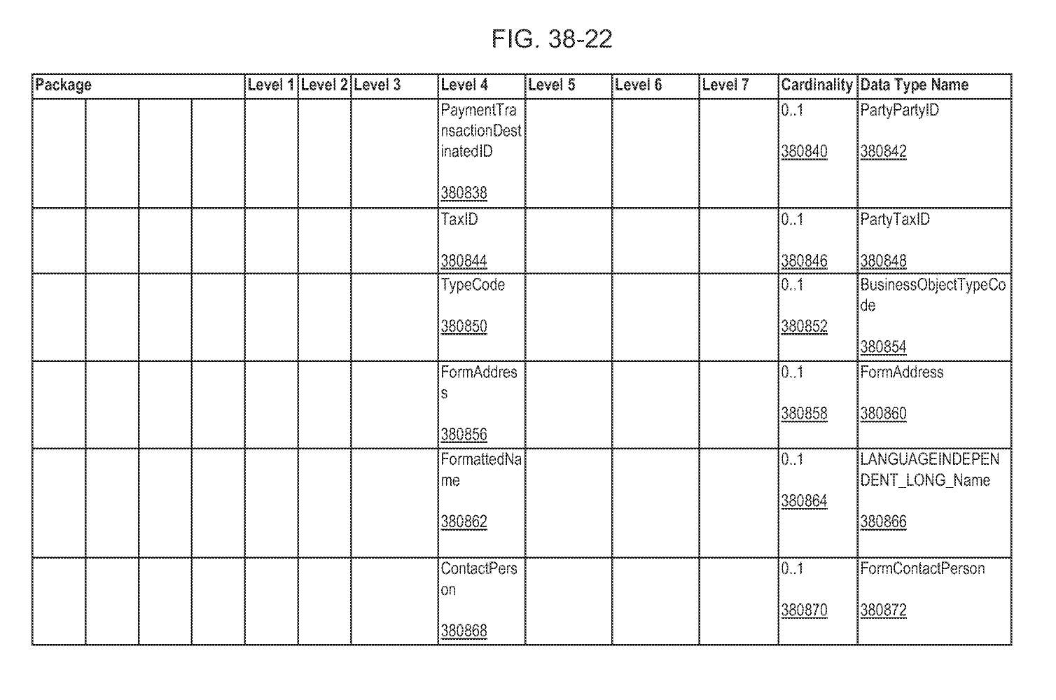

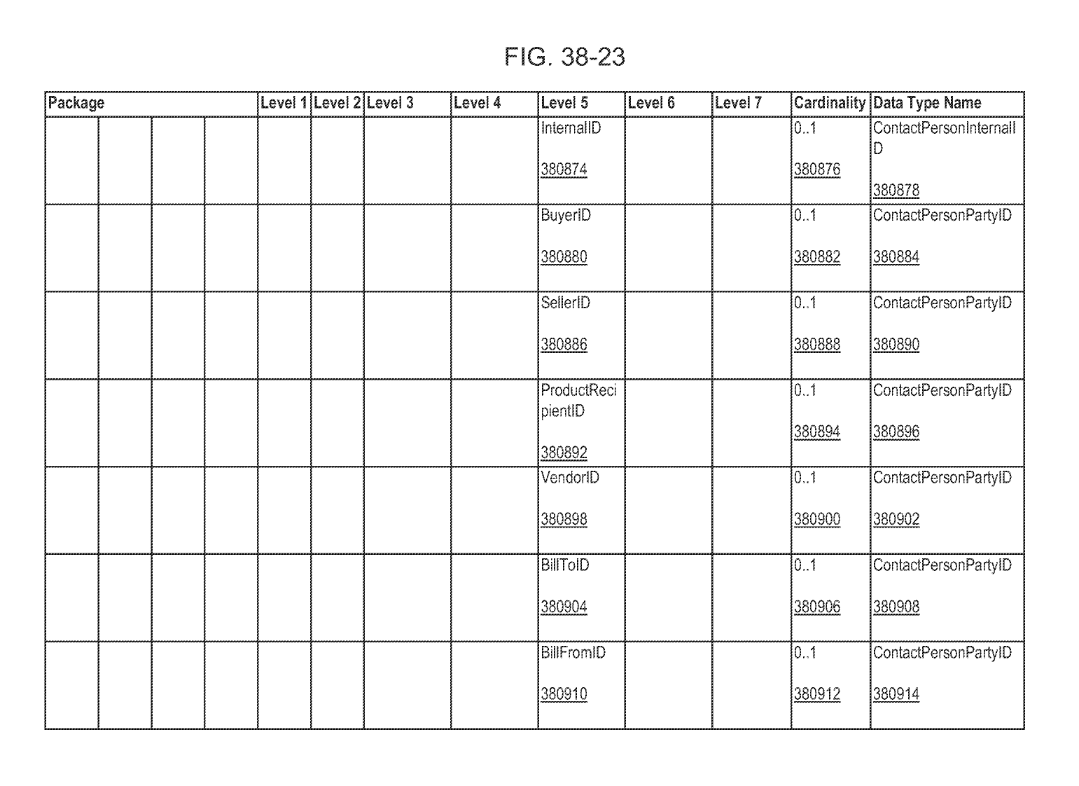

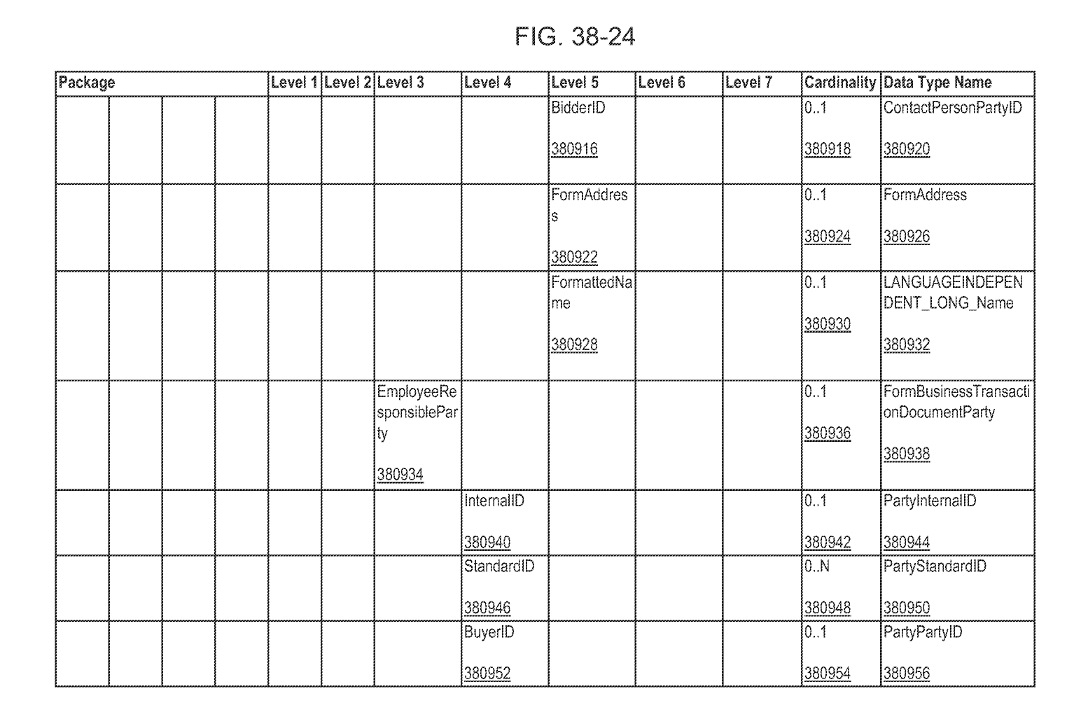

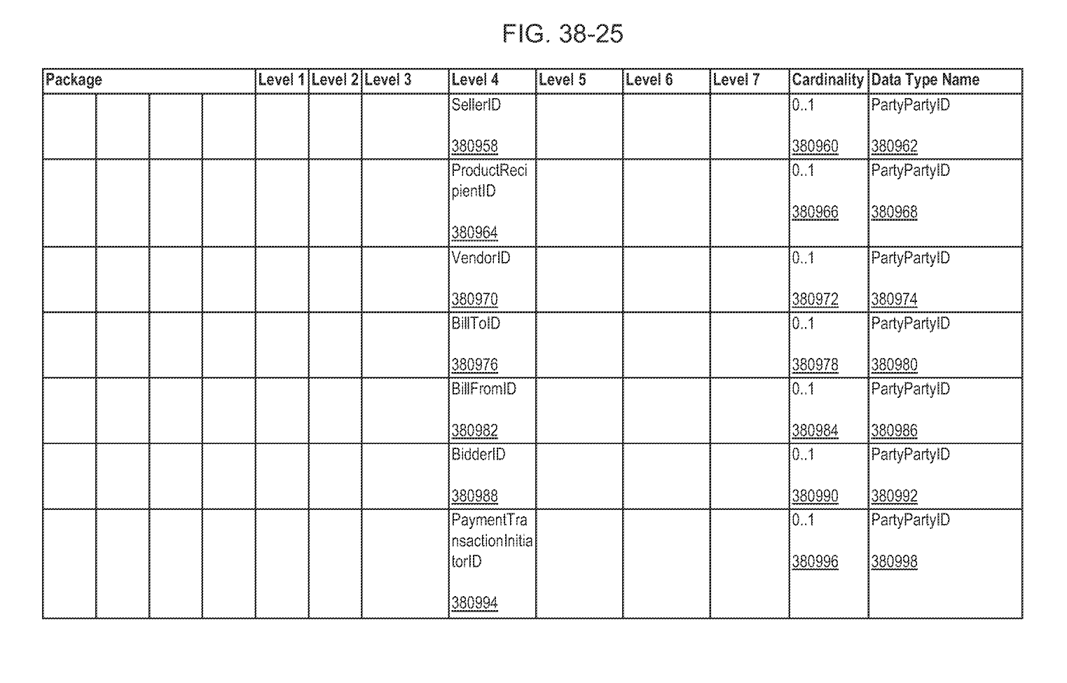

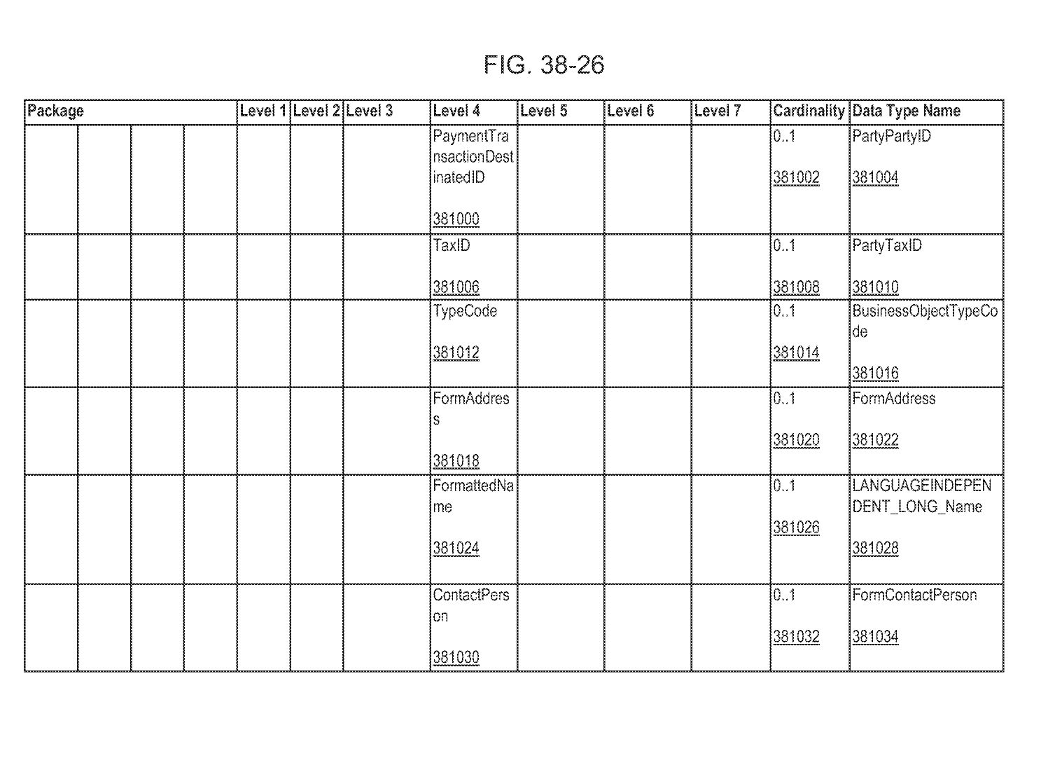

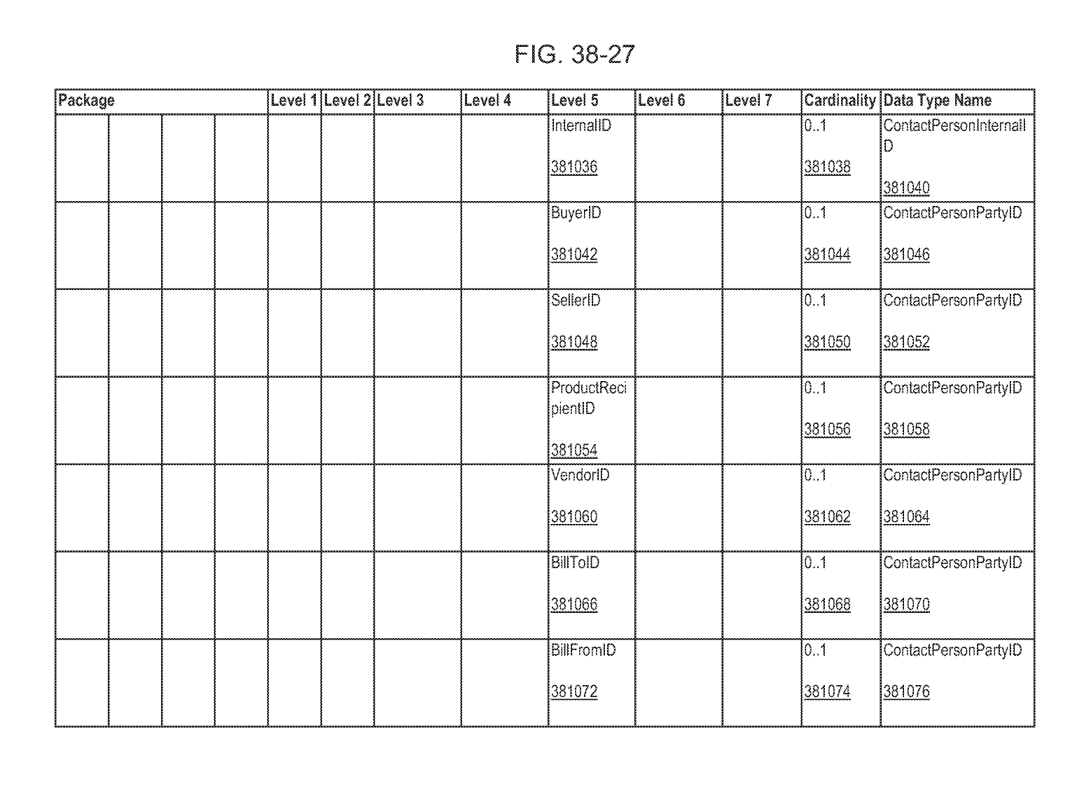

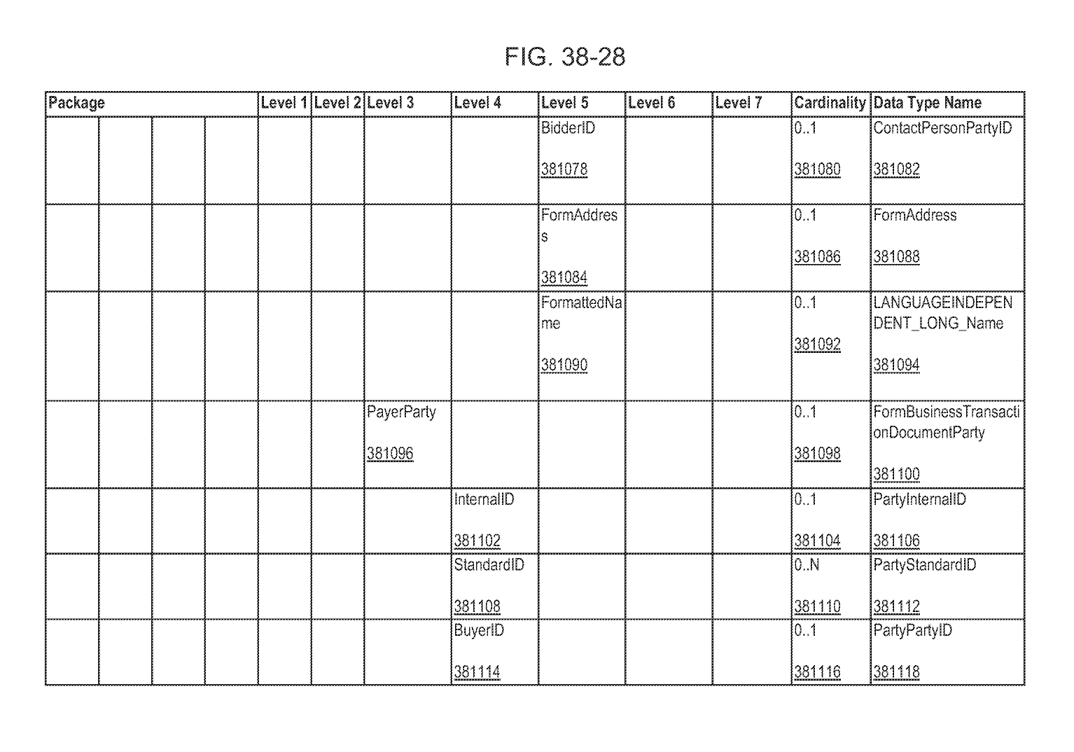

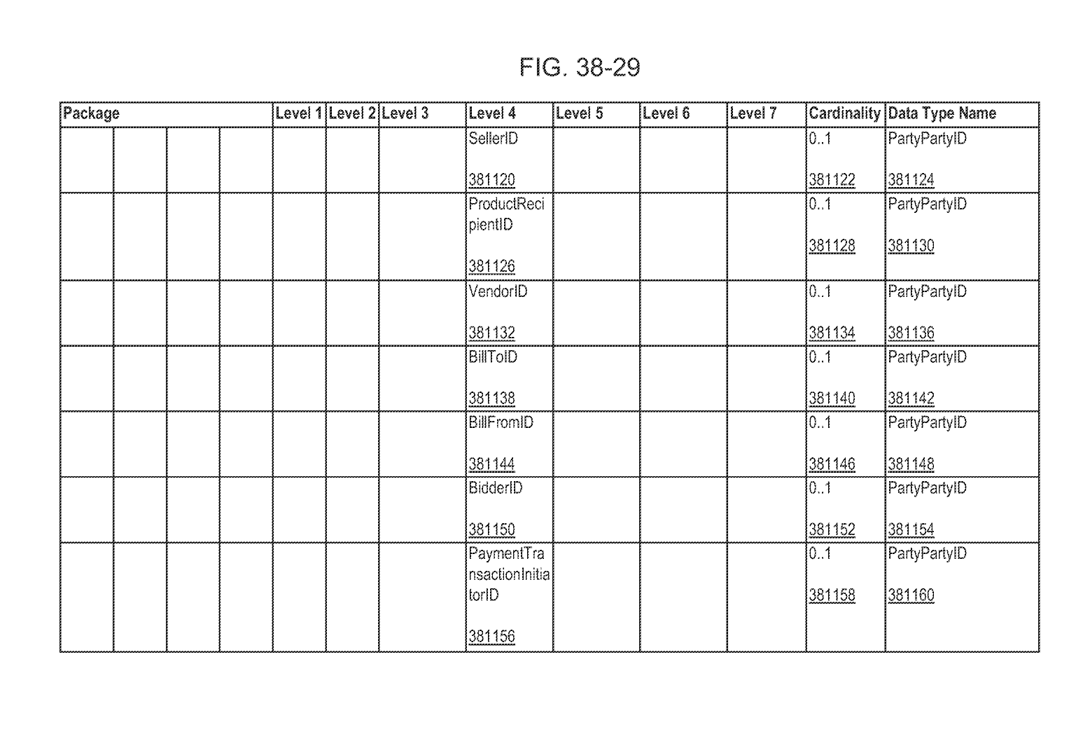

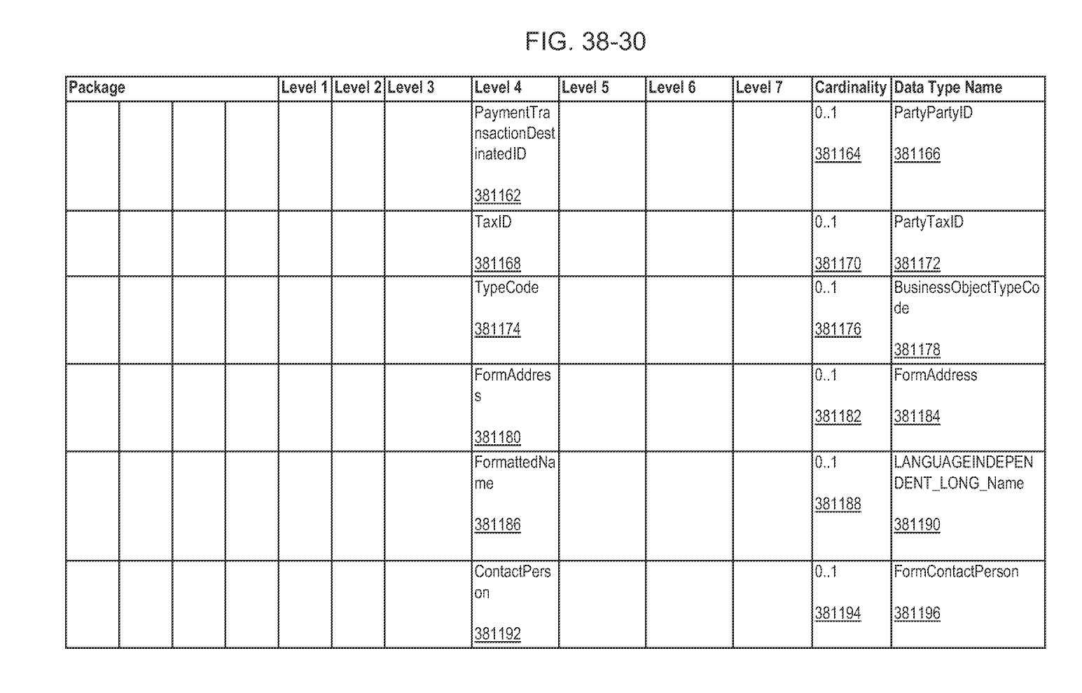

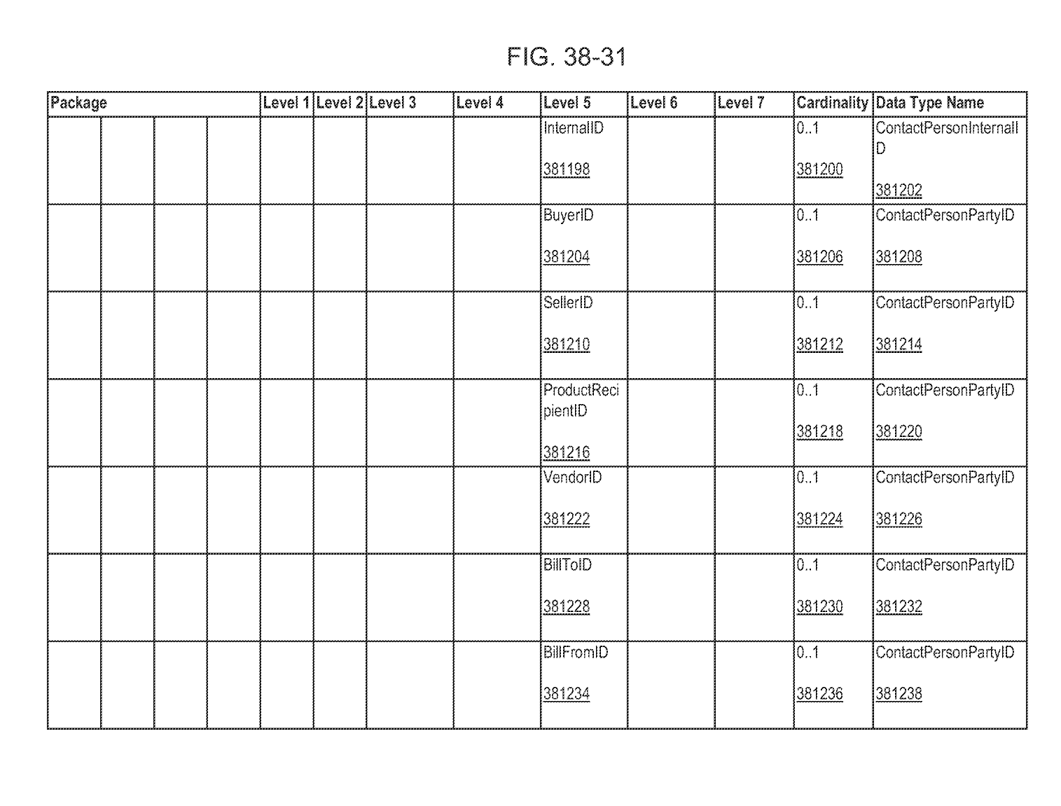

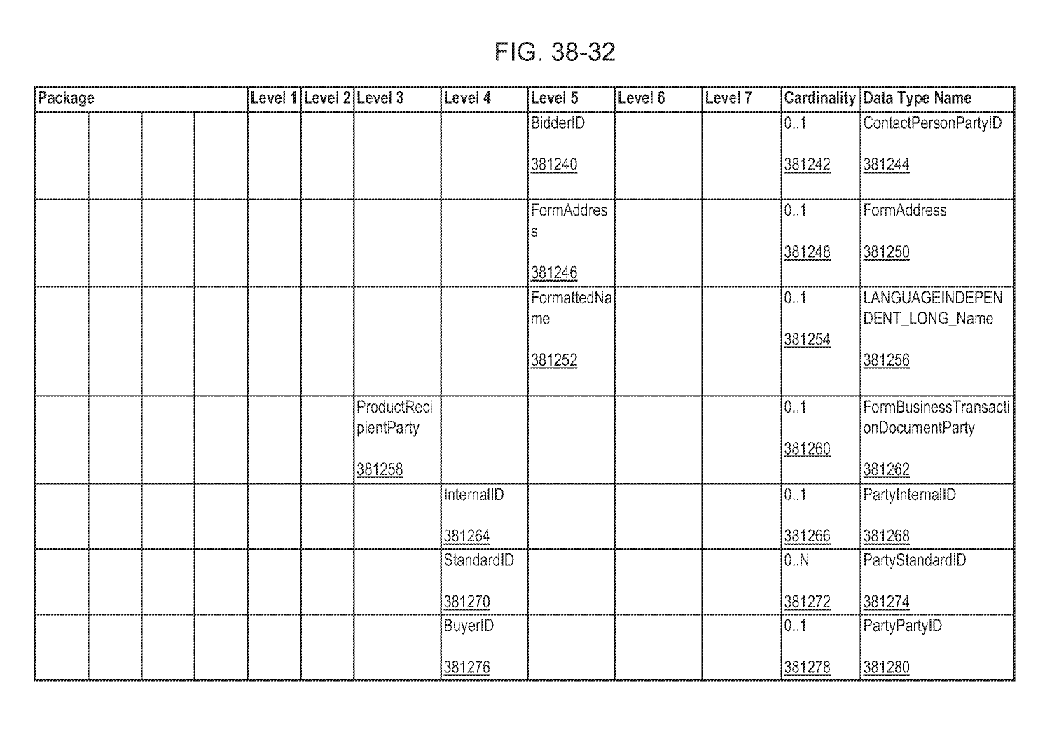

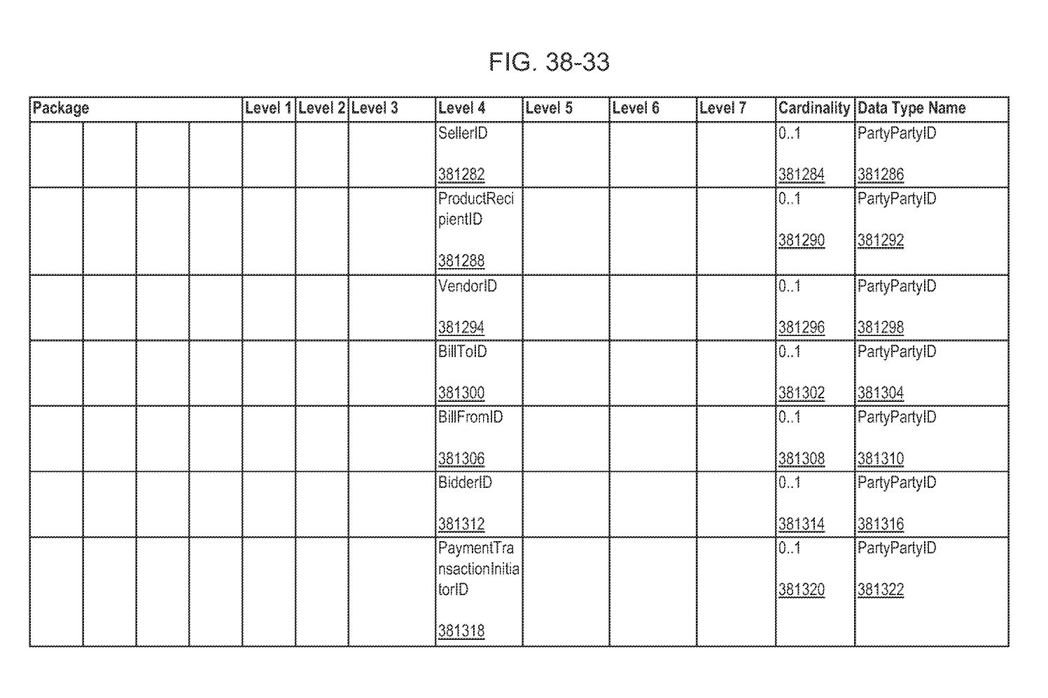

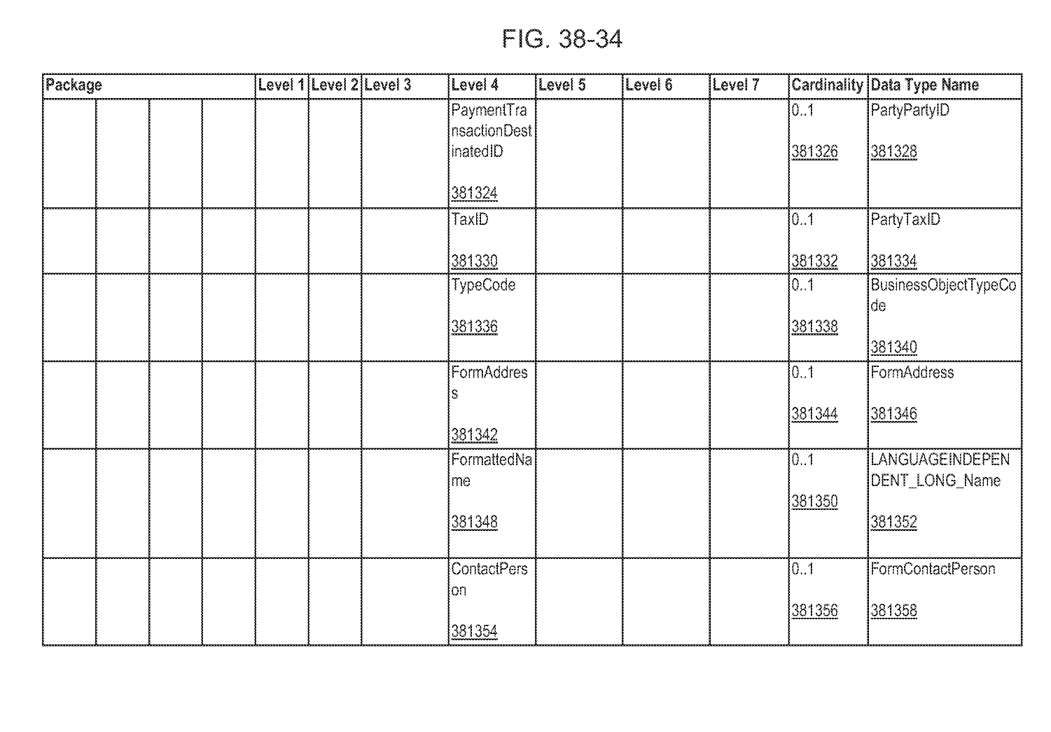

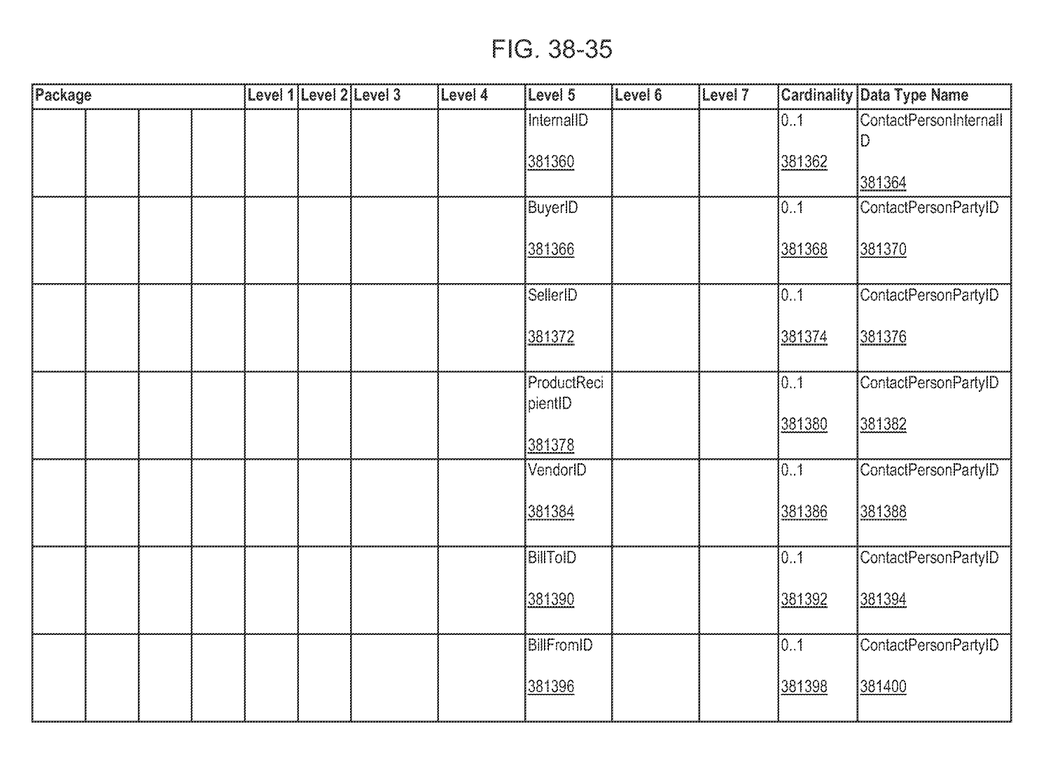

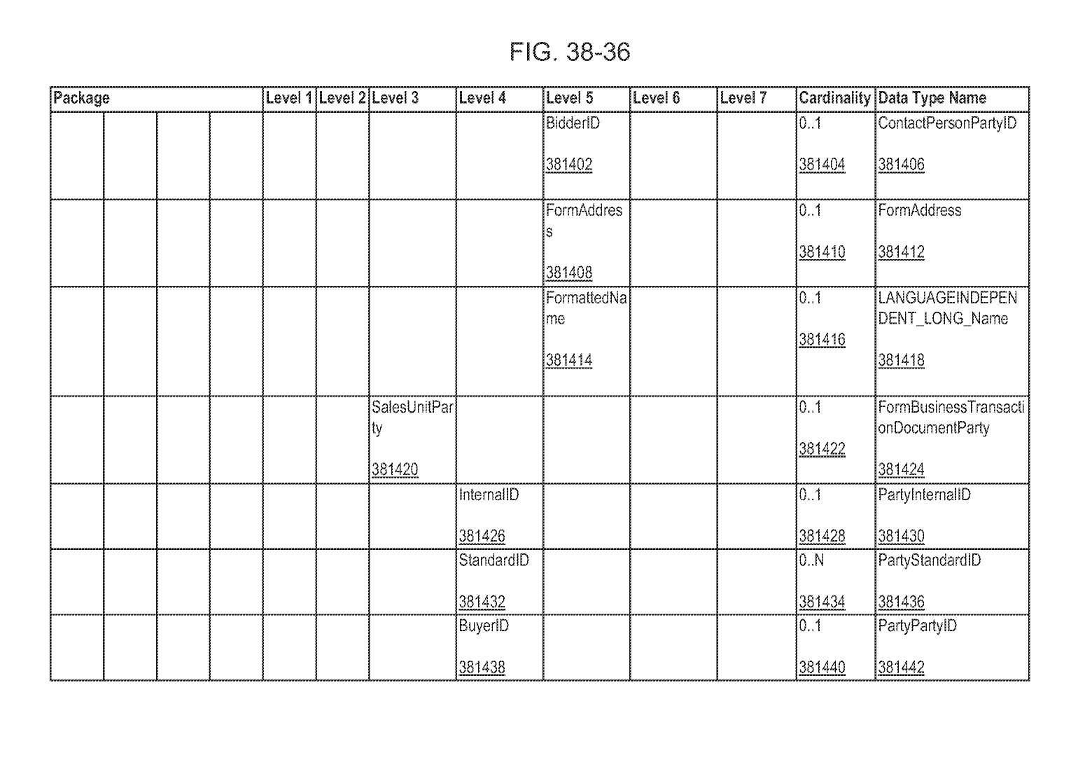

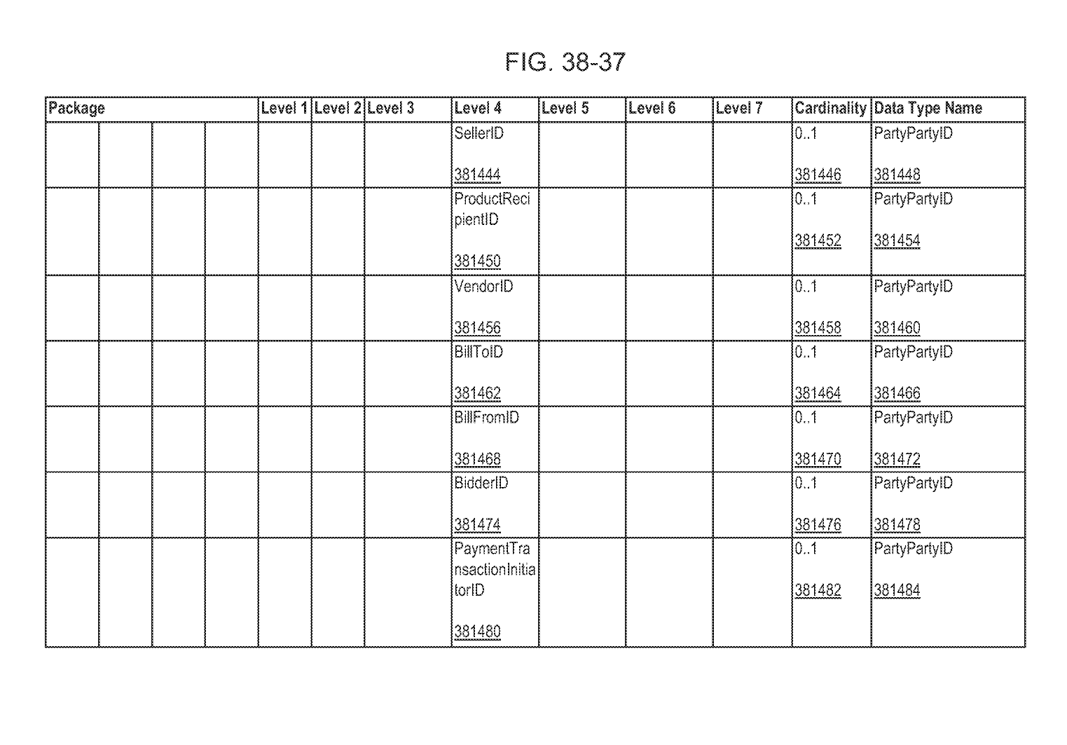

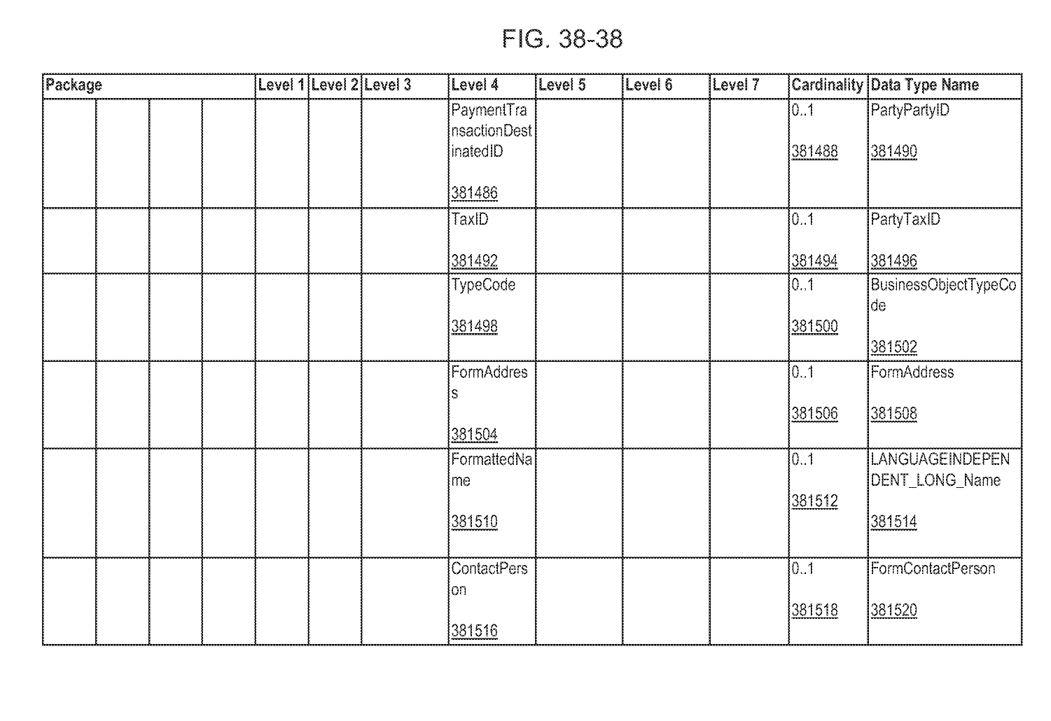

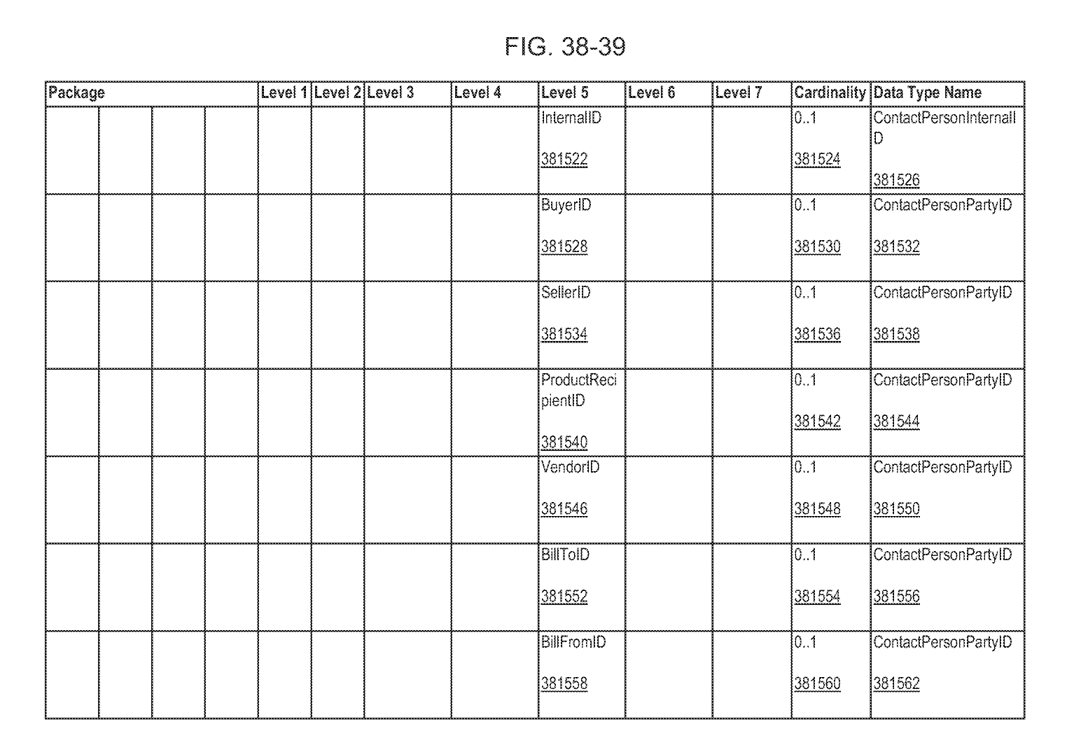

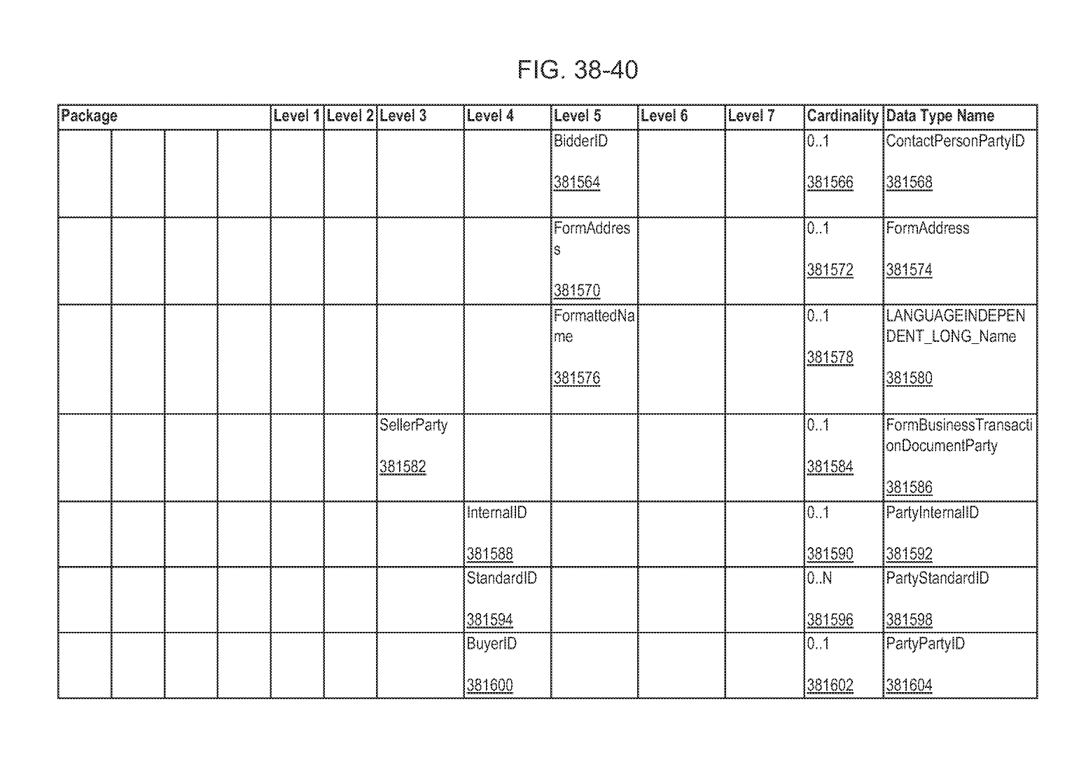

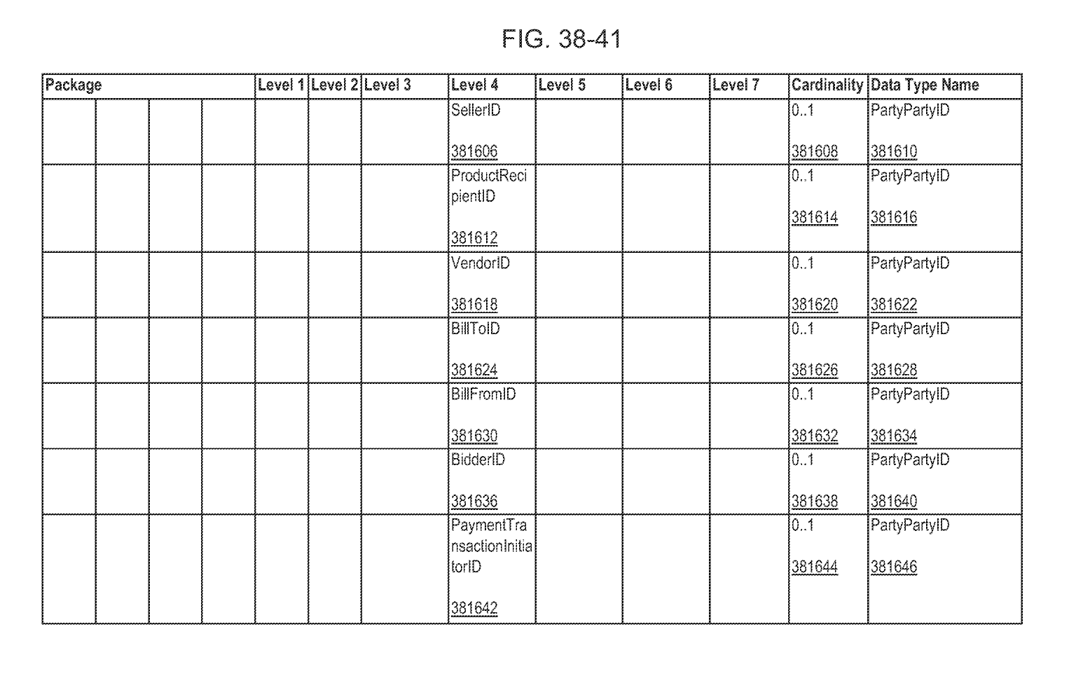

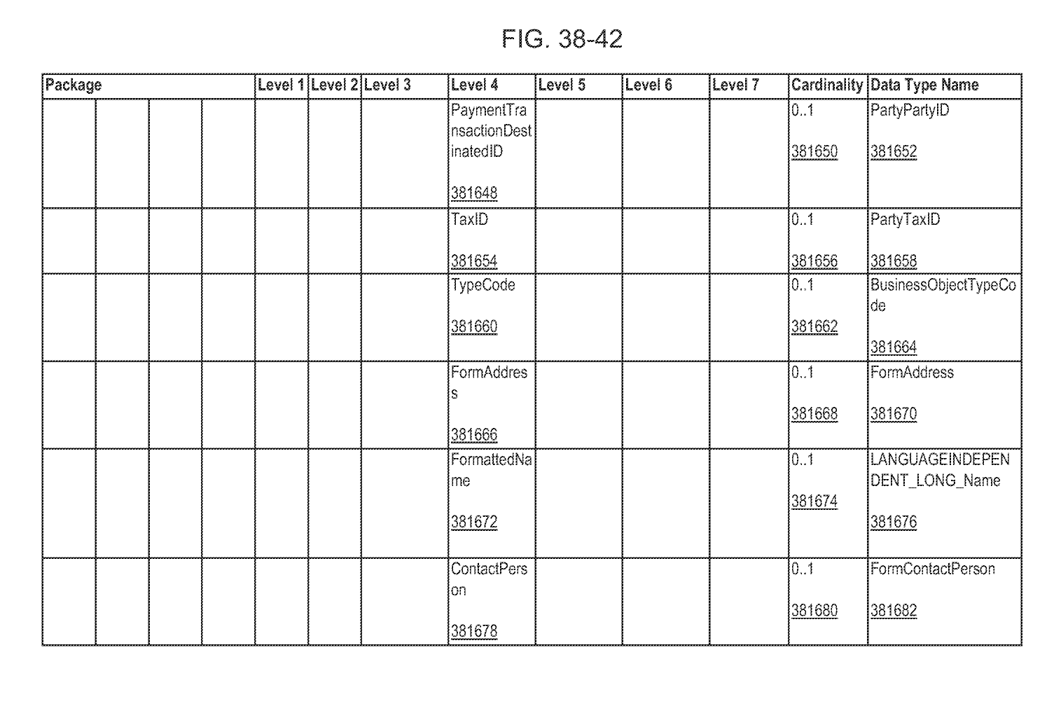

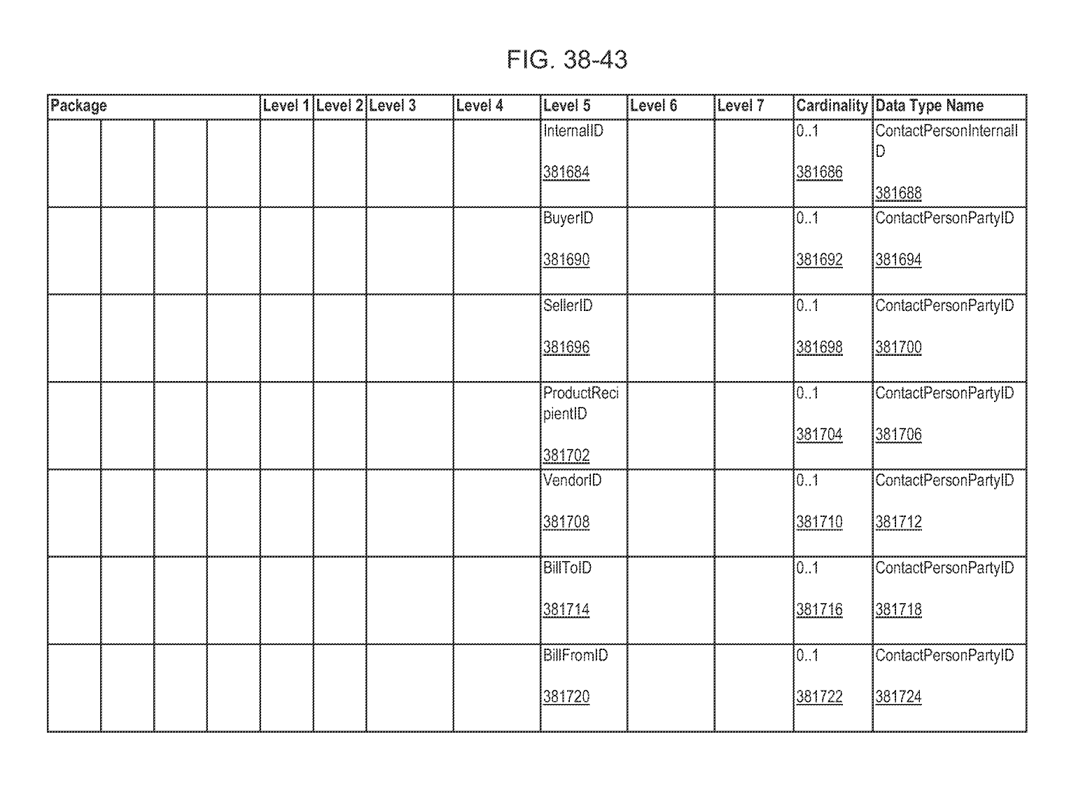

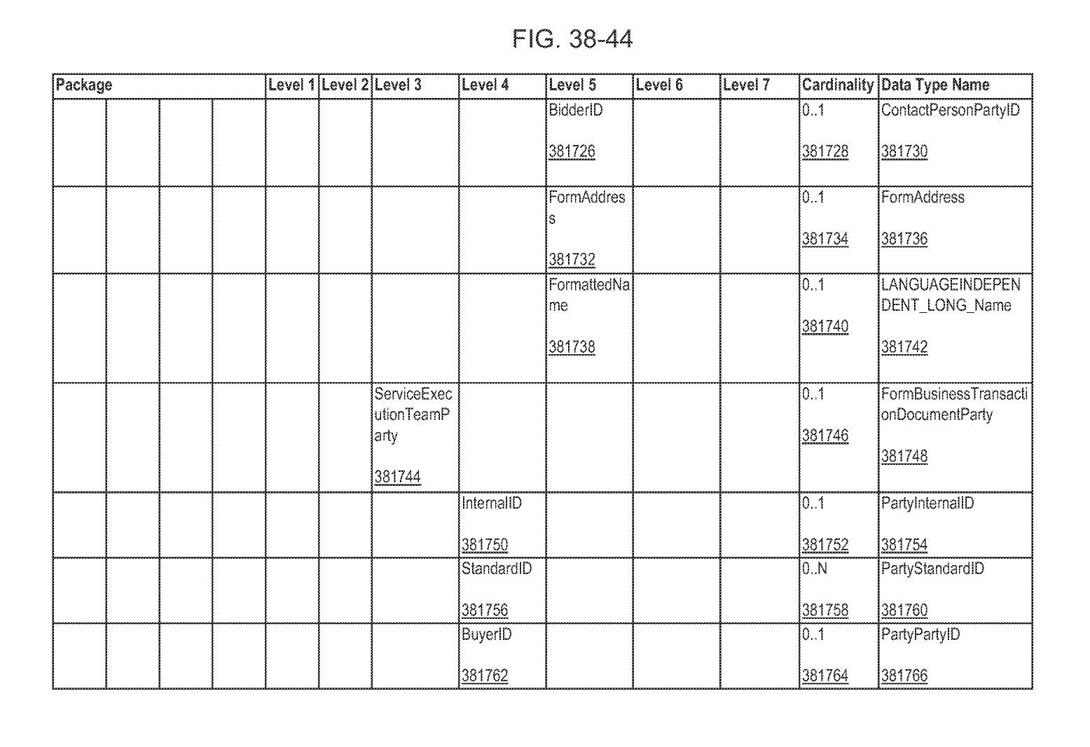

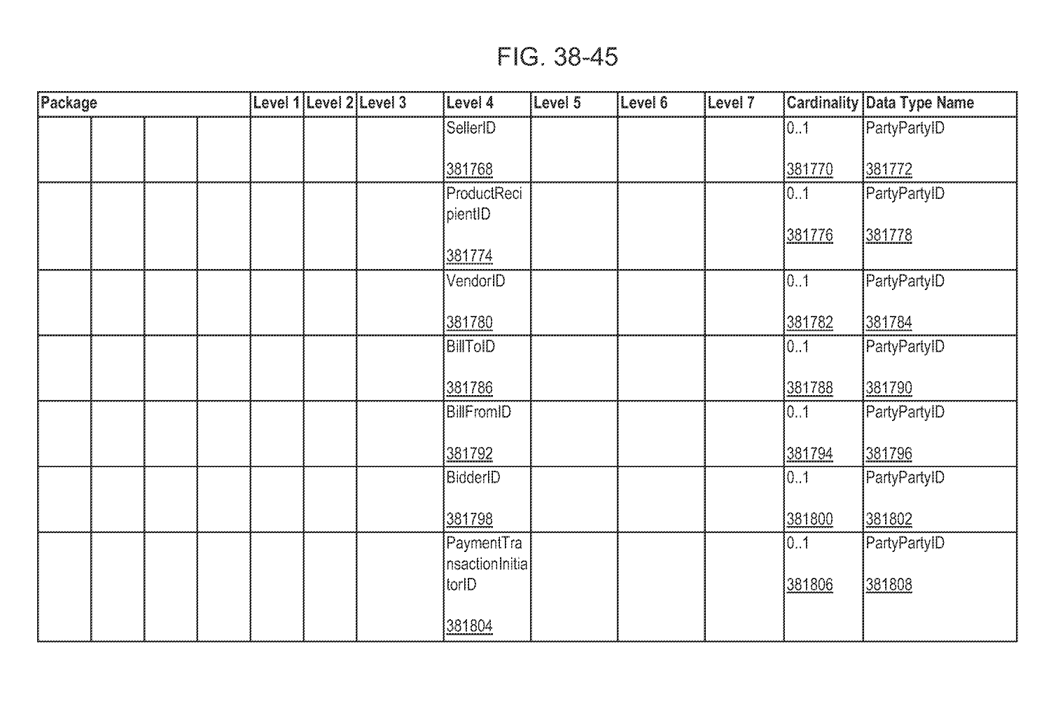

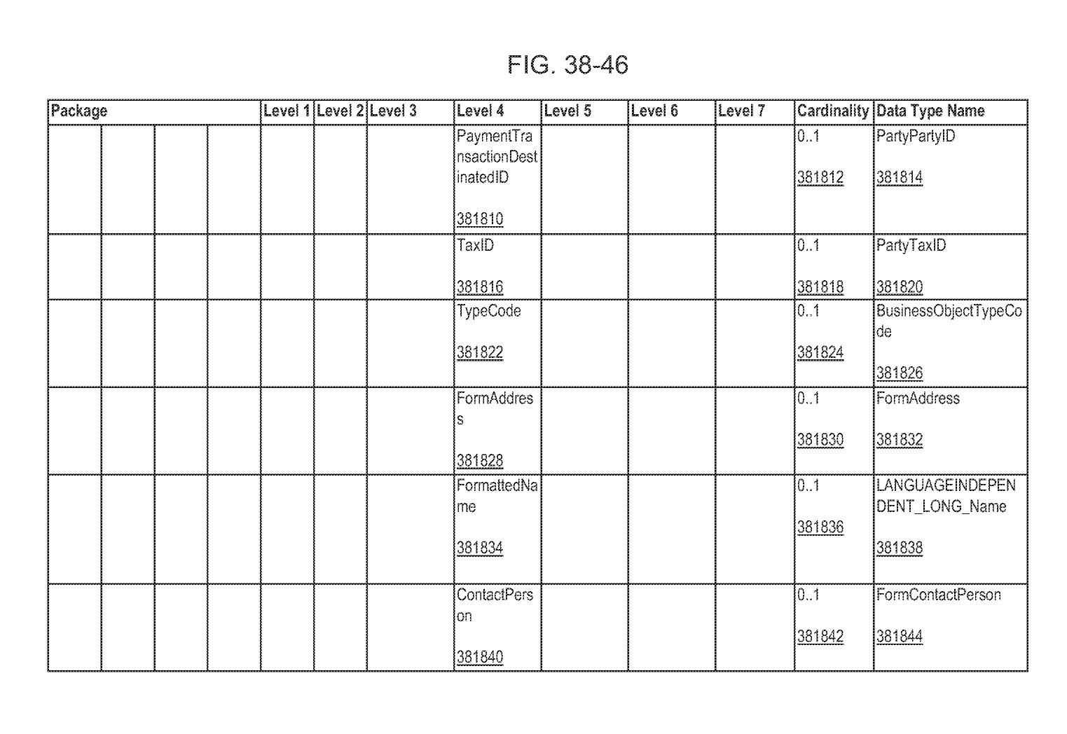

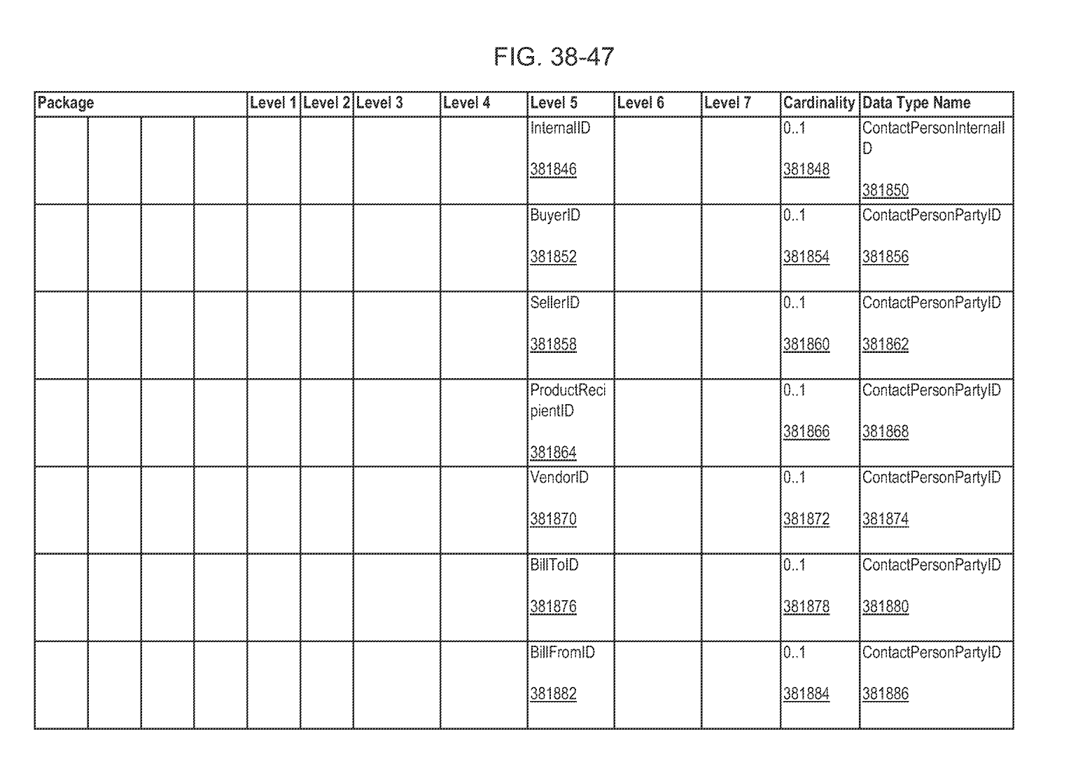

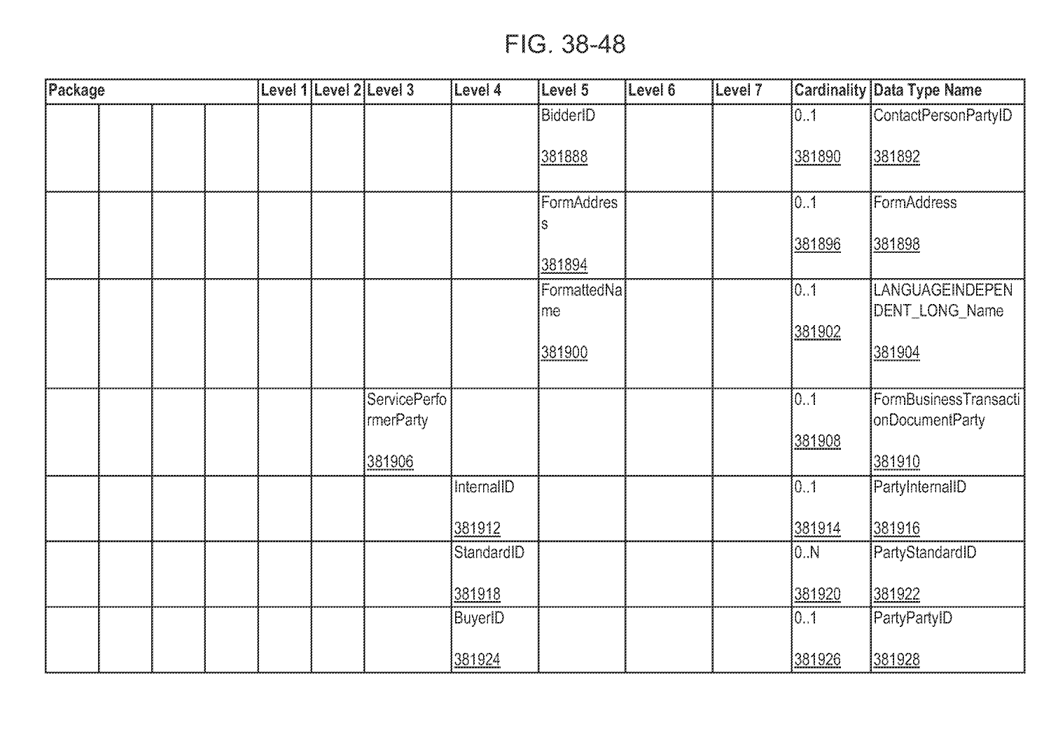

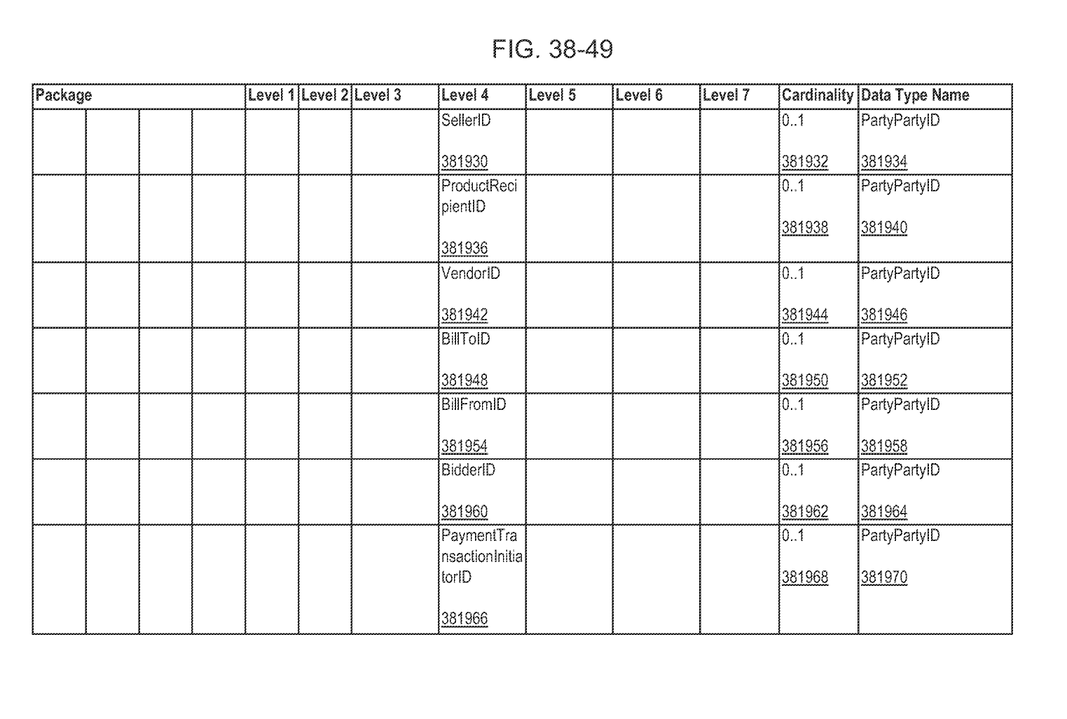

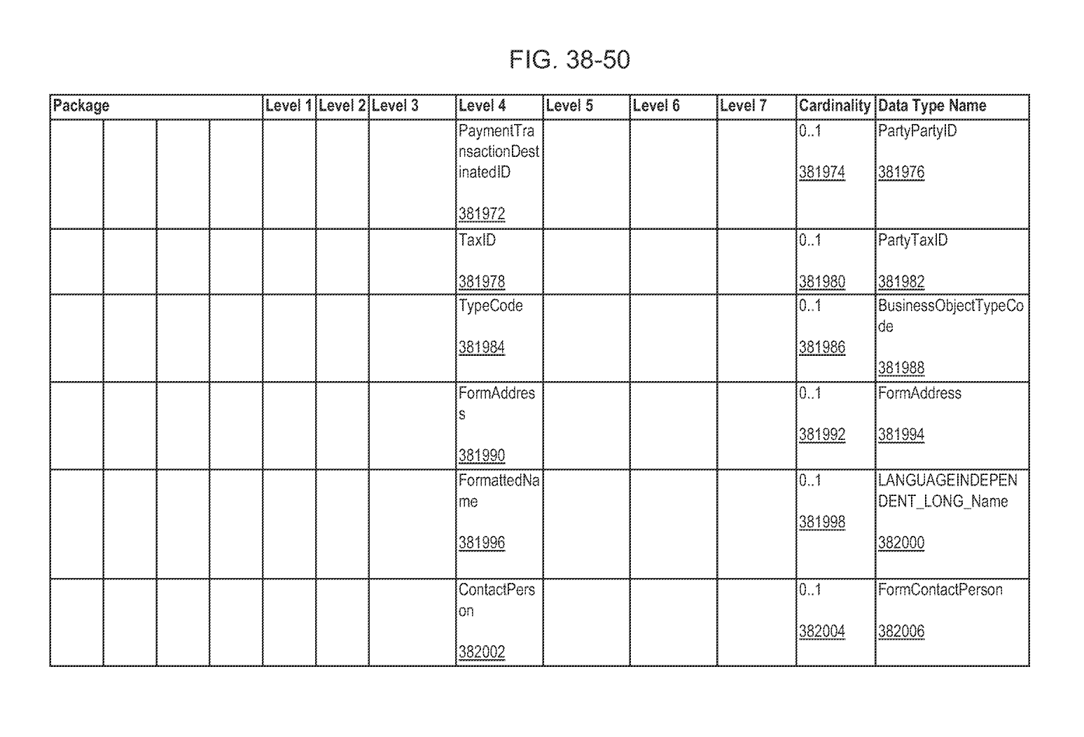

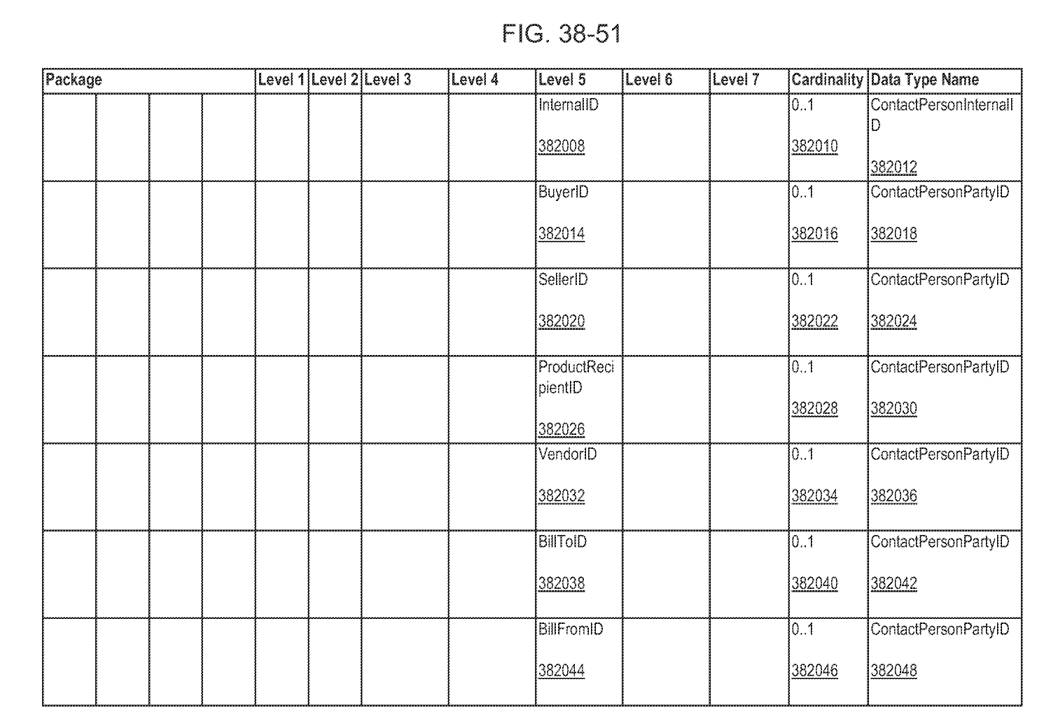

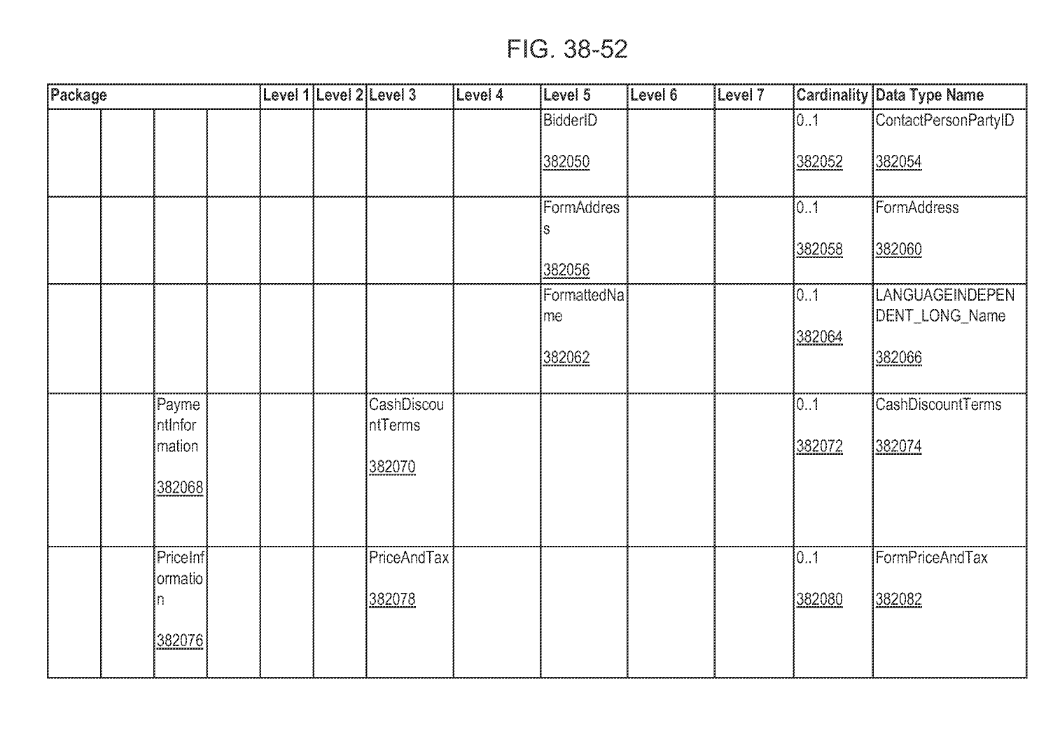

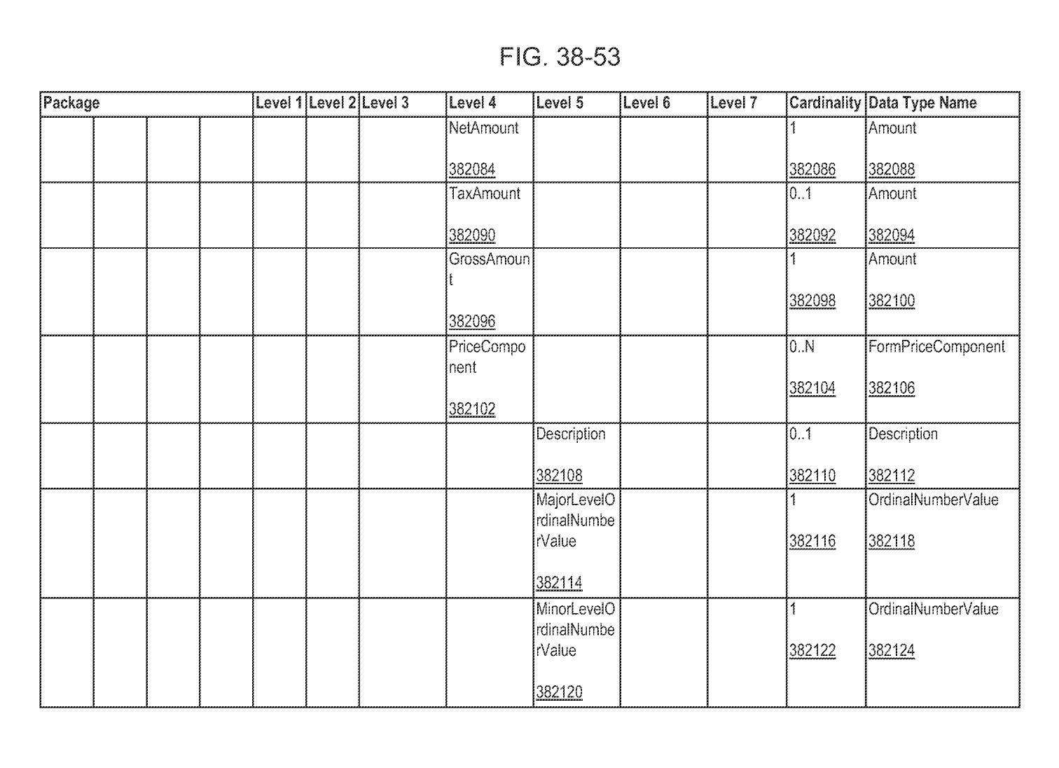

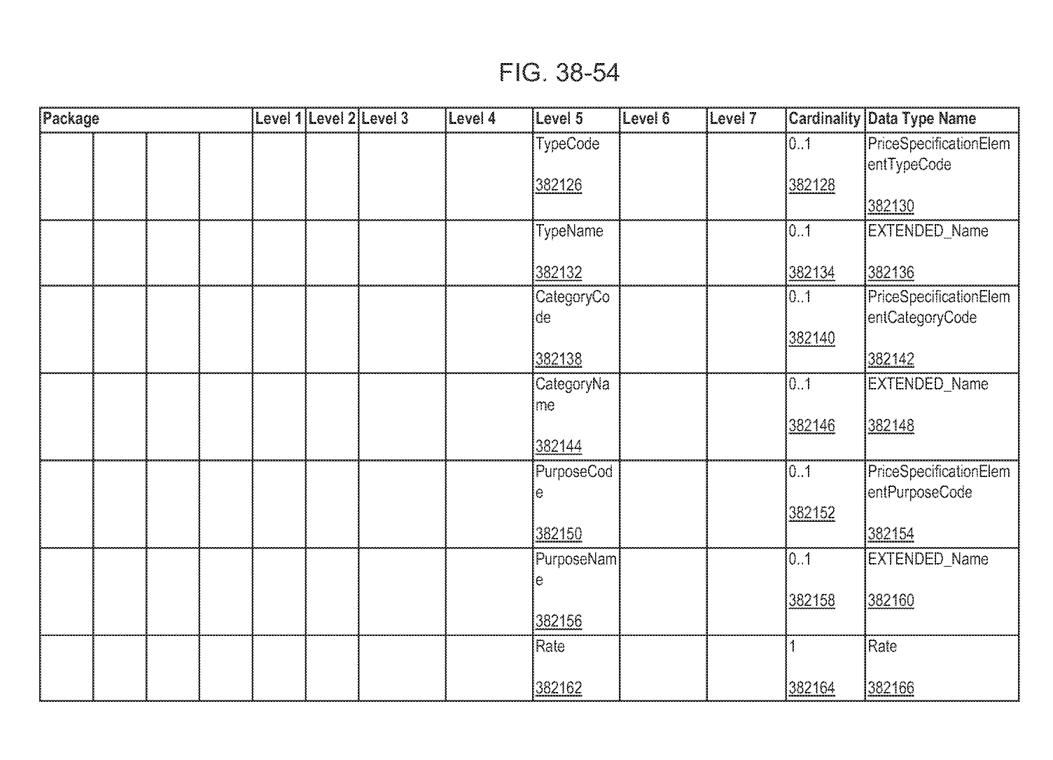

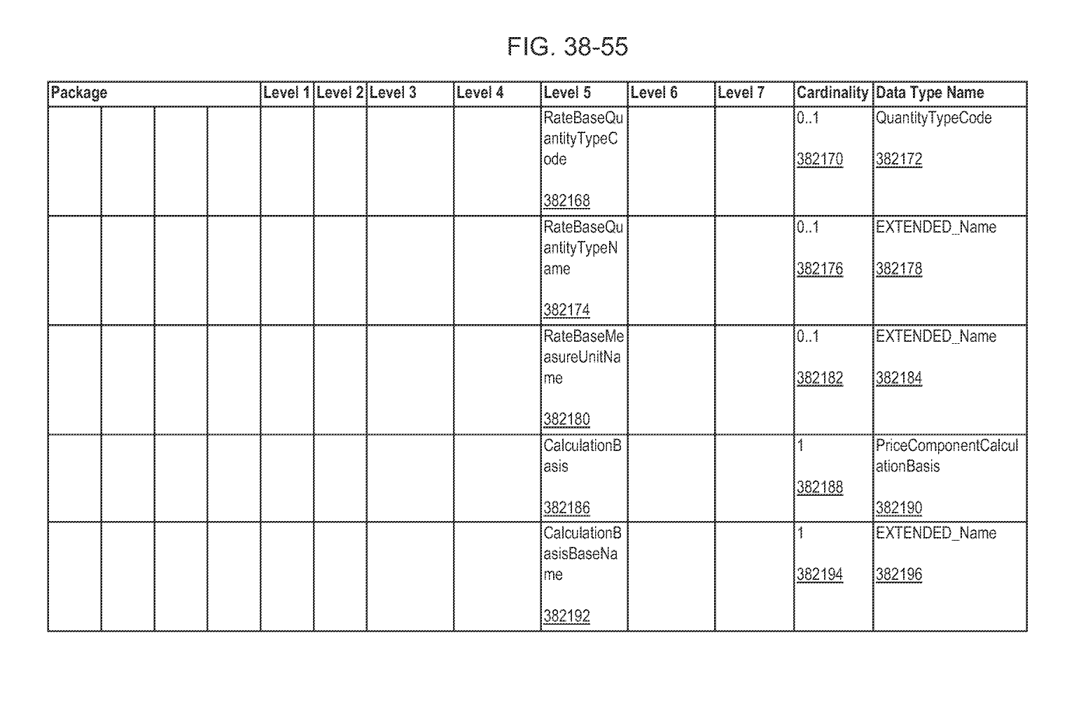

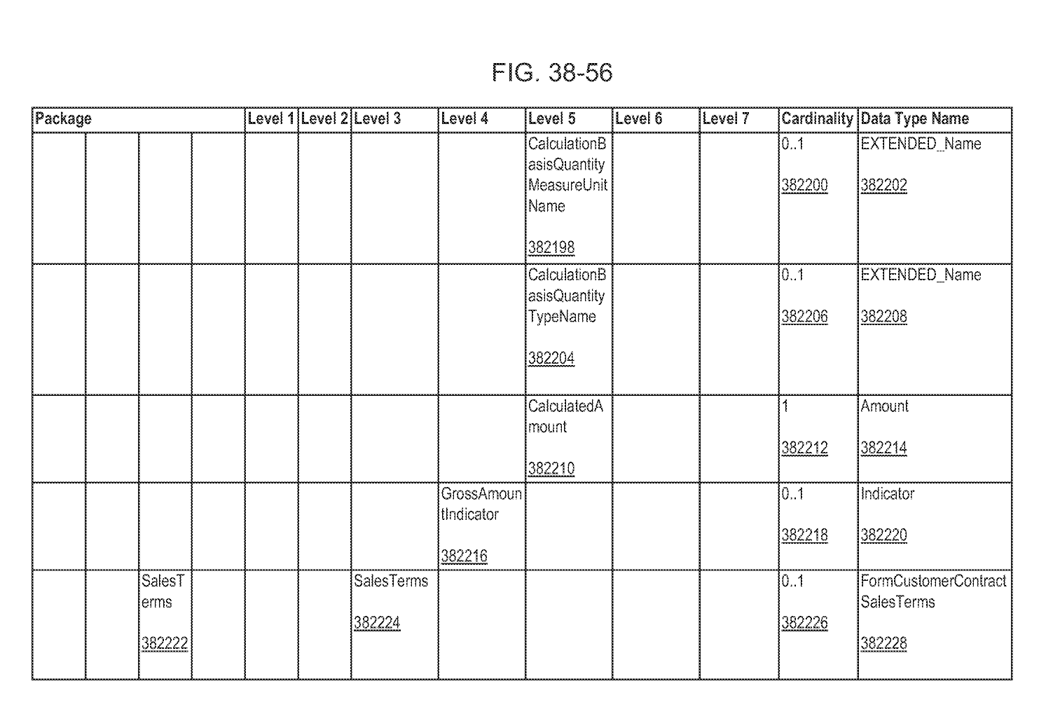

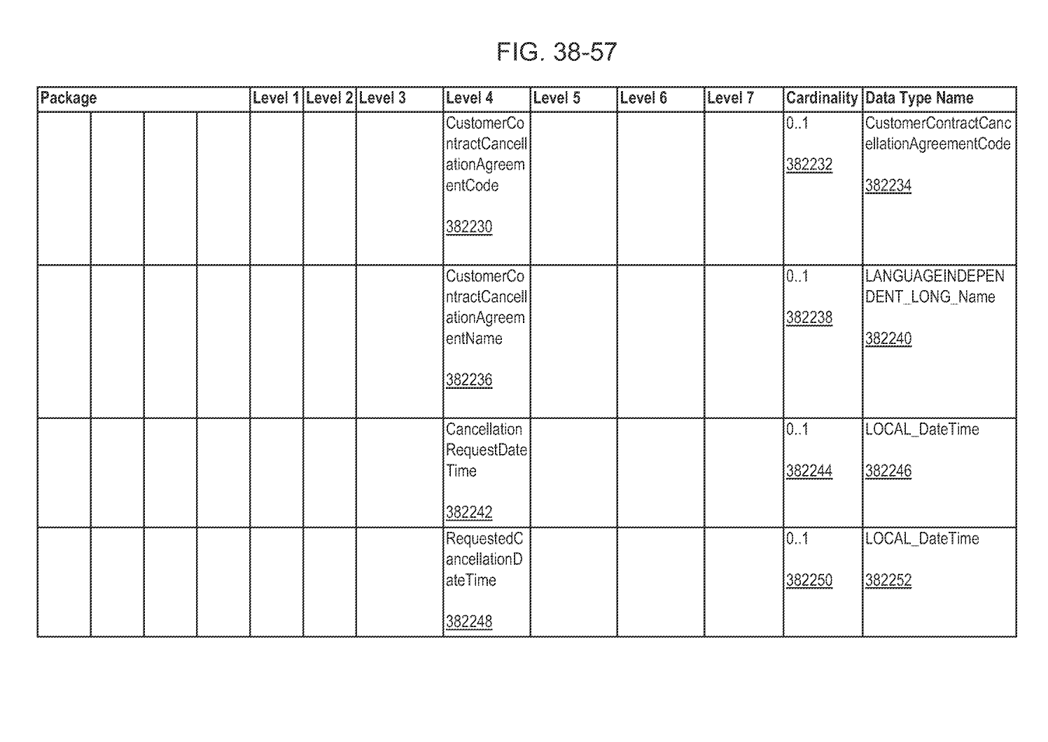

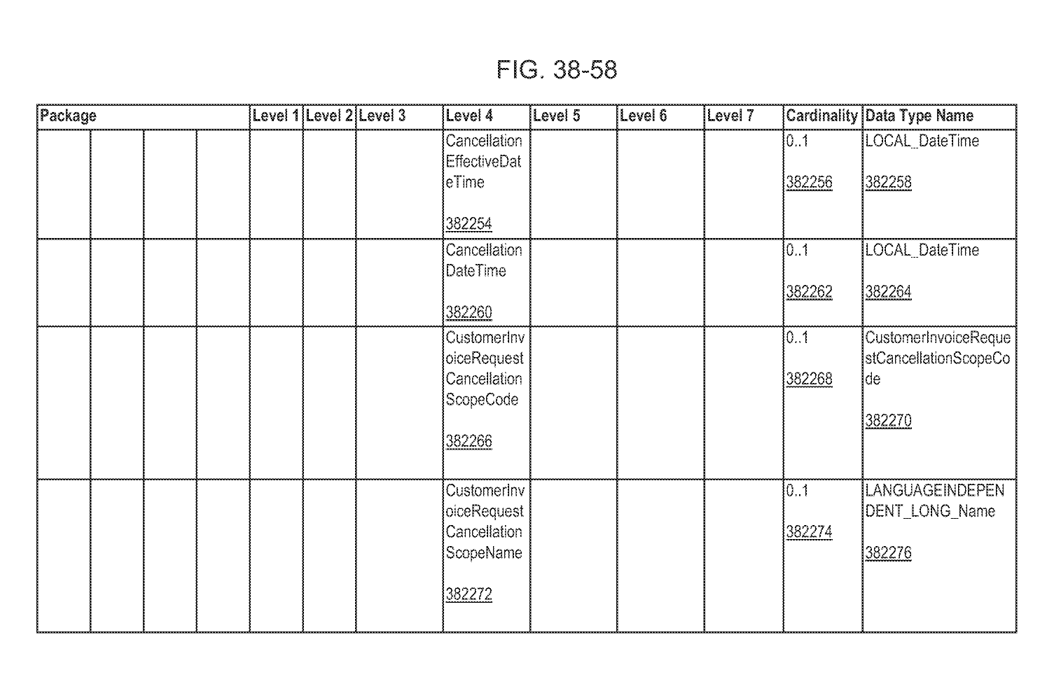

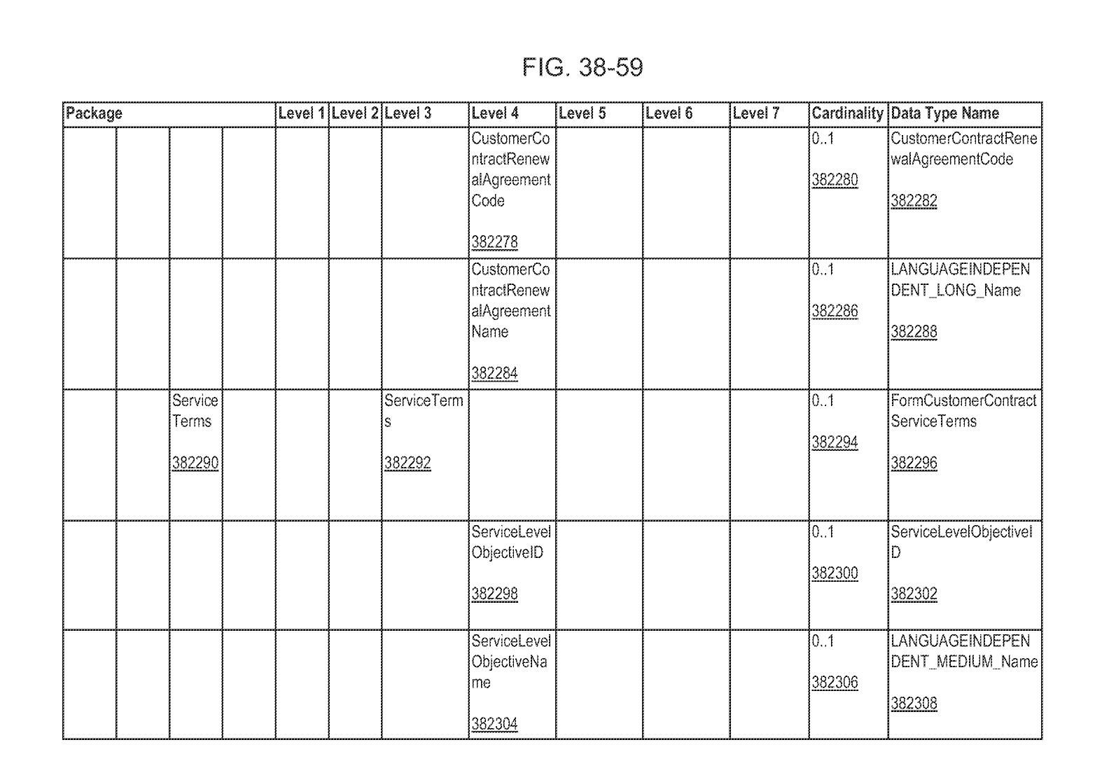

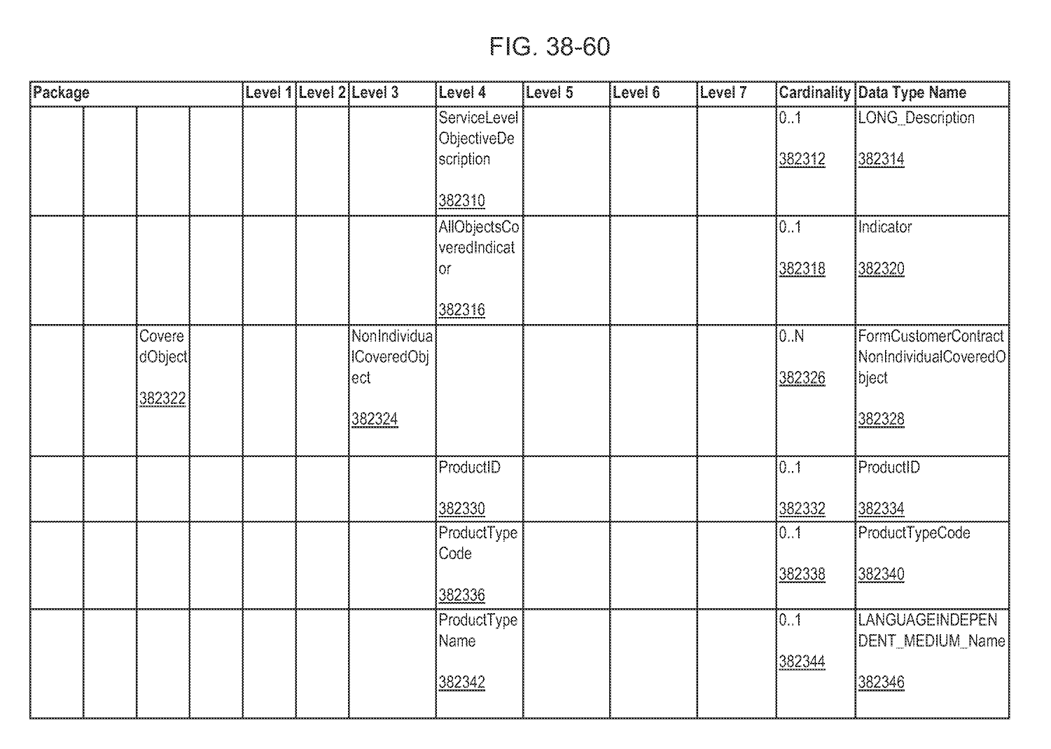

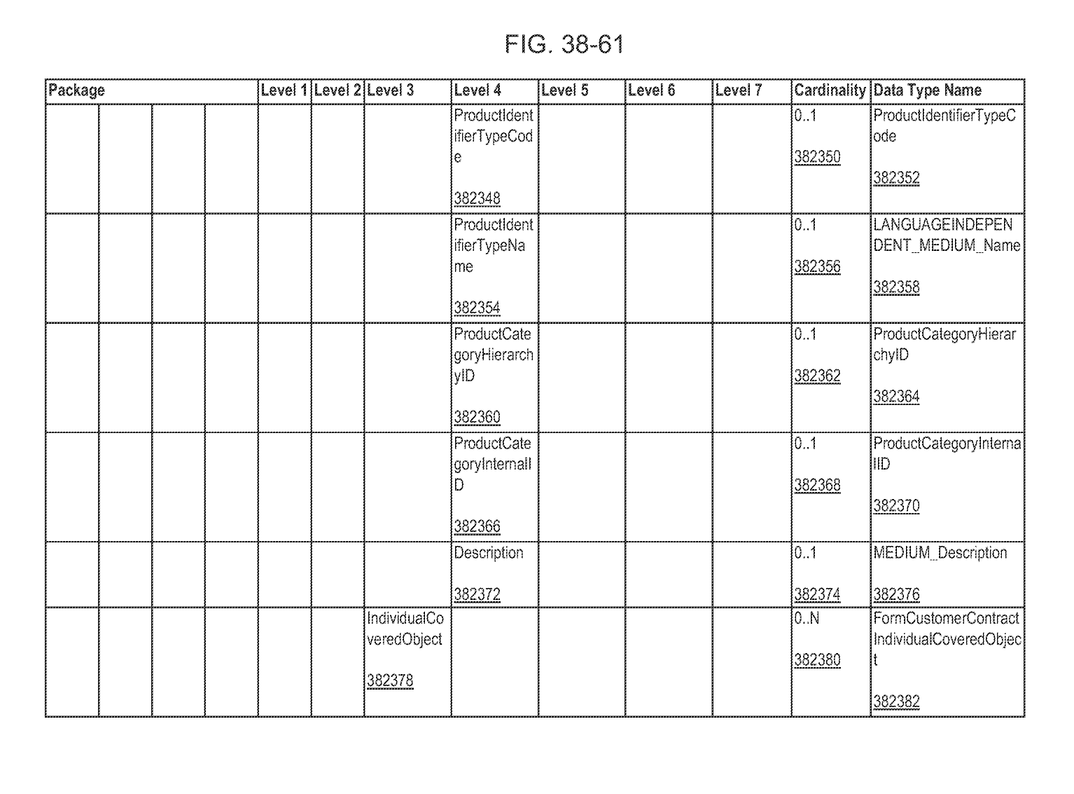

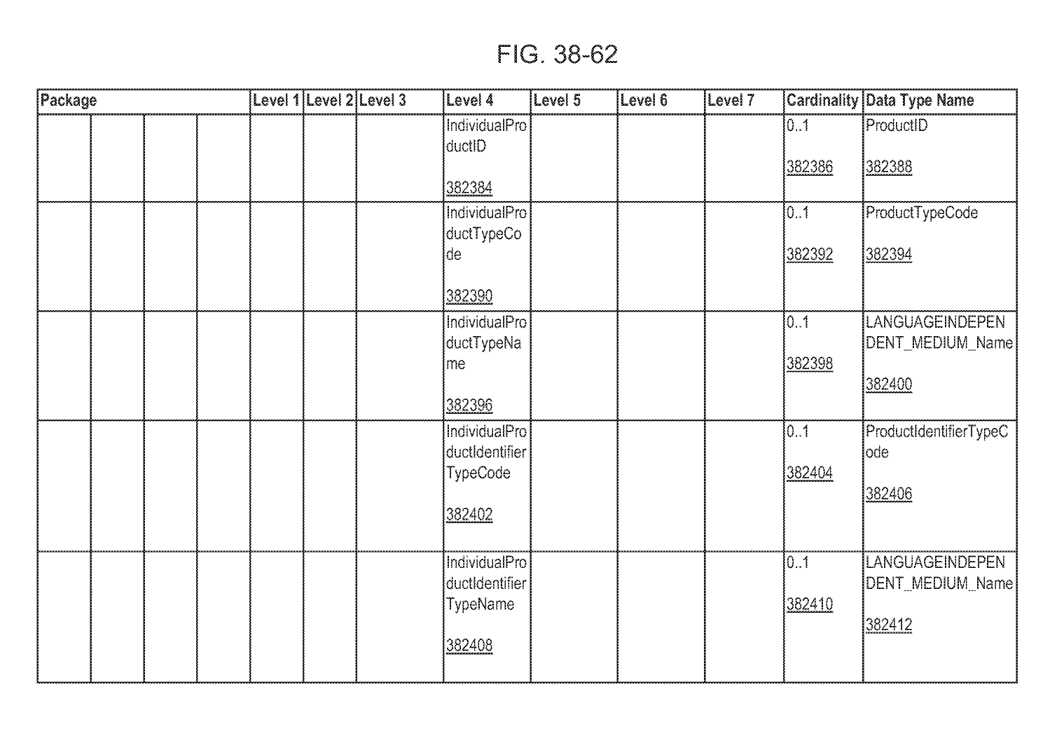

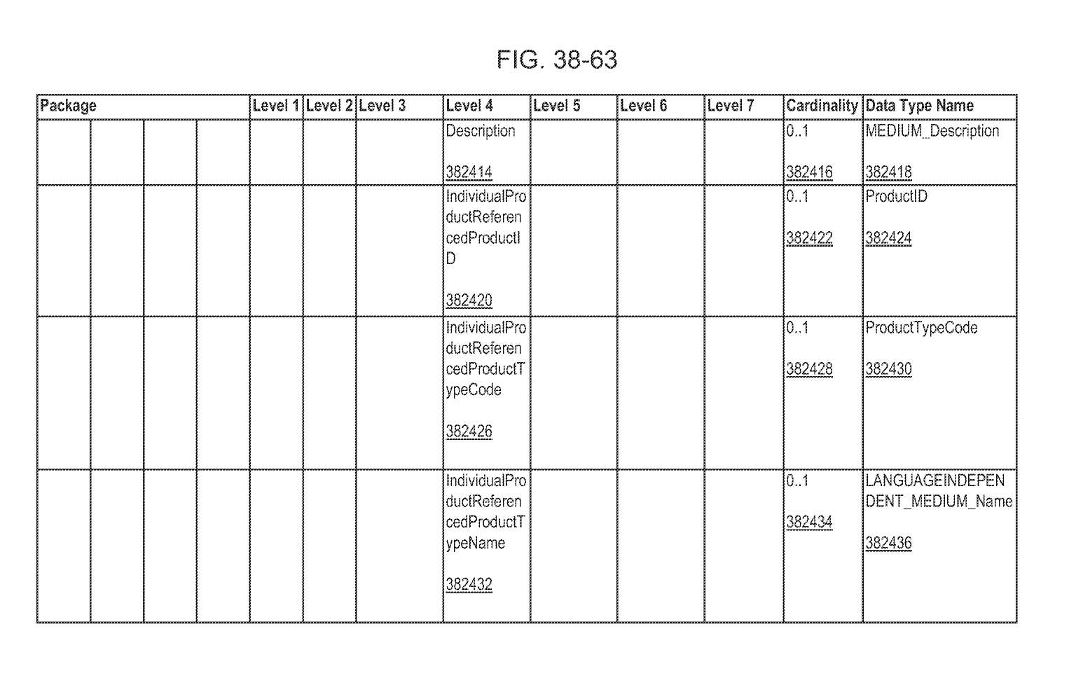

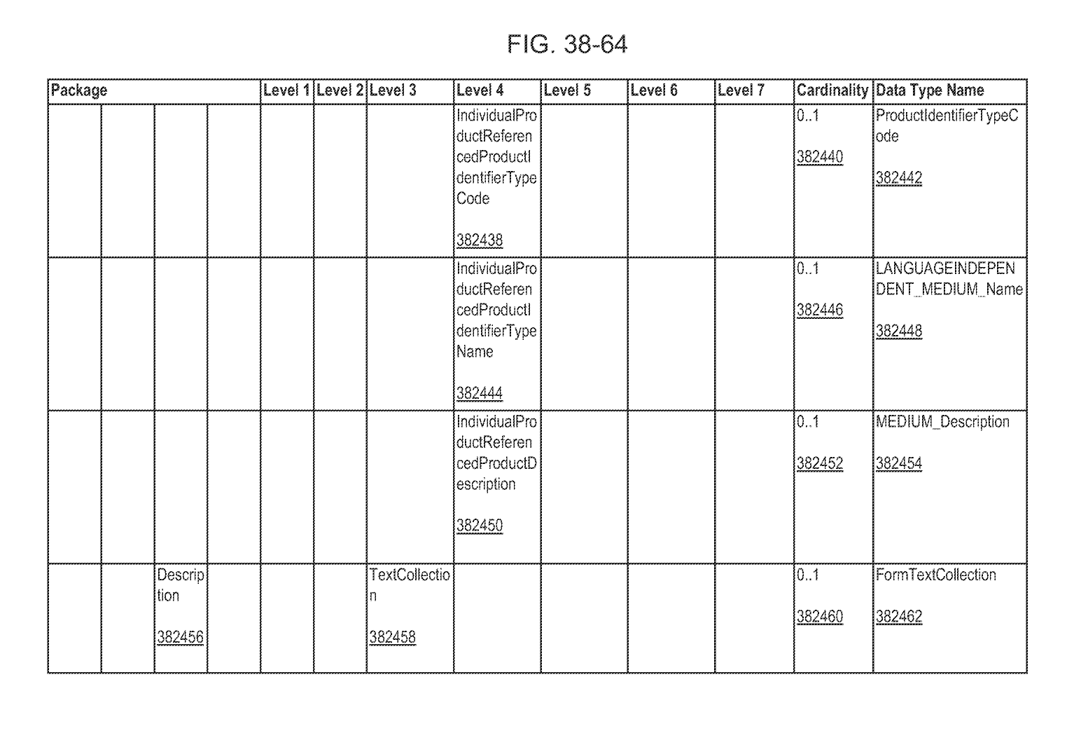

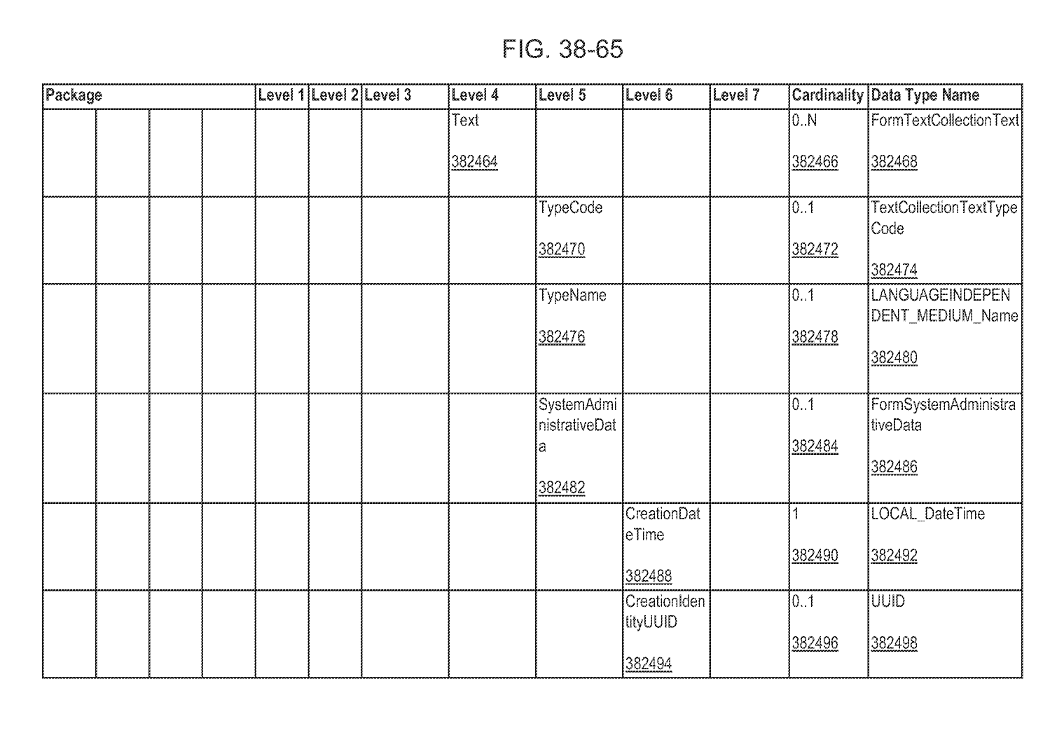

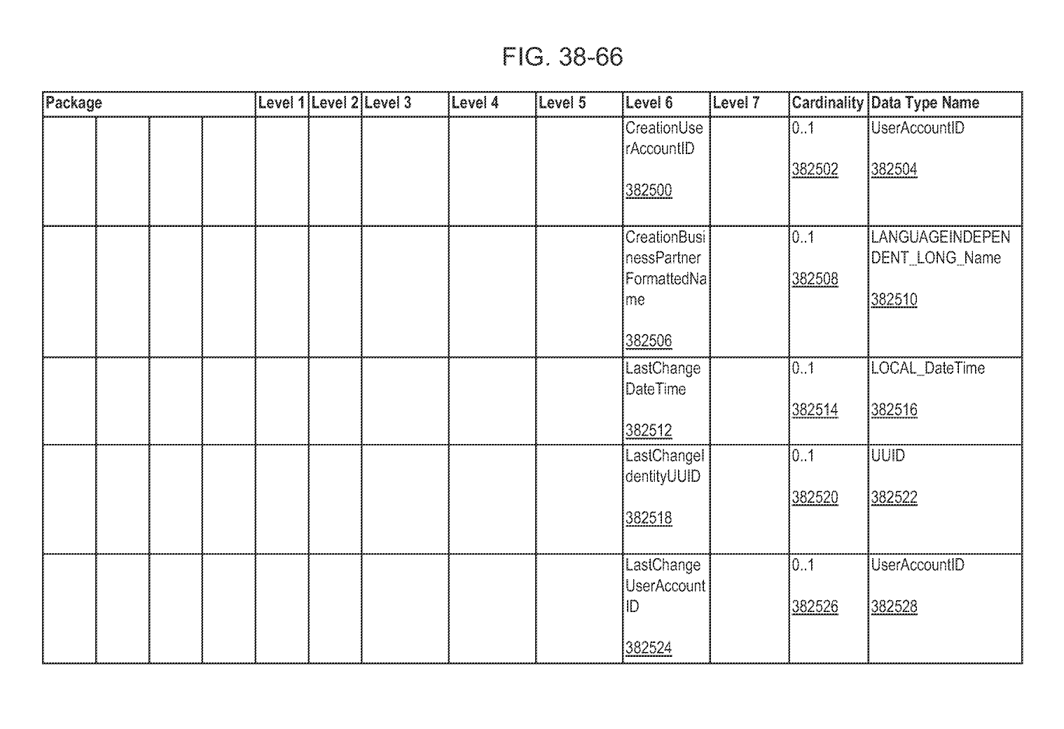

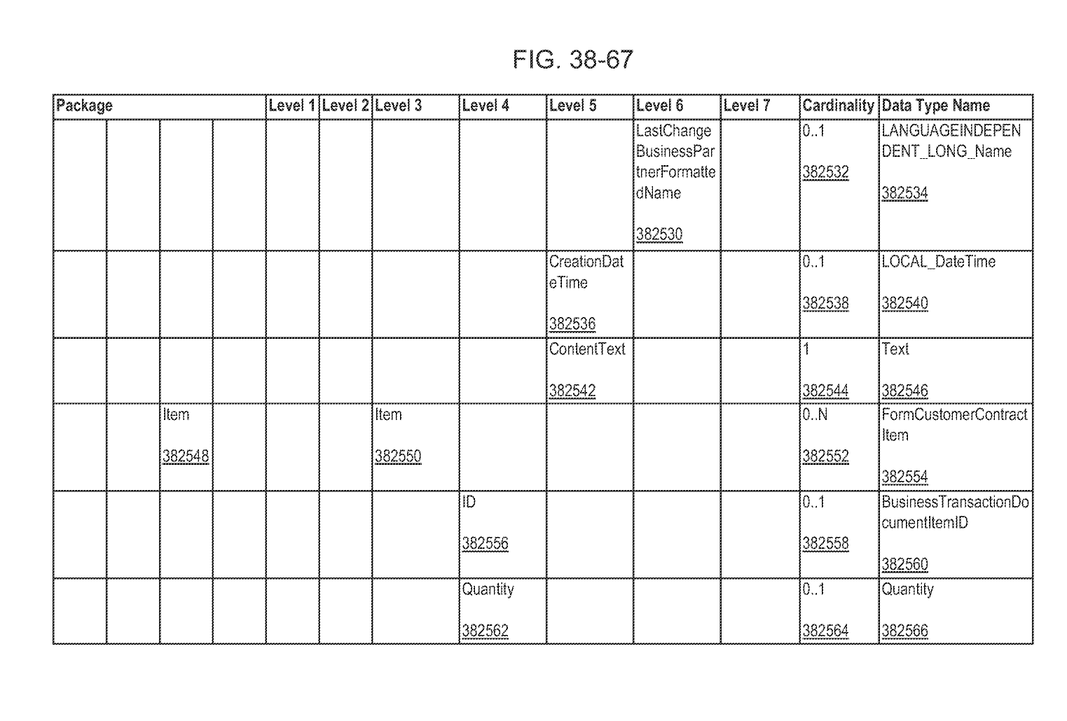

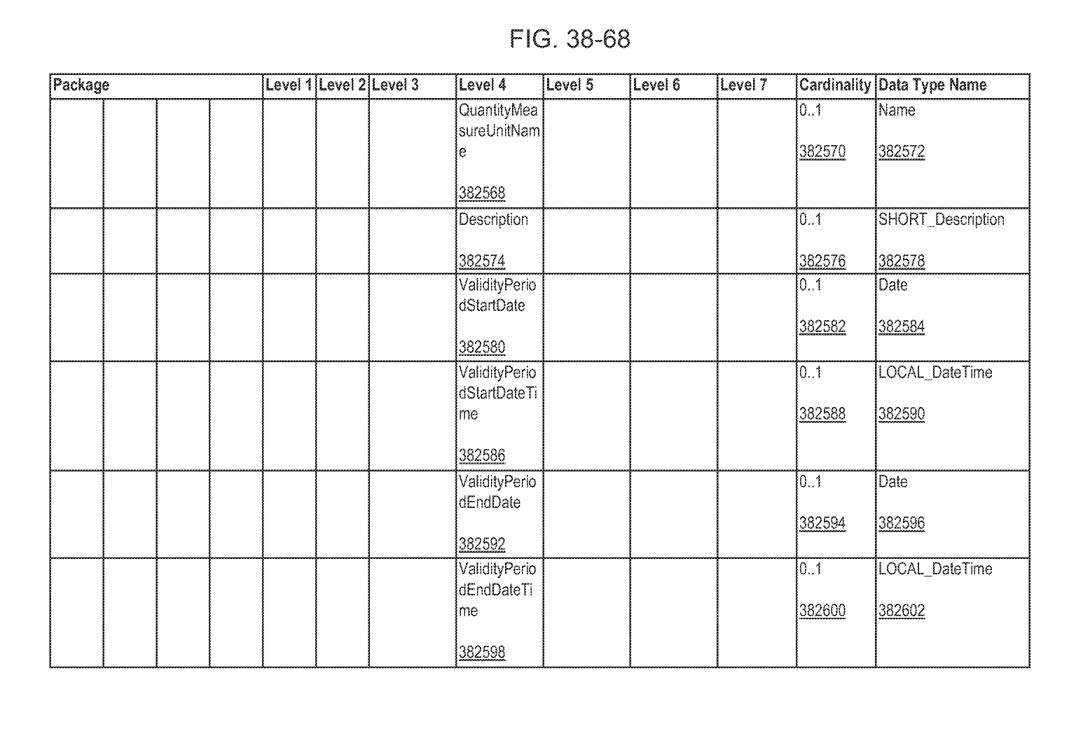

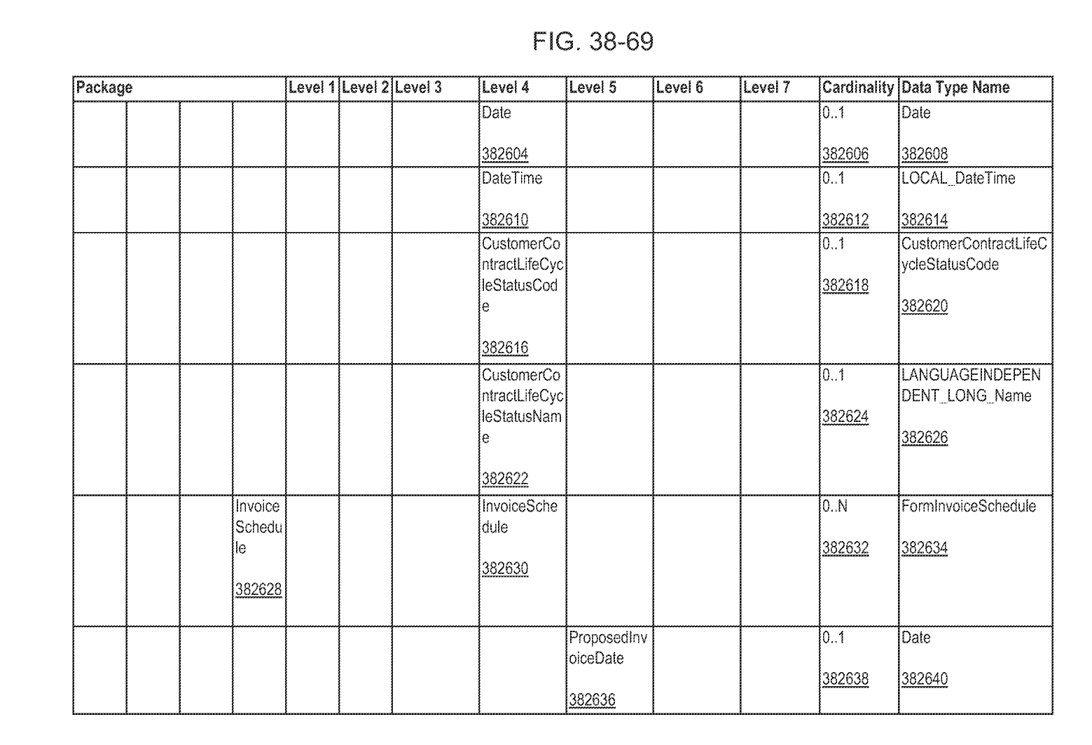

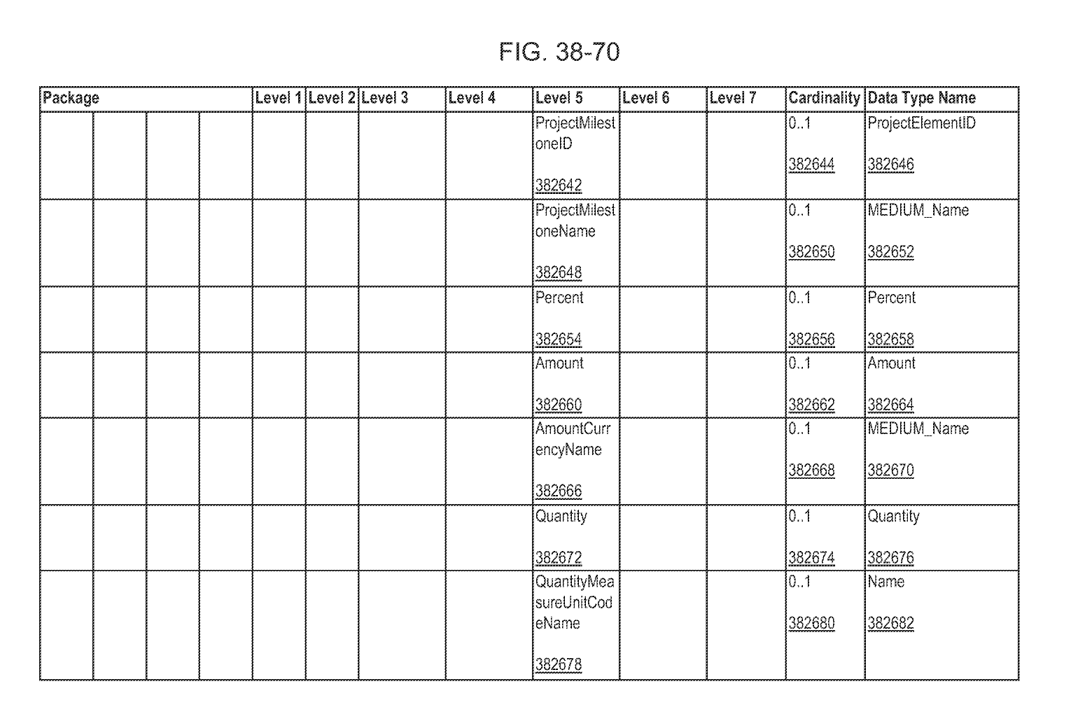

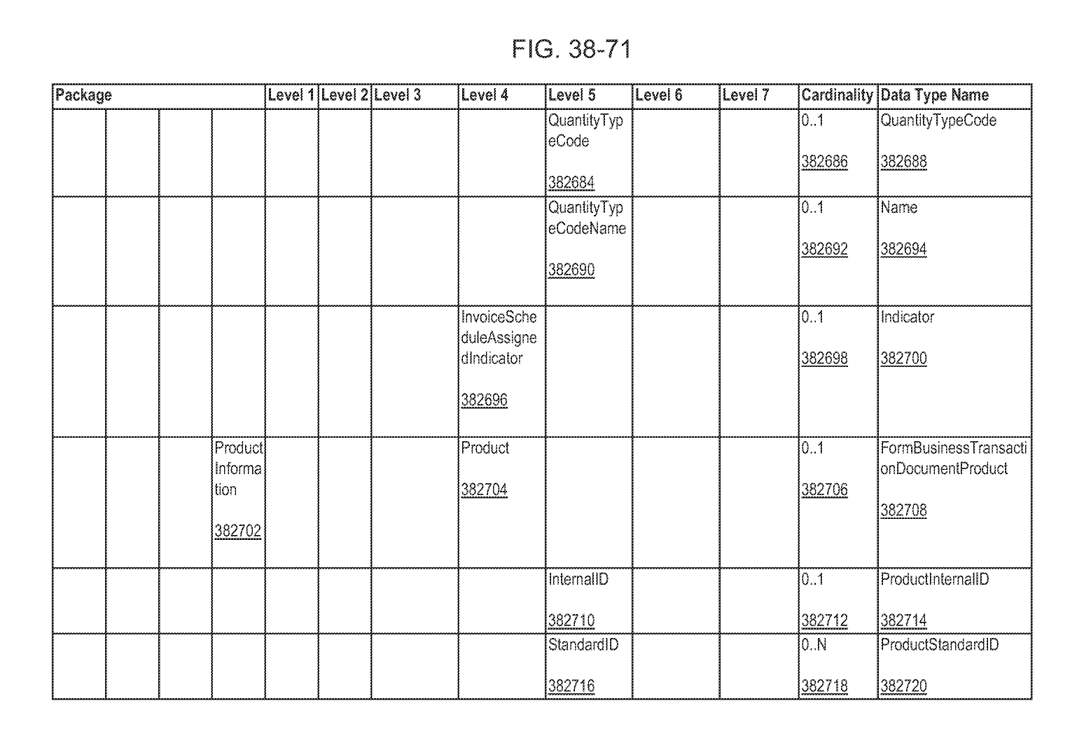

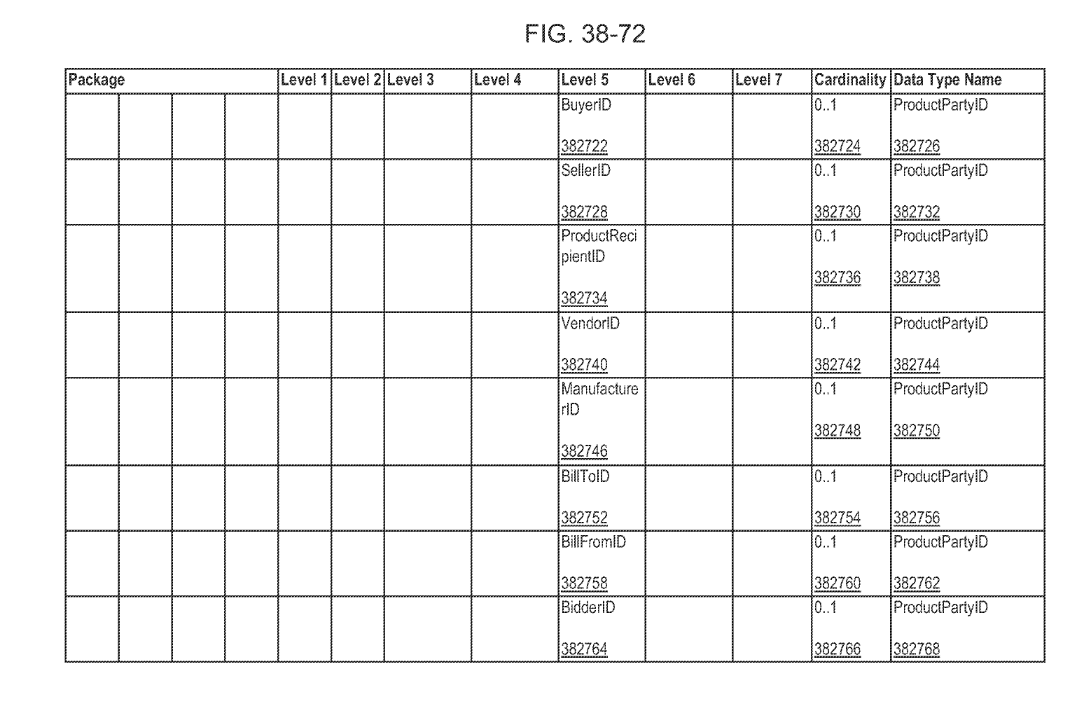

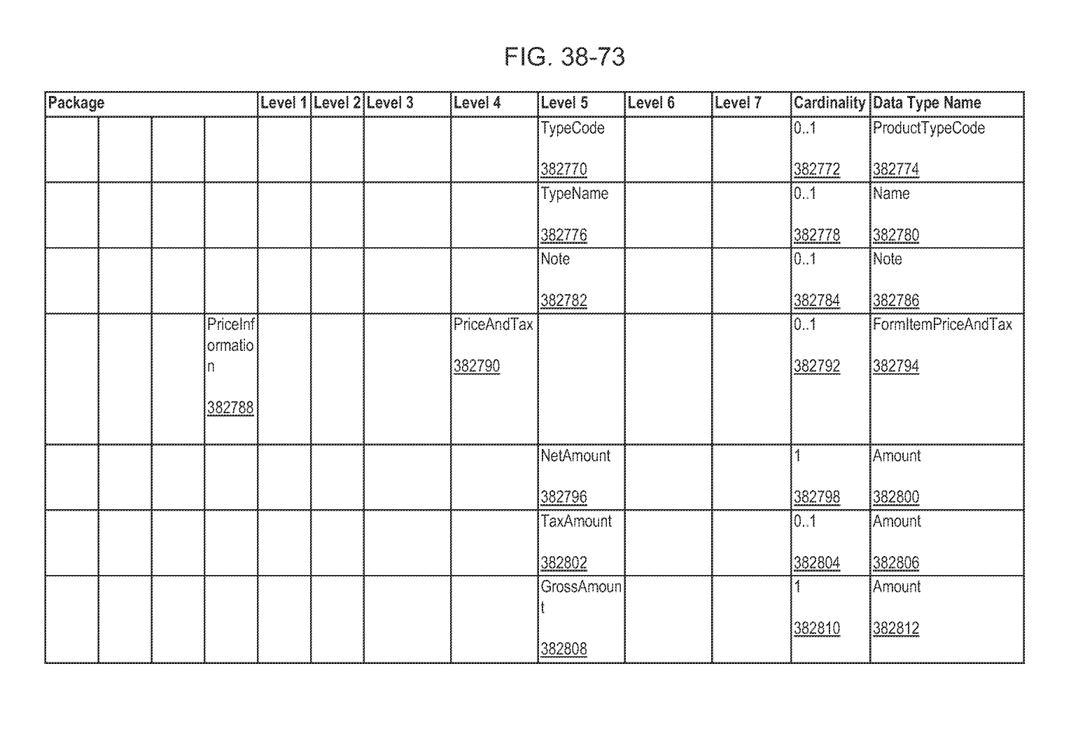

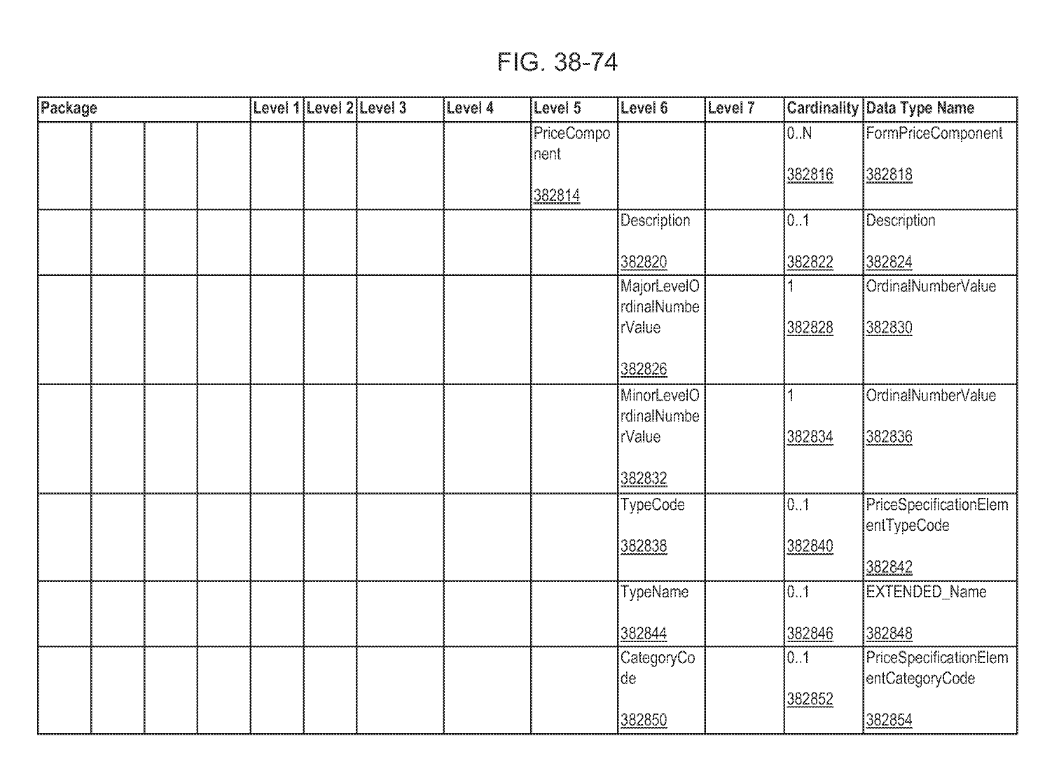

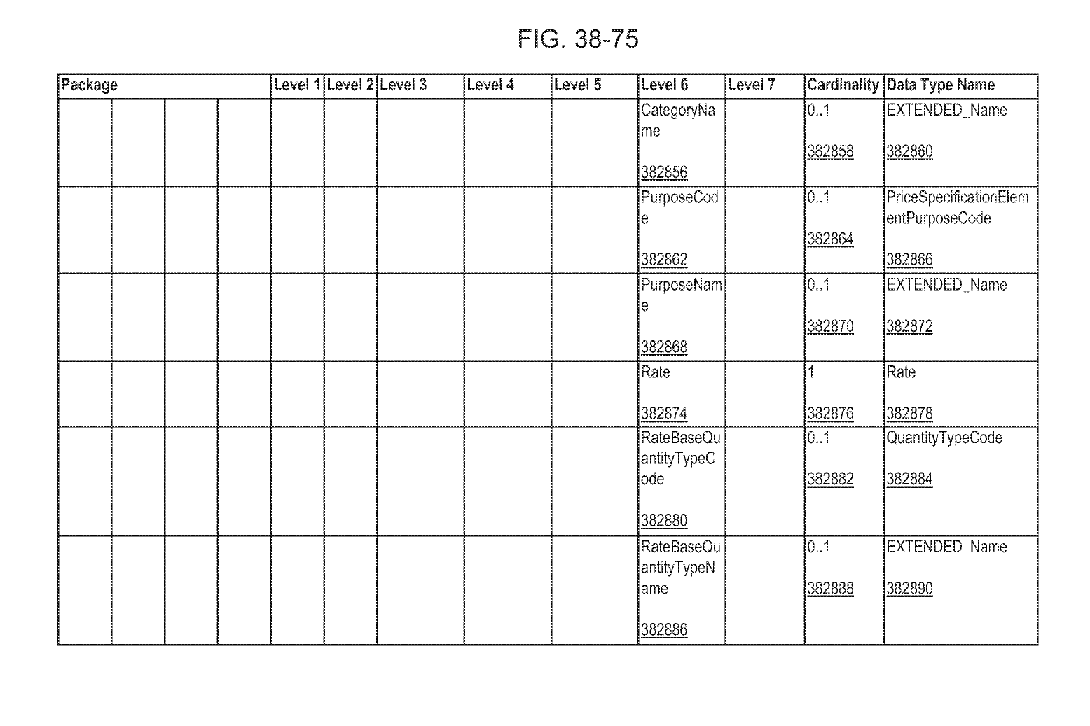

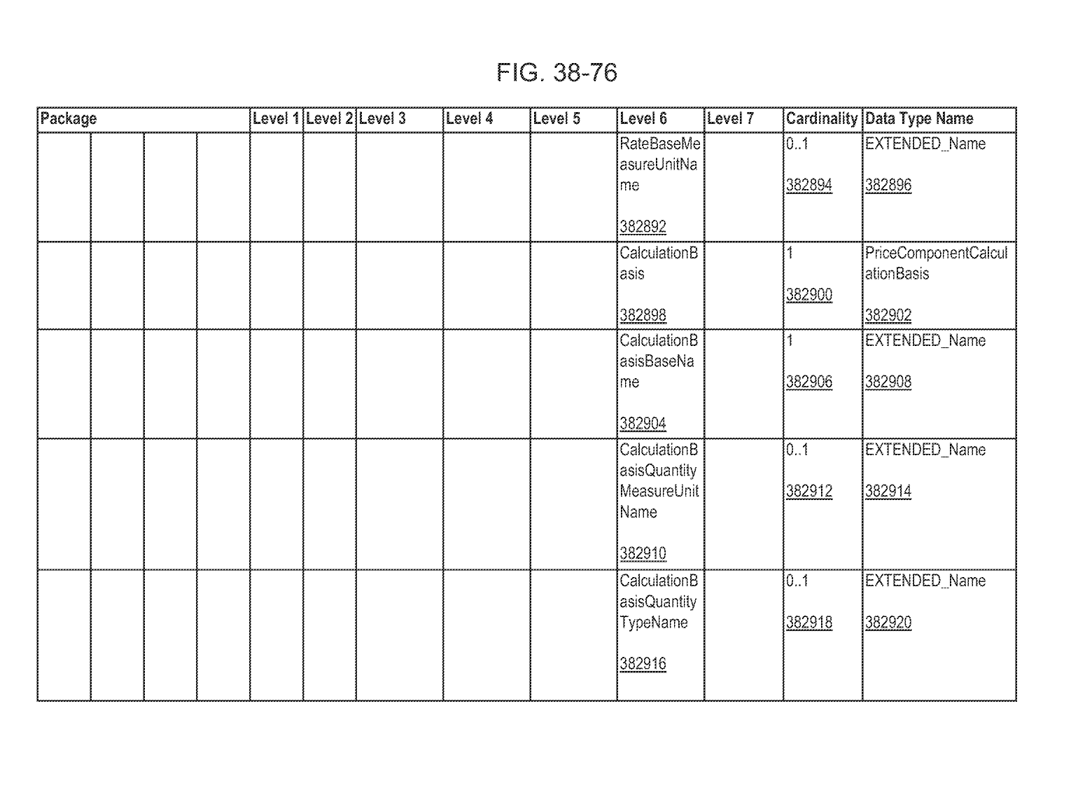

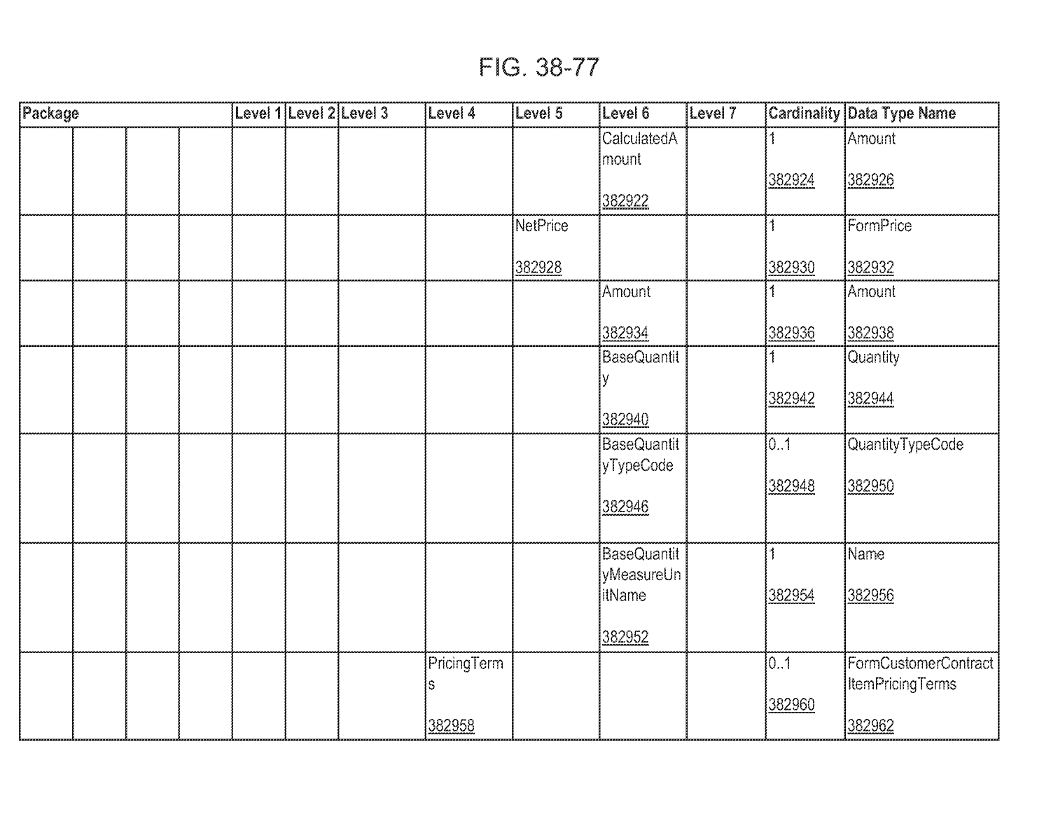

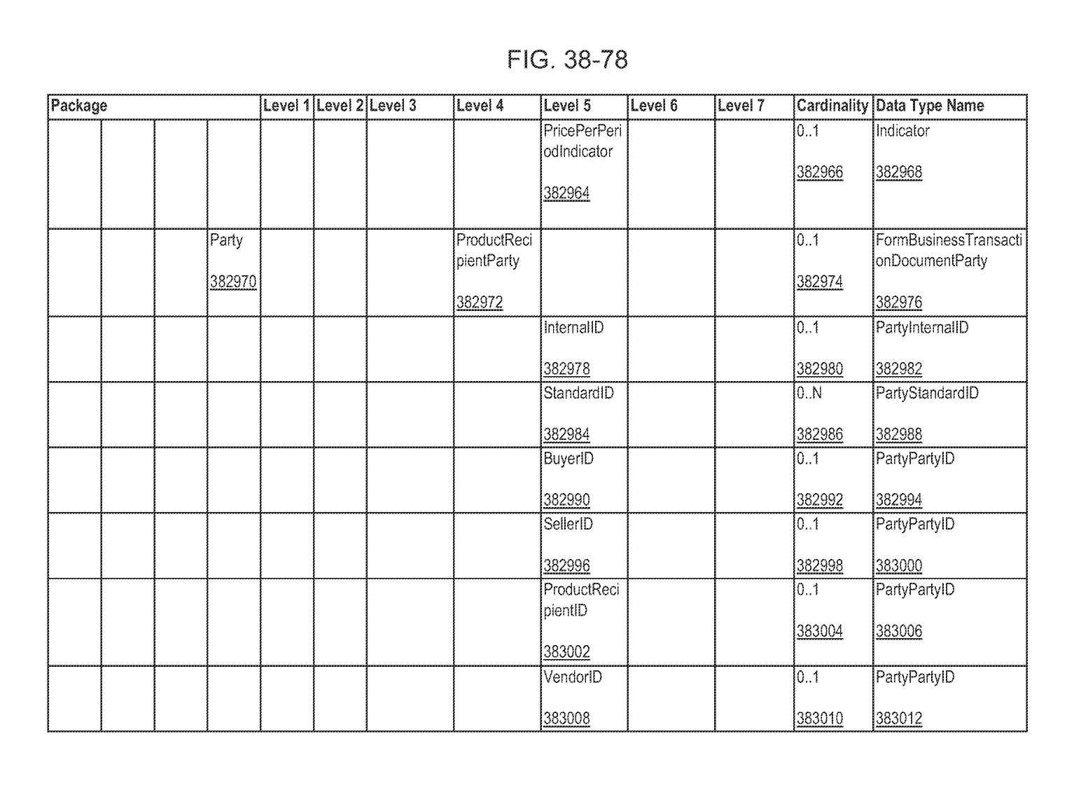

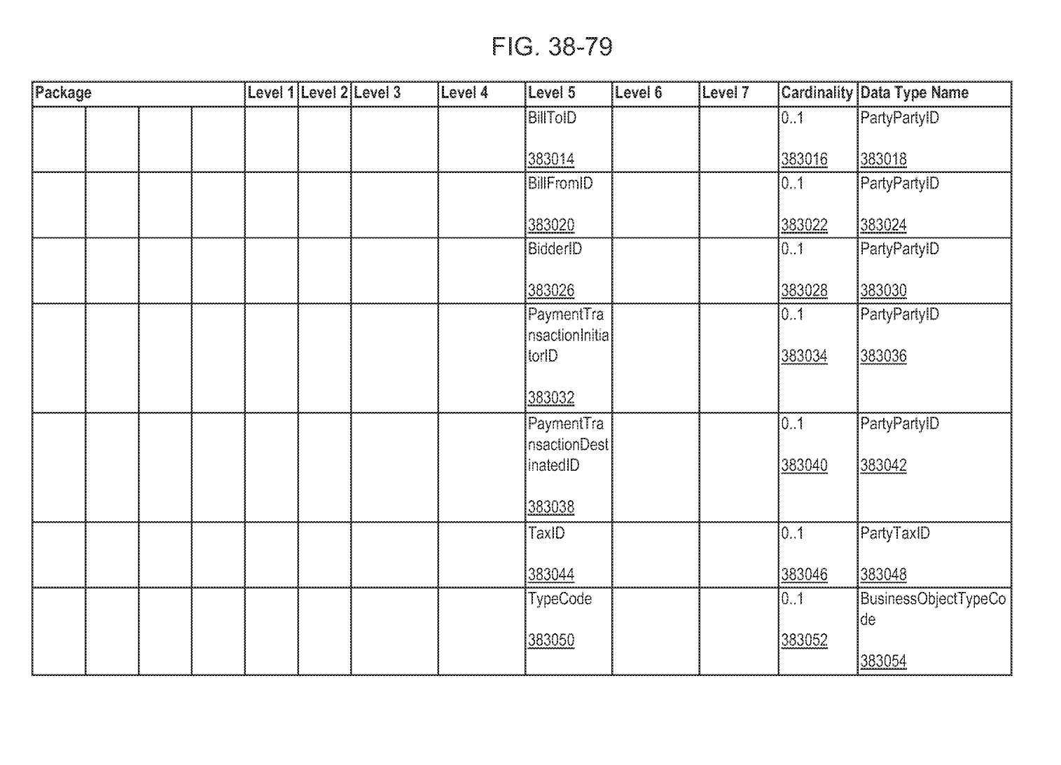

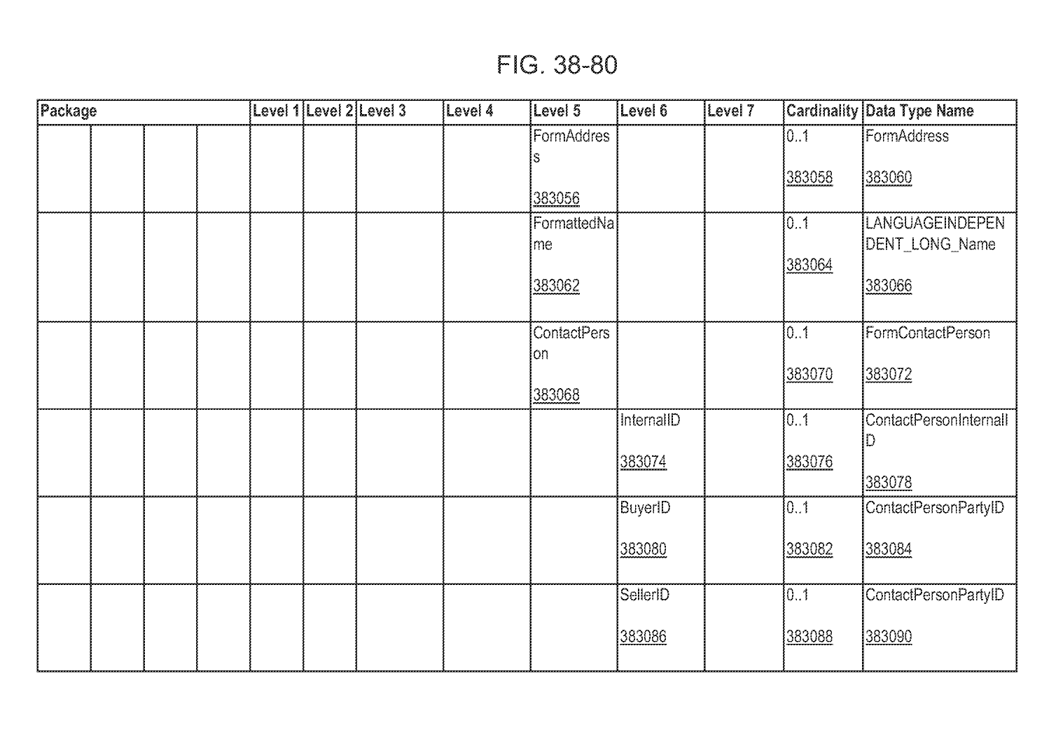

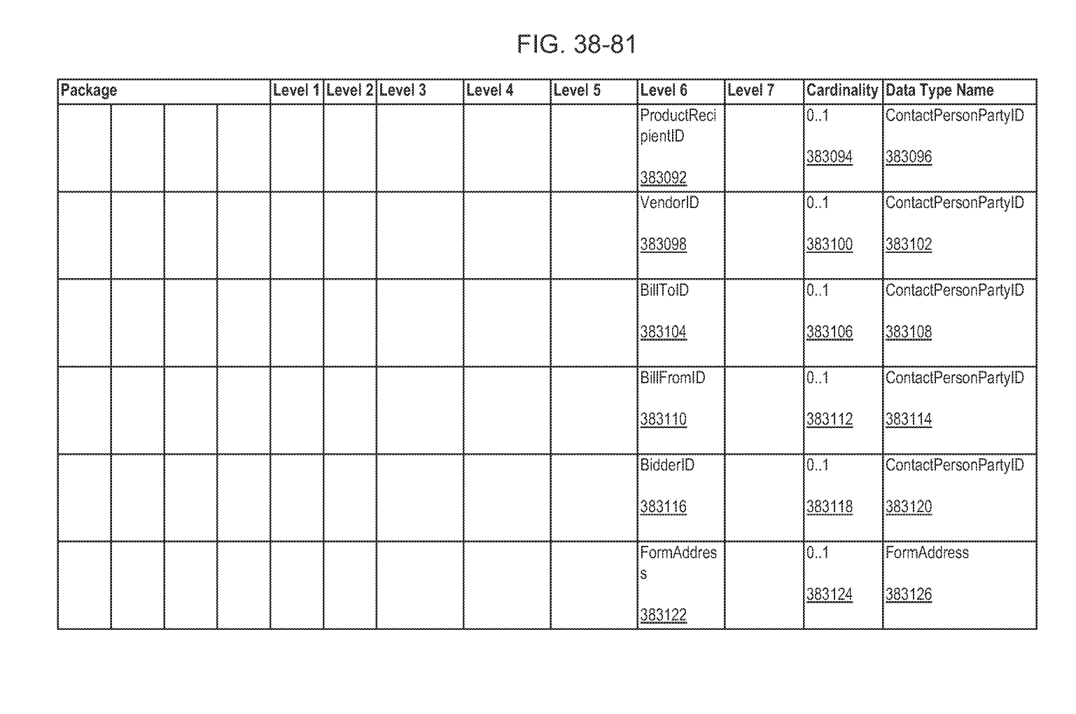

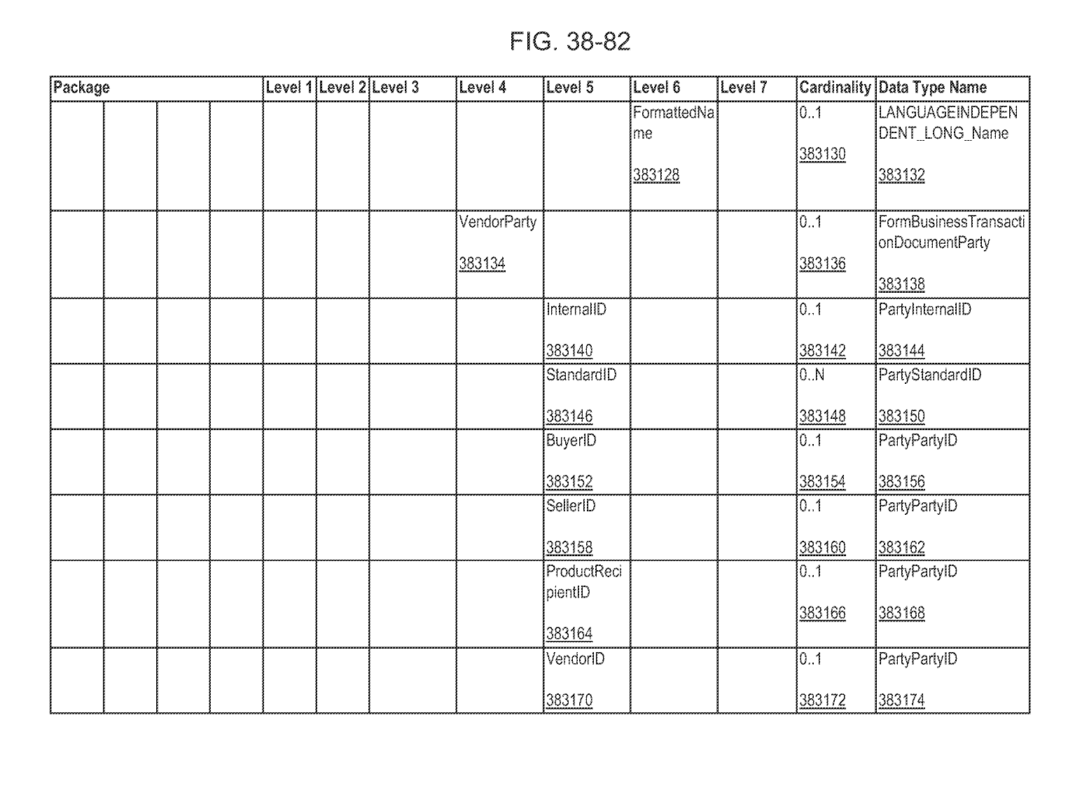

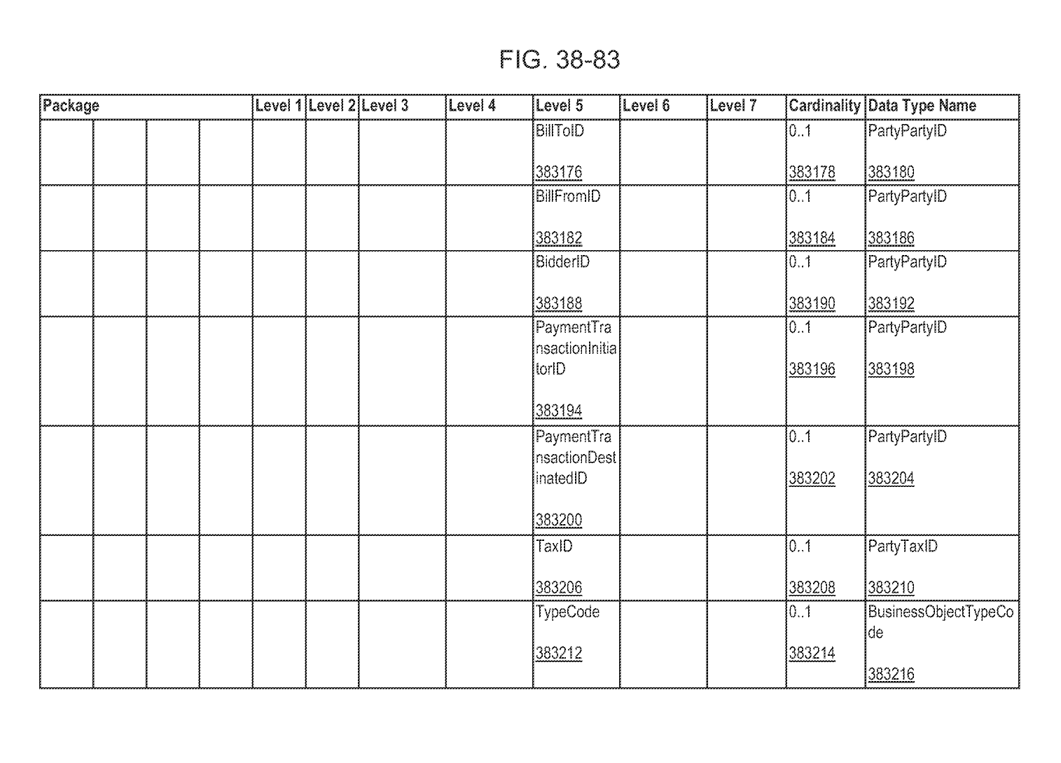

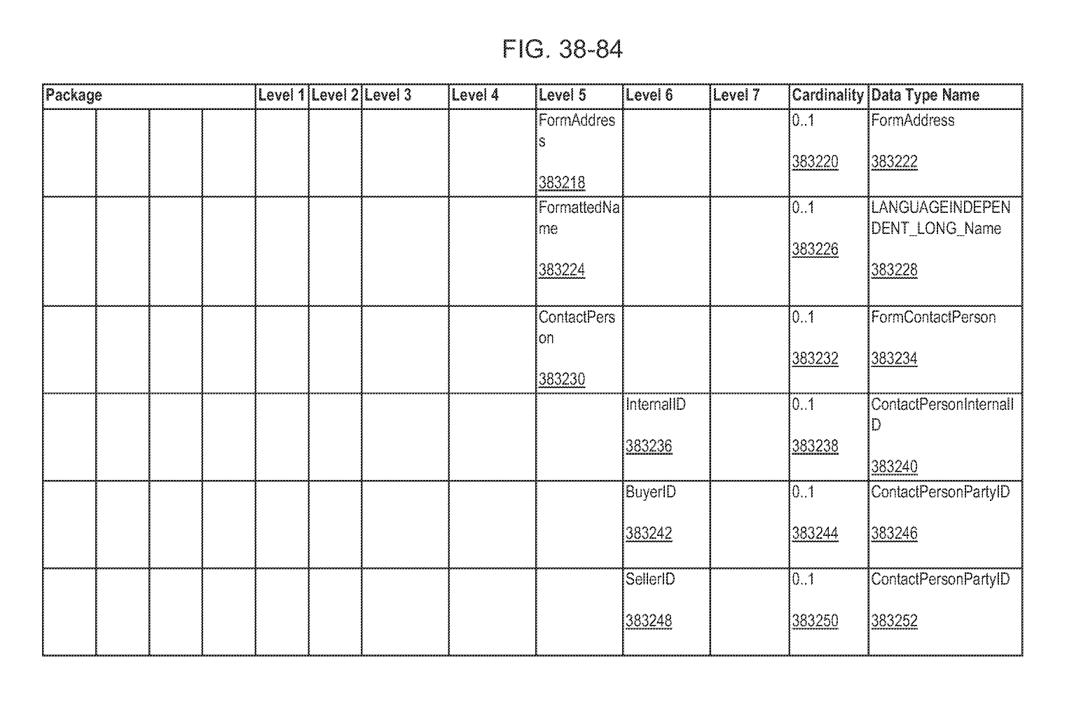

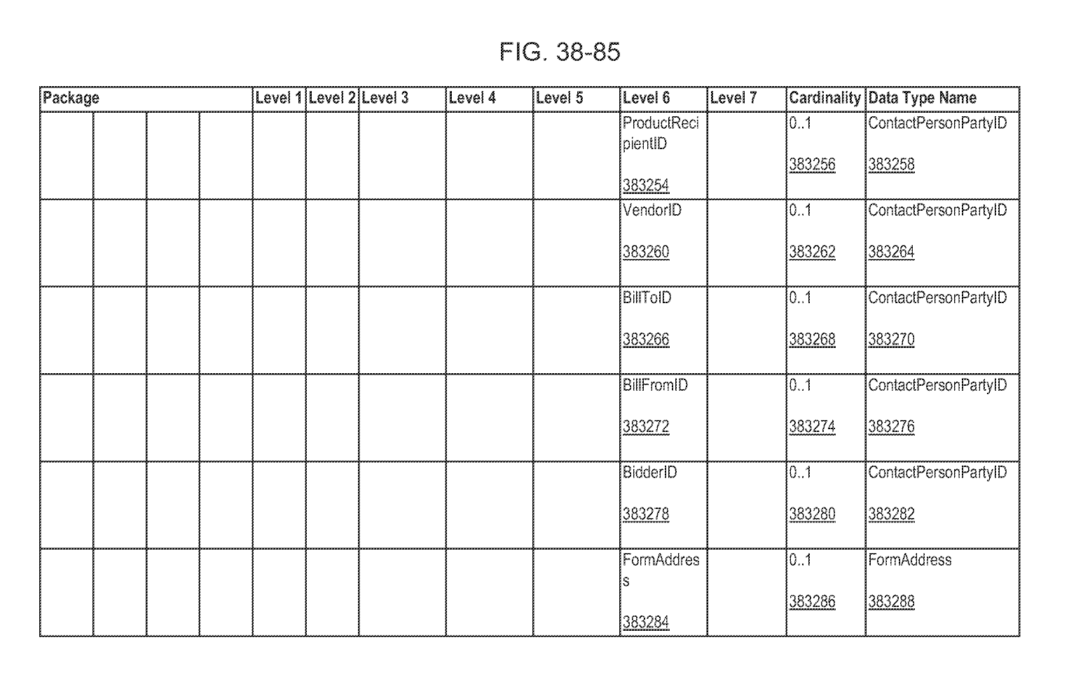

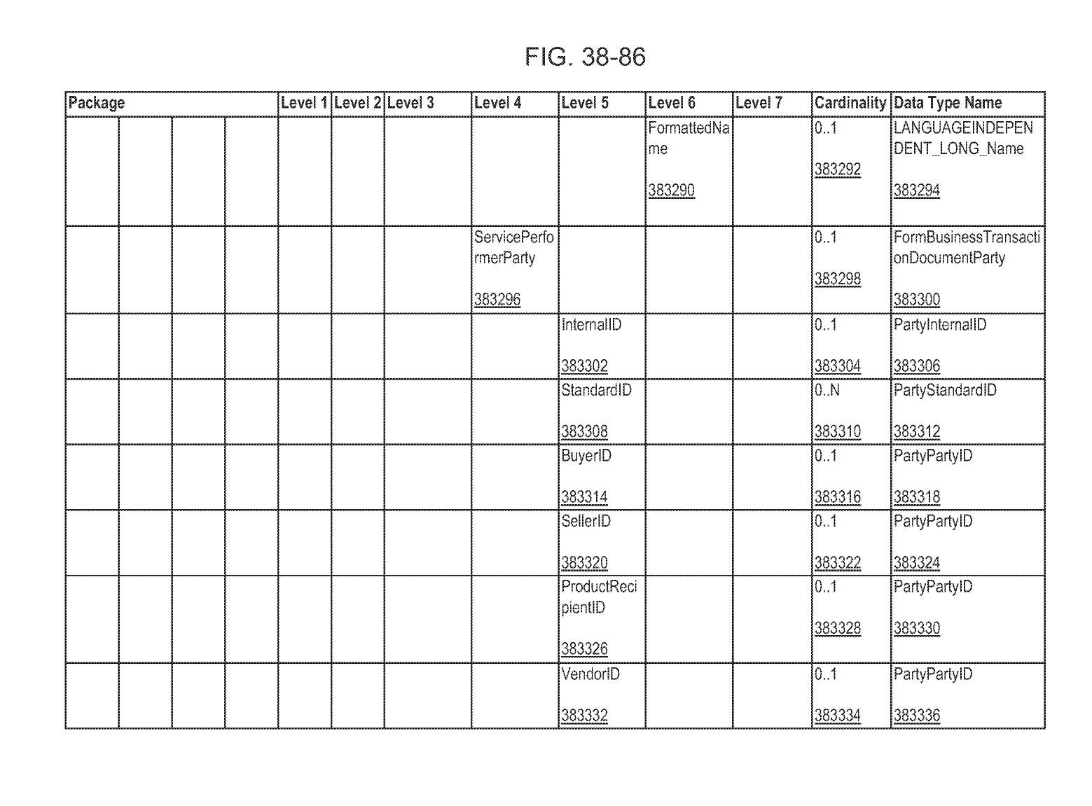

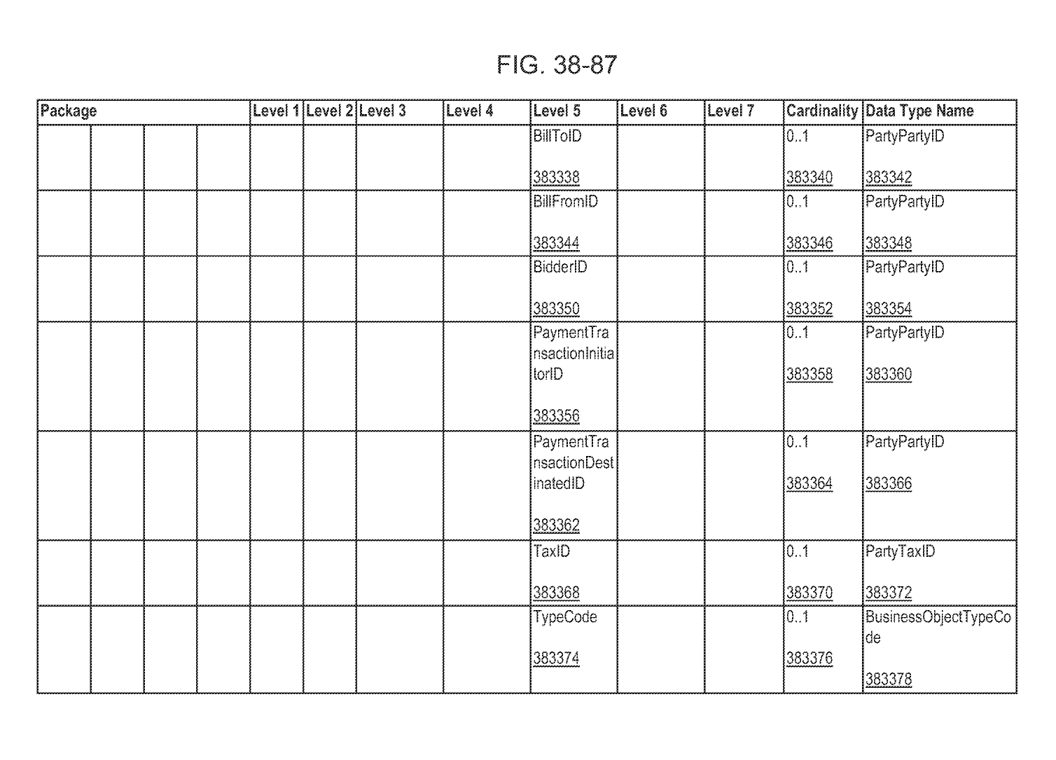

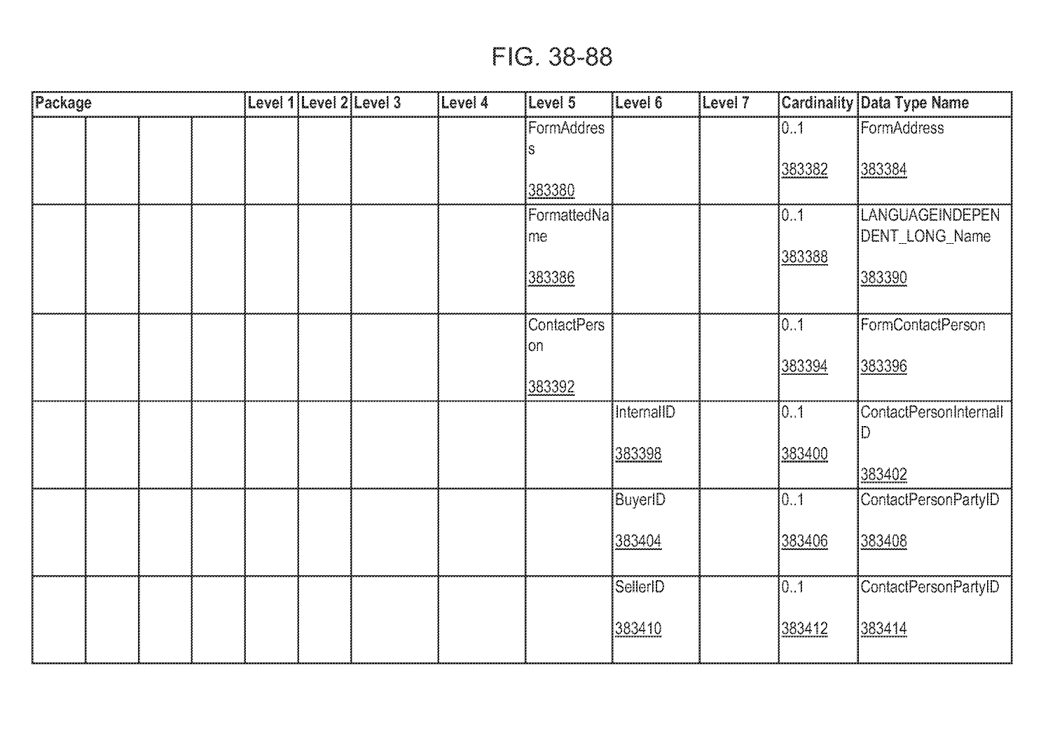

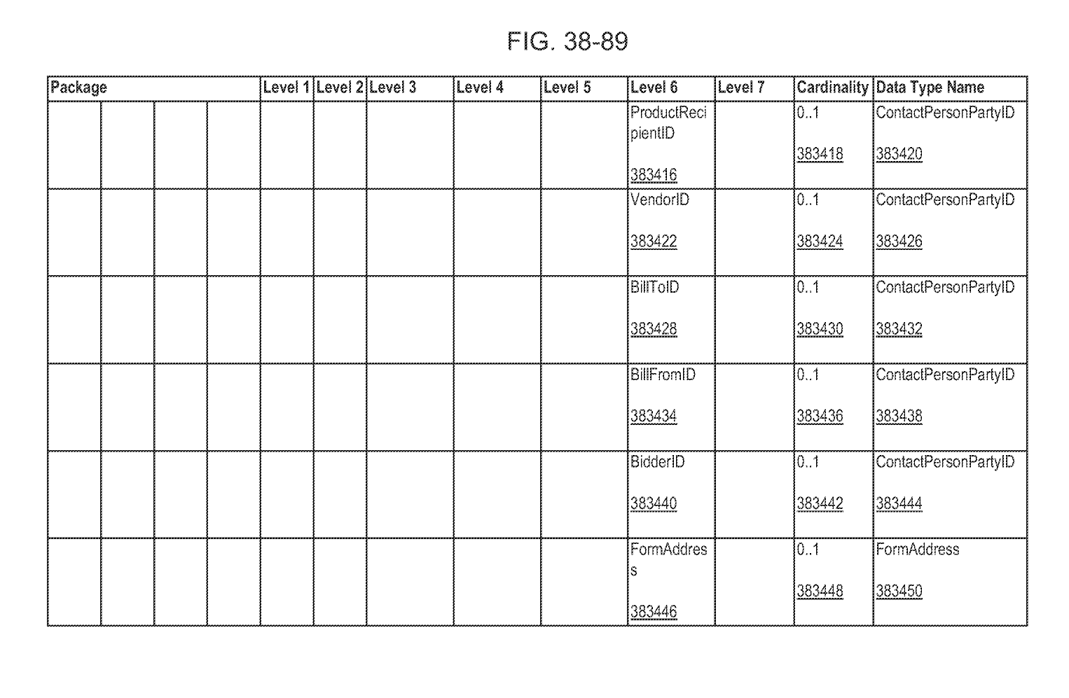

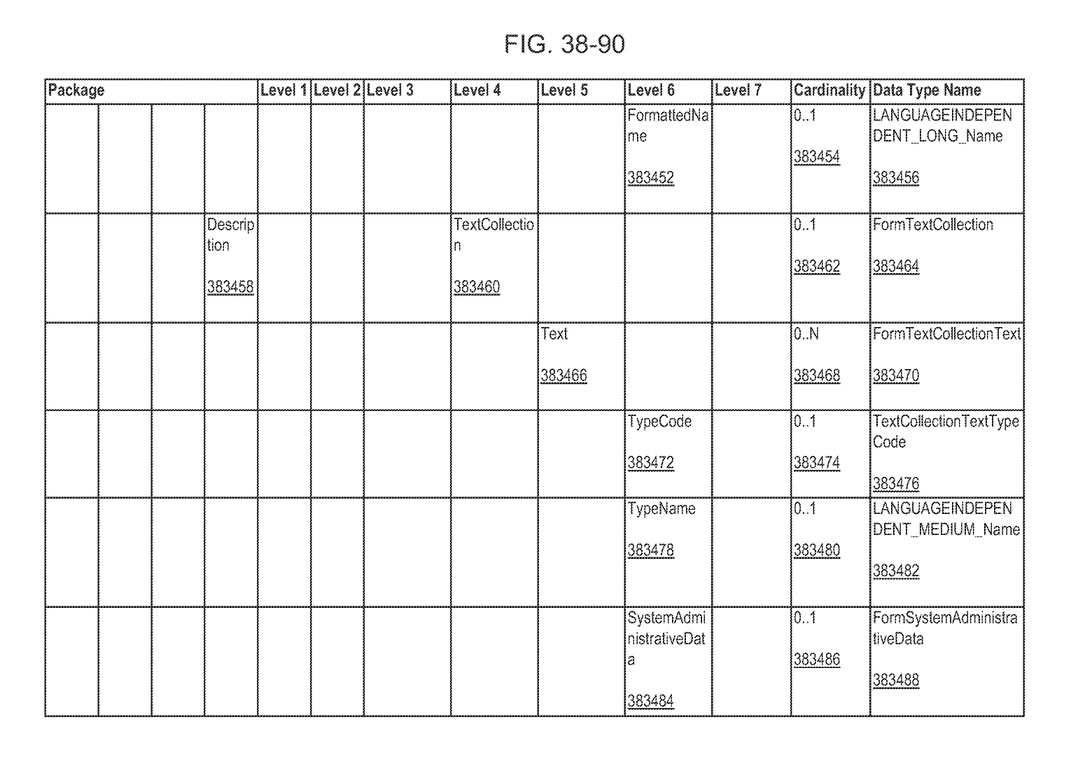

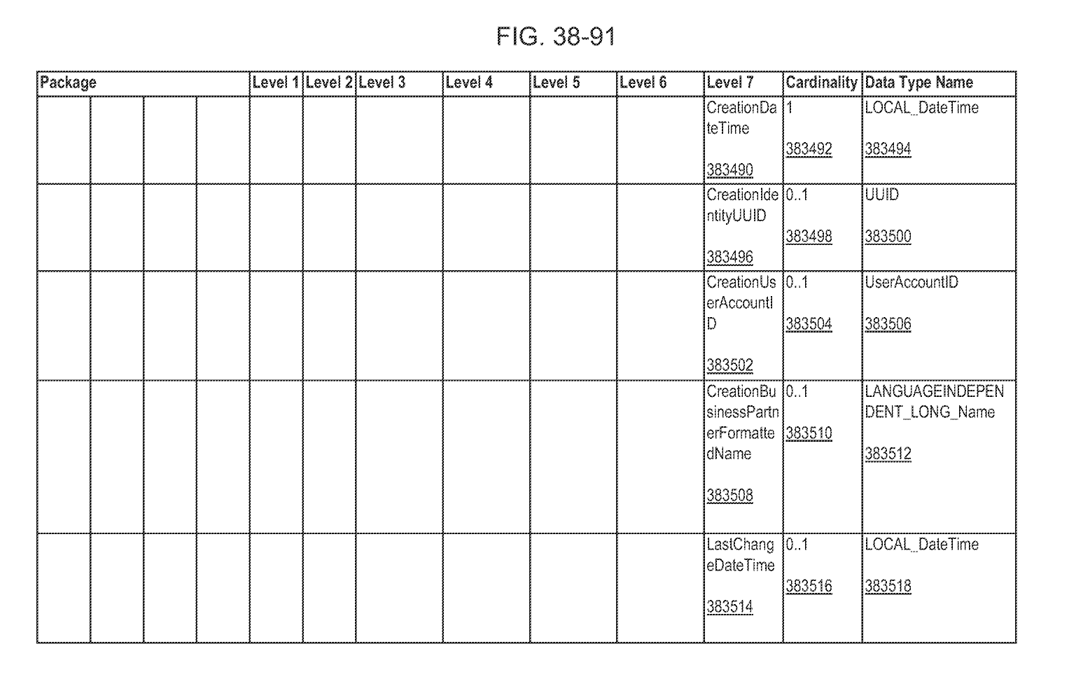

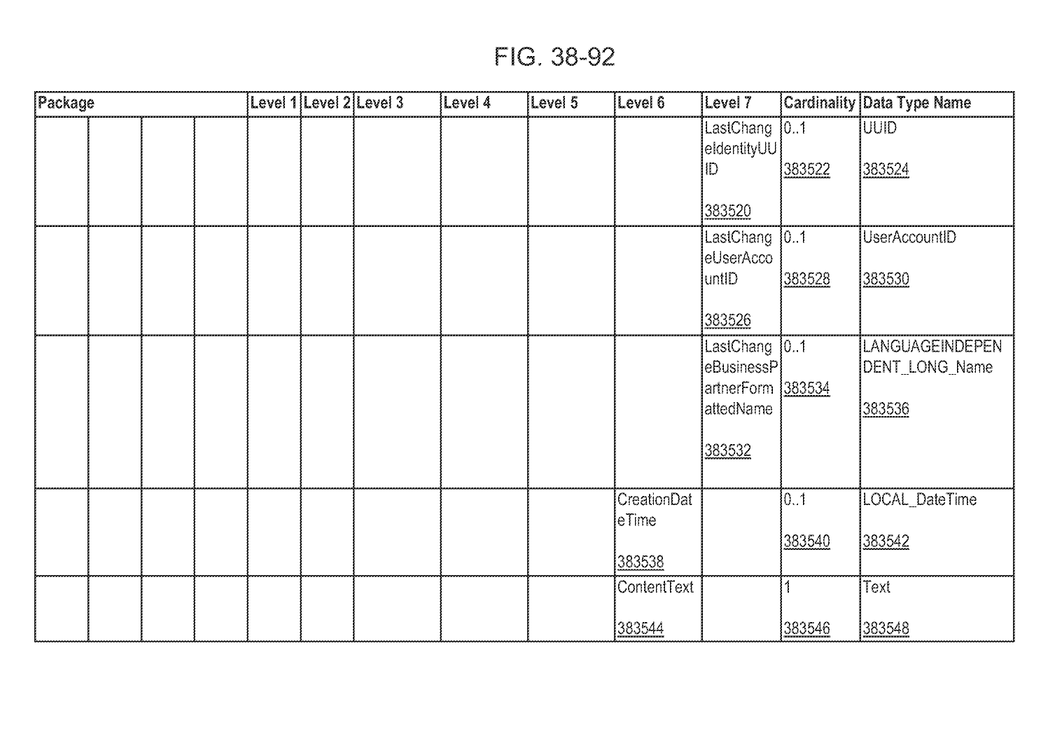

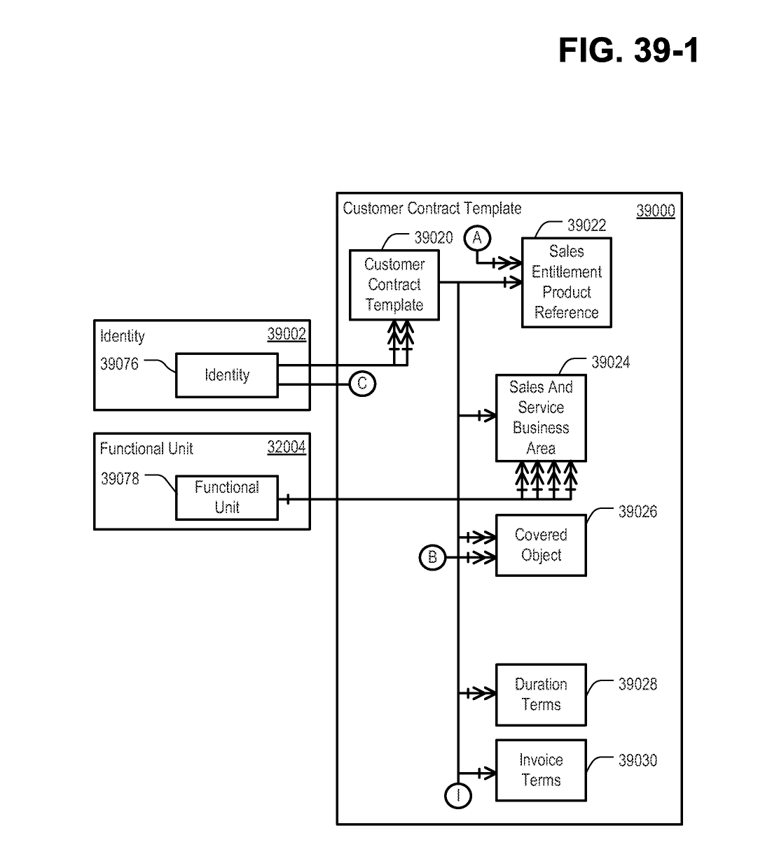

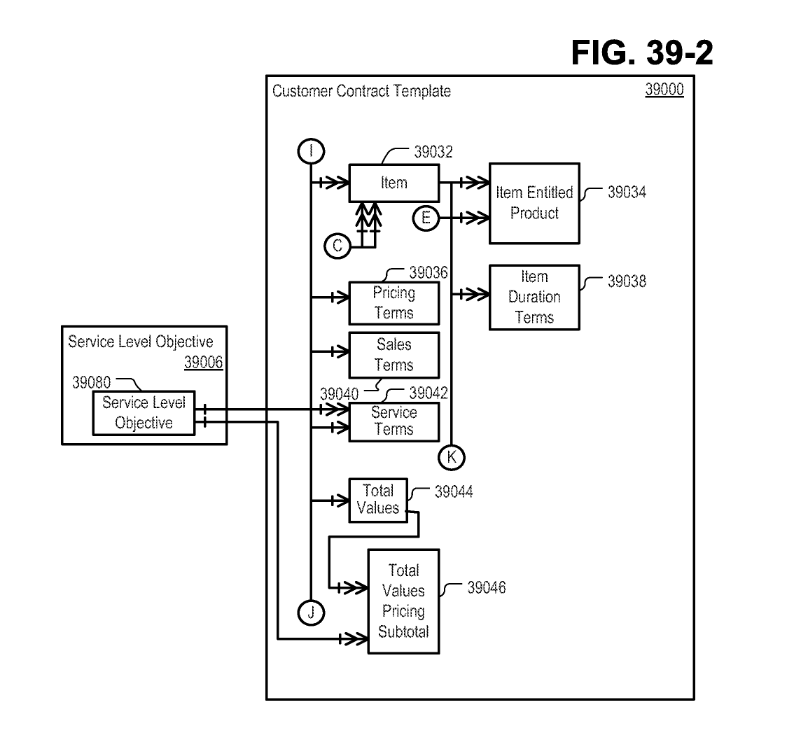

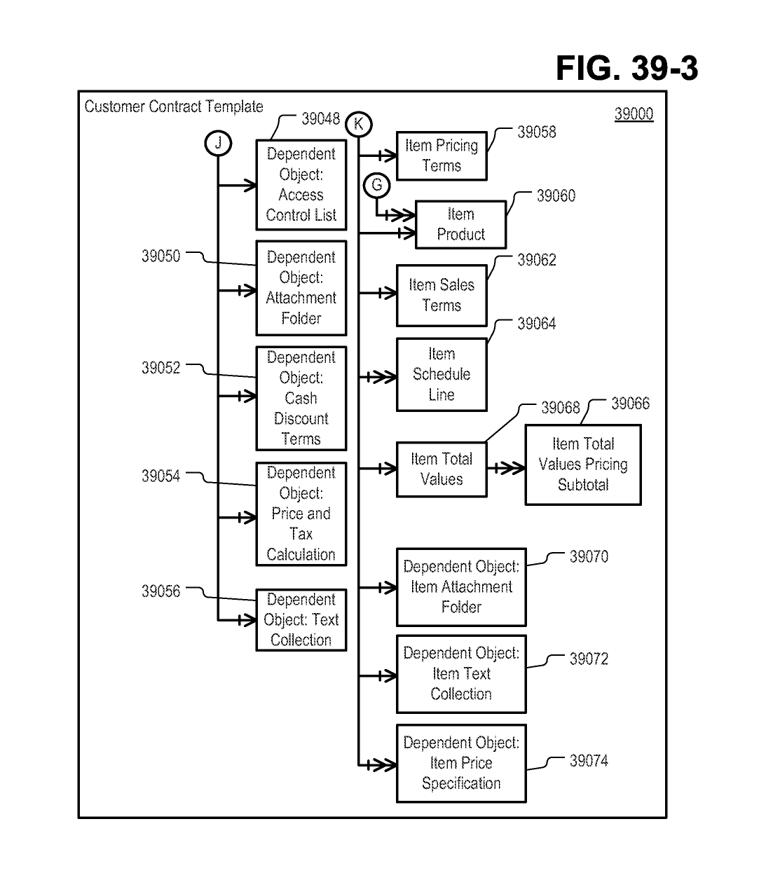

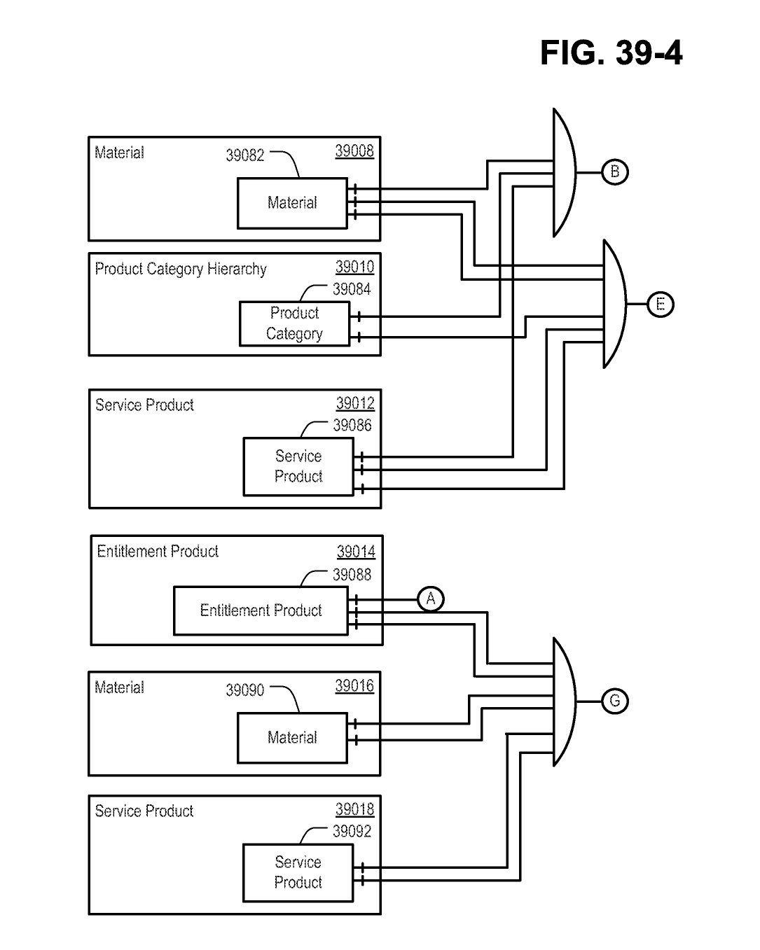

FIGS. 38-1 through 38-92 show an example configuration of an Element Structure that includes a Form Customer Contract Notification 380000 package. Specifically, these figures depict the arrangement and hierarchy of various components such as one or more levels of packages, entities, and datatypes, shown here as 380000 through 383548. As described above, packages may be used to represent hierarchy levels. Entities are discrete business elements that are used during a business transaction. Data types are used to type object entities and interfaces with a structure. For example, the Form Customer Contract Notification 380000 includes, among other things, a Form Customer Contract Notification 380002. Accordingly, heterogeneous applications may communicate using this consistent message configured as such.

FIGS. 39-1 through 39-4 collectively illustrate an example object model for a Customer Contract Template business object 39000. Specifically, the object model depicts interactions among various components of the Customer Contract Template business object 39000, as well as external components that interact with the Customer Contract Template business object 39000 (shown here as 39002 through 39018 and 39076 through 39092). The Customer Contract Template business object 39000 includes elements 39020 through 39074, which can be hierarchical, as depicted. For example, the Customer Contract Template entity 38020 hierarchically includes one or more instances of the entities 39022 through 39030, among others. Some or all of the entities 39020 through 39074 can correspond to packages and/or entities in the message data types described below.

The business object Customer Contract Template is a template for a customer contract that defines a structure and conditions of standardized customer contracts. The Customer Contract Template business object belongs to the process component Customer Contract Processing. The Customer Contract Template business object belongs to the deployment unit Customer Relationship Management. The Customer Contract Template business object is a projection of Customer Transaction Document Template. The general structure of a customer contract template corresponds to a customer contract, can include non-operational data, and might not be negotiated individually and therefore might not include customer-related information. Similarly, date-related information can be defined as general durations instead of specific time periods. Contract templates are defined to describe contract offerings in detail and to build pre-defined packages which can be used later. A contract template can be assigned to an entitlement product to be used as a sellable item. As an example, suppose a company sells a standard package for “platinum” customer support that entitles customers to exceptional support. A contract template can include an entitlement to call a customer support hotline that can be reached 24/7. A resulting contract can be valid for one year and can be canceled by a customer three months before the contract ends. A customer contract template can include header data relevant for a contract template and detailed information about items that are part of the contract template. The Customer Contract Template business object has an object category of Business Transaction Document and a technical category of Standard Business Object.

The Customer Contract Template business object has a Root node. The Root node can represent a document for customer specific business transactions that have a focus on the delivery of goods, the provision of services, prices, and/or preparations for invoicing. The Customer Contract Template business object can be time dependent on Time Point. The elements located directly at the node Customer Contract Template are defined by the data type CustomerTransactionDocumentElements. These elements include: ID, TypeCode, ProcessingTypeCode, Name, SystemAdministrativeData, UUID, and Status. ID may be an alternative key, is a unique identifier assigned by a seller for a Customer Transaction Document, and may be based on datatype GDT: BusinessTransactionDocumentID. TypeCode may be optional, is an encoded representation of a type of Customer Transaction Document, and may be based on datatype GDT: BusinessTransactionDocumentTypeCode. TypeCode can be set internally and can include a fixed value CustomerTransactionDocumentTemplate. TypeCode can be used to display a type in cross-business object lists, for example. ProcessingTypeCode is an encoded representation of Customer Transaction Document processing in a process component, and may be based on datatype GDT: BusinessTransactionDocumentProcessingTypeCode. A ProcessingTypeCode “transaction type” includes standard orders, for example. Name is a name of a Customer Transaction Document, and may be based on datatype GDT: EXTENDED_Name. SystemAdministrativeData includes administrative data stored in a system, such as system users and change dates/times, and may be based on datatype GDT: SystemAdministrativeData. UUID may be an alternative key, is a universally unique Customer Transaction Document identifier, can be assigned internally, and may be based on datatype GDT: UUID. Status may be optional, is a CustomerTransactionDocumentStatus, can describe one or more statuses of a Customer Transaction Document, and may be based on datatype BOIDT: CustomerTransactionDocumentStatus. Status can include Status/ConsistencyStatusCode, which may be optional, describes a status consisting of errors where business data is not consistent or where data includes errors, and may be based on datatype GDT: ConsistencyStatusCode. Status can include Status/CustomerContractTemplateLifeCycleStatusCode, which may be optional and may be based on datatype GDT: CustomerContractTemplateLifeCycleStatusCode.

The following composition relationships to subordinate nodes exist: Sales Entitlement Product Reference, with a cardinality of 1:C; SalesAndServiceBusinessArea, with a cardinality of 1:C; Covered Object, with a cardinality of 1:CN; DurationTerms, with a cardinality of 1:CN; InvoiceTerms, with a cardinality of 1:C; Item, with a cardinality of 1:CN; PricingTerms, with a cardinality of 1:C; SalesTerms, with a cardinality of 1:C; ServiceTerms, with a cardinality of 1:C; and TotalValues, with a cardinality of 1:C.

The following composition relationships to dependent objects exist: AccessControlList, with a cardinality of 1:1, which is a list of access groups that have access to a CustomerTransactionDocument; AttachmentFolder, with a cardinality of 1:C, which is an AttachmentContainer that is a collection of documents attached for a CustomerTransactionDocument; CashDiscountTerms, with a cardinality of 1:C, which are CashDiscountTerms that include data used for a CustomerTransactionDocument for handling payments; PriceAndTaxCalculation, with a cardinality of 1:C; which is a PriceAndTaxCalculation that includes price and tax components determined by one or more price and tax determinations/valuations that are valid for a CustomerTransactionDocument; and TextCollection, with a cardinality of 1:C, which is a TextCollection that is a collection of natural-language text that refers to a CustomerTransactionDocument.

The following inbound associations relationships may exist: Creation Identity, from the business object Identity/node Identity, with a cardinality of 1:CN, which is an identity of a user that created a Customer Transaction Document; and Last Change Identity, from the business object Identity/node Identity, with a cardinality of 1:CN, which is an identity of a user that last changed a Customer Transaction Document.

The following specialization associations for navigation may exist: Non Individual Covered Object, to the node Covered Object, with a target cardinality of CN, which is a Covered Object that is not an individual object. The following specialization associations for navigation may exist to the node Duration Terms: Minimum Validity Duration, with a target cardinality of C, which is a minimum duration during which a customer transaction document is valid; Reminder Duration, with a target cardinality of C, which is a duration before which a reminder for a customer transaction document is to be triggered; and Validity Duration, with a target cardinality of C, which is a duration during which a customer transaction document is valid.

In some implementations, TypeCode and ProcessingTypeCode are not changed after they have been created. In some implementations, SystemAdministrativeData is set internally by the system and such data is not assigned or changed externally. In some implementations, once a CustomerTransactionDocumentTemplate has been created, the document can be deleted only if no subsequent processes have been started that have a mapped status that forbids a delete action. If a document cannot be deleted, such a document can be canceled.

A Check Consistency action checks a CustomerTransactionDocument for errors and can set a ConsistencyStatus to either ‘Consistent’ or ‘Inconsistent’. A Copy action creates a customer transaction document from an existing customer transaction document, from which relevant data is copied. The two customer transaction documents are not necessarily linked in a business sense. The copy action creates a new customer transaction document of a same type as another document. An Activate action activates a customer transaction document. The Activate action can be applied at a root node of a customer transaction document. The Activate action can be relevant for customer transaction documents that have a status of “In Preparation”. The Activate action can set a life cycle status of a customer transaction document to “Active”.

A Block action blocks a customer transaction document. The Block action can be applied at the root node of a customer transaction document. The Block action can be relevant for those customer transaction documents that have a status of “Active”. The Block action can set the life cycle status of a customer transaction document to “Blocked”. An Unblock action unblocks a customer transaction document. The Unblock action can be applied at the root node of a customer transaction document. The Unblock action can be relevant for those customer transaction documents that have a status of “Blocked”. The Unblock action sets a life cycle status of a customer transaction document to “Active”. A Flag As Obsolete action flags a customer transaction document as obsolete. The Flag As Obsolete action can be applied at the root node of a customer transaction document. The Flag As Obsolete action can be relevant for those customer transaction documents that have a status of “Active” or “Blocked”. The Flag As Obsolete action sets a life cycle status of a customer transaction document to “Obsolete”. A Revoke Obsolescence action can be used to revoke an obsolescence of a customer transaction document. The Revoke Obsolescence action can be applied at a root node of a customer transaction document. The Revoke Obsolescence action can be relevant for those customer transaction documents that have a status of “Obsolete”. The Revoke Obsolescence action sets a life cycle status of a customer transaction document to “Blocked”.

A Query By Elements query returns a list of CustomerTransactionDocumentTemplate documents including specified selection criteria. The selection criteria can be specified by a logical ‘AND’ combination of query elements. The query elements are defined by the data type CustomerTransactionDocumentElementsQueryElements. These elements include: ID, Name, SearchText, and Status. Status can include Status/CreditWorthinessStatusCode and Status/ItemListFollowUpProcessingStatusCode. ID is a unique identifier assigned by a seller for a Customer Transaction Document, and may be based on datatype GDT: BusinessTransactionDocumentID. Name is a name of a Customer Transaction Document, and may be based on datatype GDT: MEDIUM_Name. SearchText includes free text including one or several word search terms used to search for a customer transaction document, and may be based on datatype GDT: SearchText. Status includes one or more statuses of a Customer Transaction Document, can correspond with same elements in the Root node, and may be based on datatype BOIDT: CustomerTransactionDocumentStatus. Status/CreditWorthinessStatus Code may be based on datatype GDT: CreditWorthinessStatusCode. Status/ItemListFollowUpProcessingStatusCode aggregates a follow-up processing status of one or more items, and may be based on datatype GDT: ProcessingStatusCode. A Select All query provides the NodeIDs of all instances of the node and can be used to enable an initial load of data for a Fast Search Infrastructure.

Sales Entitlement Product Reference is a reference to an entitlement product that allows a customer contract template to be sold as a product. An entitlement product is assigned to a customer contract template to offer and sell standardized contracts. As an example, suppose a company sells a standard package for platinum customer support that entitles customers to exceptional support. The elements located directly at the node Sales Entitlement Product Reference are defined by the inline structure APCRM_S_CTD_ENTLMNT_PRD_REF_EL. These elements include: ProductKey and ProductUUID. ProductKey can include ProductKey/ProductTypeCode, ProductKey/ProductidentifierTypeCode, and ProductKey/ProductID. ProductKey may be optional, is a grouping of elements that uniquely identifies a product by product type, product identifier type, and product ID, and may be based on datatype KDT: ProductKey. ProductKey/ProductTypeCode may be optional, is a coded representation of a product type such as a material or service, and may be based on datatype GDT: ProductTypeCode. ProductKey/ProductidentifierTypeCode may be optional, is a coded representation of a product identifier type, and may be based on datatype GDT: ProductidentifierTypeCode. ProductKey/ProductID may be optional, is an identifier for a product, and may be based on datatype GDT: ProductID. An entered entitlement product describes a contract template as a sellable product which can be different than an entitlement product entered in a customer contract or contract template item. An entitlement product of item group Entitlement—contract sale can be entered. ProductUUID may be optional, is a globally unique identifier for an entitlement product, and may be based on datatype GDT: UUID. An Entitlement inbound aggregation relationship may exist from the business object Entitlement Product/node Entitlement Product. with a cardinality of C:CN. The following specialization associations for navigation may exist to the node Customer Contract Template: Parent, with a target cardinality of 1; and Root, with a target cardinality of 1.

A SalesAndServiceBusinessArea is a business or service specific area within an enterprise that is valid for a CustomerTransactionDocument, such as, for example, sales organization, service organization, distribution channel, or division. The elements at the node Sales and Service Business Area can be derived from the organizational units Sales Unit or Service Unit (e.g., as indicated by Party responsible for the CustomerTransactionDocument). The elements can be overwritten manually. The elements located directly at the node Sales And Service Business Area are defined by the data type CustomerTransactionDocumentSalesAndServiceBusinessAreaElements. These elements include: SalesOrganisationID, DistributionChannelCode, Sales OrganisationUUID, SalesGroupUUID, SalesOfficeUUID, and ServiceOrganisationUUID. SalesOrganisationID may be optional, is an identifier for a sales organization that is responsible for a Customer Transaction Document, and may be based on datatype GDT: OrganisationalCentreID. DistributionChannelCode is a coded representation of a distribution channel by which goods and services reach customers, and may be based on datatype GDT: DistributionChannelCode. SalesOrganisationUUID is a universally unique identifier for a sales organization, and may be based on datatype GDT: UUID. SalesGroupUUID is a universally unique identifier for a sales group, and may be based on datatype GDT: UUID. SalesOfficeUUID is a universally unique identifier for a sales office, and may be based on datatype GDT: UUID. ServiceOrganisationUUID is a universally unique identifier for a service organization, and may be based on datatype GDT: UUID.

The following inbound aggregation relationships may exist: Sales Group, from the business object Functional Unit/node Functional Unit, with a cardinality of C:CN, which is a functional unit within the specialisation Sales Group; Sales Office, from the business object Functional Unit/node Functional Unit, with a cardinality of C:CN, which is a functional unit within the specialization Sales Office; Sales Organisation, from the business object Functional Unit/node Functional Unit, with a cardinality of C:CN, which is a functional unit with the specialization Sales Organisation; and Service Organisation, from the business object Functional Unit/node Functional Unit, with a cardinality of C:CN, which is a functional unit within the specialisation Service Organisation. The following specialization associations for navigation may exist to the node Customer Contract Template: Parent, with a target cardinality of 1; and Root, with a target cardinality of 1.

CoveredObject is an object that is covered by a CustomerTransactionDocument. Such an object can be a service product, a material, an individual material, or all products that are assigned to a particular product category, for example. The elements located directly at the node Covered Object are defined by the data type CustomerTransactionDocumentCoveredObjectElements. These elements include: ProductKey, ProductCategoryHierarchyProductCategoryIDKey, ProductUUID, ProductCategoryHierarchyProductCategoryUUID, and Description. ProductKey can include ProductKey/ProductTypeCode, ProductKey/ProductidentifierTypeCode, and ProductKey/ProductID. ProductCategoryHierarchyProductCategoryIDKey can include ProductCategoryHierarchyProductCategoryIDKey/ProductCategoryInternalID. ProductKey may be optional, is a grouping of elements that uniquely identifies a product in a covered object of a customer transaction document by product type, product identifier type, and/or product ID, and may be based on datatype KDT: ProductKey. ProductKey/ProductTypeCode may be optional, is a coded representation of a product type such as a material or service, and may be based on datatype GDT: ProductTypeCode. ProductKey/ProductidentifierTypeCode may be optional, is a coded representation of a product identifier type, and may be based on datatype GDT: ProductidentifierTypeCode. ProductKey/ProductID may be optional, is an identifier for a product, and may be based on datatype GDT: ProductID. ProductCategoryHierarchyProductCategoryIDKey may be optional, is a grouping of elements that uniquely identifies a product category of products covered by a customer transaction document, by product category hierarchy ID and/or product category ID, and may be based on datatype KDT: ProductCategoryHierarchyProductCategoryIDKey. ProductCategoryHierarchyProductCategoryIDKey/ProductCategoryHierarchyID may be optional, is an identifier for a product category hierarchy, and may be based on datatype GDT: ProductCategoryHierarchyID. ProductCategoryHierarchyProductCategoryIDKey/ProductCategoryInternalID may be optional, is an identifier for a product category, and may be based on datatype GDT: ProductCategoryInternalID. ProductUUID may be optional, is a globally unique identifier for a product, and may be based on datatype GDT: UUID. ProductCategoryHierarchyProductCategoryUUID may be optional, is a globally unique identifier for a product category, and may be based on datatype GDT: UUID. Description may be optional, is a description of a covered object in a customer transaction document, and may be based on datatype GDT: MEDIUM_Description.

The following inbound aggregation relationships may exist: Material, from the business object Material/node Material, with a cardinality of C:CN, which is a material covered by a customer transaction document; Product Category Hierarchy, from the business object Product Category Hierarchy/node Product Category, with a cardinality of C:CN; and Service Product, from the business object Service Product/node Service Product, with a cardinality of C:CN, which is a service product covered by a customer transaction document. The following specialization associations for navigation may exist to the node Customer Contract Template Parent, with a target cardinality of 1; and Root, with a target cardinality of 1. In some implementations, a ProductTypeCode is determined internally and is not subsequently changed. In some implementations, either a product or a product category can be specified, but not both at the same time.

DurationTerms is a duration related agreement for goods and services that can occur in a CustomerTransactionDocument. DurationTerms can occur in the following disjoint specializations with reference to a role of the duration DurationRoleCode: MaximumFirstReactionDuration, which is a duration before an expiration of which a reaction to a newly received service request or to a newly received service order is to occur, where the duration can be calculated from a Service Level Objective; MaximumCompletionDuration, which is a duration before an expiration of which a service request or service order is to have been completed, where the duration period can be calculated from a Service Level; RequestMaximumProviderCompletionDuration, which is a duration before an expiration of which a provider is to complete a request, where the duration period can be calculated from a Service Level Objective SLO; RequestTotalInitialReactionDuration, which is a total duration that elapses before a request is accessed for processing, where the duration can be calculated using status changes of a document, and where the duration can be represented by the expression ‘“In Process since”—“Opened At”+TotalInitialReactionDurationold’; RequestTotalProcessingDuration, which is a total duration of the processing of a request, where the duration can be calculated using status changes of a document, and where the duration can be represented by the expression ‘“Finished At”—“Opened At”+“TotalProcessingDuration old”; RequestTotalRequestorDuration, which is a total duration that a requestor needs for processing a request, where the duration can be calculated using status changes of a document, and where the duration can be represented by the expression “Finished At”—“Opened At”+“TotalRequestorDuration old”; and RequestTotalProviderProcessingDuration, which is a total duration that a provider needs for processing a request, where the duration can be calculated using status changes of a document, and where the duration can be represented by the expression ‘“Received from Provider At”—“Sent to Provider At”+“TotalProviderProcessingDuration old”.

The elements located directly at the node Duration Terms are defined by the data type CustomerTransactionDocumentDurationTermsElements. These elements include: DurationRoleCode, Duration, and DateCalculationFunctionReference. DurationRoleCode is a role of a specified duration, and may be based on datatype GDT: DurationRoleCode. Duration is a specification of a duration, and may be based on datatype GDT: Duration. DateCalculationFunctionReference is a reference to a function with which a duration is calculated, and may be based on datatype GDT: DateCalculationFunctionReference. The following specialization associations for navigation may exist to the node Customer Contract Template: Parent, with a target cardinality of 1; and Root, with a target cardinality of 1.

InvoiceTerms are agreements that apply for invoicing goods and services in a CustomerTransactionDocument. The elements located directly at the node Invoice Terms are defined by the data type CustomerTransactionDocumentInvoiceTermsElements. These elements include ProposedInvoiceDateDateCalculationFunctionReference and InvoicingBlockingReasonCode. ProposedInvoiceDateDateCalculationFunctionReference is a date rule for determining a proposed price date, and may be based on datatype GDT: DateCalculationFunctionReference. InvoicingBlockingReasonCode may be optional, specifies why processing of invoicing documents is blocked for a business transaction item, and may be based on datatype GDT: InvoicingBlockingReasonCode. The following specialization associations for navigation may exist to the node Customer Contract Template: Parent, with a target cardinality of 1; and Root, with a target cardinality of 1. In some implementations, at least one of the elements is set.

Item is an item of a customer-specific business transaction that focuses on delivering goods or providing a service, on prices, and/or on preparing an invoice. Item includes identifying and administrative item information in a CustomerTransactionDocument which, in addition to schedule lines, includes all data that applies to an item, for example, product information, parties involved, sales, delivery, and/or customer invoicing-specific agreements, status and references. Item can occur in the following specializations: Sales Service Item, Sales Service Quote Item, Service Contract Item, Customer Service Confirmation Item, Customer Spare Part Quote Item, Customer Service Quote Item, Customer Spare Part Confirmation Item, Customer Service Item, Customer Spare Part Item, Sales Item, Sales Quote Item, Complaint Item, Customer Return Item, Compensation Delivery Item, Refund Item, and Sales Contract Item. In some implementations, a specialization type is implemented by a Type attribute.

The elements located directly at the node Item are defined by the data type CustomerTransactionDocumentItemElements. These elements include: ID, TypeCode, ProcessingTypeCode, Description, UUID, SystemAdministrativeData, FulfilmentPartyCategoryCode, and Status. Status can include Status/ConsistencyStatusCode and Status/CustomerContractTemplateLifeCycleStatusCode. ID is a unique identifier for an item of a Customer Transaction Document, can be assigned by a seller in a Customer Transaction Document document, and may be based on datatype GDT: BusinessTransactionDocumentItemID TypeCode is a coded representation of a type of a Customer Transaction Document item, may be based on datatype GDT: BusinessTransactionDocumentItemTypeCode, can be set internally from a ProcessingTypeCode, and can include a permissible item specialization of the CustomerTransactionDocumentTemplate. An example of a TypeCode is a SalesItem. ProcessingTypeCode may be optional, is a coded representation of item processing of a Customer Transaction Document in a process component, and may be based on datatype GDT: Business TransactionDocumentItemProcessingTypeCode. For example, ProcessingTypeCode “Item type” or “item category” represents standard order items. Description is a description of a Customer Transaction Document item, and may be based on datatype GDT: SHORT_Description. UUID may be an alternative key, is an identifier for a Customer Transaction Document item, can be assigned internally, and may be based on datatype GDT: UUID. UUID can serve as an alternate key, with which other business objects can define foreign keys. SystemAdministrativeData includes administrative data stored in a system, such as system users and change dates/times, and may be based on datatype GDT: SystemAdministrativeData. FulfilmentPartyCategoryCode represents a Party category of a Fulfilment of a customer transaction document item, may be based on datatype GDT: FulfilmentPartyCategoryCode, and can define if a delivery of a material or a provision of a service is done by the internal company or by an external supplier. Status may be optional, describes one or more statuses of a Customer Transaction Document on an item level, and may be based on datatype BOIDT: CustomerTransactionDocumentItemStatus. Status/ConsistencyStatusCode may be optional, denotes if a Customer Transaction Document has errors, and may be based on datatype GDT: ConsistencyStatusCode. Status/CustomerContractTemplateLifeCycleStatusCode may be optional and may be based on datatype GDT: CustomerContractTemplateLifeCycleStatusCode.

The following composition relationships to subordinate nodes exist: Item Entitled Product, with a cardinality of 1:CN; ItemDurationTerms, with a cardinality of 1:CN; ItemPricingTerms, with a cardinality of 1:C; ItemProduct, with a cardinality of 1:C; ItemSalesTerms, with a cardinality of 1:C; ItemScheduleLine, with a cardinality of 1:CN; and ItemTotalValues, with a cardinality of 1:C. The following composition relationships to dependent objects exist: ItemAttachmentFolder, with a cardinality of 1:C, which is an ItemAttachmentContainer that is a collection of documents attached for an item of a CustomerTransactionDocument; ItemTextCollection, with a cardinality of 1:C, which is a collection of natural-language texts that refer to an item in a CustomerTransactionDocument; and Item Price Specification, with a cardinality of 1:CN.

The following inbound association relationships may exist: CreationIdentity, from the business object Identity/node Identity, with a cardinality of 1:CN, which is an identity of a user that created a Customer Transaction Document Item; and Last Change Identity, from the business object Identity/node Identity, with a cardinality of 1:CN, which is an identity of a user who last changed a Customer Transaction Document Item. The following specialization associations for navigation may exist: Parent, to the node Customer Contract Template, with a target cardinality of 1; Root, to the node Customer Contract Template, with a target cardinality of 1; and Price and Tax Calculation Item, to the node Item, with a target cardinality of C, which is an association to an item in the results of a price and tax calculation.

The following specialization associations for navigation may exist to the node Item Duration Terms Minimum Validity Item Duration, with a target cardinality of C, which is a minimum duration during which a customer transaction document item is valid; Reminder Item Duration, with a target cardinality of C, which is a duration before which a reminder for a customer transaction document item is to be triggered; and Validity Item Duration, with a target cardinality of C, which is a duration during which a customer transaction document item is valid. The following specialization associations for navigation may exist to the node Item Schedule Line: First Simulated Confirmed Item Schedule Line, with a target cardinality of C, which is an association to a first ItemScheduleLine that occurs in a SimulatedConfirmedItemScheduleLine specialization; and First Requested Item Schedule Line, with a target cardinality of C, which is an association to a ScheduleLine that occurs in a RequestedItemScheduleLine specialization.

In some implementations, the BuyerID and the ID are not changed after an item has been created. In some implementations, the ParentItemID and the HierarchyRelationshipTypeCode are not changed after an item has been created. In some implementations, the SystemAdministrativeData is set internally by the system and such data is not assigned or changed externally. In some implementations, the ParentItemID is not changed after an item has been created. In some implementations, the HierarchyRelationshipTypeCode is not changed after an item has been created. In some implementations, the ParentItemID, ParentItemUUID and HierarchyRelationshipTypeCode are set together. A Check Consistency action checks a CustomerTransactionDocument for errors and can set a ConsistencyStatus to either ‘Consistent’ or ‘Inconsistent’.

ItemEntitledProduct is an identification and description of a product, or of products assigned to a product category that a customer is entitled to release with reference to a CustomerTransactionDocument item. Such a product can be a service product, including expense, or a material as a spare part. The elements located directly at the node Item Entitled Product are defined by the data type CustomerTransactionDocumentItemEntitledProductElements. These elements include: ProductKey, ProductUUID, ProductCategoryHierarchyProductCategoryUUID, Description, and ProductCategoryHierarchyProductCategoryIDKey. ProductKey can include ProductKey/ProductTypeCode, ProductKey/ProductidentifierTypeCode, and ProductKey/ProductID.

ProductCategoryHierarchyProductCategoryIDKey can include ProductCategoryHierarchyProductCategoryIDKey/ProductCategoryHierarchyID and ProductCategoryHierarchyProductCategoryIDKey/ProductCategoryInternalID. ProductKey may be optional, is a grouping of elements that uniquely identifies an entitled product in a customer transaction document item by product type, product identifier type, and product ID, and may be based on datatype KDT: ProductKey. ProductKey/ProductTypeCode may be optional, is a coded representation of a product type such as a material or service, and may be based on datatype GDT: ProductTypeCode. ProductKey/ProductidentifierTypeCode may be optional, is a coded representation of a product identifier type, and may be based on datatype GDT: ProductidentifierTypeCode. ProductKey/ProductID may be optional, is an identifier for a product, and may be based on datatype GDT: ProductID. ProductCategoryHierarchyProductCategoryIDKey may be optional, is a grouping of elements that uniquely identifies a product category assigned to a product by product category hierarchy ID and product category ID, and may be based on datatype KDT: ProductCategoryHierarchyProductCategoryIDKey. ProductCategoryHierarchyProductCategoryIDKey/ProductCategoryHierarchyID may be optional, is an identifier for a product category hierarchy, and may be based on datatype GDT: ProductCategoryHierarchyID. ProductCategoryHierarchyProductCategoryIDKey/ProductCategoryInternalID may be optional, is an identifier for a product category, and may be based on datatype GDT: ProductCategoryInternalID. ProductUUID may be optional, is a globally unique identifier for a product, and may be based on datatype GDT: UUID. ProductCategoryHierarchyProductCategoryUUID may be optional, is a globally unique identifier for a product category, and may be based on datatype GDT: UUID. Description may be optional, is a description of an entitled product in a customer transaction document item, and may be based on datatype GDT: MEDIUM_Description.

The following inbound aggregation relationships may exist: Material, from the business object Material/node Material, with a cardinality of C:CN, which denotes a material in a customer transaction document item entitled product; Material_V1, from the business object Material/node Material, with a cardinality of C:CN, which is a material in a customer transaction document item entitled product; Product Category Hierarchy, from the business object Product Category Hierarchy/node Product Category, with a cardinality of C:CN; Service Product, from the business object Service Product/node Service Product, with a cardinality of C:CN; and ServiceProduct_V1, from the business object Service Product/node Service Product, with a cardinality of C:CN, which is a service product in a customer transaction document item entitled product.

The following specialization associations for navigation may exist: Root, to the node Customer Contract Template, with a target cardinality of 1; Parent, to the node Item, with a target cardinality of 1; and Item Price Specification, to the node Price Specification, with a target cardinality of CN. In some implementations, the ProductTypeCode is determined internally and cannot be subsequently changed. In some implementations, either a product or a product category can be specified, but not both at the same time.

ItemDurationTerms is a duration related agreement for goods and services that can occur at an item level in a CustomerTransactionDocument. Item Duration Terms can occur in the following specializations: Maximum First Reaction Item Duration Terms and Maximum Completion Item Duration Terms. In some implementations, a specialization type is implemented by a type Attribute. The elements located directly at the node Item Duration Terms are defined by the data type CustomerTransactionDocumentItemDurationTermsElements. These elements include: DurationRoleCode, Duration, and DateCalculationFunctionReference. DurationRoleCode is a role of a specified duration, and may be based on datatype GDT: DurationRoleCode. Duration is a specification of a duration, and may be based on datatype GDT: Duration. DateCalculationFunctionReference is a reference to a function with which a duration is calculated, and may be based on datatype GDT: DateCalculationFunctionReference. The following specialization associations for navigation may exist: Root, to the node Customer Contract Template, with a target cardinality of 1; and Parent, to the node Item, with a target cardinality of 1.

ItemPricingTerms are item-specific characteristics used for pricing and value dating goods and services in a CustomerTransactionDocument. The elements located directly at the node Item Pricing Terms are defined by the data type CustomerTransactionDocumentItemPricingTermsElements. These elements include: CurrencyCode, CustomerPricingProcedureDeterminationCode, PriceDateTime, PriceSpecificationCustomerGroupCode, CustomerGroupCode, PricePerPeriodIndicator, and GrossAmountIndicator. CurrencyCode may be optional, is a currency for a valuation of goods and services ordered in a document currency, and may be based on datatype GDT: CurrencyCode. CustomerPricingProcedureDeterminationCode may be optional, is a customer scheme for determining a pricing procedure proposed by a buyer or an ordering party, and may be based on datatype GDT: CustomerPricingProcedureDeterminationCode. PriceDateTime is a price date used to determine price specifications using a rule for automatic scheduling, and may be based on datatype GDT: LOCALNORMALISED_DateTime, with a qualifier of Price. PriceSpecificationCustomerGroupCode indicates a group of Labour Resources for which same price specifications are valid, and may be based on datatype GDT: PriceSpecificationCustomerGroupCode. CustomerGroupCode indicates a group of customers for general purposes, such as pricing and statistics proposed by a buyer or ordering party, and may be based on datatype GDT: CustomerGroupCode. PricePerPeriodIndicator may be optional, indicates if a price is defined for a specific period, e.g. a month, and may be based on datatype GDT: Indicator. GrossAmountIndicator may be optional, specifies whether a price and/or value is given as a gross amount including taxes, and may be based on datatype GDT: Indicator, with a qualifier of GrossAmount. The following specialization associations for navigation may exist: Root, to the node Customer Contract Template, with a target cardinality of 1; and Parent, to the node Item, with a target cardinality of 1. In some implementations, a currency and associated elements for currency conversion and a calculation procedure are not changed at an item-level. In some implementations, ItemPricingTerms are set as defaults from the PricingTerms and can be changed.

ItemProduct is an identification, description and classification of a product material or ServiceProduct in an item. The elements located directly at the node Item Product are defined by the data type CustomerTransactionDocumentItemProductElements. These elements include: ProductKey, ProductInternalID, ProductStandardID, QuantityMeasureUnitCode, QuantityTypeCode, ProductCategoryHierarchyProductCategoryIDKey, PriceSpecificationProductGroupCode, CashDiscountDeductibleIndicator, IdentifiedStockKey, ProductUUID, PricingProductKey, PricingProductUUID, and UUID. ProductKey can include ProductKey/ProductTypeCode, ProductKey/ProductidentifierTypeCode, and ProductKey/ProductID ProductCategoryHierarchyProductCategoryIDKey can include ProductCategoryHierarchyProductCategoryIDKey/ProductCategoryHierarchyID and ProductCategoryHierarchyProductCategoryIDKey/ProductCategoryInternalID IdentifiedStockKey can include IdentifiedStockKey/MaterialKey. PricingProductKey can include PricingProductKey/ProductTypeCode, PricingProductKey/ProductidentifierTypeCode, and PricingProductKey/ProductID.

ProductKey is a key to identify a product in a customer transaction document item, and may be based on datatype KDT: ProductUnformattedKey. ProductKey/ProductTypeCode is a coded representation of a product type, such as material or service, and may be based on datatype GDT: ProductTypeCode. ProductKey/ProductidentifierTypeCode is a coded representation of a product identifier type, and may be based on datatype GDT: ProductidentifierTypeCode. ProductKey/ProductID is an identifier for a product, and may be based on datatype GDT: NOCONVERSION_ProductID. ProductInternalID is an internal identifier of a product, and may be based on datatype GDT: ProductInternalID. ProductStandardID is a standard ID for a product, and may be based on datatype GDT: ProductStandardID.

QuantityMeasureUnitCode may be optional, is a unit of measure in which quantities are used for a product in a Customer Transaction Document, and may be based on datatype GDT: MeasureUnitCode. QuantityTypeCode is a type code in which quantities are used for a product in a Customer Transaction Document, and may be based on datatype GDT: QuantityTypeCode. ProductCategoryHierarchyProductCategoryIDKey is a key to identify a product category assigned to a product, and may be based on datatype KDT: ProductCategoryHierarchyProductCategoryIDKey. ProductCategoryHierarchyProductCategoryIDKey/ProductCategoryHierarchyID is an identifier for a product category hierarchy, and may be based on datatype GDT: ProductCategoryHierarchyID. ProductCategoryHierarchyProductCategoryIDKey/ProductCategoryInternalID is an identifier for a product category, and may be based on datatype GDT: ProductCategoryInternalID. PriceSpecificationProductGroupCode is a coded representation of a product group to which a product is assigned and for which specific price specifications apply, and may be based on datatype GDT: PriceSpecificationProductGroupCode. CashDiscountDeductibleIndicator specifies if a discount can be granted for a product, and may be based on datatype GDT: Indicator, with a qualifier of CashDiscountDeductible. IdentifiedStockKey is a key to identify an Identified Stock related to a corresponding material, and may be based on datatype KDT: IdentifiedStockKey. IdentifiedStockKey/MaterialKey is a grouping of elements that uniquely identifies a material, a sub-quantity of which is identified by an identified stock, and may be based on datatype KDT: ProductKey. ProductUUID is a UUID of a product, and may be based on datatype GDT: UUID. PricingProductKey is an identification of a product that is used for pricing, and may be based on datatype KDT: ProductKey. PricingProductKey/ProductTypeCode is a coded representation of a product type such as a material or service, and may be based on datatype GDT: ProductTypeCode. PricingProductKey/ProductidentifierTypeCode is a coded representation of a product identifier type, and may be based on datatype GDT: ProductidentifierTypeCode. PricingProductKey/ProductID is an identifier for a product, and may be based on datatype GDT: ProductID. PricingProductUUID is a UUID of a product that is used for pricing, and may be based on datatype GDT: UUID.

The following inbound aggregation relationships may exist: EntitlementProduct, from the business object Entitlement Product/node Entitlement Product, with a cardinality of C:CN, which denotes an entitlement product in a customer transaction document item; EntitlementProduct_V1, from the business object Entitlement Product/node Entitlement Product, with a cardinality of C:CN, which is an entitlement product in a customer transaction document item; Material, from the business object Material/node Material, with a cardinality of C:CN, which denotes a material in a customer transaction document item; Material_V1, from the business object Material/node Material, with a cardinality of C:CN, which is a material in a customer transaction document item; ServiceProduct, from the business object Service Product/node Service Product, with a cardinality of C:CN, which denotes a service product in a customer transaction document item; and ServiceProduct_V1, from the business object Service Product/node Service Product, with a cardinality of C:CN, which is a service product in a customer transaction document item.

The following specialization associations for navigation may exist: Root, to the node Customer Contract Template, with a target cardinality of 1; and Parent, to the node Item, with a target cardinality of 1. In some implementations, the ProductTypeCode is determined internally is not subsequently changed. In some implementations, the elements of the ItemProduct are taken as defaults from the Material or the ServiceProduct and can be changed.

ItemSalesTerms are item-specific agreements and conditions that apply for selling goods and services in a CustomerTransactionDocument. The elements located directly at the node Item Sales Terms are defined by the data type CustomerTransactionDocumentItemSalesTermsElements. These elements include: IndustrialSectorCode, IndustryClassificationSystemCode, ProductUsageCode, CustomerContractCancellationAgreementCode, CustomerInvoiceRequestCancellationScopeCode, and CustomerContractRenewalAgreementCode. IndustrialSectorCode represents an industrial sector assigned to a buyer ordering party. An industrial sector is a division of enterprises according to a focus of business activities. IndustrialSectorCode may be based on datatype GDT: IndustrialSectorCode. IndustryClassificationSystemCode represents an industry system assigned to a buyer ordering party. An industry system or industry classification system is a systematically structured hierarchy, as the case may be for a directory of industrial sectors, and may be based on datatype GDT: IndustryClassificationSystemCode. ProductUsageCode defines what a buyer ordering party uses a product for in a current process, and may be based on datatype GDT: ProductUsageCode. CustomerContractCancellationAgreementCode may be optional, is a coded representation of a customer contract cancellation agreement, and may be based on datatype GDT: CustomerContractCancellationAgreementCode. A customer contract cancellation agreement code specifies terms and conditions for cancellation of a customer contract as agreed upon by a customer and a supplier. The CustomerContractCancellationAgreementCode element is part of an item sales terms node of a Customer Transaction Document business object and can refer to a cancellation of a customer contract item. CustomerInvoiceRequestCancellationScopeCode may be optional, is a coded representation of a cancellation scope for customer invoice requests, and may be based on datatype GDT: CustomerInvoiceRequestCancellationScopeCode. On cancellation of a customer contract item, related invoice requests that have not yet been invoiced can either be canceled or kept for further processing. CustomerContractRenewalAgreementCode may be optional, is a coded representation of a customer contract renewal agreement, and may be based on datatype GDT: CustomerContractRenewalAgreementCode. A customer contract renewal agreement code specifies terms and conditions for renewal of a customer contract as agreed upon by a company and a customer, can be part of an item sales terms node of a Customer Transaction Document business object, and can refer to a renewal of a customer contract item. The following specialization associations for navigation may exist: Root, to the node Customer Contract Template, with a target cardinality of 1; and Parent, to the node Item, with a target cardinality of 1. In some implementations, ItemSalesTerms are set as defaults from the SalesTerms and can be changed. In some implementations, the following elements are not overwritten on an item: RegionCode, IndustrialSectorCode, IndustryClassificationSystemCode and ProductUsageCode. In some implementations, ConfirmationFixeIndicator is always set.

An ItemScheduleLine is an agreement regarding when products of an item are requested or provided and in what amount. Item Schedule Line occurs in the following complete, disjoint specializations:Requested Item Schedule Line, Confirmed Item Schedule Line, Promised Item Schedule Line, and Fulfilled Item Schedule Line. In some implementations, a specialization type is implemented by a Type attribute. The elements located directly at the node Item Schedule Line are defined by the data type CustomerTransactionDocumentItemScheduleLineElements. These elements include: ID, TypeCode, Quantity, QuantityTypeCode, UUID, RelatedUUID, and RelatedID. ID may be optional, is a unique identifier for an ItemScheduleLine assigned by a seller, and may be based on datatype GDT: BusinessTransactionDocumentItemScheduleLineID. TypeCode may be optional, is a coded representation of a type of an ItemScheduleLine such as RequestedScheduleLine, and may be based on datatype GDT: BusinessTransactionDocumentItemScheduleLineTypeCode. In some implementations, for ServiceProductItem, a BusinessTransactionDocumentItemScheduleLineTypeCode indicating Requested is allowed. In some implementations, for SparePartItem, BusinessTransactionDocumentItemScheduleLineTypeCodes corresponding to Requested, Confirmed and Promised are allowed. In some implementations, a BusinessTransactionDocumentItemScheduleLineTypeCode corresponding to Fulfilled is allowed. Quantity is a quantity with reference to TypeCode, and may be based on datatype GDT: Quantity. QuantityTypeCode qualifies a type of a quantity, and may be based on datatype GDT: QuantityTypeCode. UUID may be an alternative key, is a UUID of a scheduling line, and may be based on datatype GDT: UUID. RelatedUUID is a UUID of a corresponding schedule line that stands in relation to a current schedule line, and may be based on datatype GDT: UUID. RelatedID may be optional, is an ID of a corresponding schedule line that stands in relation to a current schedule line, and may be based on datatype GDT: BusinessTransactionDocumentItemScheduleLineID. The following specialization associations for navigation may exist: Root, to the node Customer Contract Template, with a target cardinality of 1; and Parent, to the node Item, with a target cardinality of 1. In some implementations, a time period for a requested schedule line can be proposed from a RequestedFulfilmentPeriod, and can be changed. In some implementations, in service product items, one RequestedScheduleLine is allowed. In some implementations, all ItemScheduleLines for an item use a same unit of measure.

ItemTotalValues are total values for an item resulting from an Item's dependent nodes. Examples include: a total desired delivery quantity or a confirmed quantity of an ItemScheduleLine, an item-specific gross or net weight, a volume, a gross and net value and tax amount, or shipment costs. Quantities, weights, volumes and values can be calculated by accumulation, and dates can be calculated by special logic. The elements located directly at the node Item Total Values are defined by the data type CustomerTransactionDocumentItemTotalValuesElements. These elements include: RequestedQuantity, RequestedQuantityTypeCode, NetAmount, NetPrice, and GrossAmount. RequestedQuantity is a total quantity requested of a Customer Transaction Document item, and may be based on datatype GDT: Quantity, with a qualifier of Requested. RequestedQuantityTypeCode qualifies a type of a requested quantity, and may be based on datatype GDT: QuantityTypeCode, with a qualifier of Requested. NetAmount is a net amount of a Customer Transaction Document item, and may be based on datatype GDT: Amount, with a qualifier of Net. NetPrice is a net price of a product in a CustomerTransacationDocumentTemplate item, and may be based on datatype GDT: Price, with a qualifier of Net. GrossAmount is a gross amount of a Customer Transaction Document item, and may be based on datatype GDT: Amount, with a qualifier of Gross. The following composition relationships to subordinate nodes exist: ItemTotalValuesPricingSubtotal, with a cardinality of 1:CN. The following specialization associations for navigation may exist: Root, to the node Customer Contract Template, with a target cardinality of 1; and Parent, to the node Item, with a target cardinality of 1. In some implementations, ItemTotalValues cannot be changed after being initialized.

TotalValuesPricingSubtotal is a condition subtotal of a specific type in a total value of all items that result from Pricing. Condition subtotals can be freely defined in configuration for Pricing, and can be transferred together with a code from Pricing. The elements located directly at the node Item Total Values Pricing Subtotal are defined by the data type CustomerTransactionDocumentItemTotalValuesPricingSubtotalElements. These elements include: TypeCode and Amount. TypeCode is a coded representation of a subtotal in a price calculation, and may be based on datatype GDT: PricingSubtotalTypeCode. Amount is a value of a condition subtotal, and may be based on datatype GDT: Amount. The following specialization associations for navigation may exist: Root, to the node Customer Contract Template, with a target cardinality of 1; and Parent, to the node Item Total Values, with a target cardinality of 1. In some implementations, the ItemTotalValuesPriceSubtotal cannot be changed.

PricingTerms are characteristics used for pricing and valuation of goods and services in a CustomerTransactionDocument. The elements located directly at the node Pricing Terms are defined by the data type CustomerTransactionDocumentPricingTermsElements. These elements include: CurrencyCode, CustomerPricingProcedureDeterminationCode, PriceDateTime, PriceSpecificationCustomerGroupCode, CustomerGroupCode, and GrossAmountIndicator. CurrencyCode may be optional, is a currency for a valuation of goods and services in an ordered document currency, and may be based on datatype GDT: CurrencyCode. CustomerPricingProcedureDeterminationCode may be optional, is a customer scheme for determining a pricing procedure proposed by a buyer or an ordering party, and may be based on datatype GDT: CustomerPricingProcedureDeterminationCode. PriceDateTime is a price date at which price specifications are determined using a rule for automatic scheduling, and may be based on datatype GDT: LOCALNORMALISED_DateTime, with a qualifier of Price. PriceSpecificationCustomerGroupCode is a group of customers for whom one or more same price specifications apply as suggested by a buyer or ordering party, and may be based on datatype GDT: PriceSpecificationCustomerGroupCode. CustomerGroupCode indicates a group of customers for general purposes, such as pricing and statistics, as proposed by a buyer or ordering party, and may be based on datatype GDT: CustomerGroupCode. GrossAmountIndicator may be optional, is an indicator that specifies whether a price and/or value is given as a gross amount including taxes, and may be based on datatype GDT: Indicator, with a qualifier of GrossAmount. The following specialization associations for navigation may exist to the node Customer Contract Template: Parent, with a target cardinality of 1; and Root, with a target cardinality of 1. In some implementations, exchange rate elements ExchangeRate are set together.

SalesTerms are agreements and conditions applicable for the sale of goods and services in a CustomerTransactionDocument. The elements located directly at the node Sales Terms are defined by the data type CustomerTransactionDocumentSalesTermsElements. These elements include: IndustrialSectorCode, IndustryClassificationSystemCode, ProductUsageCode, CustomerContractCancellationAgreementCode, CustomerInvoiceRequestCancellationScopeCode, and CustomerContractRenewalAgreementCode. IndustrialSectorCode indicates an industrial sector assigned to a buyer ordering party. An industrial sector is a division of enterprises according to a focus of business activities. IndustrialSectorCode may be based on datatype GDT: IndustrialSectorCode. IndustryClassificationSystemCode indicates an industry system assigned to a buyer ordering party. An industry system or industry classification system is a systematically structured hierarchy, as the case may be for a directory of industrial sectors. IndustryClassificationSystemCode may be based on datatype GDT: IndustryClassificationSystemCode. ProductUsageCode defines what a buyer ordering party uses a product for in a current process, and may be based on datatype GDT: ProductUsageCode. CustomerContractCancellationAgreementCode may be optional, is a coded representation of a customer contract cancellation agreement, and may be based on datatype GDT: CustomerContractCancellationAgreementCode. A customer contract cancellation agreement code specifies terms and conditions for cancellation of a customer contract as agreed upon by a customer and a supplier. CustomerInvoiceRequestCancellationScopeCode may be optional, is a coded representation of a cancellation scope for customer invoice requests, and may be based on datatype GDT: CustomerInvoiceRequestCancellationScopeCode. On cancellation of a customer contract item, related invoice requests that have not yet been invoiced can either be canceled or kept for further processing. CustomerContractRenewalAgreementCode may be optional, is a coded representation of a customer contract renewal agreement, and may be based on datatype GDT: CustomerContractRenewalAgreementCode. The following specialization associations for navigation may exist to the node Customer Contract Template: Parent, with a target cardinality of 1; and Root, with a target cardinality of 1.

ServiceTerms are conditions and agreements that apply for an execution of a service activity in a CustomerTransactionDocument and which can control processing. The elements located directly at the node Service Terms are defined by the data type CustomerTransactionDocumentServiceTermsElements. These elements include: ServiceLevelObjectiveID, ServiceLevelObjectiveUUID, ServiceLevelDeterminationMethodCode, and AllObjectsCoveredIndicator. ServiceLevelObjectiveID is an identifier for a Service Level Objective that specifies objectives for execution of services, and may be based on datatype GDT: ServiceLevelObjectiveID. ServiceLevelObjectiveUUID is a universally unique identifier for a Service Level Objective that specifies objectives for execution of services, and may be based on datatype GDT: UUID. ServiceLevelDeterminationMethodCode may be optional, is a coded representation of a method by which a service level is determined in a customer transaction document, and may be based on datatype GDT: ServiceLevelDeterminationMethodCode. In a service request or a service order a service level can be determined either automatically by determination rules, or can be copied from an assigned customer contract. When a service level has been copied from an assigned customer contract, the service level is not re-determined automatically by determination rules. In a customer contract, a service level can be entered manually. AllObjectsCoveredIndicator may be optional, is an indicator that specifies whether all objects are covered, and may be based on datatype GDT: Indicator. In some implementations, when AllObjectsCoveredIndicator is set, products or product categories are not specified in the covered objects node. A ServiceLevelObjective inbound aggregation relationship may exist from the business object Service Level Objective/node Service Level Objective, with a cardinality of C:CN, which specifies objectives for execution of services. The following specialization associations for navigation may exist to the node Customer Contract Template: Parent, with a target cardinality of 1; and Root, with a target cardinality of 1.

TotalValues are cumulated total values that occur in a CustomerTransactionDocument, for example, a total gross and net weight, a volume, a gross and net amount, a tax amount, and freight costs. The elements located directly at the node Total Values are defined by the data type CustomerTransactionDocumentTotalValuesElements. These elements include NetAmount, which is a total net amount in a Customer Transaction Document document, and may be based on datatype GDT: Amount, with a qualifier of Net. The following composition relationships to subordinate nodes exist: TotalValuesPricingSubtotal, with a cardinality of 1:CN. The following specialization associations for navigation may exist to the node Customer Contract Template: Parent, with a target cardinality of 1; and Root, with a target cardinality of 1. In some implementations, TotalValues are not changed externally.

TotalValuesPricingSubtotal is a condition subtotal of a specific type in a total value of all items that result from Pricing. Condition subtotals can be freely defined in configuration for Pricing, and can be transferred together with a code from Pricing. The elements located directly at the node Total Values Pricing Subtotal are defined by the data type CustomerTransactionDocumentTotalValuesPricingSubtotalElements. These elements include: TypeCode and Amount. TypeCode is a coded representation of a subtotal in a price calculation, and may be based on datatype GDT: PricingSubtotalTypeCode. Amount is a value of a condition subtotal, and may be based on datatype GDT: Amount. The following specialization associations for navigation may exist: Root, to the node Customer Contract Template, with a target cardinality of 1; and Parent, to the node Total Values, with a target cardinality of 1.

A number of implementations have been described. Nevertheless, it will be understood that various modifications may be made without departing from the spirit and scope of the disclosure. Accordingly, other implementations are within the scope of the following claims.

1. A computer readable medium including program code for providing a message-based interface for exchanging information about customer contracts the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for querying information about customer contract data, using a query by elements, the first message including a first message package derived from the common business object model, the first message package hierarchically organized in memory based on the common business object model, the first message package including:
a customer contract by elements query sync message entity;
a customer contract selection by elements package, a processing conditions package, and a requested elements package, wherein the customer contract selection by elements package includes at least one customer contract selection by elements entity, wherein the processing conditions package includes a processing conditions entity, and wherein the requested elements package including a requested elements entity;
program code for processing the first message according to the hierarchical organization of the first message package, where processing the first message includes unpacking the first message package based on the first message package's structure and the first message package's derivation from the common business object model, wherein the particular structure of the first message package is used at least in part to identify the purpose of the first message; and
program code for sending a second message to the heterogeneous application responsive to the first message, where the second message includes a second message package derived from the common business object model to provide consistent semantics with the first message package.

2. The computer readable medium of claim 1, wherein the customer contract selection by elements entity includes at least one of the following: at least one selection by identifier, at least one selection by item list customer contract life cycle status code, at least one selection by buyer party identifier, and at least one selection by last changed date time.

3. The computer readable medium of claim 1, wherein the requested elements entity includes a customer contact.

4. A distributed system operating in a landscape of computer systems providing message-based services defined in a service registry, the system comprising:
at least one processor operable to execute computer readable instructions embodied on non-transitory media;
a graphical user interface executable by the at least one processor and comprising computer readable instructions, embedded on non-transitory media, for querying information about customer contract data, using a query by elements, the instructions using a request;
a first memory storing a user interface controller executable by the at least one processor for processing the request and involving a message including a message package derived from a common business object model, where the common business object model includes business objects having relationships that enable derivation of message-based service interfaces and message packages, the message package hierarchically organized based on the common business object model, the hierarchical organization of the message package including:
a customer contract by elements query sync message entity;
a customer contract selection by elements package, a processing conditions package, and a requested elements package, wherein the customer contract selection by elements package includes at least one customer contract selection by elements entity, wherein the processing conditions package includes a processing conditions entity, and wherein the requested elements package including a requested elements entity;
and
a second memory, remote from the graphical user interface, storing a plurality of service interfaces executable by the at least one processor and derived from the common business object model to provide consistent semantics with messages derived from the common business object model, wherein one of the service interfaces is operable to process the message via the service interface according to the hierarchical organization of the message package, where processing the message includes unpacking the first message package based on the message package's structure and the message package's derivation from the common business object model, wherein the particular structure of the message package is used at least in part to identify the purpose of the message.

5. The distributed system of claim 4, wherein the first memory is remote from the graphical user interface.

6. The distributed system of claim 4, wherein the first memory is remote from the second memory.
